(19) United States
(12) Patent Application Publication
(10) Pub. No.: US 2016/0045867 A1
(43) Pub. Date: Feb. 18, 2016

(54) ZONE COATED CATALYTIC SUBSTRATES WITH PASSIVE NOX ADSORPTION ZONES

(71) Applicant: SDCmaterials, Inc., Tempe, AZ (US)

(72) Inventors: Bryant Kearl, Phoenix, AZ (US); Qinghua YIN, Tempe, AZ (US); Xiwang QI, Scottsdale, AZ (US); Maximilian A. BIBERGER, Scottsdale, AZ (US)

(21) Appl. No.: 14/812,661

(22) Filed: Jul. 29, 2015

Related U.S. Application Data
(60) Provisional application No. 62/030,550, filed on Jul. 29, 2014.
(60) Provisional application No. 62/121,440, filed on Feb. 26, 2015.

(51) Int. Cl. B01D 53/94; B01J 20/02; B01J 29/068; B01J 29/06; B01J 37/02; B01J 21/04; B01J 23/44; B01J 35/00; B01J 35/04; B01J 20/06; B01J 23/38

(52) U.S. Cl. CPC B01D 53/9418; B01J 20/06; B01J 20/02; B01J 29/068; B01J 29/06; B01J 23/38; B01J 21/04; B01J 23/44; B01J 35/0006; B01J 35/04; B01J 37/0244; B01J 37/0246; B01D 53/9431; B01D 53/9481; B01D 2255/1021; B01D 2255/1023; B01D 2255/50; B01D 2255/30; B01D 2255/2092; B01D 2253/1122; B01D 2253/1124; B01D 2255/902; B01D 2255/91

(57) ABSTRACT

Disclosed are methods of forming zone coated substrates for use in catalytic converters, as well as washcoat compositions and methods suitable for using in preparation of the zone coated substrates, and the zone coated substrates formed thereby. The zone coated substrates can include a Passive NOₓ Adsorption zone and a catalytic zone. Also disclosed are exhaust treatment systems, and vehicles, such as diesel vehicles, using catalytic converters and exhaust treatment systems using the zone coated substrates.

### CROSS-REFERENCE TO RELATED APPLICATIONS

This application claims priority benefit of U.S. Provisional Patent Application No. 62/030,550, filed Jul. 29, 2014, and U.S. Provisional Application No. 62/121,440, filed Feb. 26, 2015. The entire contents of those applications are hereby incorporated by reference herein.

### FIELD OF THE INVENTION

The present disclosure relates to the field of catalysts. More specifically, the present disclosure relates to nanoparticle catalysts, substrate washcoats, zone coated substrates, washcoat compositions, and catalytic converters formed from such washcoats and zone coated substrates.

### BACKGROUND OF THE INVENTION

Car exhaust primarily contains harmful gases such as carbon monoxide (CO), nitrogen oxides (NOₓ), and hydrocarbons (HC). Environmental concerns and government regulations have led efforts to remove these noxious combustion products from vehicle exhaust by conversion to more benign gases such as carbon dioxide (CO₂), nitrogen (N₂), and water (H₂O). In order to accomplish this conversion, the exhaust gases must pass through a treatment system that contains materials that can oxidize CO to CO₂, reduce NOₓ to N₂ and H₂O, and oxidize hydrocarbons to CO₂ and H₂O.

Emission regulations and standards are becoming more and more stringent worldwide, especially for NOₓ emissions. Two competing exhaust technologies to reduce the amount of NOₓ released into the atmosphere are Lean NOₓ Traps (LNT) and Selective Catalytic Reduction (SCR). LNTs absorb, store, or trap nitrogen oxides during lean-burn engine operation (i.e., when excess oxygen is present), and release and convert these gases when the oxygen content in the exhaust gas is reduced. An example of an LNT system can be found in International Patent Application PCT/US2014/061812 and U.S. Provisional Application 61/894,346, which are hereby incorporated by reference in their entirety. On the other hand, SCR units reduce nitrogen oxides regardless of the amount of oxygen in the exhaust gas. However, SCR units cannot properly reduce NOₓ emissions at low operating temperatures, for example, temperatures below 200° C.

Unfortunately, a significant portion of pollutant gases emitted by internal combustion engines are produced when the engine is initially started (“cold-start”), but before the catalytic converters, LNTs, or SCR units in the emissions system have warmed up to their operating temperatures. In order to reduce harmful emissions during the cold-start phase, such as that of a diesel or gasoline vehicle (for example, an automobile or truck), washcoats that contain temporary storage for pollutants can be used to coat the substrate used in the catalytic converter of the vehicle. After the catalytic converter heats up to its operating temperature, known as the light-off temperature (the temperature at which the conversion rate reaches 50% of the maximum rate), the stored gases are released and subsequently decomposed by the catalytic converter.

A high light-off temperature is undesirable, as many vehicular trips are of short duration, and during the time required for the catalytic converter to reach its operating temperature, pollutants must either be released untreated to the environment, or stored in the exhaust system until the light-off temperature is reached. Even if pollutants are trapped effectively prior to light-off, the catalytic converter may not reach operating temperature if multiple successive short trips are made. Thus, the washcoats used for storage may become saturated, resulting once again in the release of pollutants to the environment.

In addition, the exhaust temperature of an engine or vehicle can vary depending on the type of engine or vehicle. Thus, the operating temperature of the catalytically active material or the operating temperature of the SCR unit can vary depending on the engine and vehicle. For example, large engines (e.g., greater than 2.5 Liters) typically run colder than small engines (e.g., less than 2 Liters). Accordingly a tunable material used for storage of pollutants, where the release temperature can be adjusted or tuned up or down to accommodate varying operating temperatures in engines or vehicles, is desirable.

Commercially available catalytic converters use platinum group metal (PGM) catalysts deposited on substrates by wet chemistry methods, such as precipitation of platinum ions and/or palladium ions from solution onto a substrate. These PGM catalysts are a considerable portion of the cost of catalytic converters. Thus, any reduction in the amount of PGM catalysts used to produce a catalytic converter is desirable. Commercially available catalytic converters also display a phenomenon known as “aging,” in which they become less effective over time; the light-off temperature starts to rise as the catalytic converter ages, and emission levels also start to rise. Accordingly, reduction of the aging effect is also desirable, in order to prolong the efficacy of the catalytic converter for controlling emissions.

### SUMMARY OF THE INVENTION

The disclosed catalysts and washcoats may provide, among other advantages, catalytic converters with significantly reduced light-off temperatures, especially in comparison to aged commercially available catalysts prepared using only wet-chemistry methods for the deposition of platinum group metal, while using the same amount or less of platinum group metal. Alternatively, the described catalysts and washcoats may reduce the amount of platinum group metal used to attain the same light-off temperature as aged commercially available catalysts prepared using only wet-chemistry methods for the deposition of platinum group metal. Thus, improved performance of the emission control system (that is, reduced emissions of one or more regulated pollutant), and/or reduced cost of the emission control system may be attained, as compared to catalytic converters prepared using only the previous wet-chemistry methods for the deposition of platinum group metal.

The disclosed catalysts and washcoats described herein also include Passive NOₓ Adsorbers (PNAs). Described herein are coated substrates that include PNAs, washcoat formulations for preparing coated substrates with PNAs, methods for preparing coated substrates for use as PNAs, and systems incorporating coated substrates with PNAs in an emission-control system. The disclosed PNAs can adsorb NOₓ emissions at low start-up temperatures, and can release the adsorbed NOₓ at efficient operating temperatures (for example, at or above light-off temperature) and under lean conditions. In addition, the disclosed PNAs can reduce the amount of platinum group metals used in catalytic converters. At lower temperatures (temperatures where the T₅₀ of NOₓ has not yet been reached), NOₓ emissions can block the oxidation of carbon monoxide and hydrocarbons. Thus, storing NOₓ emissions at lower temperatures and releasing them at higher temperatures (such as temperatures above the T₅₀ temperature of NOₓ), can decrease the amount of PGMs needed to oxidize car exhaust pollutants. Furthermore, the PNA materials disclosed may also be able to store as many NOₓ emissions as possible at temperatures from ambient up to a maximum storage temperature, where the maximum storage temperature is tailored to the type of engine and vehicle employed. Thus, the disclosed PNA materials can be tunable to store NOₓ emissions in some instance only up to about 100° C., in some cases up to about 150° C., and in some cases up to about 200° C. or higher. Regardless of the maximum storage temperature, the PNA materials can exhibit a “sharp” release temperature slightly above the maximum storage temperature.

The coated substrates described herein can be zone coated substrates. “Zone coated substrates” are a subset of coated substrates,” and any embodiments herein described for coated substrates are applicable to zone coated substrates where physically feasible. Zone coating can be used to separate various washcoat formulations or washcoat layers into different regions on a substrate, rather than having the washcoat formulations or washcoat layers in the same region on the substrate. In other words, instead of coating a substrate with a first washcoat, and then coating the substrate with a second washcoat disposed on top of the first washcoat, the substrate can be coated in one region or zone with a first washcoat, and then in a different region or zone with another washcoat, so that the contact (or overlap) between different washcoats can be adjusted as desired, including minimizing contact or eliminating contact between different washcoats. By zone coating the substrate, particular washcoat formulations can be applied to particular zones of the substrate in a particular combination to achieve a certain result. For example, some washcoat formulations or washcoat layers inhibit or reduce the ability of other washcoat formulations or washcoat layers from fully functioning when they are in the same region (same zone) on a substrate. By separating washcoats into different zones, such a result can be avoided.

Washcoat formulations comprising the catalytic material, zeolites, or PNA material may be used to provide one or more layers in a coating on one or more zones or sections of a substrate used for catalysis, such as a catalytic converter substrate. Accordingly, one or more washcoat formulations can be used to provide one or more layers in a coating on a first zone of a substrate and one or more washcoat formulations can be used to provide one or more layers in a coating on a second zone of a substrate. The substrates can have more than one zone, each with one or more washcoat formulations to provide one or more layers in a coating to a zone of the substrate. In addition, some of the zones of the substrate may not contain any washcoat formulation or washcoat layer in a coating. Furthermore, a portion or part of one zone coating can overlap with another zone's coating. It is also possible for one or more of the zones of the substrate to share a common washcoat formulation or washcoat layer, such as a corner fill layer.

In some embodiments, a coated substrate comprises a substrate comprising a first zone and a second zone; the first zone comprising a Passive NOₓ Adsorber (PNA) layer comprising nano-sized platinum group metal (PGM) on a plurality of support particles comprising cerium oxide; and the second zone comprising a first catalytic layer comprising a first composite nanoparticle, wherein the first composite nanoparticle comprises a first catalytic nanoparticle on a first support nanoparticle. The first composite nanoparticle can be plasma created. The coated substrate can include a third zone between the first zone and the second zone. The third zone can be uncoated. In addition, the third zone may only include a corner-fill layer. Furthermore, a portion of the first zone and the second zone can overlap. For example, the PNA layer may overlap the first catalytic layer or the first catalytic layer can overlap the PNA layer.

Any and all composite nanoparticles can be bonded to micron-sized carrier particles to form NNm particles. For example, the first composite nanoparticle can be bonded to a micron-sized carrier particle to form a first NNm particle. In addition, any and all composite nanoparticles can be embedded within carrier particles to form NNiM particles. For example, the first composite nanoparticle can be embedded within carrier particles to form a first NNiM particle. The second zone of the substrate can include a second catalytic layer. The second catalytic layer can comprise a second composite nanoparticle, wherein the second composite nanoparticle comprises a second catalytic nanoparticle on a second support nanoparticle. The second catalytic layer can be formed on top of the first catalytic layer. Any and all catalytic nanoparticles can include at least one platinum group metal. For example, the first, second, or first and second catalytic nanoparticles can include at least one platinum group metal Any and all catalytic nanoparticles can include platinum and palladium. For example, the first, second, or first and second catalytic nanoparticles can comprise platinum and palladium. The weight ratio of platinum to palladium can be 2:1 to 10:1 platinum:palladium. The support nanoparticles can have an average diameter of 5 nm to 20 nm. For example, the first, second, or first and second support nanoparticles can have an average diameter of 5 nm to 20 nm. The catalytic nanoparticles can have an average diameter between 1 nm and 5 nm. For example, the first, second, or first and second catalytic nanoparticles can have an average diameter of between 1 nm and 5 nm.

The second zone of the substrate can include a zeolite layer comprising zeolite particles. The zeolite layer may not include platinum group metals. The zeolite layer can be formed on top of the catalytic layer(s) and the catalytic layer(s) can be formed on top of the zeolite layer. For example, the zeolite layer can be formed on top of the first catalytic layer or on top of the second catalytic layer. In addition, the first catalytic layer can be formed on top of the zeolite layer. A second catalytic layer can be formed on top of the first catalytic layer. The first catalytic layer can include a weight ratio of 2:1 to 4:1 platinum:palladium. The second catalytic layer can include a weight ratio of 10:1 platinum:palladium. Any catalytic layer can be substantially free of zeolites. For example, the first, second, or first and second catalytic layer can be substantially free of zeolites. In the disclosed embodiments, when a layer (layer Y) is said to be formed “on top of” another layer (layer X), either no additional layers, or any number of additional layers (layer(s) A, B, C, etc.) can be formed between the two layers X and Y. For example, if layer Y is said to be formed on top of layer X, this can refer to a situation where layer X can be formed, then layer A can be formed immediately atop layer X, then layer B can be formed immediately atop layer A, then layer Y can be formed immediately atop layer B. Alternatively, if layer Y is said to be formed on top of layer X, this can refer to a situation where layer Y can be deposited directly on top of layer X with no intervening layers between X and Y. For the specific situation where no intervening layers are present between layer X and layer Y, layer Y is said to be formed immediately atop layer X, or equivalently, layer Y is said to be formed directly on top of layer X.

The PNA layer can store NOₓ gas up to at least a first temperature and can release the stored NOₓ gas at or above the first temperature. The first temperature can be 150° C. The first temperature can also be 300° C. The plurality of support particles can be micron-sized. The plurality of support particles can be nano-sized. The plurality of support particles can include zirconium oxide, lanthanum oxide, yttrium oxide, or a combination thereof. The plurality of support particles can be HSA5, HSA20, or a mixture thereof. The nano-sized PGM on the plurality of support particles can be produced by wet chemistry techniques followed by calcination. The nano-sized PGM on the plurality of support particles can be produced by incipient wetness followed by calcination. The nano-sized PGM on the plurality of support particles can comprise PNA composite nanoparticles, wherein the PNA composite nanoparticles can include a PGM nanoparticle on a third support nanoparticle comprising cerium oxide. The PNA composite nanoparticles can be bonded to micron-sized carrier particles to form second NNm particles. The PNA composite nanoparticles can be embedded within carrier particles to form second NNiM particles. The carrier particles can include cerium oxide, zirconium oxide, lanthanum oxide, yttrium oxide, or a combination thereof. The carrier particles can include 86 wt. % cerium oxide, 10 wt. % zirconium oxide, and 4 wt. % lanthanum oxide.

The nano-sized PGM can comprise palladium. The PNA layer can comprise about 2 g/L to about 4 g/L Pd, including 3 g/L Pd. The nano-sized PGM can comprise ruthenium. The PNA layer can comprise about 3 g/L to about 15 g/L Ru, including 5 g/L to 6 g/L Ru. The coated substrate can be used in any engine system including engine systems greater than or equal to 2.5 L and less than or equal to 2.5 L. The PNA layer can include greater than or equal to about 150 g/L of the plurality of support particles. The PNA layer can include greater than or equal to about 300 g/L of the plurality of support particles. The PNA layer can include boehmite particles. The nano-sized PGM on the plurality of support particles can include 95-98% by weight of the mixture of the nano-sized PGM on the plurality of support particles and boehmite particles in the PNA layer. The boehmite particles can include 2-5% by weight of the mixture of the nano-sized PGM on the plurality of support particles and boehmite particles in the PNA layer.

The substrate can comprise cordierite. The substrate can comprise a honeycomb structure. The coated substrate can include a corner-fill layer deposited directly on the substrate. The corner-fill layer can be deposited directly on the second zone of the substrate. The corner-fill layer can be deposited directly on the first and second zone of the substrate.

Any and all composite nanoparticles can be plasma created.

In some embodiments, a catalytic converter comprises a coated substrate according to any of the disclosed embodiments. In some embodiments, an exhaust treatment system comprises a conduit for exhaust gas and a catalytic converter comprising a coated substrate according to any of the disclosed embodiments. In some embodiments, a vehicle comprises a catalytic converter comprising a coated substrate according to any of the disclosed embodiments. The vehicle can comply with European emission standard Euro 5 or Euro 6. The vehicle can be a diesel vehicle including a light-duty diesel vehicle or a heavy-duty diesel vehicle.

In some embodiments, a method of treating an exhaust gas comprises contacting the coated substrate of any of the disclosed embodiments with the exhaust gas. The substrate can be housed within a catalytic converter configured to receive the exhaust gas. In some embodiments, the exhaust gas first contacts the first zone of the substrate before contacting the second zone of the substrate.

In some embodiments, a method of forming a coated substrate comprises coating a first zone of a substrate with a Passive NOx Adsorber (PNA) washcoat composition comprising nano-sized platinum group metal (PGM) on a plurality of support particles comprising cerium oxide; and coating a second zone of the substrate with a first catalytic washcoat composition comprising a first composite nanoparticle, wherein the first composite nanoparticle comprises a first catalytic nanoparticle and a second support nanoparticle. The method can include leaving an uncoated gap between the first zone and the second zone of the substrate. The second zone can be coated prior to coating the first zone. In addition, the first zone can be coated prior to coating the second zone. Furthermore, at least a portion of the zones may overlap. For example, at least a portion of the PNA washcoat composition can overlap at least a portion of the first catalytic washcoat composition or at least a portion of the first catalytic washcoat composition can overlap at least a portion of the PNA washcoat composition. The method can include coating the second zone of the substrate with a second catalytic washcoat composition. The second catalytic washcoat composition can include a second composite nanoparticle, wherein the second composite nanoparticle can comprise a second catalytic nanoparticle on a second support nanoparticle. The second zone of the substrate can be coated with the first catalytic washcoat composition before coating the second zone with the second catalytic washcoat composition. The method can include coating the second zone of the substrate with a zeolite washcoat composition comprising zeolite particles. The second zone of the substrate can be coated with the zeolite washcoat composition before coating the second zone with the first and/or second catalytic washcoat composition. The second zone of the substrate can be coated with the first and/or second catalytic washcoat composition before coating the second zone with the zeolite washcoat composition. The second zone of the substrate can be coated with a first catalytic washcoat composition before coating the second zone with a second catalytic washcoat composition. The variations described above for the previously described coated substrates, PNA layers, catalytic layers, and zeolite layers are also applicable to the method of forming a coated substrate.

In some embodiments, a method of treating an exhaust gas comprises contacting a coated substrate with an exhaust gas comprising NOₓ emissions, wherein the coated substrate comprises: a substrate comprising a first zone and a second zone; the first zone comprising a Passive NOx Adsorber (PNA) layer comprising nano-sized platinum group metal (PGM) on a plurality of support particles comprising cerium oxide; and the second zone comprising a first catalytic layer comprising a first composite nanoparticle, wherein the first composite nanoparticle can comprise a first catalytic nanoparticle on a first support nanoparticle. The method can include contacting the first zone of the substrate with the exhaust gas before contacting the second zone of the substrate with the exhaust gas. The variations described above for the previously described coated substrates, PNA layers and washcoat compositions, catalytic layers and washcoat compositions, and zeolite layers and washcoat compositions are also applicable to the method of treating an exhaust gas.

In some embodiments, a catalytic converter comprises a coated substrate comprising: a substrate comprising a first zone and a second zone. The first zone can include a PNA layer comprising nano-sized PGM on a plurality of support particles comprising cerium oxide and the second zone can include a first catalytic layer comprising a first composite nanoparticle, wherein the first composite nanoparticle can comprise a first catalytic nanoparticle and a second support nanoparticle. The variations described above for the previously described coated substrates, PNA layers and washcoat compositions, catalytic layers and washcoat compositions, and zeolite layers and washcoat compositions are also applicable to the catalytic converter.

In some embodiments, a vehicle comprises a catalytic converter comprising a coated substrate comprising: a substrate comprising a first zone and a second zone; the first zone comprising a PNA layer comprising nano-sized PGM on a plurality of support particles comprising cerium oxide; and the second zone comprising a first catalytic layer comprising a first composite nanoparticle, wherein the first composite nanoparticle comprises a first catalytic nanoparticle and a first support nanoparticle. The vehicle can be a diesel vehicle including a light-duty or heavy-duty diesel vehicle. The vehicle can also comply with European emission standard Euro 5 or Euro 6. The vehicle can also include an SCR unit. The SCR unit can be downstream the catalytic converter. The vehicle can also include an LNT. The variations described above for the previously described coated substrates, PNA layers and washcoat compositions, catalytic layers and washcoat compositions, zeolite layers and washcoat compositions, and catalytic converters are also applicable to the vehicle.

In some embodiments, an exhaust treatment system comprises a conduit for exhaust gas comprising NOₓ emissions and a catalytic converter comprising a coated substrate comprising: a substrate comprising a first zone and a second zone; the first zone comprising a PNA layer comprising nano-sized PGM on a plurality of support particles comprising cerium oxide; and the second zone comprising a first catalytic layer comprising a first composite nanoparticle, wherein the first composite nanoparticle comprises a first catalytic nanoparticle and a first support nanoparticle. The exhaust treatment system can include an SCR unit. The SCR unit can be downstream the catalytic converter. The exhaust treatment system can include an LNT. The exhaust treatment system can comply with European emission standard Euro 5 or Euro 6. The variations described above for the previously described coated substrates, PNA layers and washcoat compositions, catalytic layers and washcoat compositions, zeolite layers and washcoat compositions, catalytic converters, and vehicles are also applicable to the exhaust treatment system.

In any of the embodiments, the micron-sized carrier particles may comprise one or more platinum group metals deposited by wet chemistry methods. This can be followed by calcination.

It is understood that aspects and embodiments of the invention described herein include “consisting” and/or “consisting essentially of” aspects and embodiments. For all methods, systems, compositions, and devices described herein, the methods, systems, compositions, and devices can either comprise the listed components or steps, or can “consist of” or “consist essentially of” the listed components or steps. When a system, composition, or device is described as “consisting essentially of” the listed components, the system, composition, or device contains the components listed, and may contain other components which do not substantially affect the performance of the system, composition, or device, but either do not contain any other components which substantially affect the performance of the system, composition, or device other than those components expressly listed; or do not contain a sufficient concentration or amount of the extra components to substantially affect the performance of the system, composition, or device. When a method is described as “consisting essentially of” the listed steps, the method contains the steps listed, and may contain other steps that do not substantially affect the outcome of the method, but the method does not contain any other steps which substantially affect the outcome of the method other than those steps expressly listed.

Any of the embodiments described above and herein are suitable for use in gasoline engines and in diesel engines, such as light-duty or heavy-duty diesel engines, and diesel vehicles, such as light-duty or heavy-duty diesel vehicles.

The systems, compositions, substrates, and methods described herein, including any embodiment of the invention as described herein, may be used alone or may be used in combination with other systems, compositions, substrates, and methods.

### BRIEF DESCRIPTION OF THE DRAWINGS

FIG. 1 illustrates a catalytic converter in accordance with some embodiments of the present disclosure, while FIG. 1A is a magnified view of a portion of the drawing of FIG. 1.

FIG. 2 illustrates a method of forming a coated substrate in accordance with some embodiments of the present disclosure.

FIGS. 3A-C illustrate formation of a coated substrate at different stages of a washcoat coating method in accordance with some embodiments of the present disclosure.

FIG. 4 compares the performance of one embodiment of the present disclosure (filled circles) to a combined washcoat (filled squares).

FIG. 5 illustrates a method of forming a coated substrate in accordance with some embodiments of the present disclosure.

FIGS. 6A-C illustrate formation of a coated substrate at different stages of a washcoat coating method in accordance with some embodiments of the present disclosure.

FIG. 7 illustrates a method of forming a coated substrate in accordance with some embodiments of the present disclosure.

FIGS. 8A-D illustrate formation of a coated substrate at different stages of a washcoat coating method in accordance with some embodiments of the present disclosure.

FIG. 9 shows a single rectangular channel in a coated substrate prepared according to one embodiment of the present disclosure.

FIG. 10 compares the performance of one embodiment of the present disclosure (filled circles) to a standard commercially available catalytic converter (filled squares).

FIG. 11 shows a comparison of midbed catalytic converter gases of certain embodiments of the present disclosure versus a standard commercially available catalytic converter.

FIG. 12 illustrates a method of forming a coated substrate in accordance with some embodiments of the present disclosure.

FIG. 13A-D illustrate formation of a coated substrate at different stages of a washcoat coating method in accordance with some embodiments of the present disclosure.

FIG. 14A-C illustrate coated substrate formations in accordance with some embodiments of the present disclosure.

FIG. 15 is a graph demonstrating the NOₓ emission adsorption and release for manganese based PNA material across an operating temperature spectrum.

FIG. 16 is a graph demonstrating the NOₓ emission adsorption and release for magnesium based PNA material across an operating temperature spectrum.

FIG. 17 is a graph demonstrating the NOₓ emission adsorption and release for calcium based PNA material across an operating temperature spectrum.

FIG. 18 is an illustration demonstrating the exhaust flow to a coated substrate containing a PNA zone and DOC zone.

FIG. 19 is a graph demonstrating NOₓ emission storage comparison performance of a catalytic converter employing PNA material as described herein to a commercially available catalytic converter.

FIG. 20 is a graph demonstrating tailpipe emission comparison performance of a catalytic converter employing PNA material as described herein to a commercially available catalytic converter.

FIG. 21 illustrates performance data for a catalyst of the disclosure prepared as described in Example 9, as compared to the performance of a commercially available catalyst.

FIG. 22A illustrates one method of forming a coated substrate with more than one catalytic washcoat layer in accordance with some embodiments of the present disclosure.

FIG. 22B illustrates one embodiment of a coated substrate with more than one catalytic washcoat layer according to the present disclosure.

### DETAILED DESCRIPTION OF THE INVENTION

Described are composite nanoparticle catalysts, washcoat formulations/compositions, zone coated substrates, and catalytic converters. Also described are methods of making and using these composite nanoparticle catalysts, washcoat formulations, coated substrates, and catalytic converters. Throughout the specification, the term “coated substrate” includes embodiments where the substrate is a zone-coated substrate. In addition, a “coated substrate” can refer to one zone, region, or portion of a zone coated substrate. The disclosure also embraces catalyst-containing washcoat compositions, and methods of making the washcoats by combining the various washcoat ingredients. It has been found that the described composite nanoparticle catalysts and washcoat solutions provide for increased performance relative to prior catalysts and washcoat formulations when used to produce catalytic converters, allowing for the production of catalytic converters having reduced light-off temperatures, reduced emissions, and/or reduced platinum group metal loading requirements, as compared to catalytic converters having catalysts prepared using only wet-chemistry methods for the deposition of platinum group metal.

In addition, described are zone coated substrates and catalytic converters wherein at least one zone of the substrate and/or catalytic converter includes a PNA material (i.e., composition). The PNA materials may be able to store as many NOₓ emissions as possible at temperatures from ambient to about 100° C., 150° C., 200° C., 250° C., or 300° C., for example. The PNA materials may exhibit a “sharp” release temperature under lean conditions (i.e., releases the stored NOₓ emissions at slightly above about 100° C., 150° C., 200° C., 250° C., or 300° C., for example). High release temperatures and/or long release “tails” are not desirable because these high temperatures may not be reached prior to the engine being turned off. Thus, all the initially adsorbed NOₓ emissions may not be released from the PNA materials before the engine is running again, therefore prohibiting adsorption repeatability in the PNA materials. In addition, the PNA material may be cost efficient, may be able to handle sulfur rich fuels (i.e., can be sulfurized and de-sulfurized), and can be introduced independently to the oxidation material.

The PNA materials may also be able to store as many NOₓ emissions as possible at temperatures from ambient up to a maximum variable temperature. The maximum variable temperature can change depending on the type of engine and vehicle employed. Thus, the disclosed PNA materials can be tunable to store NOₓ emissions in some instance only up to about 100° C., in some cases up to about 150° C., in some cases up to about 200° C., and in some cases up to about 300° C. Regardless of the maximum variable temperature, the PNA materials may exhibit a “sharp” release temperature slightly above the maximum variable temperature.

It is understood that the coated substrates described herein, catalytic converters using the coated substrates described herein, and exhaust treatment systems using the coated substrates described herein, are particularly useful for diesel engines and diesel vehicles, especially light-duty or heavy-duty diesel engines and light-duty or heavy-duty diesel vehicles.

The composite nanoparticles described herein include catalytic (or PGM) nanoparticles and support nanoparticles that are bonded together to form nano-on-nano composite nanoparticles. The composite nanoparticles may be produced, for example, in a plasma reactor so that consistent and tightly bonded nano-on-nano composite particles are produced. These composite nanoparticles can then be bonded to a micron-sized carrier particle to form micron-sized catalytically active particles (“nano-on-nano-on-micro” particles or NNm particles). The nano-on-nano composite particles are predominantly located at or near the surface of the resulting micron-sized particles. Alternatively, the composite nanoparticles can be embedded within a porous carrier to produce micron-sized catalytic particles (“nano-on-nano-in-micro” particles or NNiM particles). In this configuration, the nano-on-nano composite nanoparticles are distributed throughout the micron-sized carrier particles. In addition, hybrid NNm/wet-chemistry particles can be formed. These micron-sized catalytically active particles bearing composite nanoparticles (i.e., NNm, NNiM, and hybrid NNm/wet-chemistry particles) may offer better initial engine start-up performance, better performance over the lifetime of the catalyst and/or NOₓ storage material, and/or less decrease in performance over the life of the catalyst and/or NOₓ storage material, as compared to previous catalysts and NOₓ storage materials used in catalytic converters.

Further, the washcoat formulations may be formulated in order to provide one or more layers on a catalyst substrate in one or more zones on the catalyst substrate, such as a catalytic converter substrate. In some embodiments, the washcoat formulations may form two or more layers in which catalytically active material, such as micron-sized catalytically active particles bearing composite nano particles, are in a separate layer than a layer containing the PNA material. One embodiment, for example, is a multi-zoned washcoat in which a first washcoat layer includes the PNA material and a second, distinct washcoat layer includes a catalytically active material (i.e., oxidative and/or reductive material). The layer with the PNA material may include no catalytically active material, and the second layer with the catalytically active material may include no PNA material. In addition, the PNA layer can be in a first zone of the substrate and the catalytically active layer can be in a second zone on the substrate. The order and placement of these two layers on a substrate may be changed in different embodiments and, in further embodiments, additional washcoat formulations/layers may also be used over, under, or between the washcoats, for example, a corner-fill washcoat layer which is initially deposited on the substrate to be coated or a washcoat layer containing zeolites which is deposited on the catalytically active layer. In other embodiments, the two layers can be directly disposed on each other, that is, there are no intervening layers between the first and second washcoat layers. The described washcoat formulations may include a lower amount of platinum group metals. In addition, the described washcoat may offer better performance when compared to previous washcoat formulations, particularly when these washcoat formulations utilize the micron-sized particles bearing composite nano-particles.

The coated substrates, catalytic converters, and exhaust treatment systems described herein are useful for vehicles employing a selective catalytic reduction (SCR) system, a lean NOₓ trap (LNT) system, or other NOₓ storage catalyst (NSC) system. It is understood that the coated substrates described herein, catalytic converters using the coated substrates described herein, and exhaust treatment systems using the coated substrates described herein useful for either gasoline or diesel engines, and either gasoline or diesel vehicles. These coated substrates, catalytic converters, and exhaust treatment systems are especially useful for light-duty or heavy-duty engines and light-duty or heavy-duty diesel vehicles.

Various aspects of the disclosure can be described through the use of flowcharts. Often, a single instance of an aspect of the present disclosure is shown. As is appreciated by those of ordinary skill in the art, however, the protocols, processes, and procedures described herein can be repeated continuously or as often as necessary to satisfy the needs described herein. Additionally, it is contemplated that certain method steps can be performed in alternative sequences to those disclosed in the flowcharts.

When numerical values are expressed herein using the term “about” or the term “approximately,” it is understood that both the value specified, as well as values reasonably close to the value specified, are included. For example, the description “about 50° C.” or “approximately 50° C.” includes both the disclosure of 50° C. itself, as well as values close to 50° C. Thus, the phrases “about X” or “approximately X” include a description of the value X itself. If a range is indicated, such as “approximately 50° C. to 60° C.,” it is understood that both the values specified by the endpoints are included, and that values close to each endpoint or both endpoints are included for each endpoint or both endpoints; that is, “approximately 50° C. to 60° C.” is equivalent to reciting both “50° C. to 60° C.” and “approximately 50° C. to approximately 60° C.”

As used herein, the term “embedded” when describing nanoparticles embedded in a porous carrier includes the term “bridged together by” when describing nanoparticles bridged together by a porous carrier, and refers to the configuration of the nanoparticles in the porous carrier resulting when the porous carrier is formed around or surrounds the nanoparticles, generally by using the methods described herein. That is, the resulting structure contains nanoparticles with a scaffolding of porous carrier between the nanoparticles, for example built up around or surrounding the nanoparticles. The porous carrier encompasses the nanoparticles, while at the same time, by virtue of its porosity, the porous carrier permits external gases to contact the embedded nanoparticles. Nanoparticles “embedded” within a porous carrier may include a configuration wherein nanoparticles are connected together (i.e., bridged together) by a carrier material.

It is generally understood by one of skill in the art that the unit of measure “g/l” or “grams per liter” is used as a measure of density of a substance in terms of the mass of the substance in any given volume containing that substance. In some embodiments, the “g/l” is used to refer to the loading density of a substance into, for example, a coated substrate. In some embodiments, the “g/l” is used to refer to the loading density of a substance into, for example, a layer of a coated substrate. In some embodiments, the “g/l” is used to refer to the loading density of a substance into, for example, a washcoat composition. The loading density of a substance into a layer of a coated substrate can be different then the loading density of a substance into the coated substrate. For example, if a PNA layer on the substrate is loaded with 4 g/l PGM but the layer only covers half of the substrate, then the loading density of PGM on the substrate would be 2 g/l.

By “substantial absence of any platinum group metals” is meant that less than about 5%, less than about 2%, less than about 1%, less than about 0.5%, less than about 0.1%, less than about 0.05%, less than about 0.025%, or less than about 0.01% of platinum group metals are present by weight. Preferably, substantial absence of any platinum group metals indicates that less than about 1% of platinum group metals are present by weight.

By “substantially free of” a specific component, a specific composition, a specific compound, or a specific ingredient in various embodiments, is meant that less than about 5%, less than about 2%, less than about 1%, less than about 0.5%, less than about 0.1%, less than about 0.05%, less than about 0.025%, or less than about 0.01% of the specific component, the specific composition, the specific compound, or the specific ingredient is present by weight. Preferably, “substantially free of” a specific component, a specific composition, a specific compound, or a specific ingredient indicates that less than about 1% of the specific component, the specific composition, the specific compound, or the specific ingredient is present by weight.

It should be noted that, during fabrication, or during operation (particularly over long periods of time), small amounts of materials present in one washcoat layer may diffuse, migrate, or otherwise move into other washcoat layers. Accordingly, use of the terms “substantial absence of” and “substantially free of” is not to be construed as absolutely excluding minor amounts of the materials referenced.

By “substantially each” of a specific component, a specific composition, a specific compound, or a specific ingredient in various embodiments, is meant that at least about 95%, at least about 98%, at least about 99%, at least about 99.5%, at least about 99.9%, at least about 99.95%, at least about 99.975%, or at least about 99.99% of the specific component, the specific composition, the specific compound, or the specific ingredient is present by number or by weight. Preferably, substantially each” of a specific component, a specific composition, a specific compound, or a specific ingredient is meant that at least about 99% of the specific component, the specific composition, the specific compound, or the specific ingredient is present by number or by weight.

This disclosure provides several embodiments. It is contemplated that any features from any embodiment can be combined with any features from any other embodiment. In this fashion, hybrid configurations of the disclosed features are within the scope of the present disclosure.

It is understood that reference to relative weight percentages in a composition assumes that the combined total weight percentages of all components in the composition add up to 100. It is further understood that relative weight percentages of one or more components may be adjusted upwards or downwards such that the weight percent of the components in the composition combine to a total of 100, provided that the weight percent of any particular component does not fall outside the limits of the range specified for that component.

This disclosure refers to both particles and powders. These two terms are equivalent, except for the caveat that a singular “powder” refers to a collection of particles. The present disclosure can apply to a wide variety of powders and particles. The terms “nanoparticle” and “nano-sized particle” are generally understood by those of ordinary skill in the art to encompass a particle on the order of nanometers in diameter, typically between about 0.5 nm to 500 nm, about 1 nm to 500 nm, about 1 nm to 100 nm, or about 1 nm to 50 nm. The nanoparticles can have an average grain size less than 250 nanometers and an aspect ratio between one and one million. In some embodiments, the nanoparticles have an average grain size of about 50 nm or less, about 30 nm or less, about 20 nm or less, about 10 nm or less, or about 5 nm or less. In additional embodiments, the nanoparticles have an average diameter of about 50 nm or less, about 30 nm or less, about 20 nm or less, about 10 nm or less, or about 5 nm or less. The aspect ratio of the particles, defined as the longest dimension of the particle divided by the shortest dimension of the particle, is preferably between one and one hundred, more preferably between one and ten, yet more preferably between one and two. “Grain size” is measured using the ASTM (American Society for Testing and Materials) standard (see ASTM E112-10). When calculating a diameter of a particle, the average of its longest and shortest dimension is taken; thus, the diameter of an ovoid particle with long axis 20 nm and short axis 10 nm would be 15 nm. The average diameter of a population of particles is the average of diameters of the individual particles, and can be measured by various techniques known to those of skill in the art.

In additional embodiments, the nanoparticles have a grain size of about 50 nm or less, about 30 nm or less, about 20 nm or less, about 10 nm or less, or about 5 nm or less. In additional embodiments, the nanoparticles have a diameter of about 50 nm or less, about 30 nm or less, about 20 nm or less, about 10 nm or less, or about 5 nm or less.

The terms “micro-particle,” “micro-sized particle,” “micron-particle,” and “micron-sized particle” are generally understood to encompass a particle on the order of micrometers in diameter, typically between about 0.5 μm to 1000 μm, about 1 μm to 1000 μm, about 1 μm to 100 μm, or about 1 μm to 50 μm. Additionally, the term “platinum group metals” (abbreviated “PGM”) used in this disclosure refers to the collective name used for six metallic elements clustered together in the periodic table. The six platinum group metals include ruthenium, rhodium, palladium, osmium, iridium, and platinum.

### Particles Produced by Only Wet-Chemistry Methods

Particles produced by only wet-chemistry methods generally comprise precipitated elemental metal impregnated into porous supports. In some embodiments, the porous supports are micron-sized particles. In some embodiments, the porous support comprises a metal oxide, such as alumina (Al₂O₃), or silica (SiO₂), or zirconia (ZrO₂), or titania (TiO₂), or ceria (CeO₂), or baria (BaO), or yttria (Y₂O₃), or combinations thereof. In some embodiments, a single metal type (such as palladium) may be impregnated into the support, and in other embodiments, various combinations of catalytic metals may be impregnated into the support. For example, in some embodiments, a catalyst may comprise a mixture of platinum and palladium. In some embodiments, a catalyst may comprise a mixture of platinum and palladium at any ratio or any range of ratios, such as about 1:2 to about 100:1 Pt/Pd (weight/weight), 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or about 20:1 Pt/Pd (weight/weight).

The production of catalytic particles produced by only wet-chemistry methods generally involves the use of a solution of one or more catalytic metal ions or metal salts, which are impregnated into supports (typically micron-sized particles), and reduced to platinum group metal in elemental form. For example, a solution of metal acid can be applied to support particles (micron-sized), followed by drying and calcining, resulting in precipitation of the metal onto the support particles. For example, in some embodiments a solution of chloroplatinic acid, H₂PtCl₆, can be applied to alumina micro-particles (such as MI-386 material from Grace Davison, Rhodia, or the like), followed by drying and calcining, resulting in precipitation of platinum onto the alumina. In some embodiments, a mixture of two or more different solutions of catalytic metal ions or metal salts, such as chloroplatinic acid, H₂PtCl₆, and chloropalladic acid, H₂PdCl₆, may be applied to alumina micro-particles, followed by drying and calcining, resulting in precipitation of both platinum and palladium onto the alumina. When using two or more different solutions of catalytic metal ions or metal salts, the solution may be of the concentration or amount necessary to obtain the desired ratio of catalytic metal.

### Composite Nanoparticle

A composite nanoparticle may include a nanoparticle attached to a support nanoparticle to form a “nano-on-nano” composite nanoparticle. These composite nanoparticles can include oxidative composite nanoparticles, reductive composite nanoparticles, and PNA composite nanoparticles. The composite nanoparticles can be produced by a plasma-based method, such as by vaporizing the catalytic material and support material in a plasma gun or plasma chamber, and then condensing the plasma into nanoparticles. Multiple nano-on-nano particles may then be bonded to a micron-sized carrier particle to form a composite micro/nanoparticle, that is, a micro-particle bearing composite nanoparticles. These composite micro/nanoparticles may be used in washcoat formulations and catalytic converters as described herein. A micron-sized carrier particle (which can be produced by any method, such as plasma, wet chemistry, milling, or other methods) combined with composite nanoparticles that are generated by plasma methods is an example of catalytically active particles comprising one or more plasma-generated catalyst components. (In the preceding example, both the support nanoparticle and catalytic nanoparticle of the composite nanoparticle are plasma generated, which meets the criterion of comprising one or more plasma-generated catalytic components.) Composite micro/nanoparticles of different compositions may be present in a single washcoat layer. The use of these particles can reduce requirements for platinum group metal content and/or significantly enhance performance, particularly in terms of reduced light-off temperature, as compared with currently available commercial catalytic converters prepared using only wet-chemistry methods for the deposition of platinum group metal.

The wet-chemistry methods for the deposition of platinum group metal generally involve use of a solution of platinum group metal ions or metal salts, which are impregnated on already formed supports (typically commercially available micron-sized particles), and reduced to platinum group metal in elemental form for use as the catalyst. For example, a solution of chloroplatinic acid, H₂PtCl₆, can be applied to alumina micro-particles, followed by drying and calcining, resulting in precipitation of platinum onto the alumina. Production of catalysts by wet chemistry methods is discussed in Heck, Ronald M.; Robert J. Farrauto; and Suresh T. Gulati, Catalytic Air Pollution Control: Commercial Technology, Third Edition, Hoboken, N.J.: John Wiley & Sons, 2009, at Chapter 2, pages 24-40 (see especially pages 30-32) and references disclosed therein. See also Marceau, Eric; Xavier Carrier, and Michel Che, “Impregnation and Drying,” Chapter 4 of Synthesis of Solid Catalysts (Editor de Jong, Krijn) Weinheim, Germany: Wiley-VCH, 2009, at pages 59-82 and references disclosed therein. The platinum group metals deposited by wet-chemical methods onto metal oxide supports, such as alumina, are mobile at high temperatures, such as temperatures encountered in catalytic converters. That is, at elevated temperatures, the PGM atoms can migrate over the surface on which they are deposited, and will clump together with other PGM atoms. The finely-divided portions of PGM combine into larger and larger agglomerations of platinum group metal as the time of exposure to high temperature increases. This agglomeration leads to reduced catalyst surface area and degrades the performance of the catalytic converter. This phenomenon is referred to as “aging” of the catalytic converter.

In contrast, the composite platinum group metal catalysts are prepared by plasma-based methods. In one embodiment, the platinum group nano size metal particle is deposited on a nano sized metal oxide support, which has much lower mobility than the PGM deposited by wet chemistry methods. The resulting plasma-produced catalysts age at a much slower rate than the wet-chemistry produced catalysts. Thus, catalytic converters using plasma-produced catalysts can maintain a larger surface area of exposed catalyst to gases emitted by the engine over a longer period of time, leading to better emissions performance.

In some embodiments, catalysts and/or PNA material may comprise nanoparticles. In some embodiments, such as those using NNm particles or NNiM particles, catalysts and/or PNA material may comprise composite nanoparticles. In some embodiments of composite nanoparticles, one or more nano-sized particles are disposed on a nano-sized support particle. In embodiments comprising a single nano-sized particle disposed on the nano-sized support particle, the nano-sized particle may be a homogenous metal or may be a metal alloy. In embodiments comprising two or more nano-sized particles, each nano-sized particle may be a homogenous metal or an alloy, and the nano-sized particles may be comprised of the same homogenous metal or alloy, or of differing homogenous metals or alloys. In some embodiments, the nano-sized particle is a platinum group metal, such as platinum or palladium. Although platinum group metals are generally described, all catalytic metals are contemplated. In some embodiments, the nano-sized particle comprises an alloy of two or more platinum group metals, such as platinum and palladium. In some embodiments, such as when the nano-sized particle comprises both platinum and palladium, the metals may be found in any ratio, or any range of ratios, such as about 1:2 to about 100:1 Pt/Pd (weight/weight), 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or about 20:1 Pt/Pd (weight/weight). In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

In some embodiments of composite nanoparticles, the nano-sized support particle may be an oxide. By way of example, oxides such as alumina (Al₂O₃), silica (SiO₂), zirconia (ZrO₂), titania (TiO₂), ceria (CeO₂), baria (BaO), yttria (Y₂O₃), and combinations thereof may be used. Other useful oxides will be apparent to those of ordinary skill. In addition, other oxides are discussed herein.

In some embodiments, the relative proportion of platinum group metal to support material, such as aluminum oxide, may be a range of about 0.001 wt % to about 65 wt % platinum group metal(s) and about 99.999 wt % to about 35 wt % metal oxide. In some embodiments, such as some embodiments using NNm particles, the composite nanoparticles comprise a range of about 10 wt % to about 65 wt % platinum group metal(s) and about 35 wt % to about 90 wt % metal oxide, and in some embodiments a composition of about 35 wt % to about 45 wt % platinum group metal(s) and about 55 wt % to about 65 wt % metal oxide. In some embodiments, composite nanoparticles used in NNm particles may comprise from about 0 wt % to about 65 wt % platinum, about 0 wt % to about 65 wt % palladium, and about 35 wt % to about 99.999 wt % aluminum oxide; in some embodiments, from about 30 wt % to about 40 wt % platinum, about 2 wt % to about 10 wt % palladium, and about 50 wt % to about 68 wt % aluminum oxide; in further embodiments, from about 35 wt % to about 40 wt % platinum, about 2 wt % to about 5 wt % palladium, and about 55 wt % to about 63 wt % aluminum oxide; or in still further embodiments, about 0 wt % to about 5 wt % platinum, about 35 wt % to about 55 wt % palladium, and about 40 wt % to about 65 wt % aluminum oxide. An exemplary composite nano-on-nano particle used in NNm particles comprises about 38.1 wt % platinum, about 1.9 wt % palladium, and about 60 wt % aluminum oxide; or about 33.3 wt % platinum, about 6.7 wt % palladium and about 60 wt % aluminum oxide; or about 40 wt % palladium and 60% aluminum oxide. In some embodiments, such as those using NNiM particles, the composite nanoparticles comprise a range of about 0.001 wt % to about 20 wt % platinum group metals mad about 80 wt % to about 99.999 wt % aluminum oxide, and in some embodiments about 0.04 wt % to about 5 wt % platinum group metals and about 95 wt % to about 99.9 wt % aluminum oxide. In some embodiments of composite nanoparticles used in NNiM particles, materials range from about 0 wt % to about 20 wt % platinum, about 0 wt % to about 20 wt % palladium, and about 80 wt % to about 99.999 wt % aluminum oxide; in further embodiments, from about 0.5 wt % to about 1.5 wt % platinum, about 0.01 wt % to about 0.1 wt % palladium, and about 97.9 wt % to about 99.1 wt % aluminum oxide; in still further embodiments, from about 0.5 wt % to about 1.5 wt % platinum, about 0.1 wt % to about 0.3 wt % palladium, and about 98.2 wt % to about 99.4 wt % aluminum oxide. An exemplary composite nano-on-nano particle used in NNiM particles comprises about 0.952 wt % platinum, about 0.048 wt % palladium, and about 99 wt % aluminum oxide; or about 0.83 wt % platinum, about 0.17 wt % palladium, and about 99 wt % aluminum oxide; or about 1 wt % palladium and about 99 wt % aluminum oxide.

In some embodiments, the catalytic or PGM nanoparticles have an average diameter or average grain size between about 0.3 nm and about 10 nm, such as between about 1 nm to about 5 nm, that is, about 3 nm+/−2 nm. In some embodiments, the catalytic or PGM nanoparticles have an average diameter or average grain size between approximately 0.3 nm to approximately 1 nm, while in other embodiments, the catalytic or PGM nano-particles have an average diameter or average grain size between approximately 1 nm to approximately 5 nm, while in other embodiments, the catalytic or PGM nanoparticles have an average diameter or average grain size between approximately 5 nm to approximately 10 nm. In some embodiments, the support nanoparticles, such as those comprising a metal oxide, for example aluminum oxide or cerium oxide, have an average diameter of about 20 nm or less; or about 15 nm or less; or about 10 nm or less; or about 5 nm or less; or about 2 nm or less; or between about 2 nm and about 5 nm, that is, 3.5 nm+/−1.5 nm; or between 2 nm and about 10 nm, that is 6 nm+/−4 nm; or between about 10 nm and about 20 nm, that is, about 15 nm+/−5 nm; or between about 10 nm and about 15 nm, that is, about 12.5 nm+/−2.5 nm; or between about 5 nm and about 10 nm, that is, about 7.5 nm+/−2.5. In some embodiments, the composite nanoparticles have an average diameter or average grain size of about 2 nm to about 20 nm, that is 11 nm+/−9 nm; or about 4 nm to about 18 nm, that is 11+/−7 nm; or about 6 nm to about 16 nm, that is 11+/−5 nm; or about 8 nm to about 14 nm, that is about 11 nm+/−3 nm; or about 10 nm to about 12 nm, that is about 11+/−1 nm; or about 10 nm; or about 11 nm; or about 12 nm. In one combination, the catalytic or PGM nanoparticles have an average diameter between approximately 1 nm to approximately 5 nm, and the support nanoparticles have an average diameter between approximately 10 nm and approximately 20 nm or between approximately 5 nm and approximately 10 nm. In another combination, the catalytic or PGM nanoparticles have an average diameter between approximately 0.3 nm to approximately 10 nm, and the support nanoparticles have an average diameter between approximately 10 nm and approximately 20 nm or between approximately 5 nm and 10 nm.

### PNA Composite Nanoparticle (PNA “Nano-on-Nano” Particle)

As discussed above, another type of composite nanoparticle is a PNA composite nanoparticle. A PNA composite nanoparticle may include one or more PGM nanoparticles attached to a second support nanoparticle to form a PGM “nano-on-nano” composite nanoparticle. Palladium (Pd) and Ruthenium (Ru) can hold NOₓ gases during low temperature engine operation and release the gases when the temperature rises to a threshold temperature. In certain embodiments, the PGM nanoparticle is palladium. In some embodiments, palladium can be used when employed in a large engine system (e.g., greater than 2.5 L). In other embodiments, the PGM nanoparticle is ruthenium. In some embodiments, ruthenium can be used when employed in a small engine system (e.g., less than 2 L). The ruthenium can be ruthenium oxide. A suitable second support nanoparticle for the PGM nanoparticle includes, but is not limited to, nano-sized cerium oxide. The nano-sized cerium oxide particles may further comprise zirconium oxide. The nano-sized cerium oxide particles can also be substantially free of zirconium oxide. In addition, the nano-sized cerium oxide may further comprise lanthanum and/or lanthanum oxide. In some embodiments, the nano-sized cerium oxide particles may further comprise both zirconium oxide and lanthanum oxide. In some embodiments, the nano-sized cerium oxide particles may further comprise yttrium oxide. Accordingly, in addition to, or instead of, cerium oxide particles, particles comprising cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, and/or cerium-zirconium-lanthanum-yttrium oxide can be used. In some embodiments, the nano-sized cerium oxide particles comprise 40-90 wt % cerium oxide, 5-60 wt % zirconium oxide, 1-15 wt % lanthanum oxide, and/or 1-10 wt % yttrium oxide. In one embodiment, the nano-sized cerium oxide particles comprise 86 wt % cerium oxide, 10 wt % zirconium oxide, and 4 wt % lanthanum and/or lanthanum oxide. In another embodiment, the cerium oxide particles comprise 40 wt % cerium oxide, 50 wt % zirconium oxide, 5 wt % lanthanum oxide, and 5 wt % yttrium oxide.

Each PGM nanoparticle may be supported on a second support nanoparticle. The second support nanoparticle may include one or more PGM nanoparticles. The ratios of PGM to cerium oxide and sizes of the PNA composite nanoparticle catalyst are further discussed below in the sections describing production of composite nanoparticles by plasma-based methods and production of micron-sized carrier particles bearing composite nanoparticles.

### Production of Composite Nanoparticles by Plasma-Based Methods (“Nano-on-Nano” Particles or “NN” Particles)

The initial step in producing suitable catalysts or PNA material may involve producing composite nanoparticles. The composite nanoparticles comprise a catalytic nanoparticle comprising one or more platinum group metals, and a support nanoparticle, typically a metal oxide such as aluminum oxide or cerium oxide. As the name “nanoparticle” implies, the nanoparticles have sizes on the order of nanometers.

The composite nanoparticles may be formed by plasma reactor methods, by feeding platinum group metal(s) and support material into a plasma gun, where the materials are vaporized. Plasma guns such as those disclosed in US 2011/0143041 can be used, and techniques such as those disclosed in U.S. Pat. No. 5,989,648, U.S. Pat. No. 6,689,192, U.S. Pat. No. 6,755,886, and US 2005/0233380 can be used to generate plasma, the disclosures of which are hereby incorporated by reference in their entireties. A working gas, such as argon, is supplied to the plasma gun for the generation of plasma; in one embodiment, an argon/hydrogen mixture (in the ratio of 10:2 Ar/H₂) is used as the working gas. The platinum group metal or metals, such as platinum, palladium, or platinum/palladium in any ratio, such as 4:1 platinum:palladium by weight, or about 4:1 platinum:palladium by weight, and which are generally in the form of metal particles of about 0.5 to 6 microns in diameter, can be introduced into the plasma reactor as a fluidized powder in a carrier gas stream such as argon. Metal oxide, such as aluminum oxide in a particle size of about 15 to 25 microns diameter, is also introduced as a fluidized powder in carrier gas. However, other methods of introducing the materials into the reactor can be used, such as in a liquid slurry. A composition of about 35% to 45% platinum group metal(s) and about 65% to 55% metal oxide (by weight) is typically used, including a ratio of about 40% platinum group metal(s) to about 60% metal oxide. Examples of ranges of materials that can be used are from about 0% to about 40% platinum, about 0% to about 40% palladium, and about 55% to about 65% aluminum oxide; in some embodiments, from about 20% to about 30% platinum, about 10% to about 15% palladium, and about 50% to about 65% aluminum oxide are used; in further embodiments, from about 23.3% to about 30% platinum, about 11.7% to about 15% palladium, and about 55% to about 65% aluminum oxide are used. An exemplary composition contains about 26.7% platinum, about 13.3% palladium, and about 60% aluminum oxide.

In some embodiments two or more platinum group metals may be added, such as a mixture of platinum and palladium, in any ratio, or any range of ratios, such as about 1:2 to about 100:1 Pt/Pd (weight/weight), 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or about 20:1 Pt/Pd (weight/weight). Support material, for example a metal oxide, such as aluminum oxide, in a particle size of about 15 to 25 microns diameter, is also introduced as a fluidized powder in carrier gas. In some embodiments, such as some embodiments using NNm particles, a composition of about 10 wt % to about 65 wt % platinum group metal(s) and about 90 wt % to about 35 wt % metal oxide may be used, and in some embodiments a composition of about 35 wt % to about 45 wt % platinum group metal(s) and about 65 wt % to about 55 wt % metal oxide may be used. Examples of ranges of compositions that may be used to form composite nanoparticles used in NNm particles are from about 0 wt % to about 65 wt % platinum, about 0 wt % to about 65 wt % palladium, and about 35 wt % to about 99.999 wt % aluminum oxide; in some embodiments, from about 30 wt % to about 40 wt % platinum, about 2 wt % to about 10 wt % palladium, and about 50 wt % to about 68 wt % aluminum oxide are used; in further embodiments, from about 35 wt % to about 40 wt % platinum, about 2 wt % to about 5 wt % palladium, and about 55 wt % to about 63 wt % aluminum oxide is used; or in still further embodiments, about 0 wt % to about 5 wt % platinum, about 35 wt % to about 55 wt % palladium, and about 40 wt % to about 65 wt % aluminum oxide is used. An exemplary composition useful for forming composite nano-on-nano particle used in NNm particles comprises about 38.1 wt % platinum, about 1.9 wt % palladium, and about 60 wt % aluminum oxide; or about 33.3 wt % platinum, about 6.7 wt % palladium and about 60 wt % aluminum oxide; or about 40 wt % palladium and 60% aluminum oxide. In some embodiments, such as some embodiments using NNiM particles, the composition has a range of about 0.001 wt % to about 20 wt % platinum group metals mad about 80 wt % to about 99.999 wt % aluminum oxide, and in some embodiments about 0.04 wt % to about 5 wt % platinum group metals and about 95 wt % to about 99.9 wt % aluminum oxide. Example ranges of materials that can be used to form composite nanoparticles used in NNiM particles are from about 0 wt % to about 20 wt % platinum, about 0 wt % to about 20 wt % palladium, and about 80 wt % to about 99.999 wt % aluminum oxide; in some embodiments, from about 0.5 wt % to about 1.5 wt % platinum, about 0.01 wt % to about 0.1 wt % palladium, and about 97.9 wt % to about 99.1 wt % aluminum oxide; in further embodiments, from about 0.5 wt % to about 1.5 wt % platinum, about 0.1 wt % to about 0.3 wt % palladium, and about 98.2 wt % to about 99.4 wt % aluminum oxide. An exemplary composition useful for forming composite nano-on-nano particle used in NNiM particles comprises about 0.952 wt % platinum, about 0.048 wt % palladium, and about 99 wt % aluminum oxide; or about 0.83 wt % platinum, about 0.17 wt % palladium, and about 99 wt % aluminum oxide; or about 1 wt % palladium and about 99 wt % aluminum oxide.

Examples of ranges of materials that can be used for PNA composite nanoparticles are from about 1% to about 40% palladium and about 99% to about 60% cerium oxide, from about 5% to about 20% palladium and about 95% to about 80% cerium oxide, and from about 8% to about 12% palladium and about 92% to about 88% cerium oxide. These examples can be for PNA material to be used in large engine systems. In one embodiment, the composition contains about 10% palladium and about 90% cerium oxide. Other Examples of ranges of materials that can be used for PNA composite nanoparticles are from about 1% to about 40% ruthenium and about 99% to about 60% cerium oxide, from about 5% to about 20% ruthenium and about 95% to about 80% cerium oxide, and from about 8% to about 12% ruthenium and about 92% to about 88% cerium oxide. These examples can be for PNA material to be used in small engine systems. In one embodiment, the composition contains about 10% ruthenium and about 90% cerium oxide. As discussed below, in all embodiments, the cerium oxide can include cerium-zirconium oxide, cerium-zirconium-lanthanum oxide, and cerium-zirconium-lanthanum-yttrium oxide among others.

Other methods of introducing the materials into the reactor can be used, such as in a liquid slurry. Any solid or liquid materials are rapidly vaporized or turned into plasma. The kinetic energy of the superheated material, which can reach temperatures of 20,000 to 30,000 Kelvin, ensures extremely thorough mixing of all components.

The superheated material of the plasma stream is then quenched rapidly, using such methods as the turbulent quench chamber disclosed in US 2008/0277267. Argon quench gas at high flow rates, such as 2400 to 2600 liters per minute, is injected into the superheated material. The material is further cooled in a cool-down tube, and collected and analyzed to ensure proper size ranges of material. Equipment suitable for plasma synthesis is disclosed in U.S. Patent Application Publication No. 2008/0277267, U.S. Pat. No. 8,663,571, U.S. patent application Ser. No. 14/207,087 and International Patent Appl. No. PCT/US2014/024933.

The plasma production method described above produces highly uniform composite nanoparticles, where the composite nanoparticles comprise a PGM or catalytic nanoparticle bonded to a support nanoparticle. The catalytic nanoparticle comprises the platinum group metal or metals, such as Pt:Pd in a 2:1 ratio by weight. In some embodiments, the catalytic or PGM nanoparticles have an average diameter or average grain size between approximately 0.3 nm and approximately 10 nm, preferably between approximately 1 nm to approximately 5 nm, that is, approximately 3 nm±2 nm. These size of catalytic or PGM nanoparticles can be the size of the catalytic nanoparticles employed when using wet chemistry methods. In some embodiments, the support nanoparticles, comprising the metal oxide such as aluminum oxide or cerium oxide, have an average diameter of approximately 20 nm or less, or approximately 15 nm or less, or between approximately 10 nm and approximately 20 nm, that is, approximately 15 nm±5 nm, or between approximately 10 nm and approximately 15 nm, that is, approximately 12.5 nm±2.5 nm, or between approximately 5 nm and approximately 10 nm, that is, approximately 7.5 nm±2.5 nm.

The composite nanoparticles, when produced under reducing conditions, such as by using argon/hydrogen working gas, results in a partially reduced alumina surface on the support nanoparticle to which the PGM nanoparticle is bonded, as described in U.S. Publication No. 2011/0143915 at paragraphs 0014-0022. For example, when palladium is present in the plasma, the particles produced under reducing conditions can be a palladium aluminate. The partially reduced alumina surface, or Al₂O₍₃₋ₓ₎ where x is greater than zero, but less than three, inhibits migration of the platinum group metal on the alumina surface at high temperatures. This in turn limits the agglomeration of platinum group metal when the particles are exposed to prolonged elevated temperatures. Such agglomeration is undesirable for many catalytic applications, as it reduces the surface area of PGM catalyst available for reaction.

The composite nanoparticles comprising two nanoparticles (PGM/catalytic or support) are referred to as “nano-on-nano” particles or “NN” particles. When the nano-on-nano (NN) particles are generated by plasma, they fall in the category of catalytically active powder comprising one or more plasma generated catalyst or PGM components.

### Production of Micron-Sized Carrier Particles Bearing Composite Nanoparticles (“Nano-on-Nano-on-Micron” Particles or “NNm” Particles)

The plasma-generated composite nanoparticles (nano-on-nano particles) may be further bonded to micron-sized carrier particles to produce composite micro/nanoparticles, referred to as “nano-on-nano-on-micron” particles or “NNm” particles. When the nano-on-nano-on micron (NNm) particles are made with plasma-generated nano-on-nano (NN) particles, they fall within the category of catalytically active powder comprising one or more plasma-generated catalyst components. The carrier particles are typically metal oxide particles, such as alumina (Al₂O₃) or ceria. The micron-sized particles can have an average size between about 1 micron and about 100 microns, such as between about 1 micron and about 10 microns, between about 3 microns and about 7 microns, or between about 4 microns and about 6 microns. In one embodiment, the micron-sized particles have an average size of 5 microns. These sizes of micron-sized particles can be the size of the micron-sized particles employed when using wet chemistry methods.

In general, the nano-on-nano-on-micron particles are produced by a process of suspending the composite nanoparticles (nano-on-nano particles) in water, adjusting the pH of the suspension to between about 2 and about 7, between about 3 and about 5, or about 4, adding surfactants to the suspension (or, alternatively, adding the surfactants to the water before suspending the composite nanoparticles in the water), sonicating the composite nanoparticle suspension, applying the suspension to micron-sized metal oxide particles until the point of incipient wetness, thereby impregnating the micron-sized particles with composite nanoparticles, drying the micron-sized metal oxide particles which have been impregnated with composite nanoparticles, and calcining the micron-sized metal oxide particles which have been impregnated with composite nanoparticles. This process of drying and calcining can also be applied to producing nanoparticles on support particles (either micron-sized or on nano-sized) via incipient wetness in general.

In some embodiments, the micron-sized metal oxide particles are pre-treated with a gas at high temperature. The pre-treatment of the micron-sized metal oxide particles allows the nano-on-nano-on-micro particles to withstand the high temperatures of an engine. Without pre-treatment, the nano-on-nano-on-micro particles would more likely change phase on exposure to high temperature, compared to the nano-on-nano-on-micro particles that have been pretreated. In some embodiments, pre-treatment includes exposure of the micron-sized metal oxide particles at temperatures, such as about 700° C. to about 1500° C.; 700° C. to about 1400° C.; 700° C. to about 1300° C.; and 700° C. to about 1200° C. In some embodiments, pre-treatment includes exposure of the micron-sized metal oxide particles at temperatures, such as about 700° C., 1110° C., 1120° C., 1130° C., 1140° C., 1150° C., 1155° C., 1160° C., 1165° C., 1170° C., 1175° C., 1180° C., 1190° C., and 1200° C.

The process includes drying the micron-sized metal oxide particles which have been impregnated with composite nanoparticles and nano-sized metal oxide, and calcining the micron-sized metal oxide particles which have been impregnated with composite nanoparticles and nano-sized metal oxide.

Typically, the composite nanoparticles are suspended in water, and the suspension is adjusted to have a pH of between about 2 and about 7, preferably between about 3 and about 5, more preferably a pH of about 4 (the pH is adjusted with acetic acid or another organic acid). Dispersants and/or surfactants are added to the composite nanoparticles. Surfactants suitable for use include Jeffsperse® X3202 (Chemical Abstracts Registry No. 68123-18-2, and described as 4,4′-(1-methylethylidene)bis-phenol polymer with 2-(chloromethyl)oxirane, 2-methyloxirane, and oxirane), Jeffsperse® X3204, and Jeffsperse® X3503 surfactants from Huntsman (JEFFSPERSE is a registered trademark of Huntsman Corporation, The Woodlands, Tex., United States of America for chemicals for use as dispersants and stabilizers), which are nonionic polymeric dispersants. Other suitable surfactants include Solsperse® 24000 and Solsperse® 46000 from Lubrizol (SOLSPERSE is a registered trademark of Lubrizol Corporation, Derbyshire, United Kingdom for chemical dispersing agents). The Jeffsperse® X3202 surfactant, Chemical Abstracts Registry No. 68123-18-2 (described as 4,4′-(1-methylethylidene)bis-phenol polymer with 2-(chloromethyl)oxirane, 2-methyloxirane, and oxirane), is preferred. The surfactant is added in a range of about 0.5% to about 5%, with about 2% being a typical value.

The mixture of aqueous surfactants and composite nanoparticles is sonicated to disperse the composite nanoparticles. The quantity of composite nanoparticles particles in the dispersion is usually in the range of about 2% to about 15% (by mass). The dispersion is then applied to porous, micron-sized Al₂O₃ or cerium oxide, which may be purchased from companies such as Rhodia or Sasol. The porous, micron-sized, oxide powders may be stabilized with a small percentage of lanthanum (about 2% to about 4% La). In addition, the porous, micron sized, metal oxide powder may further comprise a percentage of zirconium oxide (about 5% to about 15%, preferably 10%). In some embodiments, the porous, micron sized, metal oxide powders may further comprise yttrium oxide. Accordingly, the porous, micron sized, metal oxide powders can include cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, cerium-zirconium-lanthanum-yttrium oxide, or a combination thereof. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the micron-sized cerium oxide particles contain 86 wt % cerium oxide, 10 wt % zirconium oxide, and 4 wt % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide. One commercial alumina powder suitable for use is MI-386, purchased from Grace Davison or Rhodia. The usable surface for this powder, defined by pore sizes greater than 0.28 μm, is approximately 2.8 m²/g. One commercial cerium oxide powder suitable for use is HSA5, HSA20, or a mixture thereof, purchased from Rhodia-Solvay. In addition, the porous, micron-sized oxide powders may be impregnated with PGM via wet-chemistry methods, for preparation of hybrid particles.

The ratio of composite nanoparticles used to micron-sized carrier particles used may be from about 3:100 to about 10:100, about 5:100 to about 8:100, or about 6.5:100, in terms of (weight of composite nanoparticle):(weight of micron carrier particle). In some embodiments, about 8 grams of composite nanoparticles may be used with about 122 grams of carrier micro-particles. The aqueous dispersion of composite nanoparticles is applied in small portions (such as by dripping or other methods) to the micron-sized powder until the point of incipient wetness, producing a material similar to damp sand.

The micron-sized carrier particles, impregnated with the composite nanoparticles, may then be dried (for example, at about 30° C. to about 95° C., preferably about 60° C. to about 70° C., at atmospheric pressure or at reduced pressure such as from about 1 pascal to about 90,000 pascal). After drying, the particles may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere or under an inert atmosphere such as nitrogen or argon) to yield the composite micro/nanoparticles, also referred to as nano-on-nano-on-micron particles, or NNm particles. The drying step may be performed before the calcining step to remove the water before heating at the higher calcining temperatures; this avoids boiling of the water, which would disrupt the impregnated nanoparticles which are lodged in the pores of the micron-sized carrier.

The NNm particles may contain from about 0.1% to about 6% PGM by weight, or in another embodiment from about 0.5% to 3.5% by weight, or in another embodiment about 1% to 2.5% by weight, or in another embodiment about 2% to about 3% by weight, or in another embodiment, about 2.5% by weight, of the total mass of the NNm particle. The NNm particles can then be used for formulations for coating substrates, where the coated substrates may be used in catalytic converters.

Examples of production of NNm material, and of equipment useful for production of NNm material, are described in the following co-owned patents and patent applications: U.S. Patent Publication No. 2005/0233380, U.S. Patent Publication No. 2006/0096393, U.S. patent application Ser. No. 12/151,810, U.S. patent application Ser. No. 12/152,084, U.S. patent application Ser. No. 12/151,809, U.S. Pat. No. 7,905,942, U.S. patent application Ser. No. 12/152,111, U.S. Patent Publication 2008/0280756, U.S. Patent Publication 2008/0277270, U.S. patent application Ser. No. 12/001,643, U.S. patent application Ser. No. 12/474,081, U.S. patent application Ser. No. 12/001,602, U.S. patent application Ser. No. 12/001,644, U.S. patent application Ser. No. 12/962,518, U.S. patent application Ser. No. 12/962,473, U.S. patent application Ser. No. 12/962,490, U.S. patent application Ser. No. 12/969,264, U.S. patent application Ser. No. 12/962,508, U.S. patent application Ser. No. 12/965,745, U.S. patent application Ser. No. 12/969,503, U.S. patent application Ser. No. 13/033,514, WO 2011/081834 (PCT/US2010/59763), US 2011/0143915 (U.S. patent application Ser. No. 12/962,473), U.S. Patent Application Publication No. 2008/0277267, U.S. Pat. No. 8,663,571, U.S. patent application Ser. No. 14/207,087 and International Patent Appl. No. PCT/US2014/024933.

Production of Hybrid Micron-Sized Carrier Particles Bearing Composite Nanoparticles (“Nano-on-Nano-on-Micro” Particles or “NNm”™ Particles) and Also Impregnated with Platinum Group Metal(s) Using Wet Chemistry Methods—“Hybrid NNm/Wet-Chemistry Particles” or “Hybrid Composite/Wet-Chemistry Particles”

Furthermore, the micron-sized particles which bear the composite nanoparticles can additionally be impregnated with platinum group metals using wet-chemistry methods, so that PGM is present on the micron-sized particle due to the nano-on-nano composite nanoparticles and also due to the deposition via wet chemistry. The micron-sized particles can be impregnated with PGM before or after the composite nanoparticles (nano-on-nano) are bonded to the micron-sized particles. When the nano-on-nano particles are added to the micron-sized carrier particles, the nano-on-nano particles tend to stay near the surface of the micron particle, as they are too large to penetrate into the smaller pores of the micron particle. Therefore, impregnating these micron-sized particles via wet-chemistry methods allows for PGM to penetrate deeper into the micron-sized particles than the corresponding nano-on-nano particles. In addition, because the nano-on-nano particles of these hybrid NNm/wet-chemistry particles contain PGM, lower amounts of PGM can be impregnated by wet-chemistry on the micron-sized particles to achieve the total desired loading. For example, if a final loading of 5 g/l of PGM is desired on the final catalyst or PNA material, loading 3 g/l of PGM as nano-on-nano (NN) particles requires only 2 g/l of PGM to be loaded via wet-chemistry methods. A lower amount of wet-chemistry impregnated PGM can reduce the agglomeration rate of these wet-chemistry impregnated catalytic particles when the catalyst or PNA material is exposed to prolonged elevated temperatures since there is less PGM to agglomerate. That is, the rate of aging of the catalyst will be reduced, since the rate of collision and agglomeration of mobile wet-chemistry-deposited PGM is reduced at a lower concentration of the wet-chemistry-deposited PGM, but without lowering the overall loading of PGM due to the contribution of PGM from the nano-on-nano particles. Thus, employing the nano-on-nano-on-micro configuration and using a micron-sized particle with wet-chemistry deposited platinum group metal can enhance catalyst performance and NOₓ storage while avoiding an excessive aging rate.

Methods for impregnation of carriers and production of catalysts by wet chemistry methods are discussed in Heck, Ronald M.; Robert J. Farrauto; and Suresh T. Gulati, Catalytic Air Pollution Control: Commercial Technology, Third Edition, Hoboken, N.J.: John Wiley & Sons, 2009, at Chapter 2, pages 24-40 (see especially pages 30-32) and references disclosed therein, and also in Marceau, Eric; Xavier Carrier, and Michel Che, “Impregnation and Drying,” Chapter 4 of Synthesis of Solid Catalysts (Editor: de Jong, Krijn) Weinheim, Germany: Wiley-VCH, 2009, at pages 59-82 and references disclosed therein.

For wet chemistry impregnation, typically a solution of a platinum group metal salt is added to the micron sized carrier particle to the point of incipient wetness, followed by drying, calcination, and reduction as necessary to elemental metal. Platinum can be deposited on carriers such as alumina by using Pt salts such as chloroplatinic acid H₂PtCl₆), followed by drying, calcining, and reduction to elemental metal. Palladium can be deposited on carriers such as alumina using salts such as palladium nitrate (Pd(NO₃)₂), palladium chloride (PdCl₂), palladium(II) acetylacetonate (Pd(acac)₂), followed by drying, calcining, and reduction to elemental metal (see, e.g., Toebes et al., “Synthesis of supported palladium catalysts,” Journal of Molecular Catalysis A: Chemical 173 (2001) 75-98).

### General Procedures for Preparation of Catalytically Active Material (Catalytic “Nano-on-Nano-on-Micro” Particles or “NNm”™ Catalytic Particles)

In some embodiments, catalytically active material may be “nano-on-nano-on-micron” or “NNm” particles. The composite nanoparticles (nano-on-nano particles) may be further bonded to the surface of and within the pores of micron-sized carrier particles to produce “nano-on-nano-on-micron” particles or “NNm” particles. The carrier particles are typically metal oxide particles, such as alumina (Al₂O₃). The micron-sized particles can have an average size between about 1 micron and about 100 microns, such as between about 1 micron and about 20 microns, such as between about 1 micron and about 10 microns, between about 3 microns and about 7 microns, or between about 4 microns and about 6 microns. In one embodiment, the catalytic nanoparticles have an average diameter between approximately 1 nm to approximately 5 nm, the support nanoparticles have an average diameter between approximately 10 nm and approximately 20 nm, or between approximately 5 nm and approximately 10 nm, and the micron-sized particles have an average diameter between approximately 1 micron and 10 microns. In another embodiment, the catalytic nanoparticles have an average diameter between approximately 0.3 nm to approximately 10 nm, the support nanoparticles have an average diameter between approximately 10 nm and approximately 20 nm, and the micron-sized particles have an average diameter between approximately 1 micron and 10 microns.

In general, the NNm particles are produced by a process forming a colloid of composite nanoparticles (nano-on-nano particles) in water, adjusting the pH of the suspension to between about 2 and about 7, between about 3 and about 5, or about 4, adding surfactants to the suspension (or, alternatively, adding the surfactants to the water before suspending the composite nano-particles in the water), sonicating the composite nano-particle suspension, applying the suspension to micron-sized metal oxide particles until the point of incipient wetness, thereby impregnating the micron-sized particles with composite nano-particles, drying the micron-sized metal oxide particles which have been impregnated with composite nanoparticles, and calcining the micron-sized metal oxide particles which have been impregnated with composite nanoparticles.

Typically, the composite nanoparticles are dispersed in water, and the colloid is adjusted to have a pH of between about 2 and about 7, preferably between about 3 and about 5, more preferably a pH of about 4 (the pH is adjusted with acetic acid or another organic acid). Dispersants and/or surfactants are added to the composite nano-particles. Surfactants suitable for use include Jeffsperse® X3202 (Chemical Abstracts Registry No. 68123-18-2, and described as 4,4′-(1-methylethylidene)bis-phenol polymer with 2-(chloromethyl)oxirane, 2-methyloxirane, and oxirane), Jeffsperse® X3204, and Jeffsperse® X3503 surfactants from Huntsman (JEFFSPERSE is a registered trademark of Huntsman Corporation, The Woodlands, Tex., United States of America for chemicals for use as dispersants and stabilizers), which are nonionic polymeric dispersants. Other suitable surfactants include Solsperse® 24000 and Solsperse® 46000 from Lubrizol (SOLSPERSE is a registered trademark of Lubrizol Corporation, Derbyshire, United Kingdom for chemical dispersing agents). The Jeffsperse® X3202 surfactant, Chemical Abstracts Registry No. 68123-18-2 (described as 4,4′-(1-methylethylidene)bis-phenol polymer with 2-(chloromethyl)oxirane, 2-methyloxirane, and oxirane), is preferred. The surfactant is added in a range of about 0.5% to about 5%, with about 2% being a typical value.

The mixture of aqueous surfactants and composite nano-particles is sonicated to disperse the composite nano-particles. The quantity of composite nano-particles particles in the dispersion is usually in the range of about 2% to about 15% (by mass). The dispersion is then applied to porous, micron sized Al₂O₃, which may be purchased from companies such as Rhodia or Sasol. In some embodiments, the porous, micron sized, Al₂O₃ powders may be stabilized with a small percentage of lanthanum (about 2% to about 4% La). One commercial alumina powder suitable for use is MI-386, purchased from Grace Davison or Rhodia. The usable surface for this powder, defined by pore sizes greater than 0.28 μm, is approximately 2.8 m²/g. In addition, the porous, micron-sized Al₂O₃ powders may be impregnated with oxidative PGM via wet-chemistry methods, for preparation of hybrid particles. The ratio of composite nano-particles used to micron-sized carrier particles used may be from about 3:100 to about 10:100, about 5:100 to about 8:100, or about 6.5:100, in terms of (weight of composite nanoparticle):(weight of micron carrier particle). In some embodiments, about 8 grams of composite nano-particles may be used with about 122 grams of carrier micro-particles. The aqueous dispersion of composite nano-particles is applied in small portions (such as by dripping or other methods) to the micron-sized powder until the point of incipient wetness, producing a material similar to damp sand.

The micron-sized carrier particles, impregnated with the composite nano-particles, may then be dried (for example, at about 30° C. to about 95° C., preferably about 60° C. to about 70° C., at atmospheric pressure or at reduced pressure such as from about 1 pascal to about 90,000 pascal). After drying, the particles may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere or under an inert atmosphere such as nitrogen or argon) to yield the composite micro/nano-particles, also referred to as nano-on-nano-on-micron particles, or NNm particles. The drying step may be performed before the calcining step to remove the water before heating at the higher calcining temperatures; this avoids boiling of the water, which would disrupt the impregnated nano-particles which are lodged in the pores of the micron-sized carrier.

The NNm particles may contain PGM from about 0.001 wt % to about 10 wt %, such as between 1 wt % to about 8 wt %, or about 4 wt % to about 8 wt %, or about 1 wt % to about 4 wt % of the total mass of the NNm particle. In some embodiments, NNm particles may contain PGM from about 2% to 3% by weight, or in some embodiments, about 2.5% by weight, of the total mass of the NNm particle. In some embodiments, NNm particles may contain PGM from about 5% to 7% by weight, or in some embodiments, about 6% by weight, of the total mass of the NNm particle. The NNm particles can then be used for formulations for coating substrates, where the coated substrates may be used in catalytic converters.

Examples of production of NNm material are described in the following co-owned patents and patent applications: U.S. Patent Publication No. 2005/0233380, U.S. Patent Publication No. 2006/0096393, U.S. patent application Ser. No. 12/151,810, U.S. patent application Ser. No. 12/152,084, U.S. patent application Ser. No. 12/151,809, U.S. Pat. No. 7,905,942, U.S. patent application Ser. No. 12/152,111, U.S. Patent Publication 2008/0280756, U.S. Patent Publication 2008/0277270, U.S. patent application Ser. No. 12/001,643, U.S. patent application Ser. No. 12/474,081, U.S. patent application Ser. No. 12/001,602, U.S. patent application Ser. No. 12/001,644, U.S. patent application Ser. No. 12/962,518, U.S. patent application Ser. No. 12/962,473, U.S. patent application Ser. No. 12/962,490, U.S. patent application Ser. No. 12/969,264, U.S. patent application Ser. No. 12/962,508, U.S. patent application Ser. No. 12/965,745, U.S. patent application Ser. No. 12/969,503, U.S. patent application Ser. No. 13/033,514, WO 2011/081834 (PCT/US2010/59763) and US 2011/0143915 (U.S. patent application Ser. No. 12/962,473), U.S. Patent Application Publication No. 2008/0277267, U.S. Pat. No. 8,663,571, U.S. patent application Ser. No. 14/207,087 and International Patent Appl. No. PCT/US2014/024933, the disclosures of which are hereby incorporated by reference in its entirety.

### General Procedures for Preparation of PNA Material (PNA “Nano-on-Nano-on-Micro” Particles or “NNm”™ Particles)

To prepare a PNA particle, a dispersion of PNA composite nanoparticles may be applied to porous, micron-sized cerium oxide, which may be purchased, for example, from companies such as Rhodia-Solvay. One commercial cerium oxide powder suitable for use is HSA5, HSA20, or a mixture thereof, available from Rhodia-Solvay. The micron-sized cerium oxide may further comprise zirconium oxide. In some embodiments, the micron-sized cerium oxide is substantially free of zirconium oxide. In other embodiments, the micron-sized cerium oxide contains up to 100% zirconium oxide. In addition, the micron-sized cerium oxide may further comprise lanthanum and/or lanthanum oxide. In some embodiments, the micro-sized cerium oxide may further comprise both zirconium oxide and lanthanum oxide. In some embodiments, the micron-sized cerium oxide may further comprise yttrium oxide. Accordingly, the micron-sized cerium oxide can be cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, cerium-zirconium-lanthanum-yttrium oxide, or a combination thereof. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the micro-sized cerium oxide contains 86 wt. % cerium oxide, 10 wt. % zirconium oxide; and 4 wt. % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide. In one embodiment, the PGM of the PNA composite nanoparticle is palladium. In one embodiment, the PGM of the PNA composite nanoparticle is ruthenium. The ruthenium of the PNA composite nanoparticle can be ruthenium oxide.

The micron-sized carrier particles, impregnated with the composite PNA nanoparticles and nano-sized metal oxide, may then be dried (for example, at about 30° C. to about 95° C., preferably about 60° C. to about 70° C., at atmospheric pressure or at reduced pressure, such as from about 1 pascal to about 90,000 pascal). After drying, the particles may be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere or under an inert atmosphere such as nitrogen or argon) to yield the composite micro/nanoparticles, also referred to as nano-on-nano-on-micro particles, or NNm™ particles. The drying step may be performed before the calcining step to remove water prior to heating at the higher calcining temperatures; this avoids boiling of the water, which would disrupt the impregnated nanoparticles, which are lodged in the pores of the micron-sized carrier.

The PNA material can be made using a procedure similar to that employed for production of the catalyst for oxidation reactions. The nano-on-nano materials, for example nano-sized Pd, Ru, or ruthenium oxide on nano-sized cerium oxide, can be prepared using the method described above. In some instances, the sizes of the nano-sized Pd, Ru, or ruthenium oxide are from about 1 nm to about 5 nm and the sizes of the nano-sized cerium oxide are from about 5 nm to about 10 nm. In some instances, the sizes of the nano-sized Pd, Ru, or ruthenium oxide are approximately 1 nm or less and the sizes of the nano-sized cerium oxide are approximately 10 nm or less. In some embodiments, the weight ratio of nano-sized Pd, Ru, or ruthenium oxide:nano-sized cerium oxide is from 1%:99% to 40%:60%. In some embodiments, the weight ratio of nano-sized Pd, Ru, or ruthenium oxide:nano-sized cerium oxide is from 5%:95% to 20%:80%. In some embodiments, the weight ratio of nano-sized Pd, Ru, or ruthenium oxide:nano-sized cerium oxide is from 8%:92% to 12%:88%. In some embodiments, the weight ratio of nano-sized Pd, Ru, or ruthenium oxide:nano-sized cerium oxide is from 9%:91% to 11%:89%. In some embodiments, the weight ratio of nano-sized Pd, Ru, or ruthenium oxide:nano-sized cerium oxide is about 10%:90%.

Next, calcination can be performed. The dried powder from the previous step, that is, the nanomaterials on the micron-sized material, can be baked at 550° C. for two hours under ambient air conditions. During the calcination step, the surfactant is evaporated and the nanomaterials are glued or fixed onto the surface of the micron-sized materials or the surface of the pores of the micron-sized materials. At this stage, the material produced (a catalytic active material) contains a micron-sized particle (micron-sized cerium oxide) having nano-on-nano (such as nano-sized Pd, Ru, or ruthenium oxide on nano-sized cerium oxide) and nano-sized cerium oxide randomly distributed on the surface.

The PNA NNm™ particles may contain from about 0.1% to 6% Pd, Ru, or ruthenium oxide by weight, or in another embodiment from about 0.5% to 3.5% by weight, or in another embodiment, about 1% to about 2.5% by weight, or in another embodiment about 2% to about 3% by weight, or in another embodiment, about 2.5% by weight, of the total mass of the NNm™ particle. The NNm™ particles can then be used for formulations for coating substrates, where the coated substrates may be used in catalytic converters.

### Porous Materials for Use in “Nano-on-Nano-in-Micro” Particles (“NNiM” Particles)

Porous materials, production of porous materials, micron-sized particles comprising composite nanoparticles and a porous carrier (“Nano-on-Nano-in-Micro” particles or “NNiM” particles), and production of micron-sized particles comprising composite nanoparticles and a porous carrier (“Nano-on-Nano-in-Micro” particles or “NNiM” particles) are described in the co-owned U.S. Provisional Patent Application No. 61/881,337, filed on Sep. 23, 2013, U.S. patent application Ser. No. 14/494,156, and International Patent Application No. PCT/US2014/057036, the disclosures of which are hereby incorporated by reference in their entirety.

Generally, a preferred porous material is a material that contains a large number of interconnected pores, holes, channels, or pits, with an average pore, hole, channel, or pit width (diameter) ranging from 1 nm to about 200 nm, or about 1 nm to about 100 nm, or about 2 nm to about 50 nm, or about 3 nm to about 25 nm. In some embodiments, the porous material has a mean pore, hole, channel, or pit width (diameter) of less than about 1 nm, while in some embodiments, a porous carrier has a mean pore, hole, channel, or pit width (diameter) of greater than about 100 nm. In some embodiments, the porous material has an average pore surface area in a range of about 50 m²/g to about 500 m²/g. In some embodiments, the porous material has an average pore surface area in a range of about 100 m²/g to about 400 m²/g. In some embodiments, a porous material has an average pore surface area in a range of about 150 m²/g to about 300 m²/g. In some embodiments, the porous material has an average pore surface area of less than about 50 m²/g. In some embodiments, the porous material has an average pore surface area of greater than about 200 m²/g. In some embodiments, the porous material has an average pore surface area of greater than about 300 m²/g, about 400 m²/g, or about 500 m²/g. In some embodiments, a porous material has an average pore surface area of about 200 m²/g. In some embodiments, a porous material has an average pore surface area of about 300 m²/g.

In some embodiments, the porous material may comprise porous metal oxide, such as aluminum oxide or cerium oxide. In some embodiments, a porous material may comprise an organic polymer, such as polymerized resorcinol. In some embodiments, the porous material may comprise amorphous carbon. In some embodiments, the porous material may comprise silica. In some embodiments, a porous material may be porous ceramic. In some embodiments, the porous material may comprise a mixture of two or more different types of interspersed porous materials, for example, a mixture of aluminum oxide and polymerized resorcinol. In some embodiments, the porous carrier may comprise aluminum oxide after a spacer material has been removed. For example, in some embodiments, a composite material may be formed with interspersed aluminum oxide and polymerized resorcinol, and the polymerized resorcinol is removed, for example, by calcination, resulting in a porous carrier. In another embodiment, a composite material may be formed with interspersed aluminum oxide and carbon black, and the carbon black is removed, for example, by calcination, resulting in a porous carrier.

In some embodiments, the porous material is a micron-sized particle, with an average size between about 1 micron and about 100 microns, between about 1 micron and about 10 microns, between about 3 microns and about 7 microns, or between about 4 microns and about 6 microns. In other embodiments, the porous material may be particles larger than about 7 microns. In some embodiments, the porous material may not be in the form of particles, but a continuous material.

The porous materials may allow gases and fluids to slowly flow throughout the porous material via the interconnected channels, being exposed to the high surface area of the porous material. The porous materials can therefore serve as an excellent carrier material for embedding particles in which high surface area exposure is desirable, such as catalytic nanoparticles, as described below.

### Production of Porous Materials for Use in “Nano-on-Nano-in-Micro” Particles (“NNiM” Particles)

A catalyst or PNA material may be formed using a porous material. This porous material includes, for example, nanoparticles embedded within the porous structure of the material. This can include nano-on-nano particles (composite nanoparticles) embedded into a porous carrier formed around the nano-on-nano particles. Nanoparticles embedded in a porous carrier can refer to the configuration of the nanoparticles in the porous carrier resulting when the porous carrier is formed around the nanoparticles, generally by using the methods described herein. That is, the resulting structure contains nanoparticles with a scaffolding of porous carrier built up around or surrounding the nanoparticles. The porous carrier encompasses the nanoparticles, while at the same time, by virtue of its porosity, the porous carrier permits external gases to contact the embedded nanoparticles.

PNA nano-on-nano particles can be produced, where the PGM can comprise palladium, ruthenium, or ruthenium oxide, and the support nanoparticles can comprise cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide. Oxidative nano-on-nano particles can be produced, where the catalytic nanoparticle can comprise platinum, palladium, or platinum/palladium alloy, and the support nanoparticle can comprise aluminum oxide. Reductive nano-on-nano particles can be produced, where the catalytic nanoparticle can comprise rhodium, and the support nanoparticle can comprise cerium oxide. The support nanoparticle can comprise cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide.

In some embodiments, the porous structure comprises alumina or cerium oxide. In some embodiments, the cerium oxide can include zirconium oxide, lanthanum, lanthanum oxide, yttrium oxide or a combination thereof. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the cerium oxide particles contain 86 wt % cerium oxide, 10 wt % zirconium oxide, and 4 wt % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide.

The porous materials with embedded nano-on-nano particles within the porous structure of the material, where the porous structure comprises alumina, or where the porous structure comprises ceria, or where the porous structure comprises cerium-zirconium oxide, cerium-zirconium-lanthanum oxide, or cerium-zirconium-lanthanum-yttrium oxide, can be prepared as follows. Alumina porous structures may be formed, for example, by the methods described in U.S. Pat. No. 3,520,654, the disclosure of which is hereby incorporated by reference in its entirety. In some embodiments, a sodium aluminate solution, prepared by dissolving sodium oxide and aluminum oxide in water, can be treated with sulfuric acid or aluminum sulfate to reduce the pH to a range of about 4.5 to about 7. The decrease in pH results in a precipitation of porous hydrous alumina which may be spray dried, washed, and flash dried, resulting in a porous alumina material. Optionally, the porous alumina material may be stabilized with silica, as described in EP0105435 A2, the disclosure of which is hereby incorporated by reference in its entirety. A sodium aluminate solution can be added to an aluminum sulfate solution, forming a mixture with a pH of about 8.0. An alkaline metal silicate solution, such as a sodium silicate solution, can be slowly added to the mixture, resulting in the precipitation of a silica-stabilized porous alumina material.

A porous material may also be generated by co-precipitating aluminum oxide nanoparticles and amorphous carbon particles, such as carbon black. Upon drying and calcination of the precipitate in an ambient or oxygenated environment, the amorphous carbon is exhausted, that is, burned off. Simultaneously, the heat from the calcination process causes the aluminum oxide nanoparticles to sinter together, resulting in pores throughout the precipitated aluminum oxide where the carbon black once appeared in the structure. In some embodiments, aluminum oxide nanoparticles can be suspended in ethanol, water, or a mix of ethanol and water. In some embodiments, dispersant, such as DisperBYK®-145 from BYK (DisperBYK is a registered trademark of BYK-Chemie GmbH LLC, Wesel, Germany for chemicals for use as dispersing and wetting agents) may be added to the aluminum oxide nanoparticle suspension. Carbon black with an average grain size ranging from about 1 nm to about 200 nm, or about 20 nm to about 100 nm, or about 20 nm to about 50 nm, or about 35 nm, may be added to the aluminum oxide suspension. In some embodiments, sufficient carbon black is added to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. The pH of the resulting mixture can be adjusted to a range of about 2 to about 7, such as a pH of between about 3 and about 5, preferably a pH of about 4, allowing the particles to precipitate. In some embodiments, the precipitant can be dried, for example by warming the precipitant (for example, at about 30° C. to about 95° C., preferably about 60° C. to about 70° C., at atmospheric pressure or at reduced pressure such as from about 1 pascal to about 90,000 pascal). Alternatively, in some embodiments, the precipitant may be freeze-dried.

After drying, the material may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the aluminum oxide nanoparticles sinter together, yielding a porous aluminum oxide material.

In other embodiments, a porous material may also be generated by co-precipitating cerium oxide nanoparticles and amorphous carbon particles, such as carbon black. Upon drying and calcination of the precipitate in an ambient or oxygenated environment, the amorphous carbon is exhausted, that is, burned off. Simultaneously, the heat from the calcination process causes the cerium oxide nanoparticles to sinter together, resulting in pores throughout the precipitated cerium oxide where the carbon black once appeared in the structure. In some embodiments, cerium oxide nanoparticles can be suspended in ethanol, water, or a mix of ethanol and water. In some embodiments, dispersant, such as DisperBYK®-145 from BYK (DisperBYK is a registered trademark of BYK-Chemie GmbH LLC, Wesel, Germany for chemicals for use as dispersing and wetting agents) may be added to the cerium oxide nanoparticle suspension. Carbon black with an average grain size ranging from about 1 nm to about 200 nm, or about 20 nm to about 100 nm, or about 20 nm to about 50 nm, or about 35 nm, may be added to the cerium oxide suspension. In some embodiments, sufficient carbon black is added to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. The pH of the resulting mixture can be adjusted to a range of about 2 to about 7, such as a pH of between about 3 and about 5, preferably a pH of about 4, allowing the particles to precipitate. In some embodiments, the precipitant can be dried, for example by warming the precipitant (for example, at about 30° C. to about 95° C., preferably about 60° C. to about 70° C., at atmospheric pressure or at reduced pressure such as from about 1 pascal to about 90,000 pascal). Alternatively, in some embodiments, the precipitant may be freeze-dried.

After drying, the material may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the cerium oxide nanoparticles sinter together, yielding a porous cerium oxide material.

In some embodiments, a porous material may be made using the sol-gel process. For example, a sol-gel precursor to an alumina porous material may be formed by reacting aluminum chloride with propylene oxide. Propylene oxide can be added to a solution of aluminum chloride dissolved in a mixture of ethanol and water, which forms a porous material that may be dried and calcined. In some embodiments, epichlorohydrin may be used in place of propylene oxide. As another example, a sol-gel precursor to a ceria porous material may be formed by reacting cerium nitrate with resorcinol and formaldehyde. Other methods of producing a porous material using the sol-gel method known in the art may also be used, for example, a porous material formed using the sol-gel process may be also be formed using tetraethyl orthosilicate.

In some embodiments, the porous material may be formed by mixing the precursors of a combustible gel with the precursors of a metal oxide material prior to polymerization of the gel, allowing the polymerization of the gel, drying the composite material, and calcining the composite material, thereby exhausting the organic gel components. In some embodiments, a gel activation solution comprising a mixture of formaldehyde and propylene oxide can be mixed with a gel monomer solution comprising a mixture of aluminum chloride and resorcinol. Upon mixing of the gel activation solution and the gel monomer solution, a combustible organic gel component forms as a result of the mixing of formaldehyde and resorcinol, and a non-combustible inorganic metal oxide material forms as a result of mixing the propylene oxide and aluminum chloride. The resulting composite material can be dried and calcined, causing the combustible organic gel component to burn away, resulting in a porous metal oxide material (aluminum oxide). In another embodiment, a solution of formaldehyde can be reacted with a solution of resorcinol and cerium nitrate. The resulting material can be dried and calcined, causing the combustible organic gel component to burn away, resulting in a porous metal oxide material (cerium oxide). The resulting material can be dried and calcined, causing the combustible organic gel component to burn away, resulting in a porous metal oxide material (cerium oxide). In yet further embodiments, a solution of formaldehyde can be reacted with a solution of resorcinol, cerium nitrate, and one or more of zirconium oxynitrate, lanthanum acetate, and/or yttrium nitrate as appropriate to form cerium-zirconium oxide, cerium-zirconium-lanthanum oxide, or cerium-zirconium-lanthanum-yttrium oxide. The resulting material can be dried and calcined, causing the combustible organic gel component to burn away, resulting in a porous metal oxide material (cerium-zirconium oxide, cerium-zirconium-lanthanum oxide, or cerium-zirconium-lanthanum-yttrium oxide).

In some embodiments, the gel activation solution may be prepared by mixing aqueous formaldehyde and propylene oxide. The formaldehyde is preferably in an aqueous solution. In some embodiments, the concentration of the aqueous formaldehyde solution is about 5 wt % to about 50 wt % formaldehyde, about 20 wt % to about 40 wt % formaldehyde, or about 30 wt % to about 40 wt % formaldehyde. Preferably, the aqueous formaldehyde is about 37 wt % formaldehyde. In some embodiments, the aqueous formaldehyde may contain about 5 wt % to about 15 wt % methanol to stabilize the formaldehyde in solution. The aqueous formaldehyde can be added in a range of about 25% to about 50% of the final weight of the gel activation solution, with the remainder being propylene oxide. Preferably, the gel activation solution comprises 37.5 wt % of the aqueous formaldehyde solution (which itself comprises 37 wt % formaldehyde) and 62.5 wt % propylene oxide, resulting in a final formaldehyde concentration of about 14 wt % of the final gel activation solution.

Separately from the gel activation solution, a gel monomer solution may be produced by dissolving aluminum chloride in a mixture of resorcinol and ethanol. Resorcinol can be added at a range of about 2 wt % to about 10 wt %, with about 5 wt % being a typical value. Aluminum chloride can be added at a range of about 0.8 wt % to about 5 wt %, with about 1.6 wt % being a typical value.

The gel activation solution and gel monomer solution can be mixed together at a ratio at about 1:1 in terms of (weight of gel activation solution):(weight of gel monomer solution). The final mixture may then be dried (for example, at about 30° C. to about 95° C., preferably about 50° C. to about 60° C., at atmospheric pressure or at reduced pressure such as from about 1 pascal to about 90,000 pascal, for about one day to about 5 days, or for about 2 days to about 3 days). After drying, the material may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere, for about 12 hours to about 2 days, or about 16 hours to about 24 hours) to burn off the combustible organic gel component and yield a porous aluminum oxide carrier.

Gel monomer solutions can be prepared with cerium nitrate, zirconium oxynitrate, lanthanum acetate, and/or yttrium nitrate in a process similar to that described above, for preparation of porous cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide carrier.

The porous materials prepared above are then ground or milled into micron-sized particles.

Nano-on-nano-in-micro (“NNiM”™) materials are prepared by mixing nano-on-nano (NN) particles into the precursors to the porous materials, for example, by using a portion of NN particles when mixing together nanoparticles with amorphous carbon, or by mixing NN particles into the sol-gel solution, followed by preparation of the porous material as described above. After grinding or milling the porous material with embedded NN particles into micron-sized particles (to form “NNiM”™ materials), the resulting material can then be used in an oxidative washcoat, a reductive washcoat, a PNA washcoat, or a combined washcoat of any of the oxidative, reductive, and PNA washcoats. The amount of NN particles added is guided by the desired loading of PGM metal in the final NNiM material.

Oxidative NNiM material can be formed, where the nano-on-nano composite nanoparticles comprise a platinum catalytic nanoparticle disposed on an aluminum oxide support particle; where the nano-on-nano composite nanoparticles comprise a palladium catalytic nanoparticle disposed on an aluminum oxide support particle; or where the nano-on-nano composite nanoparticles comprise a platinum/palladium alloy catalytic nanoparticle disposed on an aluminum oxide support particle; and one or more of those NN particles is then embedded in a porous carrier formed of aluminum oxide, which is ground or milled into micron-sized particles. Reductive NNiM material can be formed, where the nano-on-nano composite nanoparticles comprise a rhodium catalytic nanoparticle disposed on a cerium oxide support particle; where the nano-on-nano composite nanoparticles comprise a rhodium catalytic nanoparticle disposed on a cerium-zirconium oxide support particle; where the nano-on-nano composite nanoparticles comprise a rhodium catalytic nanoparticle disposed on a cerium-zirconium-lanthanum oxide support particle; or where the nano-on-nano composite nanoparticles comprise a rhodium catalytic nanoparticle disposed on a cerium-zirconium-lanthanum-yttrium oxide support particle; and one or more of those NN particles is then embedded in a porous carrier formed of porous cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide carrier, which is ground or milled into micron-sized particles. PNA NNiM material can be formed, where the nano-on-nano composite nanoparticles comprise a palladium nanoparticle disposed on a cerium oxide support particle; where the nano-on-nano composite nanoparticles comprise a palladium nanoparticle disposed on a cerium-zirconium oxide support particle; where the nano-on-nano composite nanoparticles comprise a palladium nanoparticle disposed on a cerium-zirconium-lanthanum oxide support particle; or where the nano-on-nano composite nanoparticles comprise a palladium nanoparticle disposed on a cerium-zirconium-lanthanum-yttrium oxide support particle; and one or more of those NN particles is then embedded in a porous carrier formed of aluminum oxide, cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide, which is ground or milled into micron-sized particles. PNA NNiM material can be formed, where the nano-on-nano composite nanoparticles comprise a ruthenium or ruthenium oxide nanoparticle disposed on a cerium oxide support particle; where the nano-on-nano composite nanoparticles comprise a ruthenium or ruthenium oxide nanoparticle disposed on a cerium-zirconium oxide support particle; where the nano-on-nano composite nanoparticles comprise a ruthenium or ruthenium oxide nanoparticle disposed on a cerium-zirconium-lanthanum oxide support particle; or where the nano-on-nano composite nanoparticles comprise a ruthenium or ruthenium oxide nanoparticle disposed on a cerium-zirconium-lanthanum-yttrium oxide support particle; and one or more of those NN particles is then embedded in a porous carrier formed of aluminum oxide, cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, or cerium-zirconium-lanthanum-yttrium oxide, which is ground or milled into micron-sized particles. Aluminum oxide porous material can also be used as the porous material in which any of the foregoing rhodium-containing composite NN nanoparticles can be embedded. The weight ratios of the NN particles used can be those described in the above NNm section. For example, the weight ratio of nano-sized Pd, Ru, or ruthenium oxide:nano-sized cerium oxide can be from 1%:99% to 40%:60%, from 5%:95% to 20%:80%, from 8%:92% to 12%:88%, from 9%:91% to 11%:89%, and 10%:90%.

### Micron-Sized Particles Comprising Composite Nanoparticles and a Porous Carrier (“Nano-on-Nano-in-Micro” Particles or “NNiM” Particles)

Nanoparticles or composite nanoparticles produced by plasma production or other methods may be embedded within a porous material to enhance the surface area of catalytic components (this includes PNA components because PNA components include PGM which by its very nature is catalytic). The porous material may then serve as a carrier for the composite nanoparticles, allowing gasses and fluids to slowly flow throughout the porous material via the interconnected channels. The high porosity of the carrier results in a high surface area within the carrier allowing increased contact of the gasses and fluids with the embedded catalytic components, such as composite nanoparticles. Embedding the composite nanoparticles within the porous carrier results in a distinct advantage over those technologies where catalytically active nanoparticles are positioned on the surface of carrier micro-particles or do not penetrate as effectively into the pores of the support. When catalytically active nanoparticles are position on the surface of carrier micro-particles, some catalytically active nanoparticles can become buried by other catalytically active nanoparticles, causing them to be inaccessible to target gases because of the limited exposed surface area. When the composite nanoparticles are embedded within the porous carrier, however, gases can flow through the pores of the carrier to catalytically active components.

The porous carrier may contain any large number of interconnected pores, holes, channels, or pits, preferably with an average pore, hole, channel, or pit width (diameter) ranging from 1 nm to about 200 nm, or about 1 nm to about 100 nm, or about 2 nm to about 50 nm, or about 3 nm to about 25 nm. In some embodiments, the porous carrier has a mean pore, hole, channel, or pit width (diameter) of less than about 1 nm, while in some embodiments, a porous carrier has a mean pore, hole, channel, or pit width (diameter) of greater than about 100 nm. In some embodiments, a porous material has an average pore surface area in a range of about 50 m²/g to about 500 m²/g. In some embodiments, a porous material has an average pore surface area in a range of about 100 m²/g to about 400 m²/g. In some embodiments, a porous material has an average pore surface area in a range of about 150 m²/g to about 300 m²/g. In some embodiments, a porous material has an average pore surface area of less than about 50 m²/g. In some embodiments, a porous material has an average pore surface area of greater than about 200 m²/g. In some embodiments, a porous material has an average pore surface area of greater than about 300 m²/g. In some embodiments, a porous material has an average pore surface area of about 200 m²/g. In some embodiments, a porous material has an average pore surface area of about 300 m²/g.

A porous carrier embedded with nanoparticles can be formed with any porous material. A porous carrier may include, but is not limited to, any gel produced by the sol-gel method, for example, alumina (Al₂O₃), cerium oxide, or silica aerogels as described herein. In some embodiments, the porous carrier may comprise a porous metal oxide, such as aluminum oxide or cerium oxide. In some embodiments, a porous carrier may comprise an organic polymer, such as polymerized resorcinol. In some embodiments, the porous carrier may comprise amorphous carbon. In some embodiments, the porous carrier may comprise silica. In some embodiments, a porous carrier may be porous ceramic. In some embodiments, the porous carrier may comprise a mixture of two or more different types of interspersed porous materials, for example, a mixture of aluminum oxide and polymerized resorcinol.

In some embodiments, a carrier may comprise a combustible component, for example amorphous carbon or a polymerized organic gel such as polymerized resorcinol, and a non-combustible component, for example a metal oxide such as aluminum oxide. A catalytic material can include composite nanoparticles embedded in a carrier comprising a combustible component and a non-combustible component.

Catalytic and/or PNA particles, such as the catalytic nanoparticles or catalytic and/or PNA composite nanoparticles described herein, are embedded within the porous carrier. This can be accomplished by including the catalytic and/or PNA particles in the mixture used to form the porous carrier. In some embodiments, the catalytic and/or PNA particles are evenly distributed throughout the porous carrier. In other embodiments, the catalytic and/or PNA particles are clustered throughout the porous carrier. In some embodiments, platinum group metals comprise about 0.001 wt % to about 10 wt % of the total catalytic and/or PNA material (catalytic and/or PNA particles and porous carrier). For example, platinum group metals may comprise about 1 wt % to about 8 wt % of the total catalytic and/or PNA material (catalytic and/or PNA particles and porous carrier). In some embodiments, platinum group metals may comprise less than about 10 wt %, less than about 8 wt %, less than about 6 wt %, less than about 4 wt %, less than about 2 wt %, or less than about 1 wt % of the total catalytic and/or PNA material (catalytic and/or PNA particles and porous carrier). In some embodiments, platinum group metals may comprise about 1 wt %, about 2 wt %, about 3 wt %, about 4 wt %, about 5 wt %, about 6 wt %, about 7 wt %, about 8 wt %, about 9 wt %, or about 10 wt % of the total catalytic and/or PNA material (catalytic and/or PNA particles and porous carrier).

In some embodiments, the catalytic and/or PNA nanoparticles comprise one or more platinum group metals. In embodiments with two or more platinum group metals, the metals may be in any ratio. In some embodiments, the catalytic nanoparticles comprise platinum group metal or metals, such as Pt:Pd in about a 2:1 ratio to about 100:1 ratio by weight, or about 2:1 to about 75:1 ratio by weight, or about 2:1 to about 50:1 ratio by weight, or about 2:1 to about 25:1 ratio by weight, or about 2:1 to about 15:1 ratio by weight. In one embodiment, the catalytic nanoparticles comprise platinum group metal or metals, such as Pt:Pd in about 2:1 ratio by weight.

The composite nanoparticles (nano-on-nano particles) embedded within a porous carrier may take the form of a powder to produce composite catalytic micro-particles, referred to as “nano-on-nano-in-micron” particles or “NNiM” particles. In typical NNiM particles, a porous material (or matrix) may be formed around and surround nanoparticles or composite nanoparticle produced by plasma production or other methods. The porous material can bridge together the surrounded nanoparticles or composite nanoparticles, thereby embedding the particles within the matrix. The porous material may then serve as a carrier for the composite nanoparticles, allowing gases and fluids to slowly flow throughout the porous material (i.e., the interconnected bridges) via the interconnected channels. The high porosity of the carrier results in a high surface area within the carrier allowing increased contact of the gases and fluids with the contained catalytic components, such as composite nanoparticles.

The micron-sized NNiM particles can have an average size between about 1 micron and about 100 microns, such as between about 1 micron and about 10 microns, between about 3 microns and about 7 microns, or between about 4 microns and about 6 microns. The PGM particles may comprise about 0.001 wt % to about 10 wt % of the total mass of the NNiM particle (catalytic and/or PNA particles and porous carrier). For example, platinum group metals may comprise about 1 wt % to about 8 wt % of the total mass of the NNiM particle (catalytic and/or PNA particles and porous carrier). In some embodiments, platinum group metals may comprise less than about 10 wt %, less than about 8 wt %, less than about 6 wt %, less than about 4 wt %, less than about 2 wt %, or less than about 1 wt % of the total mass of the NNiM particle (catalytic and/or PNA particles and porous carrier). In some embodiments, platinum group metals may comprise about 1 wt %, about 2 wt %, about 3 wt %, about 4 wt %, about 5 wt %, about 6 wt %, about 7 wt %, about 8 wt %, about 9 wt %, or about 10 wt % of the total mass of the NNiM particle (catalytic and/or PNA particles and porous carrier).

In some embodiments, the catalytic (or PNA) nanoparticles comprise one or more platinum group metals. In embodiments with two or more platinum group metals, the metals may be in any ratio. In some embodiments, the catalytic nano-particles comprise platinum group metal or metals, such as about 1:2 to about 100:1 Pt/Pd (weight/weight), 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or about 20:1 Pt/Pd (weight/weight).

NNiM particles may be used for any catalytic purpose or NOₓ storage purpose. For example, NNiM particles may be suspended in a liquid, for example ethanol or water, which may catalyze dissolved compounds. Alternatively, the NNiM particles may be used as a solid state catalyst. For example, the NNiM particles can then be used in catalytic converters.

### Production of Micron-Sized Particles Comprising Composite Nanoparticles and a Porous Carrier (“Nano-on-Nano-in-Micro” Particles or “NNiM” Particles)

In some embodiments, catalytic nanoparticles or composite nanoparticles can be embedded in a porous carrier by forming a suspension or colloid of nanoparticles, and mixing the suspension or colloid of nanoparticles with a porous material precursor solution. Upon solidification of the porous material with the mixture, such as by polymerization, precipitation, or freeze-drying, the porous material will form around the nanoparticles, resulting in a catalytic material comprising nanoparticles embedded in a porous carrier. In some embodiments, the catalytic and/or PNA material is then processed, such as by grinding or milling, into a micron-sized powder, resulting in NNiM particles.

Described below is the production of NNiM particles using a porous aluminum oxide carrier formed using a composite carrier comprising a combustible organic gel component and an aluminum oxide component, followed by drying and calcination. However, one skilled in the art would understand any manner of porous carrier (such as cerium oxide) originating from soluble precursors may be used to produce catalytic (including PNA) material comprising composite nanoparticles embedded within a porous carrier using the methods described herein.

For typical NNiM particles produced using a porous aluminum oxide carrier formed using a composite carrier comprising a combustible organic gel component and an aluminum oxide component, the composite nanoparticles are initially dispersed in ethanol. In some embodiments, at least 95 vol % ethanol is used. In some embodiments, at least 99 vol % ethanol is used. In some embodiments, at least 99.9 vol % ethanol is used. Dispersants, surfactants, or mixtures thereof are typically added to the ethanol before suspension of the composite nanoparticles. A suitable surfactant includes DisperBYK®-145 from BYK-Chemie GmbH LLC, Wesel, which can be added in a range of about 2 wt % to about 12 wt %, with about 7 wt % being a typical value, and dodecylamine, which can be added in a range of about 0.25 wt % to about 3 wt %, with about 1 wt % being a typical value. Preferably, both DisperBYK®-145 and dodecylamine are used at about 7 wt % and 1 wt %, respectively. In some embodiments, the mixture of ethanol, composite nanoparticles, and surfactants, dispersants, or mixtures thereof is sonicated to uniformly disperse the composite nanoparticles. The quantity of composite nanoparticles particles in the dispersion may be in the range of about 5 wt % to about 20 wt %.

Separately from the composite nanoparticle suspension, a gel activation solution is prepared by mixing formaldehyde and propylene oxide. The formaldehyde is preferably in an aqueous solution. In some embodiments, the concentration of the aqueous formaldehyde solution is about 5 wt % to about 50 wt % formaldehyde, about 20 wt % to about 40 wt % formaldehyde, or about 30 wt % to about 40 wt % formaldehyde. Preferably, the aqueous formaldehyde is about 37 wt % formaldehyde. In some embodiments, the aqueous formaldehyde may contain about 5 wt % to about 15 wt % methanol to stabilize the formaldehyde in solution. The aqueous formaldehyde solution can be added in a range of about 25% to about 50% of the final weight of the gel activation solution, with the remainder being propylene oxide. Preferably, the gel activation solution comprises 37.5 wt % of the aqueous formaldehyde solution (which itself comprises 37 wt % formaldehyde) and 62.5 wt % propylene oxide, resulting in a final formaldehyde concentration of about 14 wt % of the final gel activation solution.

Separately from the composite nanoparticle suspension and gel activation solution, an aluminum chloride solution is produced by dissolving aluminum chloride in a mixture of resorcinol and ethanol. Resorcinol can be added at a range of about 10 wt % to about 30 wt %, with about 23 wt % being a typical value. Aluminum chloride can be added at a range of about 2 wt % to about 12 wt %, with about 7 wt % being a typical value.

The composite nanoparticle suspension, gel activation solution, and aluminum chloride solution can be mixed together at a ratio from of about 100:10:10 to about 100:40:40, or about 100:20:20 to about 100:30:30, or about 100:25:25, in terms of (weight of composite nanoparticle suspension):(weight of gel activation solution):(weight of aluminum chloride solution). The final mixture will begin to polymerize into a carrier embedded with composite nanoparticles. The carrier comprises a combustible component, an organic gel, and a non-combustible component, aluminum oxide. The resulting carrier may then be dried (for example, at about 30° C. to about 95° C., preferably about 50° C. to about 60° C., at atmospheric pressure or at reduced pressure such as from about 1 pascal to about 90,000 pascal, for about one day to about 5 days, or for about 2 days to about 3 days). After drying, the resulting carrier may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere or under an inert atmosphere such as nitrogen or argon), to yield a porous carrier comprising composite catalytic nanoparticles and aluminate. When the composite carrier is calcined under ambient atmosphere or other oxygenated conditions, organic material, such as polymerized resorcinol, formaldehyde, or propylene oxide, is burnt off, resulting in a substantially pure aluminum oxide porous carrier embedded with composite nanoparticles. If the composite carrier is calcined under an inert atmosphere, such as argon or nitrogen, the organic materials may become substantially porous amorphous carbon interspersed with the porous aluminum oxide embedded with composite nanoparticles. The resulting porous carrier can be processed, such as by grinding or milling, into a micro-sized powder of NNiM particles.

In another embodiment, a composite catalytic nanoparticles may be mixed with a dispersion comprising metal oxide nanoparticles, such as aluminum oxide nanoparticles, and amorphous carbon, such as carbon black. The dispersed solid particles from resulting dispersed colloid may be separated from the liquid by co-precipitation, dried, and calcined. Upon calcination of the solid material in an ambient or oxygenated environment, the amorphous carbon is exhausted. Simultaneously, the heat from the calcination process causes the aluminum oxide nanoparticles to sinter together, resulting in pores throughout the precipitated aluminum oxide.

In some embodiments, aluminum oxide nanoparticles can be suspended in ethanol, water, or a mix of ethanol and water. Carbon black with an average grain size ranging from about 1 nm to about 200 nm, or about 20 nm to about 100 nm, or about 20 nm to about 50 nm, or about 35 nm, may be added to the aluminum oxide suspension. In some embodiments, sufficient carbon black to obtain a pore surface area of about 50 m²/g to about 500 m²/g should be used, such as about 50 m²/g, about 100 m²/g, about 150 m²/g, about 200 m²/g, about 250 m²/g, about 300 m²/g, about 350 m²/g, about 400 m²/g, about 450 m²/g, or about 500 m²/g. Composite nanoparticles may be mixed into the dispersion comprising aluminum oxide nanoparticles and carbon black. In some embodiments, the composite nanoparticles are dispersed in a separate colloid, optionally with dispersants or surfactants, before being mixed with the dispersion comprising aluminum oxide nanoparticles and carbon black. The pH of the resulting mixture can be adjusted to a range of about 2 to about 7, such as a pH of between about 3 and about 5, preferably a pH of about 4, allowing the particles to precipitate. The precipitant can be dried (for example, at about 30° C. to about 95° C., preferably about 50° C. to about 70° C., at atmospheric pressure or at reduced pressure such as from about 1 pascal to about 90,000 pascal, for about one day to about 5 days, or for about 2 days to about 3 days). After drying, the carrier may then be calcined (at elevated temperatures, such as from 400° C. to about 700° C., preferably about 500° C. to about 600° C., more preferably at about 540° C. to about 560° C., still more preferably at about 550° C. to about 560° C., or at about 550° C.; at atmospheric pressure or at reduced pressure, for example, from about 1 pascal to about 90,000 pascal, in ambient atmosphere). The calcination process causes the carbon black to substantially burn away and the aluminum oxide nanoparticles sinter together, yielding a porous aluminum oxide carrier embedded with composite nanoparticles.

The resulting carrier may be further processed, for example by grinding or milling, into micron-sized NNiM particles.

### Non-Exclusive Use of Different Types of Catalytically Active or PNA Materials.

In some embodiments, two or more different types of catalytically active or PNA materials are used. In some embodiments, two or more different types of catalytically active or PNA materials may be used in the same washcoat composition or layer. For example, in some embodiments, both particles produced by only wet-chemistry methods and NNm particles may be used in a single washcoat composition or layer. In another example, in some embodiments, both particles produced by only wet-chemistry methods and NNiM particles may be used in a single washcoat composition or layer. In some embodiments, both NNiM particles and NNm particles may be used in a single washcoat composition or layer. In another example, in some embodiments, particles produced by only wet-chemistry methods, NNm particles, and NNiM particles may be used in a single washcoat composition or layer. In some embodiments, NNm particles and hybrid NNm/wet-chemistry particles may be used in a single washcoat composition or layer. In some embodiments, particles produced by only wet-chemistry methods and hybrid NNm/wet-chemistry particles may be used in a single washcoat composition or layer. In some embodiments, NNiM particles and hybrid NNm/wet-chemistry particles may be used in a single washcoat composition or layer. In some embodiments, NNm particles, particles produced by only wet-chemistry methods, and hybrid NNm/wet-chemistry particles may be used in a single washcoat composition or layer. In some embodiments, NNiM particles, particles produced by only wet-chemistry methods, and hybrid NNm/wet-chemistry particles may be used in a single washcoat composition or layer. In some embodiments, NNm particles, NNiM particles, and hybrid NNm/wet-chemistry particles may be used in a single washcoat composition or layer. In some embodiments, NNm particles, NNiM particles, particles produced by only wet-chemistry methods, and hybrid NNm/wet-chemistry particles may be used in a single washcoat composition or layer.

In some embodiments of the present disclosure, different ratios of different catalytic metals may be more or less efficient in catalyzing various emissions, such as carbon monoxide (CO), nitrogen oxides (NOₓ), or hydrocarbons (HC). For example, in some embodiments, catalytically active materials with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight) are more efficient at catalyzing NOₓ emissions and less efficient at catalyzing HC emissions when compared to catalytically active materials with a mixture of platinum and palladium at a ratio of 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, for an equivalent amount of total PGM used. Therefore, in some embodiments of the disclosure, it is preferred to utilize different types of catalytically active materials with different ratios of catalytic metals (or catalytically active materials with a mixture of metal types and catalytically active materials with a single metal type), and for such ratios to be maintained during the continued operation of the catalysts.

In some embodiments, different types of catalytically active materials of the same structure but with different catalytic metal ratios are used in a single catalytic washcoat composition or catalytic layer. For example, in some embodiments, catalytic particles produced by only wet-chemistry methods with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with catalytic particles produced by only wet-chemistry methods with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, NNm particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with NNm particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, NNiM particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with NNiM particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, hybrid NNm/wet-chemistry particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with hybrid NNm/wet-chemistry particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer.

In some embodiments, different types of catalytically active materials of different structures and with different catalytic metal ratios are used in a single catalytic washcoat composition or catalytic layer. For example, in some embodiments, catalytic particles produced by only wet-chemistry methods with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with NNm particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, catalytic particles produced by only wet-chemistry methods with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with NNiM particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, NNiM particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with NNm particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, NNiM particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with catalytic particles produced by only wet-chemistry methods with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, NNm particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with catalytic particles produced by only wet-chemistry methods with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, NNm particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with NNiM particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, different types of catalytically active materials of different structures and with different catalytic metal ratios are used in a single catalytic washcoat composition or catalytic layer. For example, in some embodiments, catalytic particles produced by only wet-chemistry methods with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with hybrid NNm/wet-chemistry particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, hybrid NNm/wet-chemistry particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with NNiM particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, NNiM particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with hybrid NNm/wet-chemistry particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, hybrid NNm/wet-chemistry particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with catalytic particles produced by only wet-chemistry methods with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, NNm particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with hybrid NNm/wet-chemistry particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer. In some embodiments, hybrid NNm/wet-chemistry particles with a mixture of platinum and palladium at a ratio of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), may be mixed with NNm particles with a mixture of platinum and palladium at a ratio of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, in a single catalytic washcoat composition or catalytic layer.

Combinations of different types of catalytically active materials, such as catalytically active materials with different structures or different ratios of catalytic metals are contemplated by this disclosure. Different types catalytically active materials with different or the same catalytic metal ratios but with different structures may be combined in any proportion. Different types catalytically active materials with different or the same catalytic structure but with different ratios of catalytic ratios may be combined in any proportion. In some embodiments, a first type of catalytically active material and a second type of catalytically active material may be combined a proportion of about 99.9:0.1 to about 50:50 by weight, or about 95:5 by weight, about 90:10 by weight, about 80:20 by weight, about 70:30 by weight, about 65:35 by weight, about 60:40 by weight, about 55:45 by weight, or about 50:50 by weight.

The platinum group metals deposited by wet-chemical methods onto metal oxide supports, such as alumina, are mobile at high temperatures, such as temperatures encountered in catalytic converters, such as when used with heavy-duty vehicles. That is, at elevated temperatures, the platinum group metal atoms can migrate over the surface on which they are deposited, and may clump together with other PGM atoms within a single catalytic layer. The finely-divided portions of PGM combine into larger and larger agglomerations of platinum group metal as the time of exposure to high temperature increases. This agglomeration leads to reduced catalyst surface area and degrades the performance of the catalytic converter. This phenomenon is referred to as “aging” of the catalytic converter. When different catalytic particles produced by wet-chemistry methods with different catalytic metal ratios (such as different Pt/Pd ratio) are used in a single catalytic layer, there is some concern that the aging catalytic converter will allow the PGMs to combine, decreasing the ratio differential between the different catalytic particles produced by wet-chemistry methods. It is therefore preferred, but should not be considered limiting, that when using different types of catalytic particles produced by wet-chemistry methods with different catalytic metal ratios, the different catalytic particles be located in different catalytic layers. This should not be considered limiting, however, as in some embodiments different catalytic particles produced by wet-chemistry methods with different catalytic metal ratios are located in the same catalytic layer.

In embodiments using composite nanoparticles, such as NNiM particles or NNm particles, platinum group metals generally have much lower mobility than the platinum group metals deposited by wet-chemistry methods. The resulting plasma-produced metals and catalysts age at a much slower rate than the wet-chemistry produced catalysts. Thus, catalytic converters using plasma-produced catalysts can maintain a larger surface area of exposed catalyst to gases emitted by the engine over a longer period. The Pt/Pd-alumina composite nanoparticles, when produced under reducing conditions, such as by using argon/hydrogen working gas, results in a partially reduced alumina surface on the support nano-particle on which the platinum group metal catalytic nano-particle is disposed, as described in US 2011/0143915 at paragraphs 0014-0022, the disclosure of which is hereby incorporated by reference in its entirety. The partially reduced alumina surface, or Al₂O₍₃₋ₓ₎ where x is greater than zero, but less than three, inhibits migration of the platinum group metal on the alumina surface at high temperatures. This in turn limits the agglomeration of platinum group metal when the particles are exposed to prolonged elevated temperatures, such as those found in catalytic converters of heavy-duty vehicles. It is therefore preferred, but not considered limiting, that in embodiments where catalytic particles produced by wet-chemistry methods with a first catalytic metal ratio, or hybrid NNm/wet-chemistry particles with a first catalytic metal ratio, are mixed in the same washcoat layer with a second type of catalytically active material with a second ratio of catalytic metal, that the second type of catalytically active material with the second ratio of catalytic material be of a type using composite nanoparticles, such as NNm particles or NNiM particles. However, this should not be considered limiting, as combinations of any or all types of particles as disclosed herein in the same washcoat layer can be used.

Impregnation of a support, such as a micron-sized support, using wet-chemistry methods tends to deposit the material throughout the material, that is, deep into the interior of the material. For example, applying a solution of chloroplatinic acid to a micron-sized aluminum oxide particle will result in penetration of the solution throughout the particle. When followed by drying and calcining, platinum precipitates from solution onto the alumina in finely-divided portions (typically on the order of tenths of nanometers, i.e., clusters of a few atoms, or on the order of nanometers) throughout the entire volume of the particle. Thus, a support impregnated with a metal salt via wet-chemistry methods will have material distributed substantially evenly throughout the volume of the support, or at the very least throughout the volume of the particle accessible to the metal salt solution.

In contrast, impregnation of a support, such as a micron-sized support, with composite nanoparticles (“nano-on-nano” or “NN” particles) tends to result in the material distributed primarily on or near the surface of the support particle. As the nano-on-nano particles are applied to the support particle in a suspension, they cannot penetrate as deeply into the interior of the support particle as the solution of metal salt used in the wet-chemistry methods, resulting in an “eggshell” distribution, where a thin layer of NN particles coats the surface (and the pores closest to the surface) of the support. Thus, the majority of NN particles tend to be located on or near the surface of the support. The NN particles cannot penetrate into pores of the support which are not large enough to accept the NN particles, and are restricted to the exterior surface, and the interior portions of the support particle that are accessible to the NN particles. The nano-on-nano-on-micro (“NNm”) particles thus have composite nanoparticles distributed on the exterior surface and on the nano-on-nano accessible interior surface of the micron-sized support particle.

The nano-on-nano-in-micro (NNiM) particles described herein, and described in more detail in co-owned U.S. Provisional Patent Appl. No. 61/881,337 filed Sep. 23, 2013, U.S. patent application Ser. No. 14/494,156 filed Sep. 23, 2014, and International Patent Appl. No. PCT/US2014/057036 filed Sep. 23, 2014, the disclosures of which are hereby incorporated by reference in their entirety, were designed in order to remedy the uneven distribution of the composite nanoparticles on the micron-sized support. By forming a matrix of the support material around the composite nanoparticles (nano-on-nano or “NN” particles), the composite nanoparticles can be substantially evenly distributed throughout the support material. The support material containing the composite nanoparticles can be milled or ground to the desired micron-sized dimension, thus creating a micron-sized support particle with a substantially uniform distribution of composite nanoparticles throughout its entire volume. This nano-on-nano-IN-micro (NNiM) configuration permits loading much more catalyst per unit volume of support material (i.e., per unit volume of micron-sized support particle) than the nano-on-nano-ON-micro (NNm) configuration.

The hybrid particles as described herein also alleviate the uneven distribution of catalyst material to some extent, by using a wet-chemistry-impregnated particle as the support micron particle for the nano-on-nano-on-micron (NNm) procedure. By impregnating the micron support with a PGM salt solution, then drying and calcining, and then by adding nano-on-nano particles to the wet-chemistry-impregnated micron support, a hybrid particle, with catalyst distributed substantially evenly throughout the volume of the support, or at the very least throughout the volume of the particle accessible to the metal salt solution, and also having composite nanoparticles distributed on the exterior surface and on the nano-on-nano accessible interior surface of the micron-sized support particle, can be formed. As noted above, the inclusion of nano-on-nano particles reduces the concentration of the material that must be impregnated by wet-chemistry methods, which in turn slows down the kinetics of aging of the material deposited by wet-chemistry methods.

NNm and NNiM Particles with Inhibited Migration of Platinum Group Metals

The NNm™ particles including micron-sized carrier particle bearing composite nanoparticles, where the composite nanoparticles are produced by methods described herein, are particularly advantageous for use in catalytic converter applications. The NNiM particles, including those made using a porous carrier and composite nanoparticles, where the carrier is produced by methods described herein and composite nanoparticles produced under reducing conditions, are also particularly advantageous for use in catalytic converter applications. The platinum group metal of the catalytic and/or PNA nanoparticle has a greater affinity for the partially reduced surface of the support nanoparticle than for the surface of the micron-sized carrier particles. Thus, at elevated temperatures, neighboring PGM nanoparticles bound to neighboring support nano-particles are less likely to migrate on the micron-sized carrier particle surface and agglomerate into larger catalyst and/or PNA clumps. Since the larger agglomerations of catalyst and/or PNA have less surface area and are less effective as catalysts and NOₓ adsorbers, the inhibition of migration and agglomeration provides a significant advantage for the NNm™ and NNiM particles. In contrast, PGM particles deposited solely by wet-chemical precipitation onto alumina support demonstrate higher mobility and migration, forming agglomerations of PGM and leading to decreased catalytic efficacy over time (that is, catalyst aging).

### PNA Material (or Composition)

A PNA material or composition is a material that holds NOₓ gases during low temperature engine operation and releases the gases when the temperature rises to a threshold temperature. PNA material can be made up of a single type of particle or multiple types of particles. PNA material can also refer to a PNA washcoat composition or a PNA layer on a substrate. An example of PNA material and systems including PNA material can be found in U.S. Provisional Application No. 61/969,035, U.S. Provisional Application No. 61/985,388, U.S. Provisional Application No. 62/121,444, and U.S. patent application Ser. No. 14/663,330, all of which are hereby incorporated in their entirety by reference.

The PNA material can comprise PGM on support particles; alkali oxide or alkaline earth oxide on support particles; alkali oxide or alkaline earth oxide and PGM on support particles; a combination of alkali oxide or alkaline earth oxide on support particles and different alkali oxides or alkaline earth oxides each on different support particles in any ratio; a combination of alkali oxide or alkaline earth oxide on support particles and PGM on support particles in any ratio; a combination of alkali oxide or alkaline earth oxide on support particles, different alkali oxides or alkaline earth oxides each on different support particles, and PGM on support particles in any ratio; a combination of alkali oxide or alkaline earth oxide and PGM on support particles and the same or different alkali oxides or alkaline earth oxides each on different support particles in any ratio; a combination of alkali oxide or alkaline earth oxide and PGM on support particles and PGM on support particles in any ratio; a combination of alkali oxide or alkaline earth oxide and PGM on support particles; the same or different alkali oxides or alkaline earth oxides each on different support particles; and PGM on support particles in any ratio. In addition, various other combinations of PGM on support particles; alkali oxides and alkaline earth oxides on support particles; and alkali oxides and alkaline earth oxides and PGM on support particles in any ratio can be employed. These PGM particles can refer to any of the above mentioned catalytic particles.

The alkali oxides or alkaline earth oxides can include, for example, magnesium oxide, calcium oxide, manganese oxide, barium oxide, and strontium oxide. The PGM can include, for example, palladium, ruthenium, or mixtures thereof. In addition, the PGM can include their oxides, such as ruthenium oxide.

In some embodiments, the PNA material can comprise palladium on support particles; ruthenium or ruthenium oxide on support particles; manganese oxide (preferably Mn₃O₄) on support particles; magnesium oxide on support particles; calcium oxide on support particles; a combination of manganese oxide on support particles and magnesium oxide on support particles in any ratio; a combination of manganese oxide on support particles and calcium oxide on support particles in any ratio; a combination of magnesium oxide on support particles and calcium oxide on support particles in any ratio; or a combination of manganese oxide on support particles, magnesium oxide on support particles, and calcium oxide on support particles in any ratio. Other embodiments include PNA material comprising a combination of manganese oxide on support particles and PGM on support particles in any ratio; a combination of magnesium oxide on support particles and PGM on support particles in any ratio; a combination of calcium oxide on support particles and PGM on support particles in any ratio; a combination of manganese oxide on support particles, magnesium oxide on support particles, and PGM on support particles in any ratio; a combination of manganese oxide on support particles, calcium oxide on support particles, and PGM on support particles in any ratio; a combination of magnesium oxide on support particles, calcium oxide on support particles, and PGM on support particles in any ratio; or a combination of manganese oxide on support particles, magnesium oxide on support particles, calcium oxide on support particles, and PGM on support particles in any ratio.

Support particles can include, for example, bulk refractory oxides such as alumina or cerium oxide. The cerium oxide particles may further comprise zirconium oxide. The cerium oxide particles may further comprise lanthanum and/or lanthanum oxide. In addition, the cerium oxide particles may further comprise both zirconium oxide and lanthanum oxide. In some embodiments, the cerium oxide particles may further comprise yttrium oxide. Accordingly, the cerium oxide particles can be cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, cerium-zirconium-lanthanum-yttrium oxide particles, or a combination thereof. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the cerium oxide particles contain 86 wt % cerium oxide, 10 wt % zirconium oxide, and 4 wt % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide.

The support particles can be micron-sized, nano-sized, or a mixture thereof. An example of micron-sized support particles include micron-sized cerium oxide particles including, but not limited to, HSA5, HSA20, or a mixture thereof from Rhodia-Solvay.

In some embodiments, the support particles may include PGM, alkali oxides, and/or alkaline earth oxides. For example, the micron-sized cerium oxide particles may include palladium, ruthenium, or a mixture thereof in addition to alkali oxide or alkaline earth oxide or mixtures thereof.

In some embodiments, different PNA materials may not be mixed on a support material. For example, if a combination of manganese oxide on cerium oxide support and magnesium oxide on cerium oxide support is used, the manganese oxide is impregnated onto cerium oxide support material and set aside. Separately, magnesium oxide is then impregnated onto fresh cerium oxide support material. The manganese oxide/cerium oxide and magnesium oxide/cerium oxide are then combined in the desired ratio of the PNA material.

The PNA materials are adsorbers that hold NOₓ compounds during low temperature engine operation. These gases are then released and reduced by the catalysts during high temperature engine operation. During low temperature engine operation, PNA particles physisorbs the NOₓ via non-covalent adsorption. Subsequently, during high temperature engine operation, the NOₓ sharply releases from the PNA particles. In this way, the released NOₓ can then be reduced to the benign gases N₂ and H₂O.

### PGM, Alkali Oxide, and Alkaline Earth Oxide Nanoparticles and Micron-Particles

Alkali oxide, alkaline earth oxide, and PGM nanoparticles may be included in an oxidative washcoat layer, a reductive washcoat layer, a PNA layer, a zeolite layer, or any combination of the oxidative, reductive, PNA, and zeolite washcoat layers. As an alternative embodiment, micron-sized alkali oxide, alkaline earth oxide, and PGM particles may be included in any combination of the oxidative, reductive, PNA, and zeolite washcoat layers. In another alternative embodiment, both nanoparticles and micron particles of alkali oxide, alkaline earth oxide, and PGM may be included in any combination of the oxidative, reductive, PNA, and zeolite washcoat layers.

Alkali oxides, alkaline earth oxides, and PGM particles are adsorbers that hold NOₓ compounds during low temperature engine operation. The NOₓ compounds are then released and reduced by catalysts during high temperature engine operation. The temperature at which the NOₓ compounds are released varies depending on the oxide, PGM, combination of oxides, or combination of oxides and PGM, among other factors. For example, alkali oxides or alkaline earth oxides can be used to release NOₓ compounds at temperatures lower than PGM particles. In addition, the alkali oxides or alkaline earth oxides can be magnesium oxide, calcium oxide, manganese oxide, barium oxide, and/or strontium oxide. Furthermore, the PGM can be palladium, ruthenium, or mixtures thereof. When used alone or in combination with other NOₓ adsorbing materials, such as those described herein, the amount of PGM needed to store NOₓ gases can be substantially reduced or even eliminated.

Alkali oxide, alkaline earth oxide, and PGM nanoparticles and micron particles on support particles may be produced via wet chemistry techniques or by the plasma-based methods described above. The PNA nanoparticles can include the composite nanoparticles described above. As such, the alkali oxide, alkaline earth oxide, and PGM nanoparticles on support particles can include PNA nano-on-nano particles, PNA NNm particles, PNA NNiM particles, or PNA hybrid NNm/wet-chemistry particles described above.

In some embodiments, the alkali oxide, alkaline earth oxide, and PGM nanoparticles have an average diameter of approximately 20 nm or less, or approximately 15 nm or less, or approximately 10 nm or less, or approximately 5 nm or less, or between approximately 1 nm and approximately 20 nm, that is, approximately 10.5 nm±9.5 nm, or between approximately 1 nm and approximately 15 nm, that is, approximately 8 nm±7 nm, or between approximately 1 nm and approximately 10 nm, that is, approximately 5.5 nm±4.5 nm, or between approximately 1 nm and approximately 5 nm, that is, approximately 3 nm±2 nm. In some embodiments, the alkali oxide, alkaline earth oxide, and PGM nanoparticles have a diameter of approximately 20 nm or less, or approximately 15 nm or less, or approximately 10 nm or less, or approximately 5 nm or less, or between approximately 1 nm and approximately 10 nm, that is, approximately 5.5 nm±4.5 nm, or between approximately 1 nm and approximately 5 nm, that is, approximately 3 nm±2 nm.

In some embodiments, the alkali oxide, alkaline earth oxide, and PGM micron particles may have an average diameter of approximately 10 μm or less, or approximately 8 μm or less, or approximately 5 μm or less, or approximately 2 μm or less, or approximately 1.5 μm or less, or approximately 1 μm or less, or approximately 0.5 μm or less. In some embodiments, the alkali oxide, alkaline earth oxide, and PGM micron particles have an average diameter between approximately 6 μm and approximately 10 μm, that is, approximately 8 μm±2 μm, or between approximately 7 μm and approximately 9 μm, that is, approximately 8 μm±1 μm. In some embodiments, the alkali oxide, alkaline earth oxide, and PGM micron particles have an average diameter between approximately 0.5 μm and approximately 2 μm, that is, approximately 1.25 μm±0.75 μm, or between approximately 1.0 μm and approximately 1.5 μm, that is, approximately 1.25 μm±0.25 μm.

The alkali oxide, alkaline earth oxide, and PGM particles can be applied to support particles by any of the processes described above with respect to applying nanoparticles to support and/or carrier particles including wet chemistry, incipient wetness, and plasma nano-on-nano methods. These support particles can be nano-sized or micron-sized. In addition, these support particles can be, for example, refractory oxides including cerium oxide. As discussed above, the cerium oxide particles may contain zirconium oxide, lanthanum, lanthanum oxide, yttrium oxide, or a combination thereof.

In one embodiment, the oxide and PGM nanoparticles can be impregnated into micron-sized cerium oxide supports. The procedure for impregnating these supports may be similar to the process described above with respect to impregnating the composite nanoparticles into micron-sized cerium oxide supports. One of ordinary skill in the art would understand that the support particles can be impregnated one at a time or simultaneously co-impregnated with the alkali and/or alkaline earth oxides and PGM. In some embodiments, the alkali oxide, alkaline earth oxide, and PGM nanoparticles on supports can be prepared by applying a dispersion of alkali oxide, alkaline earth oxide, or PGM nanoparticles to porous, micron-sized cerium oxide, as described with respect to incipient wetness techniques described above, including subsequent drying and calcination. In some embodiments, the alkali oxide, alkaline earth oxide, and PGM nanoparticles on supports can be prepared using wet chemistry techniques described above, including subsequent drying and calcination. The porous, micron-sized cerium oxide powders may contain zirconium oxide, lanthanum, yttrium oxide, and/or lanthanum oxide. In some embodiments, the cerium oxide is substantially free of zirconium oxide. In other embodiments, the cerium oxide contains up to 50 mole % zirconium oxide (at exactly 50 mole %, the material is cerium-zirconium oxide, CeZrO₄). One commercial cerium oxide powder suitable for use is HSA5, HSA20, or a mixture thereof. These nanoparticles may also be impregnated into micron-sized aluminum oxide supports.

In one embodiment, palladium is used in an amount of from about 0.01% to about 5% (by weight) of the amount of cerium oxide used in the PNA material (i.e., composition). (As described above, in all embodiments, the cerium oxide can include zirconium oxide, lanthanum, lanthanum oxide, yttrium oxide, or a combination thereof). In one embodiment, palladium is used in an amount of from about 0.5% to about 3% (by weight) of the amount of cerium oxide used in the PNA material. In one embodiment, palladium is used in an amount of from about 0.67% to about 2.67% (by weight) of the amount of cerium oxide used in the PNA material. In another embodiment, the amount of cerium oxide used in the PNA material is from about 50 g/L to about 400 g/L. In another embodiment, the amount of cerium oxide used in the PNA material is from about 100 g/L to about 350 g/L. In another embodiment, the amount of cerium oxide used in the PNA material is from about 150 g/L to about 300 g/L. In another embodiment, the amount of cerium oxide used in the PNA material is greater than or equal to about 150 g/L. In another embodiment, Pd is used in an amount of from about 1.5% to about 2.5% (by weight) of the amount of cerium oxide used in the PNA material, and the amount of cerium oxide used is from about 100 g/L to about 200 g/L. In another embodiment, Pd is used in an amount of from about 0.5% to about 1.5% (by weight) of the amount of cerium oxide used in the PNA material, and the amount of cerium oxide used is from about 250 g/L to about 350 g/L. In another embodiment, Pd is used in an amount of from about 1% to about 2% (by weight) of the amount of cerium oxide used in the PNA material, and the amount of cerium oxide used is greater than or equal to about 150 g/L. In another embodiment, Pd is used in an amount of about 2% (by weight) of the amount of cerium oxide used in the PNA material, and the amount of cerium oxide used is greater than or equal to about 150 g/L. In another embodiment, Pd is used in an amount of about 1% (by weight) of the amount of cerium oxide used in the PNA material, and the amount of cerium oxide used is greater than or equal to about 300 g/L. In another embodiment, Pd is used in an amount of about 1 g/L to about 5 g/L. In another embodiment, Pd is used in an amount of about 2 g/L to about 4 g/L. In another embodiment, Pd is used in an amount of about 3 g/L. In another embodiment, Pd is used in an amount of about 1 g/L to about 5 g/L, and the amount of cerium oxide used in the PNA material is from about 100 g/L to about 350 g/L. In another embodiment, Pd is used in an amount of about 2 g/L to about 4 g/L, and the amount of cerium oxide used in the PNA material is from about 100 g/L to about 350 g/L. In another embodiment, Pd is used in an amount of about 3 g/L, and the amount of cerium oxide used in the PNA material is from about 150 g/L to about 300 g/L. In another embodiment, Pd is used in an amount of about 1 g/L to about 5 g/L, and the amount of cerium oxide used in the PNA material is from greater than or equal to about 150 g/L. In another embodiment, Pd is used in an amount of about 2 g/L to about 4 g/L, and the amount of cerium oxide used in the PNA material is from greater than or equal to about 150 g/L. In another embodiment, Pd is used in an amount of about 3 g/L, and the amount of cerium oxide used in the PNA material is from greater than or equal to about 150 g/L. The PNA material can include Pd in larger (cooler) engine systems (e.g., greater than 2.5 Liters).

In one embodiment, ruthenium is used in an amount of from about 0.01% to about 15% (by weight) of the amount of cerium oxide used in the PNA material (i.e., composition). (As described above, in all embodiments, the cerium oxide can include zirconium oxide, lanthanum, lanthanum oxide yttrium oxide, or a combination thereof). In one embodiment, ruthenium is used in an amount of from about 0.5% to about 12% (by weight) of the amount of cerium oxide used in the PNA material. In one embodiment, ruthenium is used in an amount of from about 1% to about 10% (by weight) of the amount of cerium oxide used in the PNA material. In another embodiment, the amount of cerium oxide used in the PNA material is from about 50 g/L to about 400 g/L. In another embodiment, the amount of cerium oxide used in the PNA material is from about 100 g/L to about 350 g/L. In another embodiment, the amount of cerium oxide used in the PNA material is from about 150 g/L to about 300 g/L. In another embodiment, the amount of cerium oxide used in the PNA material is greater than or equal to about 150 g/L. In another embodiment, the amount of cerium oxide used in the PNA material is greater than or equal to about 300 g/L. In another embodiment, Ru is used in an amount of from about 3% to about 4.5% (by weight) of the amount of cerium oxide used in the PNA material, and the amount of cerium oxide used is from about 100 g/L to about 200 g/L. In another embodiment, Ru is used in an amount of from about 1% to about 2.5% (by weight) of the amount of cerium oxide used in the PNA material, and the amount of cerium oxide used is from about 250 g/L to about 350 g/L. In another embodiment, Ru is used in an amount of from about 1.67% to about 4% (by weight) of the amount of cerium oxide used in the PNA material, and the amount of cerium oxide used is greater than or equal to about 150 g/L. In another embodiment, Ru is used in an amount of from about 1.67% to about 4% (by weight) of the amount of cerium oxide used in the PNA material, and the amount of cerium oxide used is greater than or equal to about 300 g/L. In another embodiment, Ru is used in an amount of about 3.33% to about 4% (by weight) of the amount of cerium oxide used in the PNA material, and the amount of cerium oxide used is greater than or equal to about 150 g/L. In another embodiment, Ru is used in an amount of about 1.67% to about 2% (by weight) of the amount of cerium oxide used in the PNA material, and the amount of cerium oxide used is greater than or equal to about 300 g/L. In another embodiment, Ru is used in an amount of about 1 g/L to about 20 g/L. In another embodiment, Ru is used in an amount of about 3 g/L to about 15 g/L. In another embodiment, Ru is used in an amount of about 4 g/L to about 8 g/L. In another embodiment, Ru is used in an amount of about 5 g/L to about 6 g/L. In another embodiment, Ru is used in an amount of about 1 g/L to about 20 g/L, and the amount of cerium oxide used in the PNA material is from about 100 g/L to about 350 g/L. In another embodiment, Ru is used in an amount of about 3 g/L to about 15 g/L, and the amount of cerium oxide used in the PNA material is from about 100 g/L to about 350 g/L. In another embodiment, Ru is used in an amount of about 4 g/L to about 8 g/L, and the amount of cerium oxide used in the PNA material is from about 100 g/L to about 350 g/L. In another embodiment, Ru is used in an amount of about 5 g/L to about 6 g/L, and the amount of cerium oxide used in the PNA material is from about 150 g/L to about 350 g/L. In another embodiment, Ru is used in an amount of about 1 g/L to about 20 g/L, and the amount of cerium oxide used in the PNA material is from greater than or equal to about 150 g/L. In another embodiment, Ru is used in an amount of about 3 g/L to about 15 g/L, and the amount of cerium oxide used in the PNA material is from greater than or equal to about 150 g/L. In another embodiment, Ru is used in an amount of about 4 g/L to about 8 g/L, and the amount of cerium oxide used in the PNA material is from greater than or equal to about 150 g/L. In another embodiment, Ru is used in an amount of about 5 g/L to about 6 g/L, and the amount of cerium oxide used in the PNA material is from greater than or equal to about 150 g/L. In another embodiment, Ru is used in an amount of about 1 g/L to about 20 g/L, and the amount of cerium oxide used in the PNA material is from greater than or equal to about 300 g/L. In another embodiment, Ru is used in an amount of about 3 g/L to about 15 g/L, and the amount of cerium oxide used in the PNA material is from greater than or equal to about 300 g/L. In another embodiment, Ru is used in an amount of about 4 g/L to about 8 g/L, and the amount of cerium oxide used in the PNA material is from greater than or equal to about 300 g/L. In another embodiment, Ru is used in an amount of about 5 g/L to about 6 g/L, and the amount of cerium oxide used in the PNA material is from greater than or equal to about 300 g/L. The PNA material can include Ru in small (hotter) engine systems (e.g., less than 2 Liters).

In one embodiment, MgO is used in an amount of from about 1% to about 20% (by weight) of the amount of the cerium oxide used in the PNA material (i.e., composition). In one embodiment, MgO is used in an amount of from about 1% to about 15% (by weight) of the amount of the cerium oxide used in the PNA material. In one embodiment, MgO is used in an amount of from about 1% to about 10% (by weight) of the amount of the cerium oxide used in the PNA material. In another embodiment, the amount of cerium oxide used in the PNA material is from about 50 g/L to about 450 g/L. In another embodiment, the amount of cerium oxide used in the PNA material is from about 100 g/L to about 400 g/L. In another embodiment, the amount of cerium oxide used in the PNA material is from about 150 g/L to about 350 g/L. In another embodiment, MgO is used in an amount of from about 2% to about 8% (by weight) of the amount of the cerium oxide used in the PNA material, and the amount of cerium oxide used is from about 150 g/L to about 350 g/L. In another embodiment, MgO is used in an amount of from about 2% to about 4% (by weight) of the amount of the cerium oxide used in the PNA material, and the amount of cerium oxide used is from about 250 g/L to about 350 g/L. In another embodiment, MgO is used in an amount of from about 6% to about 8% (by weight) of the amount of the cerium oxide used in the PNA material, and the amount of cerium oxide used is from about 150 g/L to about 250 g/L. In another embodiment, MgO is used in an amount of about 3% (by weight) of the amount of the cerium oxide used in the PNA material, and the amount of cerium oxide used in the PNA material is about 350 g/L. In another embodiment, MgO is used in an amount of about 7% (by weight) of the amount of the cerium oxide used in the PNA material, and the amount of cerium oxide used is about 150 g/L. In another embodiment, MgO is used in an amount of about 10.5 g/L, and the amount of cerium oxide used in the PNA material is from about 150 g/L to about 350 g/L.

In one embodiment, Mn₃O₄ is used in an amount of from about 1% to about 30% (by weight) of the amount of the cerium oxide used in the PNA material (i.e., composition). In one embodiment, Mn₃O₄ is used in an amount of from about 1% to about 25% (by weight) of the amount of the cerium oxide used in the PNA material. In one embodiment, Mn₃O₄ is used in an amount of from about 1% to about 20% (by weight) of the amount of the cerium oxide used in the PNA material. In another embodiment, the amount of cerium oxide used in the PNA material is from about 50 g/L to about 450 g/L. In another embodiment, the amount of cerium oxide used in the PNA material is from about 100 g/L to about 400 g/L. In another embodiment, the amount of cerium oxide used in the PNA material is from about 150 g/L to about 350 g/L. In another embodiment, Mn₃O₄ is used in an amount of from about 5% to about 20% (by weight) of the amount of the cerium oxide used in the PNA material, and the amount of cerium oxide used is from about 150 g/L to about 350 g/L. In another embodiment, Mn₃O₄ is used in an amount of from about 5% to about 10% (by weight) of the amount of the cerium oxide used in the PNA material, and the amount of cerium oxide used is from about 250 g/L to about 350 g/L. In another embodiment, Mn₃O₄ is used in an amount of from about 15% to about 20% (by weight) of the amount of the cerium oxide used in the PNA material, and the amount of cerium oxide used is from about 150 g/L to about 250 g/L. In another embodiment, Mn₃O₄ is used in an amount of about 8% (by weight) of the amount of the cerium oxide used in the PNA material, and the amount of cerium oxide used is about 350 g/L. In another embodiment, Mn₃O₄ is used in an amount of about 18.67% (by weight) of the amount of the cerium oxide used in the PNA material, and the amount of cerium oxide used is about 150 g/L. In another embodiment, Mn₃O₄ is used in an amount of about 28 g/L, and the amount of cerium oxide used in the PNA material is from about 150 g/L to about 350 g/L.

In one embodiment, calcium oxide is used in an amount of from about 1% to about 20% (by weight) of the amount of the cerium oxide used in the PNA material (i.e., composition). In one embodiment, calcium oxide is used in an amount of from about 1% to about 15% (by weight) of the amount of the cerium oxide used in the PNA material. In one embodiment, calcium oxide is used in an amount of from about 1% to about 10% (by weight) of the amount of the cerium oxide used in the PNA material. In another embodiment, the amount of cerium oxide used in the PNA material is from about 50 g/L to about 450 g/L. In another embodiment, the amount of cerium oxide used in the PNA material is from about 100 g/L to about 400 g/L. In another embodiment, the amount of cerium oxide used in the PNA material is from about 150 g/L to about 350 g/L. In another embodiment, calcium oxide is used in an amount of from about 2% to about 8% (by weight) of the amount of the cerium oxide used in the PNA material, and the amount of cerium oxide used is from about 150 g/L to about 350 g/L. In another embodiment, calcium oxide is used in an amount of from about 2% to about 4% (by weight) of the amount of the cerium oxide used in the PNA material, and the amount of cerium oxide used is from about 250 g/L to about 350 g/L. In another embodiment, calcium oxide is used in an amount of from about 6% to about 8% (by weight) of the amount of the cerium oxide used in the PNA material, and the amount of cerium oxide used is from about 150 g/L to about 250 g/L. In another embodiment, calcium oxide is used in an amount of about 3% (by weight) of the amount of the cerium oxide used in the PNA material, and the amount of cerium oxide used is about 350 g/L. In another embodiment, calcium oxide is used in an amount of about 7% (by weight) of the amount of the cerium oxide used in the PNA material, and the amount of cerium oxide used is about 150 g/L. In another embodiment, calcium oxide is used in an amount of about 10.5 g/L, and the amount of cerium oxide used in the PNA material is from about 150 g/L to about 350 g/L.

In one embodiment, MgO is used in an amount of about 10.5 g/L, Mn₃O₄ is used in an amount of about 28 g/L, calcium oxide is used in an amount of about 10.5 g/L, and the amount of cerium oxide used in the PNA material (i.e., composition) is from about 150 g/L to about 350 g/L.

The PNA material can be used to store NOₓ emissions from ambient temperatures to a variety of operating temperatures. For example, the PNA material can store NOₓ emissions from ambient to about 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C., 280° C., 285° C., 290° C., 295° C., 300° C., 305° C., 310° C., 315° C., 320° C., 325° C., 330° C., 335° C., 340° C., 345° C., 350° C., 355° C., 375° C., or 400° C.

In one embodiment, palladium based PNA material can be used for storing NOₓ emissions from ambient temperature to greater than or equal to about 200° C. In another embodiment, Pd based PNA material can be used for storing NOₓ emissions from ambient temperature to greater than or equal to about 190° C. In another embodiment, Pd based PNA material can be used for storing NOₓ emissions from ambient temperature to greater than or equal to about 180° C. In another embodiment, Pd based PNA material can be used for storing NOₓ emissions from ambient temperature to greater than or equal to about 170° C. In another embodiment, Pd based PNA material can be used for storing NOₓ emissions from ambient temperature to greater than or equal to about 160° C. In another embodiment, Pd based PNA material can be used for storing NOₓ emissions from ambient temperature to greater than or equal to about 150° C. In another embodiment, Pd based PNA material can be used for storing NOₓ emissions from ambient temperature to greater than or equal to about 140° C. Once the temperature surpasses the upper storage temperature, the PNA material can “cross over” (i.e., can stop adsorbing NOₓ emissions and can start releasing the NOₓ emissions). The cross over range for Pd based PNA material can be from about 130° C. to about 180° C., from about 140° C. to about 170° C., from about 145° C. to about 165° C., or from about 150° C. to about 160° C.

The NOₓ desorption temperature range depends on a variety of factors including the amount of PGM in the PNA material. In one embodiment, the desorption temperature range can be greater than or equal to the cross over temperature. At a certain temperature, the PNA material may no longer be storing any NOₓ emissions. At this point, the PNA material can be said to have fully released all NOₓ emissions. In one embodiment, the full release temperature of the Pd based PNA material is greater than about 150° C. In one embodiment, the full release temperature of the Pd based PNA material is greater than about 200° C. In another embodiment, the full release temperature of the Pd based PNA material is between about 200° C. and about 240° C. In another embodiment, the full release temperature of the Pd based PNA material is about 240° C. In another embodiment, the full release temperature of the Pd based PNA material is greater than about 240° C. In another embodiment, the Pd based PNA material no longer has any NOₓ emissions stored at temperatures greater than or equal to about 200° C. In another embodiment, the Pd based PNA material no longer has any NOₓ emissions stored at temperatures greater than or equal to about 240° C. In another embodiment, the Pd based PNA material no longer has any NOₓ emissions stored at temperatures from about 200° C. to about 300° C. In another embodiment, the Pd based PNA material no longer has any NOₓ emissions stored at about greater than or equal to 300° C.

In one embodiment, ruthenium based PNA material can be used for storing NOₓ emissions from ambient temperature to greater than or equal to about 300° C. In another embodiment, Ru based PNA material can be used for storing NOₓ emissions from ambient temperature to greater than or equal to about 275° C. In another embodiment, Ru based PNA material can be used for storing NOₓ emissions from ambient temperature to greater than or equal to about 250° C. In another embodiment, Ru based PNA material can be used for storing NOₓ emissions from ambient temperature to greater than or equal to about 225° C. In another embodiment, Ru based PNA material can be used for storing NOₓ emissions from ambient temperature to greater than or equal to about 200° C. In another embodiment, Ru based PNA material can be used for storing NOₓ emissions from ambient temperature to greater than or equal to about 190° C. Once the temperature surpasses the upper storage temperature, the PNA material can “cross over” (i.e., can stop adsorbing NOₓ emissions and can start releasing the NOₓ emissions). The cross over range for Ru based PNA material can be from about 170° C. to about 220° C., from about 180° C. to about 210° C., from about 185° C. to about 205° C., or from about 190° C. to about 200° C.

The NOₓ desorption temperature depends on a variety of factors including the amount of PGM and/or oxide in the PNA material. In one embodiment, the desorption temperature range can be greater than or equal to the cross over temperature. At a certain temperature, the PNA material may no longer be storing any NOₓ emissions. At this point, the PNA material can be said to have fully released all NOₓ emissions. In one embodiment, the full release temperature of the Ru based PNA material is greater than about 200° C. In one embodiment, the full release temperature of the Ru based PNA material is greater than about 250° C. In one embodiment, the full release temperature of the Ru based PNA material is greater than or equal to about 300° C. In one embodiment, the full release temperature of the Ru based PNA material is greater than or equal to about 340° C. In another embodiment, the full release temperature of the Ru based PNA material is between about 300° C. and about 350° C. In another embodiment, the full release temperature of the Ru based PNA material is about 340° C. In another embodiment, the Ru based PNA material no longer has any NOₓ emissions stored at temperatures greater than or equal to about 200° C. In another embodiment, the Ru based PNA material no longer has any NOₓ emissions stored at temperatures greater than or equal to about 250° C. In another embodiment, the Ru based PNA material no longer has any NOₓ emissions stored at temperatures greater than or equal to about 300° C. In another embodiment, the Ru based PNA material no longer has any NOₓ emissions stored at temperatures greater than or equal to about 340° C. In another embodiment, the Ru based PNA material no longer has any NOₓ emissions stored at temperatures from about 300° C. to about 400° C. In another embodiment, the Ru based PNA material no longer has any NOₓ emissions stored at temperatures greater than or equal to about 400° C.

In one embodiment, manganese oxide based PNA material can be used for storing NOₓ emissions from ambient temperature to about 150° C. In another embodiment, manganese oxide based PNA material can be used for storing NOₓ emissions from ambient temperature to about 125° C. In another embodiment, manganese oxide based PNA material can be used for storing NOₓ emissions from ambient temperature to about 110° C. In another embodiment, manganese oxide based PNA material can be used for storing NOₓ emissions from ambient temperature to about 100° C. In another embodiment, manganese oxide based PNA material can be used for storing NOₓ emissions from ambient temperature to less than about 100° C. Once the temperature surpasses the upper storage temperature, the PNA material can “cross over” (i.e., can stop adsorbing NOₓ emissions and can start releasing the NOₓ emissions).

In one embodiment, the manganese oxide based PNA material no longer has any NOₓ emissions stored at temperatures from about 200° C. to about 250° C. In another embodiment, the manganese oxide based PNA material no longer has any NOₓ emissions stored at temperatures from about 210° C. to about 240° C. In another embodiment, the manganese based PNA material no longer has any NOₓ emissions stored at temperatures from about 215° C. to about 225° C. In another embodiment, the manganese based PNA material no longer has any NOₓ emissions stored at about 220° C.

In one embodiment, magnesium oxide based PNA material can be used for storing NOₓ emissions from ambient temperature to about 200° C. In another embodiment, magnesium oxide based PNA material can be used for storing NOₓ emissions from ambient temperature to about 175° C. In another embodiment, magnesium oxide based PNA material can be used for storing NOₓ emissions from ambient temperature to about 150° C. In another embodiment, magnesium oxide based PNA material can be used for storing NOₓ emissions from ambient temperature to less than about 150° C. Once the temperature surpasses the upper storage temperature, the PNA material can “cross over” (i.e., can stop adsorbing NOₓ emissions and can start releasing the NOₓ emissions).

In one embodiment, the magnesium oxide based PNA material no longer has any NOₓ emissions stored at temperatures from about 210° C. to about 260° C. In another embodiment, the magnesium oxide based PNA material no longer has any NOₓ emissions stored at temperatures from about 220° C. to about 250° C. In another embodiment, the magnesium based PNA material no longer has any NOₓ emissions stored at temperatures from about 235° C. to about 245° C. In another embodiment, the magnesium based PNA material no longer has any NOₓ emissions stored at about 240° C.

In one embodiment, calcium oxide based PNA material can be used for storing NOₓ emissions from ambient temperature to about 250° C. In another embodiment, calcium oxide based PNA material can be used for storing NOₓ emissions from ambient temperature to about 225° C. In another embodiment, calcium oxide based PNA material can be used for storing NOₓ emissions from ambient temperature to about 200° C. In another embodiment, calcium oxide based PNA material can be used for storing NOₓ emissions from ambient temperature to less than about 200° C. In another embodiment, calcium oxide based PNA material can be used for storing NOₓ emissions from ambient temperature to about 180° C. In another embodiment, calcium oxide based PNA material can be used for storing NOₓ emissions from ambient temperature to less than about 180° C. Once the temperature surpasses the upper storage temperature, the PNA material can “cross over” (i.e., can stop adsorbing NOₓ emissions and can start releasing the NOₓ emissions).

In one embodiment, the calcium oxide based PNA material no longer has any NOₓ emissions stored at temperatures from about 290° C. to about 340° C. In another embodiment, the calcium oxide based PNA material no longer has any NOₓ emissions stored at temperatures from about 300° C. to about 330° C. In another embodiment, the calcium based PNA material no longer has any NOₓ emissions stored at temperatures from about 305° C. to about 315° C. In another embodiment, the calcium based PNA material no longer has any NOₓ emissions stored at about 310° C.

In some embodiments, the support particles are impregnated with alkali oxide, alkaline earth oxide, and PGM using wet chemistry techniques. In some embodiments, the PNA material may be prepared by incipient wetness techniques. In some embodiments, the PNA material is prepared by plasma based methods. In some embodiments, the PNA material includes NNm particles, NNiM particles, and/or hybrid NNm/wet-chemistry particles. In another embodiment, alkali oxide, alkaline earth oxide, and PGM nano or micron particles can be used simply by adding them to the washcoat when desired, in the amount desired, along with the other solid ingredients.

### PNA Material Compositions

The PNA material can comprise PGM on support particles, alkali oxide or alkaline earth oxide on support particles; alkali oxide or alkaline earth oxide and PGM on support particles; a combination of alkali oxide or alkaline earth oxide on support particles and different alkali oxides or alkaline earth oxides each on different support particles in any ratio; a combination of alkali oxide or alkaline earth oxide on support particles and PGM on support particles in any ratio; a combination of alkali oxide or alkaline earth oxide on support particles, different alkali oxides or alkaline earth oxides each on different support particles, and PGM on support particles in any ratio; a combination of alkali oxide or alkaline earth oxide and PGM on support particles and the same or different alkali oxides or alkaline earth oxides each on different support particles in any ratio; a combination of alkali oxide or alkaline earth oxide and PGM on support particles and PGM on support particles in any ratio; a combination of alkali oxide or alkaline earth oxide and PGM on support particles; the same or different alkali oxides or alkaline earth oxides each on different support particles; and PGM on support particles in any ratio. In addition, various other combinations of alkali oxides and alkaline earth oxides on support particles; PGM on support particles; and alkali oxides and alkaline earth oxides and PGM on support particles in any ratio can be employed, as discussed above. The PGM can include, for example, palladium, ruthenium, or mixtures thereof. In addition, the PGM can include their oxides, such as ruthenium oxide.

In some embodiments, the PNA material can comprise palladium on support particles; ruthenium on support particles; manganese oxide (preferably Mn₃O₄) on support particles; magnesium oxide on support particles; calcium oxide on support particles; a combination of manganese oxide on support particles and magnesium oxide on support particles in any ratio; a combination of manganese oxide on support particles and calcium oxide on support particles in any ratio; a combination of magnesium oxide on support particles and calcium oxide on support particles in any ratio; or a combination of manganese oxide on support particles, magnesium oxide on support particles, and calcium oxide on support particles in any ratio. Other embodiments include PNA material comprising a combination of manganese oxide on support particles and PGM on support particles in any ratio; a combination of magnesium oxide on support particles and PGM on support particles in any ratio; a combination of calcium oxide on support particles and PGM on support particles in any ratio; a combination of manganese oxide on support particles, magnesium oxide on support particles, and PGM on support particles in any ratio; a combination of manganese oxide on support particles, calcium oxide on support particles, and PGM on support particles in any ratio; a combination of magnesium oxide on support particles, calcium oxide on support particles, and PGM on support particles in any ratio; or a combination of manganese oxide on support particles, magnesium oxide on support particles, calcium oxide on support particles, and PGM on support particles in any ratio. which are discussed above.

In some embodiments, different PNA materials may not be mixed on a support material. For example, if a combination of manganese oxide on cerium oxide support and magnesium oxide on cerium oxide support is used, the manganese oxide is impregnated onto cerium oxide support material and set aside. Separately, magnesium oxide is then impregnated onto fresh cerium oxide support material. The manganese oxide/cerium oxide and magnesium oxide/cerium oxide are then combined in the desired ratio of the PNA material.

In one embodiment, palladium is used in an amount of from about 0.01% to about 5% (by weight) of the amount of cerium oxide used in the PNA composition. (As described above, in all embodiments, the cerium oxide can include zirconium oxide, lanthanum, lanthanum oxide yttrium oxide, or a combination thereof). In one embodiment, palladium is used in an amount of from about 0.5% to about 3% (by weight) of the amount of cerium oxide used in the PNA composition. In one embodiment, palladium is used in an amount of from about 0.67% to about 2.67% (by weight) of the amount of cerium oxide used in the PNA composition. In another embodiment, the amount of cerium oxide used in the PNA composition is from about 50 g/L to about 400 g/L. In another embodiment, the amount of cerium oxide used in the PNA composition is from about 100 g/L to about 350 g/L. In another embodiment, the amount of cerium oxide used in the PNA composition is from about 150 g/L to about 300 g/L. In another embodiment, the amount of cerium oxide used in the PNA composition is greater than or equal to about 150 g/L. In another embodiment, Pd is used in an amount of from about 1.5% to about 2.5% (by weight) of the amount of cerium oxide used in the PNA composition, and the amount of cerium oxide used is from about 100 g/L to about 200 g/L. In another embodiment, Pd is used in an amount of from about 0.5% to about 1.5% (by weight) of the amount of cerium oxide used in the PNA composition, and the amount of cerium oxide used is from about 250 g/L to about 350 g/L. In another embodiment, Pd is used in an amount of from about 1% to about 2% (by weight) of the amount of cerium oxide used in the PNA composition, and the amount of cerium oxide used is greater than or equal to about 150 g/L. In another embodiment, Pd is used in an amount of about 2% (by weight) of the amount of cerium oxide used in the PNA composition, and the amount of cerium oxide used is greater than or equal to about 150 g/L. In another embodiment, Pd is used in an amount of about 1% (by weight) of the amount of cerium oxide used in the PNA composition, and the amount of cerium oxide used is greater than or equal to about 300 g/L. In another embodiment, Pd is used in an amount of about 1 g/L to about 5 g/L. In another embodiment, Pd is used in an amount of about 2 g/L to about 4 g/L. In another embodiment, Pd is used in an amount of about 3 g/L. In another embodiment, Pd is used in an amount of about 1 g/L to about 5 g/L, and the amount of cerium oxide used in the PNA composition is from about 100 g/L to about 350 g/L. In another embodiment, Pd is used in an amount of about 2 g/L to about 4 g/L, and the amount of cerium oxide used in the PNA composition is from about 100 g/L to about 350 g/L. In another embodiment, Pd is used in an amount of about 3 g/L, and the amount of cerium oxide used in the PNA composition is from about 150 g/L to about 300 g/L. In another embodiment, Pd is used in an amount of about 1 g/L to about 5 g/L, and the amount of cerium oxide used in the PNA composition is from greater than or equal to about 150 g/L. In another embodiment, Pd is used in an amount of about 2 g/L to about 4 g/L, and the amount of cerium oxide used in the PNA composition is from greater than or equal to about 150 g/L. In another embodiment, Pd is used in an amount of about 3 g/L, and the amount of cerium oxide used in the PNA composition is from greater than or equal to about 150 g/L. The PNA composition can include Pd in larger (cooler) engine systems (e.g., greater than 2.5 Liters).

In one embodiment, ruthenium is used in an amount of from about 0.01% to about 15% (by weight) of the amount of cerium oxide used in the PNA composition. (As described above, in all embodiments, the cerium oxide can include zirconium oxide, lanthanum, lanthanum oxide yttrium oxide, or a combination thereof). In one embodiment, ruthenium is used in an amount of from about 0.5% to about 12% (by weight) of the amount of cerium oxide used in the PNA composition. In one embodiment, ruthenium is used in an amount of from about 1% to about 10% (by weight) of the amount of cerium oxide used in the PNA composition. In another embodiment, the amount of cerium oxide used in the PNA composition is from about 50 g/L to about 400 g/L. In another embodiment, the amount of cerium oxide used in the PNA composition is from about 100 g/L to about 350 g/L. In another embodiment, the amount of cerium oxide used in the PNA composition is from about 150 g/L to about 300 g/L. In another embodiment, the amount of cerium oxide used in the PNA composition is greater than or equal to about 150 g/L. In another embodiment, the amount of cerium oxide used in the PNA composition is greater than or equal to about 300 g/L. In another embodiment, Ru is used in an amount of from about 3% to about 4.5% (by weight) of the amount of cerium oxide used in the PNA composition, and the amount of cerium oxide used is from about 100 g/L to about 200 g/L. In another embodiment, Ru is used in an amount of from about 1% to about 2.5% (by weight) of the amount of cerium oxide used in the PNA composition, and the amount of cerium oxide used is from about 250 g/L to about 350 g/L. In another embodiment, Ru is used in an amount of from about 1.67% to about 4% (by weight) of the amount of cerium oxide used in the PNA composition, and the amount of cerium oxide used is greater than or equal to about 150 g/L. In another embodiment, Ru is used in an amount of from about 1.67% to about 4% (by weight) of the amount of cerium oxide used in the PNA composition, and the amount of cerium oxide used is greater than or equal to about 300 g/L. In another embodiment, Ru is used in an amount of about 3.33% to about 4% (by weight) of the amount of cerium oxide used in the PNA composition, and the amount of cerium oxide used is greater than or equal to about 150 g/L. In another embodiment, Ru is used in an amount of about 1.67% to about 2% (by weight) of the amount of cerium oxide used in the PNA composition, and the amount of cerium oxide used is greater than or equal to about 300 g/L. In another embodiment, Ru is used in an amount of about 1 g/L to about 20 g/L. In another embodiment, Ru is used in an amount of about 3 g/L to about 15 g/L. In another embodiment, Ru is used in an amount of about 4 g/L to about 8 g/L. In another embodiment, Ru is used in an amount of about 5 g/L to about 6 g/L. In another embodiment, Ru is used in an amount of about 1 g/L to about 20 g/L, and the amount of cerium oxide used in the PNA composition is from about 100 g/L to about 350 g/L. In another embodiment, Ru is used in an amount of about 3 g/L to about 15 g/L, and the amount of cerium oxide used in the PNA composition is from about 100 g/L to about 350 g/L. In another embodiment, Ru is used in an amount of about 4 g/L to about 8 g/L, and the amount of cerium oxide used in the PNA composition is from about 100 g/L to about 350 g/L. In another embodiment, Ru is used in an amount of about 5 g/L to about 6 g/L, and the amount of cerium oxide used in the PNA composition is from about 150 g/L to about 350 g/L. In another embodiment, Ru is used in an amount of about 1 g/L to about 20 g/L, and the amount of cerium oxide used in the PNA composition is from greater than or equal to about 150 g/L. In another embodiment, Ru is used in an amount of about 3 g/L to about 15 g/L, and the amount of cerium oxide used in the PNA composition is from greater than or equal to about 150 g/L. In another embodiment, Ru is used in an amount of about 4 g/L to about 8 g/L, and the amount of cerium oxide used in the PNA composition is from greater than or equal to about 150 g/L. In another embodiment, Ru is used in an amount of about 5 g/L to about 6 g/L, and the amount of cerium oxide used in the PNA composition is from greater than or equal to about 150 g/L. In another embodiment, Ru is used in an amount of about 1 g/L to about 20 g/L, and the amount of cerium oxide used in the PNA composition is from greater than or equal to about 300 g/L. In another embodiment, Ru is used in an amount of about 3 g/L to about 15 g/L, and the amount of cerium oxide used in the PNA composition is from greater than or equal to about 300 g/L. In another embodiment, Ru is used in an amount of about 4 g/L to about 8 g/L, and the amount of cerium oxide used in the PNA composition is from greater than or equal to about 300 g/L. In another embodiment, Ru is used in an amount of about 5 g/L to about 6 g/L, and the amount of cerium oxide used in the PNA composition is from greater than or equal to about 300 g/L. The PNA composition can include Ru in small (hotter) engine systems (e.g., less than 2 Liters).

In one embodiment, MgO is used in an amount of from about 1% to about 20% (by weight) of the amount of the cerium oxide used in the PNA composition. In one embodiment, MgO is used in an amount of from about 1% to about 15% (by weight) of the amount of the cerium oxide used in the PNA composition. In one embodiment, MgO is used in an amount of from about 1% to about 10% (by weight) of the amount of the cerium oxide used in the PNA composition. In another embodiment, the amount of cerium oxide used in the PNA composition is from about 50 g/L to about 450 g/L. In another embodiment, the amount of cerium oxide used in the PNA composition is from about 100 g/L to about 400 g/L. In another embodiment, the amount of cerium oxide used in the PNA composition is from about 150 g/L to about 350 g/L. In another embodiment, MgO is used in an amount of from about 2% to about 8% (by weight) of the amount of the cerium oxide used in the PNA composition, and the amount of cerium oxide used is from about 150 g/L to about 350 g/L. In another embodiment, MgO is used in an amount of from about 2% to about 4% (by weight) of the amount of the cerium oxide used in the PNA composition, and the amount of cerium oxide used is from about 250 g/L to about 350 g/L. In another embodiment, MgO is used in an amount of from about 6% to about 8% (by weight) of the amount of the cerium oxide used in the PNA composition, and the amount of cerium oxide used is from about 150 g/L to about 250 g/L. In another embodiment, MgO is used in an amount of about 3% (by weight) of the amount of the cerium oxide used in the PNA composition, and the amount of cerium oxide used is about 350 g/L. In another embodiment, MgO is used in an amount of about 7% (by weight) of the amount of the cerium oxide used in the PNA composition, and the amount of cerium oxide used is about 150 g/L. In another embodiment, MgO is used in an amount of about 10.5 g/L, and the amount of cerium oxide used in the PNA composition is from about 150 g/L to about 350 g/L.

In one embodiment, Mn₃O₄ is used in an amount of from about 1% to about 30% (by weight) of the amount of the cerium oxide used in the PNA composition. In one embodiment, Mn₃O₄ is used in an amount of from about 1% to about 25% (by weight) of the amount of the cerium oxide used in the PNA composition. In one embodiment, Mn₃O₄ is used in an amount of from about 1% to about 20% (by weight) of the amount of the cerium oxide used in the PNA composition. In another embodiment, the amount of cerium oxide used in the PNA composition is from about 50 g/L to about 450 g/L. In another embodiment, the amount of cerium oxide used in the PNA composition is from about 100 g/L to about 400 g/L. In another embodiment, the amount of cerium oxide used in the PNA composition is from about 150 g/L to about 350 g/L. In another embodiment, Mn₃O₄ is used in an amount of from about 5% to about 20% (by weight) of the amount of the cerium oxide used in the PNA composition, and the amount of cerium oxide used is from about 150 g/L to about 350 g/L. In another embodiment, Mn₃O₄ is used in an amount of from about 5% to about 10% (by weight) of the amount of the cerium oxide used in the PNA composition, and the amount of cerium oxide used is from about 250 g/L to about 350 g/L. In another embodiment, Mn₃O₄ is used in an amount of from about 15% to about 20% (by weight) of the amount of the cerium oxide used in the PNA composition, and the amount of cerium oxide used is from about 150 g/L to about 250 g/L. In another embodiment, Mn₃O₄ is used in an amount of about 8% (by weight) of the amount of the cerium oxide used in the PNA composition, and the amount of cerium oxide used is about 350 g/L. In another embodiment, Mn₃O₄ is used in an amount of about 18.67% (by weight) of the amount of the cerium oxide used in the PNA composition, and the amount of cerium oxide used is about 150 g/L. In another embodiment, Mn₃O₄ is used in an amount of about 28 g/L, and the amount of cerium oxide used in the PNA composition is from about 150 g/L to about 350 g/L.

In one embodiment, calcium oxide is used in an amount of from about 1% to about 20% (by weight) of the amount of the cerium oxide used in the PNA composition. In one embodiment, calcium oxide is used in an amount of from about 1% to about 15% (by weight) of the amount of the cerium oxide used in the PNA composition. In one embodiment, calcium oxide is used in an amount of from about 1% to about 10% (by weight) of the amount of the cerium oxide used in the PNA composition. In another embodiment, the amount of cerium oxide used in the PNA composition is from about 50 g/L to about 450 g/L. In another embodiment, the amount of cerium oxide used in the PNA composition is from about 100 g/L to about 400 g/L. In another embodiment, the amount of cerium oxide used in the PNA composition is from about 150 g/L to about 350 g/L. In another embodiment, calcium oxide is used in an amount of from about 2% to about 8% (by weight) of the amount of the cerium oxide used in the PNA composition, and the amount of cerium oxide used is from about 150 g/L to about 350 g/L. In another embodiment, calcium oxide is used in an amount of from about 2% to about 4% (by weight) of the amount of the cerium oxide used in the PNA composition, and the amount of cerium oxide used in the PNA composition is from about 250 g/L to about 350 g/L. In another embodiment, calcium oxide is used in an amount of from about 6% to about 8% (by weight) of the amount of the cerium oxide used in the PNA composition, and the amount of cerium oxide used is from about 150 g/L to about 250 g/L. In another embodiment, calcium oxide is used in an amount of about 3% (by weight) of the amount of the cerium oxide used in the PNA composition, and the amount of cerium oxide used is about 350 g/L. In another embodiment, calcium oxide is used in an amount of about 7% (by weight) of the amount of the cerium oxide used in the PNA composition, and the amount of cerium oxide used is about 150 g/L. In another embodiment, calcium oxide is used in an amount of about 10.5 g/L, and the amount of cerium oxide used in the PNA composition is from about 150 g/L to about 350 g/L.

In one embodiment, MgO is used in an amount of about 10.5 g/L, Mn₃O₄ is used in an amount of about 28 g/L, calcium oxide is used in an amount of about 10.5 g/L, and the amount of cerium oxide used in the PNA composition is from about 150 g/L to about 350 g/L.

The amount of cerium oxide can correspond to the total amount of cerium oxide used to form the alkali oxide or alkaline earth oxide/cerium oxide; PGM/cerium oxide (including if NNm or NNiM particles are employed); the alkali oxide or alkaline earth oxide/cerium oxide and PGM/cerium oxide; the alkali oxide or alkaline earth oxide/cerium oxide and other alkali oxide(s) or alkaline earth oxide(s)/cerium oxide; or the alkali oxide or alkaline earth oxide/cerium oxide, other alkali oxide(s) or alkaline earth oxide(s)/cerium oxide, and PGM/cerium oxide.

PNA Material with PGM Compositions

In some embodiments, the PNA material is loaded with about 1 g/L to about 20 g/L of PGM. In another embodiment, the PNA material is loaded with about 1 g/L to about 15 g/L of PGM. In another embodiment, the PNA material is loaded with about 6.0 g/L and less of PGM. In another embodiment, the PNA material is loaded with about 5.0 g/L and less of PGM. In another embodiment, the PNA material is loaded with about 4.0 g/L and less of PGM. In another embodiment, the PNA material is loaded with about 3.0 g/L and less of PGM. In another embodiment, the PNA material is loaded with about 2 g/L to about 4 g/L Pd. In another embodiment, the PNA material is loaded with about 3 g/L Pd. In another embodiment, the PNA material is loaded with about 3 g/L to about 15 g/L Ru. In another embodiment, the PNA material is loaded with about 5 g/L to about 6 g/L Ru.

The PNA material can include support particles impregnated with PGM. In some embodiments, PGM may be added to support particles using wet chemistry techniques. In some embodiments, PGM may be added to support particles using incipient wetness. In some embodiments, PGM may be added to support particles using plasma based methods such as nano-on-nano to form PNA composite nanoparticles. In some embodiments, these PNA composite nanoparticles are added to carrier particles to form NNm PNA particles or are embedded within carrier particles to form NNiM PNA particles. As such, the PGM on support particles can include micro-PGM on micron support particles, nano-PGM on micron support particles, PNA nano-on-nano particles, PNA NNm particles, PNA NNiM particles, or PNA hybrid NNm/wet-chemistry particles described above. In some embodiments, the micron-sized particles of the PGM NNm particles can be the micron-sized supports impregnated with the alkali oxides or alkaline earth oxides. In some embodiments, the micron-sized particles of the PGM NNm particles can be impregnated with alkali oxides or alkaline earth oxides. In some embodiments, the alkali oxides or alkaline earth oxides and PGM are on the same support particle. In other embodiments, the alkali oxides or alkaline earth oxides and PGM are on different support particles.

In some embodiments, the support particles of the PNA material may contain platinum. In some embodiments, the support particles of the PNA material may contain rhodium. In some embodiments, the support particles of the PNA material may contain palladium. In some embodiments, the support particles of the PNA material may contain ruthenium. In some embodiments, the support particles of the PNA material may contain a mixture of platinum and palladium. For example, the support particles of the PNA material may contain a mixture of 2:1 to 100:1 platinum to palladium. In some embodiments, the support particles of the PNA material may contain a mixture of 2:1 to 75:1 platinum to palladium. In some embodiments, the support particles of the PNA material may contain a mixture of 2:1 to 50:1 platinum to palladium. In some embodiments, the support particles of the PNA material may contain a mixture of 2:1 to 25:1 platinum to palladium. In some embodiments, the support particles of the PNA material may contain a mixture of 2:1 to 15:1 platinum to palladium. In some embodiments, the support particles of the PNA material may contain a mixture of 2:1 to 10:1 platinum to palladium. In some embodiments, the support particles of the PNA material may contain a mixture of 2:1 platinum to palladium, or approximately 2:1 platinum to palladium. In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

In some embodiments, the PNA material can include NNm™ particles comprising composite PNA nanoparticles. In other embodiments, the PNA material can include NNiM particle comprising composite PNA nanoparticles. The PGM NNm's micro-sized components can further be impregnated with alkali oxides or alkaline earth oxides to form a PNA material. The micro-sized component of the PGM NNm can be cerium oxide. As described above, in all embodiments, the cerium oxide can include zirconium oxide, lanthanum, lanthanum oxide, yttrium oxide, or a combination thereof. In some embodiments, the cerium oxide includes 86 wt % cerium oxide, 10 wt % zirconium oxide, and 4 wt % lanthanum and/or lanthanum oxide. In addition, micro-sized cerium oxide that has been impregnated with alkali oxides or alkaline earth oxides can be used as the micro-sized component of the NNm and NNiM particles.

The following discussion will be exemplified using NNm™ particles, but applies equally well to NNiM particles. The composite nanoparticle may include one or more nanoparticles attached to a support nanoparticle to form a “nano-on-nano” composite nanoparticle that may trap or store NOₓ gases. Platinum group metals may be used to prepare the composite nanoparticle. In certain embodiments, the composite nanoparticle may contain palladium. In other embodiments, the composite nanoparticle may contain ruthenium. A suitable support nanoparticle for the composite nanoparticles includes, but is not limited to, nano-sized cerium oxide (which can include zirconium oxide, lanthanum, lanthanum oxide, yttrium oxide, or a combination thereof).

Each composite nanoparticle may be supported on a single support nanoparticle or each support nanoparticle may include one or more composite nanoparticles. The composite nanoparticles on the support nanoparticle may include palladium, ruthenium, or a mixture thereof. In some embodiments, palladium is used alone. In other embodiments, ruthenium may be used alone. In further embodiments, platinum may be used in combination with palladium. For example, the support nanoparticle may contain a mixture of 2:1 to 100:1 platinum to palladium. In some embodiments, the support nanoparticle may contain a mixture of 2:1 to 75:1 platinum to palladium. In some embodiments, the support nanoparticle may contain a mixture of 2:1 to 50:1 platinum to palladium. In some embodiments, the support nanoparticle may contain a mixture of 2:1 to 25:1 platinum to palladium. In some embodiments, the support nanoparticle may contain a mixture of 2:1 to 15:1 platinum to palladium. In some embodiments, the support nanoparticle may contain a mixture of 2:1 to 10:1 platinum to palladium. In some embodiments, the support nanoparticle may contain a mixture of 2:1 platinum to palladium, or approximately 2:1 platinum to palladium. In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

The composite nanoparticles for use as components of the PNA material can be produced by plasma-based methods as described above. Platinum group metals (such as ruthenium, palladium, or a mixture thereof) can be introduced into the plasma reactor as a fluidized powder in a carrier gas stream. The resulting nano-on-nano particles have similar properties (i.e., diameter or grain size) to that of the oxidative nano-on-nano particles and reductive nano-on-nano particles. In one embodiment, for NOₓ adsorbing composite nanoparticles, ruthenium, palladium, or a mixture of palladium and platinum, can be deposited on nano-sized cerium oxide.

To prepare a PNA material that comprises a nano-on-nano-on-micro particle (NNm), a dispersion of the composite nanoparticles may be applied to porous, micron-sized cerium oxide or aluminum oxide. After the composite nanoparticles are applied to the micron-sized cerium oxide, the micron-sized cerium oxide may be impregnated with alkali oxide or alkaline earth oxide nanoparticles. In some embodiments, the NNm particles are combined with separate alkali oxides or alkaline earth oxides on cerium oxide supports to form the PNA material. The micron-sized cerium oxide may contain zirconium oxide. In some embodiments, the micron-sized cerium oxide is substantially free of zirconium oxide. In other embodiments, the micron-sized cerium oxide contains up to 100% zirconium oxide. In one embodiment, the nanoparticle is a PGM. In one embodiment, the PGM is platinum, palladium, or a mixture thereof. In another embodiment, the PGM is ruthenium. In other embodiments, the nanoparticle is a non-PGM. In some embodiments, the non-PGM is tungsten, molybdenum, niobium, manganese, or chromium.

The micron-sized carrier particles, impregnated with the composite nanoparticles may be prepared as described above for the Nano-on-Nano-on-Micro particles.

In some embodiments, the PNA material comprises multiple types of particles comprising micron-sized cerium oxide particles impregnated with alkali oxide or alkaline earth oxide particles, and separate NNm or NNiM particles comprising ruthenium, platinum, palladium, or mixtures thereof.

In some instances, the weight ratio of nano-sized Ru, Pt, Pd, or Pt/Pd:nano-sized cerium oxide is about 1%:99% to about 40%:60%. In one embodiment, the weight ratio of nano-sized Ru, Pt, Pd, or Pt/Pd:nano-sized cerium oxide is about 10%:90%. In addition, the Ru, Pt, Pd, or Pt/Pd can include their oxides, such as ruthenium oxide.

The PNA NNm™ particles may contain from about 0.1% to 6% Pd, Ru, or ruthenium oxide by weight, or in another embodiment from about 0.5% to 3.5% by weight, or in another embodiment, about 1% to about 2.5% by weight, or in another embodiment about 2% to about 3% by weight, or in another embodiment, about 2.5% by weight, of the total mass of the NNm™ particle. The NNm™ particles can then be used for formulations for coating substrates, where the coated substrates may be used in catalytic converters.

In further embodiments, the NNm™ particles may be comprised of metals such as W, Mo, Nb, Mn, or Cr produced using the plasma-based methods described above.

### Washcoat Compositions and Layers: Application to Substrates

Washcoat formulations comprising the NNm, NNiM, hybrid particles, zeolites, or PNA material may be used to provide one or more layers on a substrate used for catalysis, such as a catalytic converter substrate. Additional washcoats can also be used for improved performance. In some embodiments, the washcoat formulations may include two or more different washcoats formulations that allow for the separation of one or more washcoat layers containing high concentrations of zeolite particles from one or more washcoat layers containing platinum group metal catalyst comprising one or more plasma-generated catalyst components, such as the NNm or NNiM particles described above, on a catalytic converter substrate. In some embodiments, one catalytic washcoat is applied to a substrate. In another embodiment, two or more catalytic washcoats are applied to a substrate.

In some embodiments, additional washcoats may be applied to the substrate in addition to the catalytic washcoat. For example, in some embodiments, a corner fill washcoat may be applied to the substrate. In some embodiments, a washcoat comprising zeolites may be applied to the substrate. The washcoat comprising zeolites can be applied to the substrate as a corner-fill washcoat (that is, the first washcoat to be applied to the substrate), or under or over any of the other washcoats on the substrate. In some embodiments, no washcoat comprising zeolite particles is present. In some embodiments, washcoats are substantially free of zeolite particles. In some embodiments, the washcoats containing catalytically active materials are substantially free of zeolite particles. In some embodiments, washcoats containing nano-on-nano-on-micro (NNm) particles are substantially free of zeolite particles. In some embodiments, washcoats containing nano-on-nano-in-micro (NNiM) particles are substantially free of zeolite particles. In some embodiments, washcoats containing nano-on-nano-on-micro (NNm) particles and nano-on-nano-in-micro (NNiM) particles are substantially free of zeolite particles.

In some embodiments, the coated substrate is free of zeolites. In some embodiments, the coated substrate is substantially free of zeolites. In some embodiments, the coated substrate contains less than about 0.1% zeolites, less than about 0.5% zeolites, less than about 1% zeolites, less than about 2% zeolites, or less than about 5% zeolites by weight of the total weight of all of the washcoats on the substrate.

The formulations may be used to form washcoat layers and catalytic converter substrates that include reduced amounts of platinum group metals and/or offer better performance when compared to previous washcoat layers and formulations and catalytic converter substrates.

Many of the washcoat compositions disclosed herein can include boehmite. Boehmite can be added to the washcoat compositions as a binder and is converted to aluminum oxide upon calcination.

Some embodiments of washcoat formulations may be formulated to form one or more of the following basic washcoat layer configurations:
Substrate-Catalytic Layer (S-C)
Substrate-Catalytic Layer-Zeolite Layer (S-C-Z)
Substrate-Zeolite Layer-Catalytic Layer (S-Z-C)
Substrate-Catalytic Layer-PNA Layer-Zeolite Layer (S-C-P-Z)
Substrate-Catalytic Layer-Zeolite Layer-PNA Layer (S-C-Z-P)
Substrate-PNA Layer-Zeolite Layer-Catalytic Layer (S-P-Z-C)
Substrate-PNA Layer-Catalytic Layer-Zeolite Layer (S-P-C-Z)
Substrate-Zeolite Layer-PNA Layer-Catalytic Layer (S-Z-P-C)
Substrate-Zeolite Layer-Catalytic Layer-PNA Layer (S-Z-C-P)
Substrate-Catalytic Layer-(PNA/Zeolite Layer) (S-C-PZ)
Substrate-(PNA/Zeolite Layer)-Catalytic Layer (S-PZ-C)
Substrate-(PNA/Zeolite/Catalytic Layer) (S-PZC)
Substrate-Catalytic Layer-PNA Layer (S-C-P)
Substrate-PNA Layer-Catalytic Layer (S-P-C)
Substrate-Zeolite Layer-PNA Layer (S-Z-P)
Substrate-PNA Layer-Zeolite Layer (S-P-Z)
Substrate-PNA Layer (S-P)

These washcoat layer configurations can be a layer in any zone of the substrate. Any of the above configurations can contain a Corner Fill Layer (F) that may be used to fill corners of the substrate prior to deposition of additional layers. In addition, any of the above configurations can have more than one of any layer. In addition, any of the above configurations may remove one or more than one layer. In the configurations above: 1) the Substrate (S) may be any substrate suitable for use in a catalytic converter, 2) the Zeolite Layer (Z) is a washcoat layer that includes zeolite particles, 3) the Catalytic Layer (C) is a washcoat layer that includes catalytically active particles (this catalytic layer can include more than one catalytic layer, i.e., C₁-C₂), 4) the PNA Layer (P) is a washcoat layer that includes a NOₓ adsorber, 5) the PNA/Zeolite Layer (PZ) is a washcoat layer that includes a NOₓ adsorber and zeolites and 6) the PNA/Zeolite/Catalytic Layer (PZC) which is a washcoat layer that includes an NOₓ adsorber, zeolites, and catalytically active particles.

It should be noted that, in some embodiments, additional washcoat layers can be disposed under, over, on top of, or between any of the washcoat layers indicated in these basic configurations; that is, further layers can be present on the catalytic converter substrate in addition to the ones listed in the configurations above. When a layer (layer Y) is said to be formed “on top of” another layer (layer X), either no additional layers, or any number of additional layers (layer(s) A, B, C, etc.) can be formed between the two layers X and Y. For example, if layer Y is said to be formed on top of layer X, this can refer to a situation where layer X can be formed, then layer A can be formed immediately atop layer X, then layer B can be formed immediately atop layer A, then layer Y can be formed immediately atop layer B. Alternatively, if layer Y is said to be formed on top of layer X, this can refer to a situation where layer Y can be deposited directly on top of layer X with no intervening layers between X and Y. For the specific situation where no intervening layers are present between layer X and layer Y, layer Y is said to be formed immediately atop layer X, or equivalently, layer Y is said to be formed directly on top of layer X.

In other embodiments, additional washcoat layers are not applied; that is, the washcoats listed in the configurations above are the only washcoats present on the catalytic converter substrate. In other embodiments, the washcoats listed in the configurations above might have a layer not present (that is, a layer may be omitted).

Various configurations of washcoat layers disposed on the substrate are depicted in the figures, such as FIGS. 3, 6, 8, 9, 13, 14, 18, and 22B. The relative thickness of the substrate, washcoat layers, and other elements in the figures, such as FIGS. 3, 6, 8, 9, 13, 14, 18, and 22B, are not drawn to scale.

### Substrates

The initial substrate is preferably a catalytic converter substrate that demonstrates good thermal stability, including resistance to thermal shock, and to which the described washcoats can be affixed in a stable manner. Suitable substrates include, but are not limited to, substrates formed from cordierite or other ceramic materials, and substrates formed from metal. The substrate may be a honeycomb structure. The substrates may include a grid array structure or coiled foil structure, which provide numerous channels and result in a high surface area. The high surface area of the coated substrate with its applied washcoats in the catalytic converter provides for effective treatment of the exhaust gas flowing through the catalytic converter. A corner fill layer, or a buffer layer or adhesion layer such as a thin Boehmite layer, may be applied to the substrate prior to applying any of the active washcoat layers, but is not required.

In the following washcoat descriptions and formulations, the composite nanoparticles are described as a component of the NNm particles for illustrative purposes only. However, the composite nanoparticles could equally well be a component of the NNiM particles. In the following descriptions, the percentages of the components of the washcoat compositions are provided in terms of the amount of solids present in the washcoat compositions, as the washcoat compositions can be provided in an aqueous suspension or, in some instances, as dry powder. The “layers” refers to the corresponding washcoat composition after it has been applied to the substrate, dried, and calcined.

### General Washcoat Preparation Procedure

Washcoats are prepared by suspending the designated materials in an aqueous solution, adjusting the pH to between about 2 and about 7, to between about 3 and about 5, or to about 4, and adjusting the viscosity, if necessary, using cellulose, cornstarch, or other thickeners, to a value between about 300 cP to about 1200 cP.

The washcoat is applied to the substrate (which may already have one or more previously-applied washcoats) by coating the substrate with the aqueous solution, blowing excess washcoat off of the substrate (and optionally collecting and recycling the excess washcoat blown off of the substrate), drying the substrate, and calcining the substrate.

### General Drying and Calcining of Washcoats

Once each washcoat is applied to the substrate (which may or may not have already been coated with previous substrates), excess washcoat is blown off and the residue collected and recycled. The washcoat may then be dried. Drying of the washcoats can be performed at room temperature or elevated temperature (for example, from about 30° C. to about 95° C., preferably about 60° C. to about 70° C.), at atmospheric pressure or at reduced pressure (for example, from about 1 pascal to about 90,000 pascal, or from about 7.5 mTorr to about 675 Torr), in ambient atmosphere or under an inert atmosphere (such as nitrogen or argon), and with or without passing a stream of gas over the substrate (for example, dry air, dry nitrogen gas or dry argon gas). In some embodiments, the drying process is a hot-drying process. A hot drying process includes any way to remove the solvent at a temperature greater than room temperature, but at a temperature below a standard calcining temperature. In some embodiments, the drying process may be a flash drying process, involving the rapid evaporation of moisture from the substrate via a sudden reduction in pressure or by placing the substrate in an updraft of warm air. It is contemplated that other drying processes may also be used.

After drying the washcoat onto the substrate, the washcoat may then be calcined onto the substrate. Calcining takes place at elevated temperatures, such as from 400° C. to about 700° C., preferably about 500° C. to about 600° C., more preferably at about 540° C. to about 560° C. or at about 550° C. Calcining can take place at atmospheric pressure or at reduced pressure (for example, from about 1 pascal to about 90,000 pascal, or about 7.5 mTorr to about 675 Torr), in ambient atmosphere or under an inert atmosphere (such as nitrogen or argon), and with or without passing a stream of gas over the substrate (for example, dry air, dry nitrogen gas, or dry argon gas).

### Zone Coating a Substrate

Zone coating can be used to separate various washcoat formulations or washcoat layers into different coatings on a substrate rather than having the washcoat formulations or washcoat layers in a single coating on the substrate. Zone coating methods on substrates are known to those of ordinary skill in the art. Zone coated catalysts can be readily produced by methods such as that described in U.S. Pat. Nos. 5,010,051 & 5,057,483, which are hereby incorporated by reference in their entirety. Zone coating can be accomplished simply by dipping a first end of a substrate into a first washcoat formulation, and subsequently dipping the second end of the substrate into a second washcoat formulation. Other methods of zone coating known in the art can be used.

Zone coating can be used to separate various washcoat formulations or washcoat layers into different regions on a substrate, rather than having the washcoat formulations or washcoat layers in the same region on the substrate. In other words, instead of coating a substrate with a first washcoat, and then coating the substrate with a second washcoat disposed on top of the first washcoat, the substrate can be coated in one region or zone with a first washcoat, and then in a different region or zone with another washcoat, so that the contact (or overlap) between different washcoats can be adjusted as desired, including minimizing contact or eliminating contact between different washcoats. A small gap can be left between the zones of the coated substrate, such as a gap of 5 mm or less; the gap should be as small as practical so as to maximize the use of the surface area of the substrate. In some embodiments, the gap between the different zones of the coated substrate is between about 5 mm and about 50 mm, between about 5 mm and about 40 mm, between about 5 mm and about 30 mm, between about 5 mm and about 20 mm, between about 5 mm and about 10 mm, between about 10 mm and about 50 mm, between about 10 mm and about 40 mm, between about 10 mm and about 30 mm, or between about 10 mm and about 20 mm.

The sizes (e.g., lengths) of the zones of the substrate can vary. For example, a zone can be about 5%, about 10%, about 15%, about 20%, about 25%, about 35%, about 40%, about 45%, about 50%, about 55%, about 60%, about 65%, about 70%, about 75%, about 80%, about 85%, about 90%, or about 95% the length of the substrate. For example, a substrate that is 4 inches in length can include a first zone that is about 50% the length of the substrate (i.e., about 2 inches) with a PNA washcoat layer and a second zone that is about 50% the length of the substrate (i.e., about 2 inches) with a Catalytic layer.

By zone coating the substrate, particular washcoat formulations can be applied to particular zones of the substrate in a particular combination to achieve a certain result. Some washcoat formulations or washcoat layers inhibit or reduce the ability of other washcoat formulations or washcoat layers from fully functioning when they are in the same coating on a substrate. For example, the catalytic material can oxidize NO to NO₂. Many diesel catalysts are used in conjunction with a downstream selective catalytic reduction (SCR) unit which converts the pollutant NOₓ to N₂ and H₂O. Commercially available SCR units typically function optimally when the ratio of NO₂ to NOₓ is about 50%. However, the NOₓ from a diesel engine is typically predominantly NO. Thus, oxidation of a portion of the NO to NO₂ by the diesel catalyst can actually enhance the performance of the subsequent reduction of NO and NO2 by the downstream SCR unit. (See, for example, Nova, Isabella and Enrico Tronconi, editors, Urea-SCR Technology for deNOx After Treatment of Diesel Exhausts. New York: Springer Science+Business Media, 2014, at section 3.9, page 81.) Combining PNA material washcoat compositions or PNA material layers with a catalytically active particle-containing washcoat compositions or catalytically active layers in a single coating on a substrate can reduce the ability of the catalytically active layer to oxidize NO to NO₂. The catalytically active layer can effectively oxidize the NO to NO₂ to get the optimal NO:NO₂ ratio for reduction in the SCR unit. Therefore, by separating the PNA material washcoat compositions from the catalytically active particle-containing washcoat composition in different zones on the substrate, the NO can more easily be oxidized to NO₂ for reduction in the SCR unit. Thus, inhibiting the oxidation of NO to NO₂ can cause more unwanted NO to be released in the atmosphere from exhaust gases.

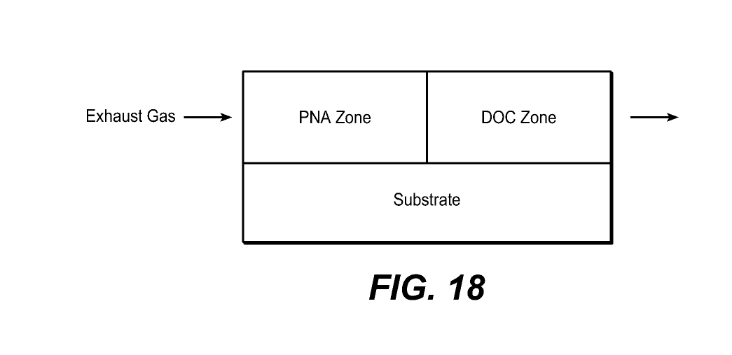

With reference to the sequence that exhaust gases flow from the engine, the PNA material coating can be in a zone on the substrate upstream from the zone containing the catalytically active particle-containing coating, such as a diesel oxidation catalyst coating. FIG. 18 illustrates FIG. 18 an exhaust flow to a coated substrate containing a PNA zone upstream a DOC zone. It should be noted that the washcoats are coated on the surface of the interior channels of the substrate; the highly schematic drawing of FIG. 18 is simply meant to aid in conceptualizing the separation of the different washcoats in the different zones, and is not meant to be a detailed physical representation, nor are the dimensions drawn to scale (the same holds true for all other figures illustrating washcoats on a substrate). The PNA material can store these NOₓ emissions until the SCR unit reaches its optimum operating temperature. In addition, the PNA material coating can be in a zone downstream from the zone containing the catalytically active particle-containing coating.

In addition, it is also possible to use multiple substrates in series instead of a single zone coated substrate.

Washcoat formulations comprising the NNm, NNiM, zeolites, or PNA material may be used to provide one or more layers in a coating on one or more zones or sections of a substrate used for catalysis, such as a catalytic converter substrate. Accordingly, one or more washcoat formulations can be used to provide one or more layers in a coating on a first zone of a substrate and one or more washcoat formulations can be used to provide one or more layers in a coating on a second zone of a substrate. The substrates can have more than one zone, each with one or more washcoat formulations to provide one or more layers in a coating to a zone of the substrate. In addition, some of the zones of the substrate may not contain any washcoat formulation or washcoat layer in a coating. Furthermore, a portion or part of one zone coating can overlap with at least a portion or part of another zone's coating. It is also possible for one or more of the zones of the substrate to share a common washcoat formulation or washcoat layer, such as a corner fill layer.

In some embodiments, the washcoat formulations may include two or more different washcoats formulations that allow for the separation of one or more washcoat layers containing high concentrations of zeolite particles from one or more washcoat layers containing platinum group metal catalyst comprising one or more plasma-generated catalyst components, such as the NNm or NNiM particles described above, in a coating on a zone of a catalytic converter substrate. A second zone of the catalytic converter substrate may include a PNA material washcoat formulation in a coating.

The formulations may be used to form washcoat layers and catalytic converter substrates that include reduced amounts of platinum group metals and/or offer better performance when compared to previous washcoat layers and formulations and catalytic converter substrates.

It should be noted that the washcoat formulations can be coated onto the substrate in any order. That is, the first washcoat formulation can be coated onto the first zone, followed by coating the second washcoat formulation onto the second zone; or the second washcoat formulation can be coated onto the second zone, followed by coating the first washcoat formulation onto the first zone. The substrate can be calcined after the initial washcoating of one of the zones onto the substrate, followed by washcoating the remaining zone onto the substrate and a second calcination of the substrate; or both zones can be washcoated onto the substrate prior to calcination of the substrate.

### Corner-Fill Washcoat Compositions and Layers

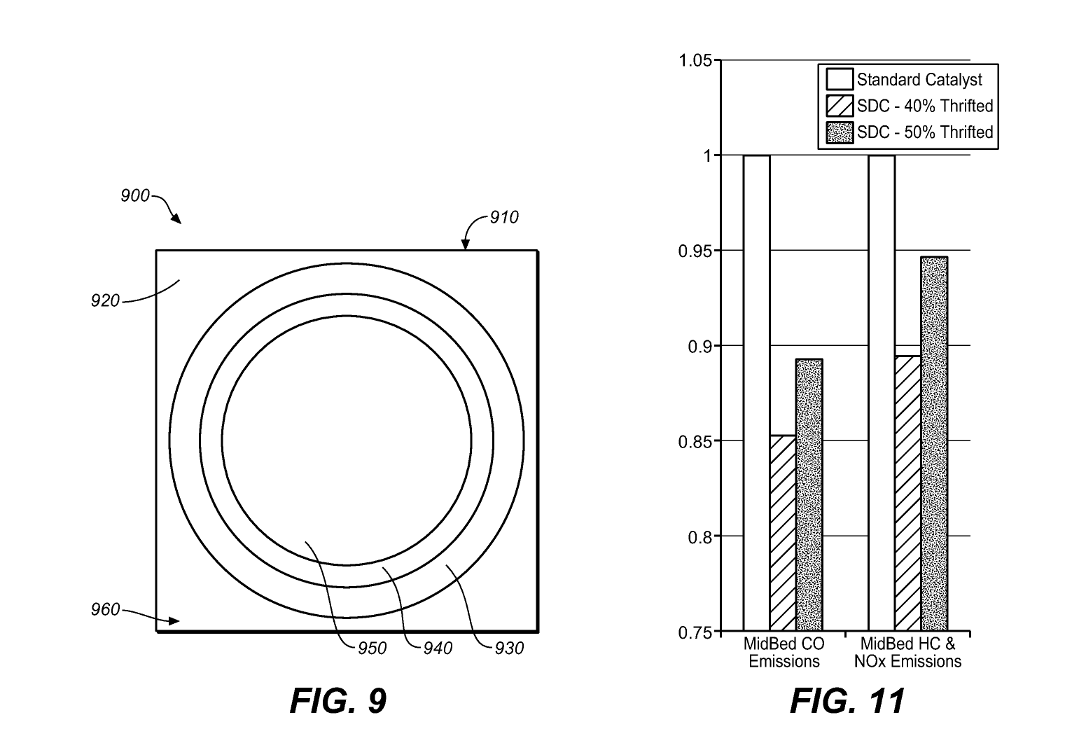

The corner fill washcoat layer (F) may be a relatively inexpensive layer, which can be applied to the substrate to fill up the “corners” and other areas of the substrate where exhaust gases are unlikely to penetrate in significant amounts. The corner fill layer is schematically diagrammed in FIG. 9, which shows a single rectangular channel 900 in a substrate coated in the S-F-C-Z configuration. The wall 910 of the substrate channel has been coated with corner-fill washcoat layer 920, then catalyst-containing washcoat layer 930, then zeolite particle-containing washcoat layer 940. When the coated substrate is operating in the catalytic converter, exhaust gases pass through the lumen 950 of the channel. The corners of the channel (one of which, 960, is indicated by an arrow) have a relatively thick coating, and exhaust gases will be less likely to contact those regions. In, for example, the S-C-Z configuration, the layers 920 and 930 would be a single layer, the catalyst-containing washcoat layer, and significant amounts of expensive platinum group metal would be located in the corners (such as 960) where they are relatively inaccessible for catalysis. Thus, while the S-C-Z configuration can be used, it may not be as cost-effective. The corner fill washcoat layer may not provide an equivalent cost savings in the S-Z-C configuration, as zeolites are relatively inexpensive.

While a rectangular shape is shown for illustration, an equivalent analysis holds for any substrate with polygonal-shaped channels, or any substrate with channels that are not essentially cylindrical. For substrates with essentially cylindrical channels, which by definition do not have corners, a corner-fill washcoat may not be necessary for economic reasons (although it may still be applied for other reasons, such as to adjust the diameter of the channels).

The corner-fill washcoat compositions may comprise aluminum oxide particles (i.e., alumina). Aluminum-oxide particles such as MI-386 material from Grace Davison, or the like, for example, can be used. The size of the aluminum oxide particles is generally above about 0.2 microns, preferably above about 1 micron. The solids content of the corner-fill washcoat include about 80% to about 98% by weight porous alumina (MI-386 or the like) and about 20% to about 2% boehmite, such as about 90% to 97% alumina and about 10% to 3% boehmite, or about 95% to 97% alumina and about 5% to about 3% boehmite, such as a corner-fill washcoat including about 97% porous alumina and about 3% boehmite.

In some embodiments, each of the aluminum oxide particles or substantially each of the aluminum oxide particles in the corner-fill washcoat composition have a diameter of approximately 0.2 microns to approximately 8 microns, such as about 4 microns to about 6 microns. In some embodiments, the aluminum oxide particles in the corner-fill washcoat composition have an average grain size of approximately 0.2 microns to approximately 8 microns, such as about 4 microns to about 6 microns. In some embodiments, at least about 75%, at least about 80%, at least about 90%, or at least about 95% of the aluminum oxide particles in the corner-fill washcoat composition have a particle size falling within the range of approximately 0.2 microns to approximately 8 microns, such as within the range of about 4 microns to about 6 microns. After a washcoat layer has been applied to a substrate, it may be dried, then calcined, onto the substrate. The corner-fill washcoat may be applied in a thickness of from about 30 g/l up to about 100 g/l; a typical value may be about 50 g/l.

### Zeolite Washcoat Compositions and Zeolite Layers

Zeolite particles may be used to trap hazardous gases, such as hydrocarbons, carbon monoxide, and nitrogen oxides, during cold start of an internal combustion engine. The Zeolite Layer (Z) is a washcoat layer, deposited using a washcoat composition that normally includes a higher percentage of zeolite than the Catalytic layer.

### Non-Iron Exchanged Zeolites

An example of zeolite composition and layer can be found in U.S. Pat. No. 8,679,433, which is hereby incorporated in their entirety by reference.

In some embodiments, the zeolite layer and washcoat compositions comprise, consist essentially of, or consist of zeolite particles, boehmite particles, and metal-oxide particles. The metal-oxide particles are preferably porous. The metal-oxide particles may be aluminum-oxide particles (e.g., MI-386 from Grace Davison or the like). The aluminum-oxide particles may be porous. Different configurations of the weight concentrations of the zeolite particles, boehmite particles, and metal-oxide particles may be employed. In the following descriptions, the percentages of the components of the washcoat compositions are provided in terms of the amount of solids present in the washcoat compositions, as the washcoat compositions can be provided in an aqueous suspension or, in some instances, as dry powder. The zeolite layer refers to the zeolite washcoat composition after it has been applied to the substrate, dried, and calcined.

In some embodiments, the zeolite particles comprise at least 50%, comprise more than about 50%, or comprise about 50% to about 100% by weight of the combination of zeolite particles, boehmite particles, and metal-oxide particles in the zeolite washcoat composition or zeolite layer. In some embodiments, the zeolite particles make up approximately 60% to approximately 80%, for example, approximately 65% to approximately 70% or approximately 70% to approximately 80%, by weight of the combination of zeolite particles, boehmite particles, and metal-oxide particles in the zeolite particle-containing washcoat composition or zeolite layer. In some embodiments, the zeolite particles in the zeolite particle-containing washcoat composition or zeolite layer each have a diameter of approximately 0.2 microns to approximately 8 microns, such as about 4 microns to about 6 microns, prior to coating. In some embodiments, at least about 75%, at least about 80%, at least about 90%, or at least about 95% of the zeolite particles in the zeolite particle-containing washcoat composition or zeolite layer have a particle size falling with the range of approximately 0.2 microns to approximately 8 microns, such as within the range of about 4 microns to about 6 microns. In some embodiments, the boehmite particles make up approximately 2% to approximately 5% by weight of the combination of zeolite particles, boehmite particles, and metal-oxide particles in the zeolite particle-containing washcoat composition or zeolite layer. In some embodiments, the boehmite particles make up approximately 3% by weight of the combination of zeolite particles, boehmite particles, and metal-oxide particles in the zeolite particle-containing washcoat composition or zeolite layer. In some embodiments, the metal-oxide particles make up approximately 15% to approximately 38%, for example, approximately 15% to approximately 30%, approximately 17% to approximately 23% or approximately 17% to approximately 22%, by weight of the mixture of zeolite particles, metal-oxide particles, and boehmite particles in the zeolite particle-containing washcoat composition or zeolite layer. In some embodiments, the metal-oxide particles make up approximately 15% to approximately 23% by weight of the mixture of zeolite particles, metal-oxide particles, and boehmite particles in the zeolite particle-containing washcoat composition or zeolite layer. In some embodiments, the metal-oxide particles make up approximately 25% to approximately 35% by weight of the mixture of zeolite particles, metal-oxide particles, and boehmite particles in the zeolite particle-containing washcoat composition or zeolite layer. In some embodiments, the zeolite-particle containing washcoat composition or zeolite layer contains about 3% boehmite particles, about 67% zeolite particles, and about 30% porous aluminum-oxide particles.

In some embodiments, the zeolite particle-containing washcoat composition or zeolite layer does not comprise any platinum group metals. As discussed above, the six platinum group metals include ruthenium, rhodium, palladium, osmium, iridium, and platinum. In some embodiments, the zeolite particle-containing washcoat composition or zeolite layer is characterized by a substantial absence of any platinum group metals. In some embodiments, the zeolite particle-containing washcoat composition or zeolite layer is 100% free of any platinum group metals. In some embodiments, the zeolite particle-containing washcoat composition or zeolite layer is approximately 100% free of any platinum group metals. In some embodiments, the zeolite particle-containing washcoat composition or zeolite layer does not comprise any catalytic particles. In some embodiments, the zeolite particle-containing washcoat composition or zeolite layer is characterized by a substantial absence of any catalytic particles. In some embodiments, the zeolite particle-containing washcoat composition or zeolite layer is 100% free of any catalytic particles. In some embodiments, the zeolite particle-containing washcoat composition or zeolite layer is approximately 100% free of any catalytic particles.

In some embodiments, the zeolite particle-containing washcoat composition or zeolite layer may include by weight about 2% to about 5% boehmite particles, about 60% to about 80% zeolite particles, and the rest porous aluminum-oxide particles (i.e., about 15% to about 38%). In one embodiment, the zeolite particle-containing washcoat composition or zeolite layer includes by weight about 2% to about 5% boehmite particles, about 75% to about 80% zeolite particles, and the rest porous aluminum-oxide particles (i.e., about 15% to about 23%). In another embodiments, the zeolite particle-containing washcoat composition or zeolite layer includes by weight about 2% to about 5% boehmite particles, about 65% to about 70% zeolite particles, and the rest porous aluminum-oxide particles (i.e., about 25% to about 33%). In some embodiment, the zeolite-particle containing washcoat composition or zeolite layer contains about 3% boehmite particles, about 67% zeolite particles, and about 30% porous aluminum-oxide particles. In some embodiments, the zeolite particle-containing washcoat composition or zeolite layer does not contain any catalytic material. In some embodiments, the zeolite particle-containing washcoat composition or zeolite layer does not contain any platinum group metals.

In some embodiments, the zeolite particle-containing washcoat composition is mixed with water and acid, such as acetic acid, prior to coating of a substrate with the zeolite particle-containing washcoat composition, thereby forming an aqueous mixture of the zeolite particle-containing washcoat composition, water, and acid. This aqueous mixture of the zeolite particle-containing washcoat composition, water, and acid may then be applied to the substrate (where the substrate may or may not already have other washcoat layers applied to it). In some embodiments, the pH of this aqueous mixture may be adjusted to a pH level of about 2 to about 7 prior to it being applied to the substrate. In some embodiments, the pH of this aqueous mixture may be adjusted to a pH level of about 4 prior to it being applied to the substrate.

In some embodiments, the zeolite layer (that is, the zeolite particle-containing washcoat composition applied to the substrate, or the zeolite-particle containing washcoat layer) has a thickness of approximately 25 g/l to approximately 90 g/l (grams/liter), approximately 50 g/l to approximately 80 g/l, or approximately 70 to approximately 90 g/l. In some embodiments, the zeolite layer has a thickness of approximately 50 g/l, 60 g/l, 70 g/l, 80 g/l, or 90 g/l. In some embodiments, the zeolite layer has a thickness of approximately 80 g/l.

In some embodiments, where the zeolite layer is applied on top of the catalyst-containing layer (i.e., the catalyst-containing layer is closer to the substrate than the zeolite layer), the zeolite layer has a thickness of about 70 g/l to about 90 g/l.

In some embodiments, where the zeolite layer is applied under the catalyst-containing layer (i.e., the zeolite layer is closer to the substrate than the catalyst-containing layer), the zeolite layer has a thickness of about 50 g/l to about 80 g/l.

### Iron-Exchanged Zeolites

An example of zeolite composition and layer can be found in U.S. application Ser. No. 14/340,351 and International Patent Application WO 2015/013545, which are hereby incorporated in their entirety by reference.

In some embodiments, the Zeolite Layer is comprised of iron-exchanged zeolite particles comprising about 1-15% of iron by weight. In some embodiments, the Zeolite Layer is comprised of iron-exchanged zeolite particles comprising about 1-10% of iron by weight. In some embodiments, the Zeolite Layer is comprised of iron-exchanged zeolite particles comprising about 2-10% of iron by weight. In some embodiments, the Zeolite Layer is comprised of iron-exchanged zeolite particles comprising about 1-8% of iron by weight. In some embodiments, the Zeolite Layer is comprised of iron-exchanged zeolite particles comprising about 2-8% of iron by weight. In some embodiments, the Zeolite Layer is comprised of iron-exchanged zeolite particles comprising about 1-6% of iron by weight. In some embodiments, the Zeolite Layer is comprised of iron-exchanged zeolite particles comprising about 2-6% of iron by weight. In some embodiments, the Zeolite Layer is comprised of iron-exchanged zeolite particles comprising about 1-5% of iron by weight. In some embodiments, the Zeolite Layer is comprised of iron-exchanged zeolite particles comprising about 2-5% of iron by weight. In some embodiments, the Zeolite Layer is comprised of iron-exchanged zeolite particles comprising about 1-4% of iron by weight. In some embodiments, the Zeolite Layer is comprised of iron-exchanged zeolite particles comprising about 2-4% of iron by weight. In some embodiments, the Zeolite Layer is comprised of iron-exchanged zeolite particles comprising about 3% of iron by weight.

In some embodiments, the Zeolite Layer is comprised of zeolite particles impregnated with palladium. In some embodiments, the Zeolite Layer is comprised of palladium-impregnated iron-exchanged zeolite particles comprising about 1-15% of iron by weight. In some embodiments, the Zeolite Layer is comprised of palladium-impregnated iron-exchanged zeolite particles comprising about 1-10% of iron by weight. In some embodiments, the Zeolite Layer is comprised of palladium-impregnated iron-exchanged zeolite particles comprising about 2-10% of iron by weight. In some embodiments, the Zeolite Layer is comprised of palladium-impregnated iron-exchanged zeolite particles comprising about 1-8% of iron by weight. In some embodiments, the Zeolite Layer is comprised of palladium-impregnated iron-exchanged zeolite particles comprising about 2-8% of iron by weight. In some embodiments, the Zeolite Layer is comprised of palladium-impregnated iron-exchanged zeolite particles comprising about 1-6% of iron by weight. In some embodiments, the Zeolite Layer is comprised of palladium-impregnated iron-exchanged zeolite particles comprising about 2-6% of iron by weight. In some embodiments, the Zeolite Layer is comprised of palladium-impregnated iron-exchanged zeolite particles comprising about 1-5% of iron by weight. In some embodiments, the Zeolite Layer is comprised of palladium-impregnated iron-exchanged zeolite particles comprising about 2-5% of iron by weight. In some embodiments, the Zeolite Layer is comprised of palladium-impregnated iron-exchanged zeolite particles comprising about 1-4% of iron by weight. In some embodiments, the Zeolite Layer is comprised of palladium-impregnated iron-exchanged zeolite particles comprising about 2-4% of iron by weight. In some embodiments, the Zeolite Layer is comprised of palladium-impregnated iron-exchanged zeolite particles comprising about 3% of iron by weight. In some embodiments, the micron-sized support (referred to as “filler”) in the Catalytic Layer may be impregnated with palladium. Palladium may be added to the filler by wet chemical methods or by preparation of NNm particles. In one embodiment, the Catalytic Layer contains no zeolites or is substantially free of zeolites. The palladium-impregnated zeolite can comprise about 0.1-5% palladium by weight, such as about 0.1%, about 1%, about 2%, about 3%, about 4%, or about 5% palladium by weight, or about 0.1 to 2% Pd by weight, about 2% to 5% Pd by weight, or about 0.5% to 2% Pd by weight. In one embodiment, the palladium-impregnated zeolite can comprise about 1% palladium by weight.

In some embodiments, the zeolites used in the Zeolite Layer and washcoat are iron-exchanged zeolites, such as zeolites comprising 3% iron. In some embodiments, the Zeolite Layer and washcoat includes no catalytically active particles (such as no PGM-containing particles). In some embodiments, the Zeolite Layer includes zeolites impregnated with palladium. In still other embodiments, the Zeolite Layer and washcoat includes iron-exchanged zeolites, such as zeolites comprising 3% iron. In still further embodiments, the Zeolite Layer and washcoat includes iron-exchanged zeolites, such as zeolites comprising 3% iron, which are impregnated with palladium. The amount of palladium on the zeolite can range from about 0.1% to 5% by weight, such as about 0.1%, about 1%, about 2%, about 3%, about 4%, or about 5% by weight, or about 0.1 to 2% Pd by weight, about 2% to 5% Pd by weight, or about 0.5% to 2% Pd by weight. The amount of palladium impregnated into the zeolite can be adjusted in order to amount to approximately 50% of the total palladium contained in all washcoat layers.

As noted previously herein, zeolites act as a temporary storage component (i.e., a trap) for the pollutants carbon monoxide (CO), hydrocarbons (HC), and nitrogen oxides (NOₓ) during the cold-start period, when the catalytic converter is still cold. After the catalytic converter heats up to its operating temperature, known as the light-off temperature, the stored gases are released and subsequently decomposed by the catalytically active material on the substrate (typically, platinum, palladium, and mixtures thereof, as described herein). See, for example, Kryl et al., Ind. Eng. Chem. Res. 44:9524 (2005). An example of iron-exchanged zeolites and iron-exchanged zeolite systems can be found in U.S. Provisional Application No. 61/858,551, which is hereby incorporated by reference in its entirety.

Zeolites can be modified by ion-exchange into the aluminosilicate zeolite matrix. Common ions for such exchange are iron or copper. Thus, iron-exchanged zeolites (iron-ion-exchanged zeolites, iron-impregnated zeolites) and copper-exchanged zeolites have been produced by soaking zeolite materials in solutions containing iron or copper atoms. These materials, particularly iron-exchanged zeolites, have been used in systems for converting nitrogen oxides to nitrogen. See, for example, US 2009/0260346, which describes use of iron-exchanged or copper-exchanged zeolites and ammonia for reduction of nitrogen oxides to nitrogen; U.S. Pat. No. 5,451,387, which describes use of iron-exchanged ZSM-5 zeolite with ammonia to convert NOₓ to N₂; EP 756,891; and EP 2,141,333, which describes cerium-exchanged zeolites and iron-exchanged zeolites for NOₓ reduction. Other uses of iron-exchanged zeolites, such as for Friedel-Crafts alkylation, have also been proposed; see, e.g., Bidart et al., Catalysis Letters, 75:155 (2001)

The instant inventors have discovered that iron-exchanged zeolites also have superior hydrocarbon trapping ability as compared to zeolites without such iron-exchange modification. Thus, inclusion of iron-exchanged zeolites in catalytic converters can lead to dramatically improved cold-start performance and improved pollution control.

Iron-exchanged zeolites can be easily prepared simply by immersing zeolites (such as ZSM-5 zeolite or beta-zeolite) in solutions containing ferric or ferrous ions, such as ferric nitrate, ferric sulfate, ferrous sulfate, ferrous acetate, ferric chloride, at concentrations of 10 mM to 100 mM, for 12-48 hours. See, e.g., Lee et al., Materials Transactions 50:2476 (2009); U.S. Pat. No. 5,451,387; Xin et al., Chem. Commun. 7590-7592 (2009); Chen et al., Catalysis Today 42:73 (1998); and Sato et al., Catalysis Letters 12:193 (1992). Iron-exchanged zeolites can also be purchased commercially, for example, from Clariant (formerly Stid-Chemie), Charlotte, N.C.

Use of iron-exchanged zeolites in the washcoats and catalysts disclosed herein can reduce levels of hydrocarbons in exhaust gases, such as in cold-start exhaust gases, by at least about 5%, at least about 10%, at least about 15%, at least about 20%, or at least about 25%, compared to the same catalyst configurations using non-iron-exchanged zeolites.

Use of iron-exchanged zeolites in the washcoats and catalysts disclosed herein can also reduce levels of carbon monoxide in exhaust gases, such as in cold-start exhaust gases, by at least about 5%, at least about 10%, at least about 15%, at least about 20%, or at least about 25%, compared to the same catalyst configurations using non-iron-exchanged zeolites.

In some embodiments, the zeolite layer and washcoat compositions comprise, consist essentially of, or consist of zeolite particles, boehmite particles, and metal-oxide particles. The metal-oxide particles are preferably porous. The metal-oxide particles may be aluminum-oxide particles (e.g., MI-386 from Grace Davison or the like). The aluminum-oxide particles may be porous. Different configurations of the weight concentrations of the zeolite particles, boehmite particles, and metal-oxide particles may be employed. In the following descriptions, the percentages of the components of the washcoat compositions are provided in terms of the amount of solids present in the washcoat compositions, as the washcoat compositions can be provided in an aqueous suspension or, in some instances, as dry powder. The zeolite layer refers to the zeolite washcoat composition after it has been applied to the substrate, dried, and calcined.

In some embodiments, the zeolite particles comprise at least 50%, comprise more than about 50%, or comprise about 50% to about 100% by weight of the combination of zeolite particles, boehmite particles, and metal-oxide particles in the zeolite washcoat composition or zeolite layer. In some embodiments, the zeolite particles make up approximately 60% to approximately 80%, for example, approximately 65% to approximately 70% or approximately 70% to approximately 80%, by weight of the combination of zeolite particles, boehmite particles, and metal-oxide particles in the zeolite particle-containing washcoat composition or zeolite layer. In some embodiments, the zeolite particles in the zeolite particle-containing washcoat composition or zeolite layer each have a diameter of approximately 0.2 microns to approximately 8 microns, such as about 4 microns to about 6 microns, prior to coating. In some embodiments, at least about 75%, at least about 80%, at least about 90%, or at least about 95% of the zeolite particles in the zeolite particle-containing washcoat composition or zeolite layer have a particle size falling with the range of approximately 0.2 microns to approximately 8 microns, such as within the range of about 4 microns to about 6 microns. In some embodiments, the boehmite particles make up approximately 2% to approximately 5% by weight of the combination of zeolite particles, boehmite particles, and metal-oxide particles in the zeolite particle-containing washcoat composition or zeolite layer. In some embodiments, the boehmite particles make up approximately 3% by weight of the combination of zeolite particles, boehmite particles, and metal-oxide particles in the zeolite particle-containing washcoat composition or zeolite layer. In some embodiments, the zeolite particles in the zeolite particle-containing washcoat composition or zeolite layer are iron-exchanged zeolites, for example, zeolites comprising 3% iron. In some embodiments, the metal-oxide particles make up approximately 15% to approximately 38%, for example, approximately 15% to approximately 30%, approximately 17% to approximately 23% or approximately 17% to approximately 22%, by weight of the mixture of zeolite particles, metal-oxide particles, and boehmite particles in the zeolite particle-containing washcoat composition or zeolite layer. In some embodiments, the metal-oxide particles make up approximately 15% to approximately 38%, for example, approximately 15% to approximately 30%, approximately 17% to approximately 23% or approximately 17% to approximately 22%, by weight of the mixture of zeolite particles (wherein the zeolite particles can be iron-exchanged zeolite particles, or non-iron-exchanged zeolite particles), metal-oxide particles, and boehmite particles in the zeolite particle-containing washcoat composition or zeolite layer. In some embodiments, the metal-oxide particles make up approximately 15% to approximately 23% by weight of the mixture of zeolite particles (wherein the zeolite particles can be iron-exchanged zeolite particles, or non-iron-exchanged zeolite particles), metal-oxide particles, and boehmite particles in the zeolite particle-containing washcoat composition or zeolite layer. In some embodiments, the metal-oxide particles make up approximately 15% to approximately 23% by weight of the mixture of zeolite particles (wherein the zeolite particles can be iron-exchanged zeolite particles, or non-iron-exchanged zeolite particles), metal-oxide particles, and boehmite particles in the zeolite particle-containing washcoat composition or zeolite layer. In some embodiments, the metal-oxide particles make up approximately 25% to approximately 35% by weight of the mixture of zeolite particles (wherein the zeolite particles can be iron-exchanged zeolite particles, or non-iron-exchanged zeolite particles), metal-oxide particles, and boehmite particles in the zeolite particle-containing washcoat composition or zeolite layer. In some embodiments, the metal-oxide particles make up approximately 25% to approximately 35% by weight of the mixture of zeolite particles (wherein the zeolite particles can be iron-exchanged zeolite particles, or non-iron-exchanged zeolite particles), metal-oxide particles, and boehmite particles in the zeolite particle-containing washcoat composition or zeolite layer. In some embodiments, the zeolite-particle containing washcoat composition or zeolite layer contains about 3% boehmite particles, about 67% zeolite particles, and about 30% porous aluminum-oxide particles, wherein the zeolite particles can be iron-exchanged zeolite particles, or non-iron-exchanged zeolite particles. In some embodiments, the zeolite-particle containing washcoat composition or zeolite layer comprises about 3% boehmite particles, about 70% zeolite particles, and about 30% porous aluminum-oxide particles, wherein the zeolite particles can be iron-exchanged zeolite particles, or non-iron-exchanged zeolite particles.

In some embodiments, the zeolite particle-containing washcoat composition or zeolite layer does not comprise any platinum group metals. As discussed above, the six platinum group metals include ruthenium, rhodium, palladium, osmium, iridium, and platinum. In some embodiments, the zeolite particle-containing washcoat composition or zeolite layer is characterized by a substantial absence of any platinum group metals. In some embodiments, the zeolite particle-containing washcoat composition or zeolite layer is 100% free of any platinum group metals. In some embodiments, the zeolite particle-containing washcoat composition or zeolite layer is approximately 100% free of any platinum group metals. In some embodiments, the zeolite particle-containing washcoat composition or zeolite layer does not comprise any catalytic particles. In some embodiments, the zeolite particle-containing washcoat composition or zeolite layer is characterized by a substantial absence of any catalytic particles. In some embodiments, the zeolite particle-containing washcoat composition or zeolite layer is 100% free of any catalytic particles. In some embodiments, the zeolite particle-containing washcoat composition or zeolite layer is approximately 100% free of any catalytic particles. In all of the above embodiments, the zeolite particles can be iron-exchanged zeolite particles, or non-iron-exchanged zeolite particles.

In other embodiments, the zeolite particle-containing washcoat composition or zeolite layer further comprises palladium, where the palladium is impregnated into the zeolite particles. The zeolite particles can be iron-exchanged zeolite particles, or non-iron-exchanged zeolite particles. In some embodiments, the zeolite particle-containing washcoat composition or zeolite layer may include by weight about 2% to about 5% boehmite particles, about 60% to about 80% zeolite particles, and the rest porous aluminum-oxide particles (i.e., about 15% to about 38%). In one embodiment, the zeolite particle-containing washcoat composition or zeolite layer includes by weight about 2% to about 5% boehmite particles, about 75% to about 80% zeolite particles, and the rest porous aluminum-oxide particles (i.e., about 15% to about 23%). In another embodiments, the zeolite particle-containing washcoat composition or zeolite layer includes by weight about 2% to about 5% boehmite particles, about 65% to about 70% zeolite particles, and the rest porous aluminum-oxide particles (i.e., about 25% to about 33%). In some embodiments, the zeolite-particle containing washcoat composition or zeolite layer contains about 3% boehmite particles, about 67% zeolite particles, and about 30% porous aluminum-oxide particles. In all of the above embodiments, the zeolite particles can be iron-exchanged zeolite particles, or non-iron-exchanged zeolite particles.

In some embodiments, the zeolite particle-containing washcoat composition is mixed with water and acid, such as acetic acid, prior to coating of a substrate with the zeolite particle-containing washcoat composition, thereby forming an aqueous mixture of the zeolite particle-containing washcoat composition, water, and acid. This aqueous mixture of the zeolite particle-containing washcoat composition, water, and acid may then be applied to the substrate (where the substrate may or may not already have other washcoat layers applied to it). In some embodiments, the pH of this aqueous mixture may be adjusted to a pH level of about 2 to about 7 prior to it being applied to the substrate. In some embodiments, the pH of this aqueous mixture may be adjusted to a pH level of about 4 prior to it being applied to the substrate.

In some embodiments, the zeolite layer (that is, the zeolite particle-containing washcoat composition applied to the substrate, or the zeolite-particle containing washcoat layer) has a thickness of approximately 25 g/l to approximately 90 g/l (grams/liter), approximately 50 g/l to approximately 80 g/l, or approximately 70 to approximately 90 g/l. In some embodiments, the zeolite layer has a thickness of approximately 50 g/l, 60 g/l, 70 g/l, 80 g/l, or 90 g/l. In some embodiments, the zeolite layer has a thickness of approximately 80 g/l.

In some embodiments, where the zeolite layer is applied on top of the catalyst-containing layer (i.e., the catalyst-containing layer is closer to the substrate than the zeolite layer), the zeolite layer has a thickness of about 70 g/l to about 90 g/l.

In some embodiments, where the zeolite layer is applied under the catalyst-containing layer (i.e., the zeolite layer is closer to the substrate than the catalyst-containing layer), the zeolite layer has a thickness of about 50 g/l to about 80 g/l.

### Catalytic Active Particle-Containing Washcoat Compositions and Catalytically Active Layers

Examples of catalytically active particle-containing washcoats and layers can be found in U.S. Pat. No. 8,679,433 and U.S. application Ser. Nos. 14/340,351 and 14/521,295, which are hereby incorporated in their entirety by reference.

The catalytic washcoat composition and the catalytic layer on the substrate can comprise a catalytically active material, and can be formed in a variety of ways. In some embodiments, the catalytically active material may be catalytic particles prepared by only wet-chemistry methods. In some embodiments, the catalytically active material may comprise nano-on-nano-on-micron (NNm) particles. In some embodiments, the catalytically active material may comprise nano-on-nano-in-micron (NNiM) particles. In some embodiments, the catalytically active material may comprise hybrid NNm/wet-chemistry particles. In some embodiments, the catalytic washcoat may comprise one, one or more, two, two or more, three, three or more, four, or four or more different types of catalytically active materials. For example, in some embodiments, a catalytic washcoat may comprise NNm particles and catalytic particles prepared by only wet-chemistry methods. In some embodiments, a catalytic washcoat may comprise NNiM particles and catalytic particles prepared by only wet-chemistry methods. In some embodiments, a catalytic washcoat may comprise NNm particles and NNiM particles. In some embodiments, a catalytic washcoat may comprise hybrid NNm/wet-chemistry particles and catalytic particles prepared by only wet-chemistry methods. In some embodiments, a catalytic washcoat may comprise hybrid NNm/wet-chemistry particles and NNiM particles. In some embodiments, a catalytic washcoat may comprise hybrid NNm/wet-chemistry particles and NNm particles. In some embodiments, a catalytic washcoat may comprise NNm particles, NNiM particles, and catalytic particles prepared by only wet-chemistry methods. In some embodiments, a catalytic washcoat may comprise NNm particles, hybrid NNm/wet-chemistry particles, and catalytic particles prepared by only wet-chemistry methods. In some embodiments, a catalytic washcoat may comprise NNiM particles, hybrid NNm/wet-chemistry particles, and catalytic particles prepared by only wet-chemistry methods. In some embodiments, a catalytic washcoat may comprise NNm particles, hybrid NNm/wet-chemistry particles, and NNiM particles. In some embodiments, a catalytic washcoat may comprise NNm particles, NNiM particles, hybrid NNm/wet-chemistry particles, and catalytic particles prepared by only wet-chemistry methods.

Preferred catalytically active materials comprise platinum group metals (PGMs). Platinum group metals include the metals platinum, palladium, rhodium, ruthenium, osmium, and iridium. In some embodiments, a single metal type may be used as catalysts in a particular catalytic washcoat (such as only palladium or only platinum), and in some embodiments, various combinations of PGMs may be used. For example, in some embodiments, a catalytic washcoat may comprise a mixture of platinum and palladium. In some embodiments, a catalytic washcoat may comprise a mixture of platinum and palladium at any ratio, or any range of ratios, such as about 1:2 to about 100:1 Pt/Pd (weight/weight), 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight). In some embodiments, such ratios of differing PGMs may arise from two or more different catalytically active materials, such as catalytically active materials comprising different types of PGM, or catalytically active materials comprising different ratios of different PGMs.

In the following descriptions, the percentages of the components of the washcoat compositions are provided in terms of the amount of solids present in the washcoat compositions, as the washcoat compositions can be provided in an aqueous suspension or, in some instances, as dry powder. The catalyst layer (or catalyst-containing layer) refers to the catalyst-containing washcoat composition after it has been applied to the substrate, dried, and calcined.

The previously described zeolite-particle containing washcoat compositions and zeolite-particle containing layers can be free of, or in an alternative embodiment, substantially free of, catalytic particles or platinum group metals. The previously described zeolite-particle containing washcoat compositions and zeolite-particle containing layers can comprise iron-exchanged zeolite particles or non-iron-exchanged zeolite particles. The previously described zeolite-particle containing washcoat compositions and zeolite-particle containing layers, which can be iron-exchanged zeolite particles, or non-iron-exchanged zeolite particles, can comprise palladium which is impregnated into zeolite particles. It is preferred that the catalyst-containing washcoat compositions and layers which comprise one or more plasma-generated catalyst components are free of, or substantially free of, zeolites. However, in some embodiments, the catalyst-containing washcoat compositions and catalyst layers can contain an amount of zeolites, such as up to about 20%, up to about 10%, or up to about 5% of the total solids in the catalyst-containing washcoat compositions or catalyst-containing layers, where the washcoat compositions or layers comprise one or more plasma-generated catalyst components.

In some embodiments, the catalyst-containing washcoat composition further includes “spacer” or “filler” particles, where the spacer particles may be ceramic, metal oxide, or metallic particles. In some embodiments, the spacer particles may be silica, alumina, boehmite, or zeolite particles, or any mixture of the foregoing, such as boehmite particles, silica particles and zeolite particles in any proportion.

In some embodiments where the catalyst-containing washcoat composition comprising one or more plasma-generated catalyst components, and catalyst layers comprising one or more plasma-generated catalyst components, are substantially free of zeolites, the catalyst-containing washcoat composition comprises, consists essentially of, or consists of silica particles, boehmite particles, and NNm particles. In some embodiments, the NNm particles make up between approximately 35% to approximately 95% by weight of the combination of the NNm particles, the boehmite particles, and the silica particles in the catalyst-containing washcoat composition or catalyst-containing layer. In some embodiments, the NNm particles make up between approximately 40% to approximately 92% by weight of the combination of the NNm particles, the boehmite particles, and the silica particles in the catalyst-containing washcoat composition or catalyst-containing layer. In some embodiments, the NNm particles make up between approximately 60% to approximately 95% by weight of the combination of the NNm particles, the boehmite particles, and the silica particles in the catalyst-containing washcoat composition or catalyst-containing layer. In some embodiments, the NNm particles make up between approximately 80% to approximately 95% by weight of the combination of the NNm particles, the boehmite particles, and the silica particles in the catalyst-containing washcoat composition or catalyst-containing layer. In some embodiments, the NNm particles make up between approximately 80% to approximately 92% by weight of the combination of the NNm particles, the boehmite particles, and the silica particles in the catalyst-containing washcoat composition or catalyst-containing layer. In some embodiments, the NNm particles make up approximately 92% by weight of the combination of the NNm particles, the boehmite particles, and the silica particles in the catalyst-containing washcoat composition or catalyst-containing layer.

In some embodiments, the percentage of platinum group metal in the catalyst-containing washcoat composition comprising one or more plasma-generated catalyst components, and in the catalyst layer comprising one or more plasma-generated catalyst components, ranges from between about 0.25% to about 4%, about 0.5% to about 4%, about 0.5% to about 3%, about 1% to about 3%, about 1% to about 2%, about 1% to about 1.5%, about 1.5% to about 3%, about 1.5% to about 2.5%, about 1.5% to about 2%, about 2% to about 3%, about 2.5% to about 3%, or about 2% to about 2.5%. In some embodiments, the percentage of platinum group metal in the catalyst-containing washcoat composition comprising one or more plasma-generated catalyst components, and catalyst layer comprising one or more plasma-generated catalyst components, is about 0.5%, about 0.75%, about 1%, about 1.25%, about 1.5%, about 1.75%, about 2%, about 2.25%, about 2.5%, about 2.75%, or about 3%. In some embodiments, the percentage of platinum group metal in the catalyst-containing washcoat composition comprising one or more plasma-generated catalyst components, and catalyst layer comprising one or more plasma-generated catalyst components, is about 2.3%.

In some embodiments, the silica particles make up approximately 20% or less by weight of the combination of the nano-on-nano-on-micron particles, the boehmite particles, and the silica particles in the catalyst-containing washcoat composition comprising one or more plasma-generated catalyst components or the catalyst-containing layer comprising one or more plasma-generated catalyst components; or the silica particles make up approximately 10% or less by weight of the combination of the nano-on-nano-on-micron particles, the boehmite particles, and the silica particles in the catalyst-containing washcoat composition or catalyst-containing layer; in further embodiments, the silica particles make up approximately 5% or less by weight of the combination of the nano-on-nano-on-micron particles, the boehmite particles, and the silica particles in the catalyst-containing washcoat composition or catalyst-containing layer. In various embodiments, the silica particles make up approximately 1% to approximately 20%, approximately 1% to approximately 10%, approximately 1% to approximately 5%, about 20%, about 10%, about 5%, or about 1% by weight of the combination of the nano-on-nano-on-micron particles, the boehmite particles, and the silica particles in the catalyst-containing washcoat composition comprising one or more plasma-generated catalyst components or catalyst-containing layer comprising one or more plasma-generated catalyst components. In some embodiments, the boehmite particles make up approximately 2% to approximately 5% by weight of the combination of the nano-on-nano-on-micron particles, the boehmite particles, and the silica particles in the catalyst-containing washcoat composition comprising one or more plasma-generated catalyst components or catalyst-containing layer comprising one or more plasma-generated catalyst components. In some embodiments, the boehmite particles make up approximately 3% by weight of the combination of the nano-on-nano-on-micron particles, the boehmite particles, and the silica particles in the catalyst-containing washcoat composition comprising one or more plasma-generated catalyst components or catalyst-containing layer comprising one or more plasma-generated catalyst components.

In some embodiments, the catalyst-containing washcoat composition comprising one or more plasma-generated catalyst components or catalyst-containing layer comprising one or more plasma-generated catalyst components further comprises metal-oxide particles, such as the metal oxide particles discussed above (e.g., porous metal-oxides, aluminum-oxides, porous aluminum-oxides, etc.). In some embodiments, these metal-oxide particles further comprise up to approximately 65%, up to approximately 60%, up to approximately 55%, or up to approximately 54%, such as approximately 2% to approximately 54%, by weight of the combination of the nano-on-nano-on-micron particles, the boehmite particles, the silica particles, and the metal-oxide particles in the catalyst-containing washcoat composition comprising one or more plasma-generated catalyst components or catalyst-containing layer comprising one or more plasma-generated catalyst components. It is contemplated that the concentration ranges discussed above for the nano-on-nano-on-micron particles, the boehmite particles, and the silica particles can be applied to the combination of those materials with the metal-oxide particles.

In other embodiments, the catalyst-containing washcoat composition comprising one or more plasma-generated catalyst components, or the catalyst-containing layer comprising one or more plasma-generated catalyst components, comprises, consists essentially of, or consists of zeolite particles, boehmite particles, and nano-on-nano-on-micron particles. In some embodiments, the nano-on-nano-on-micron particles make up between approximately 35% to approximately 95% by weight of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components. In some embodiments, the nano-on-nano-on-micron particles make up between approximately 40% to approximately 92% by weight of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components. In some embodiments, the nano-on-nano-on-micron particles make up between approximately 60% to approximately 95% by weight of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components. In some embodiments, the nano-on-nano-on-micron particles make up between approximately 80% to approximately 95% by weight of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components. In some embodiments, the nano-on-nano-on-micron particles make up between approximately 80% to approximately 92% by weight of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components. In some embodiments, the nano-on-nano-on-micron particles make up approximately 92% by weight of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components. In some embodiments, the zeolite particles make up less than approximately 20%, less than approximately 10%, or less than approximately 5%, by weight of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components. In some embodiments, the zeolite particles make up approximately 1% to approximately 5% by weight, such as about 5% by weight, of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components. In some embodiments, the boehmite particles make up approximately 2% to approximately 5% by weight of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components. In some embodiments, the boehmite particles make up approximately 3% by weight of the combination of the nano-on-nano-on-micron particles, the boehmite particles, and the zeolite particles in the catalyst-containing washcoat composition comprising one or more plasma-generated catalyst components or catalyst-containing layer comprising one or more plasma-generated catalyst components.

In some embodiments, the catalyst-containing washcoat composition comprising one or more plasma-generated catalyst components or catalyst-containing layer comprising one or more plasma-generated catalyst components further includes metal-oxide particles, such as the metal oxide particles discussed above (e.g., porous metal-oxides, aluminum-oxides, porous aluminum-oxides, etc.). In some embodiments, these metal-oxide particles make up approximately 0% to approximately 54%, such as approximately 2% to approximately 54%, by weight of the combination of the nano-on-nano-on-micron particles, the boehmite particles, the zeolite particles, and the metal-oxide particles in the catalyst-containing washcoat composition comprising one or more plasma-generated catalyst components or catalyst-containing layer comprising one or more plasma-generated catalyst components. It is contemplated that the concentration ranges discussed above for the nano-on-nano-on-micron particles, the boehmite particles, and the zeolite particles can be applied to the combination of those materials with the metal-oxide particles.

In some embodiments, the catalyst-containing washcoat composition comprising one or more plasma-generated catalyst components or catalyst-containing layer comprising one or more plasma-generated catalyst components comprises micron-sized support particles bearing composite catalytic nanoparticles, where the catalytic nanoparticles comprise a platinum/palladium alloy. In other embodiments, the catalyst-containing washcoat composition comprising one or more plasma-generated catalyst components or catalyst-containing layer comprising one or more plasma-generated catalyst components comprises micron-sized support particles bearing composite catalytic nanoparticles comprising platinum. In further embodiments, the catalyst-containing washcoat composition comprising one or more plasma-generated catalyst components or catalyst-containing layer comprising one or more plasma-generated catalyst components comprises micron-sized support particles bearing composite catalytic nanoparticles, where the composite nanoparticles have a population of support nanoparticles bearing catalytic nanoparticles comprising a platinum/palladium alloy and a population of support nanoparticles bearing catalytic nanoparticles comprising palladium.

In any of the foregoing embodiments, it will be understood that the amounts of platinum and palladium can be adjusted such that the total amount of platinum and palladium in a washcoat layer or the combined washcoat layers is from about 15:1 to 1:1 Pt/Pd ratio (weight/weight). In any of the foregoing embodiments, a ratio between about 12:1 to 1:1 platinum:palladium (weight/weight); about 10:1 to 1:1 platinum:palladium (weight/weight); about 8:1 to 1:1 platinum:palladium (weight/weight); about 5:1 to 1:1 platinum:palladium (weight/weight); about 4:1 to 1:1 platinum:palladium (weight/weight); about 3:1 to 1:1 platinum:palladium (weight/weight); about 10:1 to 2:1 platinum:palladium (weight/weight); about 7:1 to 2:1 platinum:palladium (weight/weight); about 6:1 to 3:1 platinum:palladium (weight/weight); about 5:1 to 3:1 platinum:palladium (weight/weight); about 4.5:1 to 3.5:1 platinum:palladium (weight/weight), or a ratio of about 4:1 platinum:palladium (weight/weight), about 3:1 platinum:palladium (weight/weight) about 2:1 platinum:palladium (weight/weight), or about 1:1 platinum:palladium (weight/weight) can be used. In any of the foregoing embodiments, the total amount of platinum and palladium in a washcoat layer or the combined washcoat layers can be at about a 10:1 Pt/Pd ratio (weight/weight). In any of the foregoing embodiments, the total amount of platinum and palladium in a washcoat layer or the combined washcoat layers can be at about a 4:1 Pt/Pd ratio (weight/weight). In any of the foregoing embodiments, the total amount of platinum and palladium in a washcoat layer or the combined washcoat layers can be at about a 3:1 Pt/Pd ratio (weight/weight). In any of the foregoing embodiments, the total amount of platinum and palladium in a washcoat layer or the combined washcoat layers can be at about a 2:1 Pt/Pd ratio (weight/weight). In any of the foregoing embodiments, the total amount of platinum and palladium in a washcoat layer or the combined washcoat layers can be at about a 1:1 Pt/Pd ratio (weight/weight).

The platinum and palladium can be distributed in among any components of the washcoats used to make the catalyst. For example, the nanoparticles made by plasma preparation methods can comprise all of the platinum and palladium used. Alternatively, the nanoparticles made by plasma preparation methods can comprise all of the platinum and some of the palladium used, while the remaining portion of the palladium can be distributed on one or more other components of the washcoat layers used to make the catalyst. For example, if the total amount of platinum:palladium in the catalyst is present in a 4:1 ratio, the nanoparticles can comprise 100% of the platinum used and about 50% of the palladium used, resulting in nanoparticles having about an 8:1 platinum:palladium ratio, while the remaining 50% of the palladium is distributed on another component (such as the zeolite, PNA, or an aluminum oxide filler described herein). Thus the ratio would be 8 parts platinum in the plasma-prepared nanoparticle, 1 part palladium in the plasma-prepared nanoparticle, and 1 part palladium in another component of the washcoat layers, resulting in an 8:2 or 4:1 platinum:palladium ratio overall.

A portion of the palladium can be present in any of the following washcoat components:

zeolites (either iron-exchanged zeolites or non-iron-exchanged zeolites). Pd can be deposited on zeolites by standard wet-chemical techniques, involving impregnation of a zeolite particle with a solution of a palladium salt, such as a solution of a palladium acid salt, to the point of incipient wetness, followed by drying and calcination to convert the palladium salt to elemental palladium. The amount of palladium on the zeolite can range from about 0.1% to 5% by weight, such as about 0.1%, about 1%, about 2%, about 3%, about 4%, or about 5% by weight, or about 0.1 to 2% Pd by weight, about 2% to 5% Pd by weight, or about 0.5% to 2% Pd by weight. The amount of palladium on the zeolite can be adjusted in order to amount to approximately 50% of the total palladium contained in all washcoat layers, as discussed in the preceding paragraphs.

filler material. Filler material in the form of micron-sized porous alumina (porous aluminum oxide) is used in various layers of the washcoats. Palladium can be deposited in on the filler material either by standard wet-chemical techniques (impregnation to incipient wetness of a palladium salt solution on micron-sized porous alumina, followed by drying/calcination), or by preparing Pd/Al₂O₃ nano-on-nano (“NN”) composite nanoparticles, forming a suspension of the composite nanoparticles, and impregnating the micron-sized porous alumina with the Pd/Al₂O₃ composite nanoparticles (“NNm”). The amount of palladium on the micron-sized alumina can range from about 1% to 5% by weight, such as about 1%, about 2%, about 3%, about 4%, or about 5% by weight, or about 1 to 3% Pd by weight, about 2% to 3% Pd by weight, or about 1% to 2% Pd by weight. The amount of palladium on the micron-sized alumina can be adjusted in order to amount to approximately 50% of the total palladium contained in all washcoat layers, as discussed in the preceding paragraphs.

PNA material. The previous and following discussion of PNA compositions, washcoats, and layers explains the palladium contained in such a layer.

In some embodiments, a catalytic washcoat may comprise catalytic particles prepared by only wet-chemistry methods with a mixture of platinum and palladium at a ratio of about or any range of ratios, such as about 1:2 to about 100:1 Pt/Pd (weight/weight), 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or palladium and no platinum, or platinum and no palladium. In some embodiments, a catalytic washcoat may comprise NNm particles with a mixture of platinum and palladium at a ratio, or any range of ratios, such as about 1:2 to about 100:1 Pt/Pd (weight/weight), 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or palladium and no platinum, or platinum and no palladium. In some embodiments, a catalytic washcoat may comprise NNiM particles with a mixture of platinum and palladium at a ratio, or any range of ratios, such as about 1:2 to about 100:1 Pt/Pd (weight/weight), 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or palladium and no platinum, or platinum and no palladium. In some embodiments, a catalytic washcoat may comprise hybrid NNm/wet-chemistry particles with a mixture of platinum and palladium at a ratio, or any range of ratios, such as about 1:2 to about 100:1 Pt/Pd (weight/weight), 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or palladium and no platinum, or platinum and no palladium. In some embodiments, a catalytic washcoat can comprise a catalyst comprising a weight ratio of platinum:palladium of about 20:1 and another catalyst comprising palladium, such that the combined catalysts comprise a weight ratio of 1:2 platinum:palladium to 8:1 platinum:palladium. In some embodiments where a catalytic washcoat can comprise a catalyst comprising a weight ratio of platinum:palladium of about 20:1 and another catalyst comprising palladium, such that the combined catalysts comprise a weight ratio of 1:2 platinum:palladium to 8:1 platinum:palladium, the platinum:palladium catalyst can comprise composite nanoparticles comprising a Pt:Pd alloy nanoparticle on a nanoparticle support, where the composite nanoparticles are bonded to a micron-sized carrier particle; and the catalyst comprising palladium can comprise palladium deposited on a micron-sized particle by wet-chemistry methods.

In some embodiments, a catalytic washcoat may comprise a mixture of different types of catalytically active materials with different ratios of different catalytic metals. In other embodiments, the different types of catalytically active materials can be placed in different washcoats. In some embodiments, a catalytic washcoat may comprise catalytically active material with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, catalytically active material with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise catalytic particles prepared by only wet-chemistry methods with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, catalytic particles prepared by only wet-chemistry methods with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise NNm particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, NNm particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise NNiM particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, NNiM particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise hybrid NNm/wet-chemistry particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, hybrid NNm/wet-chemistry particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of different types of catalytically active material, for example, catalytically active material of different structures or different ratios of different catalytic metals, including but not limited to catalytically active material of different structures and different ratios of different catalytic metals. In other embodiments, the different types of catalytically active materials can be placed in different washcoats. For example, in some embodiments, a catalytic washcoat may comprise a mixture of catalytic particles prepared by only wet-chemistry methods with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, NNm particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of catalytic particles prepared by only wet-chemistry methods with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, NNiM particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of NNm particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, catalytic particles prepared by only wet-chemistry methods with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of NNm particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, NNiM particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of NNiM particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, catalytic particles prepared by only wet-chemistry methods with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of NNiM particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, NNm particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of hybrid NNm/wet-chemistry catalytic particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, NNm particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of hybrid NNm/wet-chemistry catalytic particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, NNiM particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of NNm particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, hybrid NNm/wet-chemistry catalytic particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of NNiM particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, hybrid NNm/wet-chemistry catalytic particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of hybrid NNm/wet-chemistry catalytic particles with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, catalytic particles prepared by only wet-chemistry methods with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

In some embodiments, a catalytic washcoat may comprise a mixture of catalytic particles prepared by only wet-chemistry methods with a mixture of platinum and palladium at a ratio, or range of ratios, of about 10:1 to about 100:1 Pt/Pd (weight/weight), or about 10:1 to about 40:1 Pt/Pd (weight/weight), or about 10:1 to about 30:1 Pt/Pd (weight/weight), or about 15:1 to about 25:1 Pt/Pd (weight/weight), or platinum and no palladium, and, in the same washcoat or a different washcoat, hybrid NNm/wet-chemistry catalytic particles with a mixture of platinum and palladium at a ratio, or range of ratios, of about 1:2 to about 8:1 Pt/Pd (weight/weight), or about 1:1 to about 5:1 Pt/Pd (weight/weight), or about 2:1 to about 4:1 Pt/Pd (weight/weight), or about 2:1 to about 8:1 Pt/Pd (weight/weight), or palladium and no platinum, or a catalyst comprising a weight ratio of platinum:palladium of about 20:1 and another catalyst comprising palladium, such that the combined catalysts comprise a weight ratio of 1:2 platinum:palladium to 8:1 platinum:palladium.

Any other combination of different types of catalytically active materials in the catalytic washcoat is contemplated by this disclosure.

In the following descriptions, the percentages of the components of the washcoat compositions are provided in terms of the amount of solids present in the washcoat compositions, as the washcoat compositions can be provided in an aqueous suspension or, in some instances, as dry powder.

In some embodiments, the catalytic washcoat composition further includes or “filler” particles, where the filler particles may be ceramic, metal oxide, or metallic particles. In some embodiments, the filler particles may be silica or a metal oxide (such as alumina, for example MI-386, and the like) or any mixture of silica or metal oxide particles in any proportion. In some embodiments, filler particles may comprise zeolite particles. In some embodiments, no zeolite particles or substantially no zeolite particles are present in the catalytic washcoat composition.

In some embodiments, the percentage of platinum group metal in the catalytic washcoat composition and catalytic layers ranges from between about 0.01 wt % to about 20 wt %, about 0.1 wt % to about 15 wt %, about 0.5 wt % to about 12 wt %, about 1 wt % to about 10 wt %, about 2 wt % to about 9 wt %, about 3 wt % to about 8 wt %, about 4 wt % to about 7 wt %, or about 5 wt % to about 7 wt %.

In some embodiments, the catalytic washcoat composition and catalytic layers comprise, consist essentially of, or consist of boehmite particles, filler particles, and catalytically active material (such as catalytic particles prepared by only wet-chemistry methods, NNm particles, or NNiM particles). In some embodiments, the catalytically active material makes up between about 35 wt % to about 92 wt % of the combination of the catalytically active material, the boehmite particles, and the filler particles in the catalytic washcoat composition or catalytic layer. In some embodiments, the catalytically active material makes up between about 40 wt % to about 92 wt % of the combination of the catalytically active material, the boehmite particles, and the filler particles in the catalytic washcoat composition or catalytic layer. In some embodiments, the catalytically active material makes up between about 60 wt % to about 95 wt % of the combination of the catalytically active material, the boehmite particles, and the filler particles in the catalytic washcoat composition or catalytic layer. In some embodiments, the catalytically active material makes up between about 80 wt % to about 95 wt % of the combination of the catalytically active material, the boehmite particles, and the filler particles in the catalytic washcoat composition or catalytic layer. In some embodiments, the catalytically active material makes up between about 80 wt % to about 92 wt % of the combination of the catalytically active material, the boehmite particles, and the filler particles in the catalytic washcoat composition or catalytic layer. In some embodiments, the catalytically active material makes up between about 35 wt % to about 95 wt % of the combination of the catalytically active material, the boehmite particles, and the filler particles in the catalytic washcoat composition or catalytic layer. In some embodiments, the catalytically active material makes up about 92 wt % of the combination of the catalytically active material, the boehmite particles, and the filler particles in the catalytic washcoat composition or catalytic layer. In some embodiments, the catalytically active material makes up about 95 wt % of the combination of the catalytically active material, the boehmite particles, and the filler particles in the catalytic washcoat composition or catalytic layer.

In some embodiments, the boehmite particles make up about 20 wt % or less of the combination of the catalytically active material, the boehmite particles, and the filler particles in the catalytic washcoat composition or catalytic layer. In some embodiments, the boehmite particles make up about 10 wt % or less of the combination of the catalytically active material, the boehmite particles, and the filler particles in the catalytic washcoat composition or catalytic layer. In some embodiments, the boehmite particles make up about 5 wt % or less of the combination of the catalytically active material, the boehmite particles, and the filler particles in the catalytic washcoat composition or catalytic layer. In some embodiments, the boehmite particles make up about 1 wt % or less of the combination of the catalytically active material, the boehmite particles, and the filler particles in the catalytic washcoat composition or catalytic layer. In various embodiments, the boehmite particles make up about 1 wt % to about 20 wt %, or about 1 wt % to about 10 wt %, or about 1 wt % to about 5 wt %, or about 2 wt % to about 5 wt % of the combination of the catalytically active material, the boehmite particles, and the filler particles in the catalytic washcoat composition or catalytic layer. In some embodiments, the boehmite particles make up about 1 wt % of the combination of the catalytically active material, the boehmite particles, and the filler particles in the catalytic washcoat composition or catalytic layer. In some embodiments, the boehmite particles make up about 2 wt % of the combination of the catalytically active material, the boehmite particles, and the filler particles in the catalytic washcoat composition or catalytic layer. In some embodiments, the boehmite particles make up about 3 wt % of the combination of the catalytically active material, the boehmite particles, and the filler particles in the catalytic washcoat composition or catalytic layer. In some embodiments, the boehmite particles make up about 4 wt % of the combination of the catalytically active material, the boehmite particles, and the filler particles in the catalytic washcoat composition or catalytic layer. In some embodiments, the boehmite particles make up about 5 wt % of the combination of the catalytically active material, the boehmite particles, and the filler particles in the catalytic washcoat composition or catalytic layer.

In some embodiments, the filler particles, such as alumina particles (for example, MI-386, or the like), make up about 65 wt % or less of the combination of the catalytically active material, the boehmite particles, and the filler particles in the catalytic washcoat composition or catalytic layer. In some embodiments, the filler particles, for example metal oxide particles such as alumina particles (for example, MI-386, or the like) or silica particles, make up about 65 wt % or less, about 60 wt % or less, about 55 wt % or less, about 50 wt % or less, about 45 wt % or less, about 40 wt % or less, about 35 wt % or less, about 30 wt % or less, about 25 wt % or less, about 20 wt % or less, about 15 wt % or less, about 10 wt % or less, about 8 wt % or less, about 5 wt % or less, or about 3 wt % or less, or about 2% or less of the combination of the catalytically active material, the boehmite particles, and the filler particles in the catalytic washcoat composition or catalytic layer. In some embodiments, the filler particles may make up a range of about 2% to about 65%, or about 2% to about 55%, or about 3% to about 45% or about 3% to about 35% or about 5% to about 25%. It is contemplated that the concentration ranges discussed above for the catalytically active material, the boehmite particles, and the filler particles in the catalytic washcoat composition or catalytic layer can be applied to combination differing types of filler particles.

In some embodiments, the catalyst-containing washcoat composition is mixed with water and acid, such as acetic acid, prior to the coating of the substrate with the catalyst-containing washcoat composition, thereby forming an aqueous mixture of the catalyst-containing washcoat composition, water, and acid. The washcoats can be made by mixing the solid ingredients (about 30% by weight) with water (about 70% by weight), and adding acetic acid to adjust the pH to about 4. The washcoat slurry can then be milled to arrive at an average particle size of about 4 μm to about 6 μm. This aqueous mixture of the catalyst-containing washcoat composition comprising one or more plasma-generated catalyst components, water, and acid is then applied to the substrate (where the substrate may or may not already have other washcoat layers applied to it). The washcoat can be coated onto the substrate by either dip-coating or vacuum coating. In some embodiments, the pH of this aqueous mixture is adjusted to a pH level of about 2 to about 7 prior to it being applied to the substrate. In some embodiments, the pH of this aqueous mixture is adjusted to a pH level of about 4 prior to it being applied to the substrate. In some embodiments, the viscosity of the aqueous washcoat is adjusted by mixing with a cellulose solution, with corn starch, or with similar thickeners. In some embodiments, the viscosity is adjusted to a value between about 300 cP to about 1200 cP. The washcoat can be aged for about 24 hours to about 48 hours after cellulose or corn starch addition. The substrate can optionally be pre-wetted prior to coating.

In some embodiments, the catalytic washcoat composition comprises a thickness of about 30 g/l to about 250 g/l, or of about 50 g/l to about 250 g/l, such as about 30 g/l to about 140 g/l, or about 30 g/l to about 70 g/l, or about 30 g/l to about 60 g/l, or about 40 g/l to about 70 g/l, or about 40 g/l to about 60 g/l, or about 40 g/l to about 50 g/l, or about 50 g/l to about 140 g/l, or about 70 g/l to approximately 140 g/l, or about 90 g/l to about 140 g/l, or about 110 g/l to about 130 g/l. In some embodiments, the catalytic washcoat composition comprises a thickness of about 30 g/l, of about 40 g/l, of about 50 g/l, about 60 g/l, about 70 g/l, approximately 80 g/l, about 90 g/l, about 100 g/l, about 110 g/l, about 120 g/l, approximately 130 g/l, or about 140 g/l. Preferably, the catalytic washcoat composition comprises a thickness of about 40 g/l, 50 g/l, 60 g/l, or 120 g/l.

### PNA Material Washcoat Compositions and PNA Layers

PNA material may be used to store nitrogen oxide gases during the cold start of an internal combustion engine. The PNA material can be applied to a substrate of a catalytic converter as part of a washcoat. The PNA material stores nitrogen oxide gases during low temperature engine operation. In some embodiments, the PNA material in the PNA material washcoat can comprise PGM on support particles; alkali oxide or alkaline earth oxide on support particles; alkali oxide or alkaline earth oxide and PGM on support particles; a combination of alkali oxide or alkaline earth oxide on support particles and different alkali oxides or alkaline earth oxides each on different support particles in any ratio; a combination of alkali oxide or alkaline earth oxide on support particles and PGM on support particles in any ratio; a combination of alkali oxide or alkaline earth oxide on support particles, different alkali oxides or alkaline earth oxides each on different support particles, and PGM on support particles in any ratio; a combination of alkali oxide or alkaline earth oxide and PGM on support particles and the same or different alkali oxides or alkaline earth oxides each on different support particles in any ratio; a combination of alkali oxide or alkaline earth oxide and PGM on support particles and PGM on support particles in any ratio; a combination of alkali oxide or alkaline earth oxide and PGM on support particles; the same or different alkali oxides or alkaline earth oxides each on different support particles; and PGM on support particles in any ratio. In addition, various other combinations of alkali oxides and alkaline earth oxides on support particles; PGM on support particles; and alkali oxides and alkaline earth oxides and PGM on support particles in any ratio can be employed, as discussed above.

In some embodiments, different PNA materials may not be mixed on a support material. For example, if a combination of manganese oxide on cerium oxide support and magnesium oxide on cerium oxide support is used, the manganese oxide is impregnated onto cerium oxide support material and set aside. Separately, magnesium oxide is then impregnated onto fresh cerium oxide support material. The manganese oxide/cerium oxide and magnesium oxide/cerium oxide are then combined in the desired ratio of the PNA material.

Support particles can include, for example, bulk refractory oxides such as alumina or cerium oxide. On example of cerium oxide includes HSA5, HSA20, or a mixture thereof from Rhodia. The cerium oxide particles may contain zirconium oxide. The cerium oxide particles may contain lanthanum and/or lanthanum oxide. In addition, the cerium oxide particles may contain both zirconium oxide and lanthanum oxide. The cerium oxide particles may also contain yttrium oxide. As such, the cerium oxide particles can include cerium oxide, cerium-zirconium oxide, cerium-lanthanum oxide, cerium-yttrium oxide, cerium-zirconium-lanthanum oxide, cerium-zirconium-yttrium oxide, cerium-lanthanum-yttrium oxide, cerium-zirconium-lanthanum-yttrium oxide particles, or a combination thereof. In some embodiments, the nano-sized cerium oxide particles contain 40-90 wt % cerium oxide, 5-60 wt % zirconium oxide, 1-15 wt % lanthanum oxide, and/or 1-10 wt % yttrium oxide. In one embodiment, the cerium oxide particles contain 86 wt % cerium oxide, 10 wt % zirconium oxide, and 4 wt % lanthanum and/or lanthanum oxide. In another embodiment, the cerium oxide particles contain 40 wt % cerium oxide, 50 wt % zirconium oxide, 5 wt % lanthanum oxide, and 5 wt % yttrium oxide.

Support particles can be micron-sized and/or nano-sized. Suitable micron-sized support particles include micron-sized cerium oxide particles including, but are not limited to, HSA5, HSA20, or a mixture thereof. In some embodiments, the support particles may include PGM in addition to alkali oxide or alkaline earth oxide particles or mixture thereof. The PGM can include ruthenium, platinum, palladium, or a mixture thereof. The alkali oxide or alkaline earth oxide particles can be nano-sized or micron-sized, as described above. In some embodiments, PGM are added to the micron-sized support particles using wet chemistry techniques. In some embodiments, PGM are added to the micron-sized support particles using incipient wetness techniques. In some embodiments, PGM are added to nano-sized support particles using incipient wetness and/or wet chemistry techniques. In some embodiments, PGM are added to support particles by plasma based methods described above to form composite PNA nanoparticles. In some embodiments, these PNA composite nanoparticles are added to carrier particles to form NNm PNA particles or are embedded within carrier particles to form NNiM PNA particles. As such, the PGM on support particles can include micro-PGM on micron support particles, nano-PGM on micron support particles, PNA nano-on-nano particles, PNA NNm particles, PNA NNiM particles, or PNA hybrid NNm/wet-chemistry particles described above. In some embodiments, the alkali oxide or alkaline earth oxide particles and PGM are on the same micron-sized support particle. In other embodiments, the alkali oxide or alkaline earth oxide particles and PGM are on different micron-sized support particles.

In some embodiments, the PNA layer and washcoat compositions comprise, consist essentially of, or consist of PNA material and boehmite particles. Different configurations of the weight concentrations of the PNA material and boehmite particles may be employed. In the following descriptions, the percentages of the components of the washcoat compositions are provided in terms of the amount of solids present in the washcoat compositions, as the washcoat compositions can be provided in an aqueous suspension or, in some instances, as dry powder. The PNA layer refers to the PNA washcoat composition after it has been applied to the substrate, dried, and calcined.

In some embodiments, the PNA material comprises at least 50%, comprise more than about 50%, or comprises about 50% to about 100% by weight of the combination of PNA material and boehmite particles in the PNA washcoat composition or PNA material layer. In some embodiments, the PNA material makes up approximately 60% to approximately 80%, for example, approximately 65% to approximately 70% or approximately 70% to approximately 80%, by weight of the combination of PNA material and boehmite particles in the PNA material particle-containing washcoat composition or PNA material layer. In some embodiments, the PNA material makes up approximately 90% to approximately 100%, for example, approximately 90% to approximately 95% or approximately 95% to approximately 100%, by weight of the combination of PNA material and boehmite particles in the PNA material particle-containing washcoat composition or PNA material layer. In some embodiments, the PNA material makes up approximately 95% to approximately 98% by weight of the combination of PNA material and boehmite particles in the PNA material particle-containing washcoat composition or PNA material layer.

In some embodiments, the PNA material comprises cerium oxide. In some embodiments, cerium oxide (which may include zirconium oxide, lanthanum, lanthanum oxide, yttrium oxide or a combination thereof) makes up approximately 57% to approximately 99% by weight of the combination of PNA material and boehmite particles in the PNA washcoat composition or PNA material layer. In some embodiments, cerium oxide (which may include zirconium oxide, lanthanum, lanthanum oxide, yttrium oxide or a combination thereof) makes up approximately 59% to approximately 98% by weight of the combination of PNA material and boehmite particles in the PNA washcoat composition or PNA material layer. In some embodiments, cerium oxide (which may include zirconium oxide, lanthanum, lanthanum oxide, yttrium oxide or a combination thereof) makes up approximately 85% to approximately 97% by weight of the combination of PNA material and boehmite particles in the PNA washcoat composition or PNA material layer. In some embodiments, cerium oxide (which may include zirconium oxide, lanthanum, lanthanum oxide, yttrium oxide or a combination thereof) makes up approximately 85% to approximately 88% by weight of the combination of PNA material and boehmite particles in the PNA washcoat composition or PNA material layer. In some embodiments, cerium oxide (which may include zirconium oxide, lanthanum, lanthanum oxide, yttrium oxide or a combination thereof) makes up approximately 90% to approximately 98% by weight of the combination of PNA material and boehmite particles in the PNA washcoat composition or PNA material layer. In some embodiments, cerium oxide (which may include zirconium oxide, lanthanum, lanthanum oxide, yttrium oxide, or a combination thereof) makes up approximately 93% to approximately 95% by weight of the combination of PNA material and boehmite particles in the PNA washcoat composition or PNA material layer.

In some embodiments, the boehmite particles make up approximately 1% to approximately 10% by weight of the combination of PNA material and boehmite particles in the PNA material-containing washcoat composition or PNA material layer. In some embodiments, the boehmite particles make up approximately 2% to approximately 5% by weight of the combination of PNA material and boehmite particles in the PNA material-containing washcoat composition or PNA material layer. In some embodiments, the boehmite particles make up approximately 3% by weight of the combination of PNA material particles and boehmite particles in the PNA material-containing washcoat composition or PNA material layer.

In one embodiment, palladium is used in an amount of from about 0.01% to about 5% (by weight) of the amount of cerium oxide used in the PNA washcoat composition or layer. (As described above, in all embodiments, the cerium oxide can include zirconium oxide, lanthanum, lanthanum oxide yttrium oxide, or a combination thereof). In one embodiment, palladium is used in an amount of from about 0.5% to about 3% (by weight) of the amount of cerium oxide used in the PNA washcoat composition or layer. In one embodiment, palladium is used in an amount of from about 0.67% to about 2.67% (by weight) of the amount of cerium oxide used in the PNA washcoat composition or layer. In another embodiment, the amount of cerium oxide used in the PNA washcoat composition or layer is from about 50 g/L to about 400 g/L. In another embodiment, the amount of cerium oxide used in the PNA washcoat composition or layer is from about 100 g/L to about 350 g/L. In another embodiment, the amount of cerium oxide used in the PNA washcoat composition or layer is from about 150 g/L to about 300 g/L. In another embodiment, the amount of cerium oxide used in the PNA washcoat composition or layer is greater than or equal to about 150 g/L. In another embodiment, Pd is used in an amount of from about 1.5% to about 2.5% (by weight) of the amount of cerium oxide used in the PNA washcoat composition or layer, and the amount of cerium oxide used is from about 100 g/L to about 200 g/L. In another embodiment, Pd is used in an amount of from about 0.5% to about 1.5% (by weight) of the amount of cerium oxide used in the PNA washcoat composition or layer, and the amount of cerium oxide used is from about 250 g/L to about 350 g/L. In another embodiment, Pd is used in an amount of from about 1% to about 2% (by weight) of the amount of cerium oxide used in the PNA washcoat composition or layer, and the amount of cerium oxide used is greater than or equal to about 150 g/L. In another embodiment, Pd is used in an amount of about 2% (by weight) of the amount of cerium oxide used in the PNA washcoat composition or layer, and the amount of cerium oxide used is greater than or equal to about 150 g/L. In another embodiment, Pd is used in an amount of about 1% (by weight) of the amount of cerium oxide used in the PNA washcoat composition or layer, and the amount of cerium oxide used is greater than or equal to about 300 g/L. In another embodiment, Pd is used in an amount of about 1 g/L to about 5 g/L. In another embodiment, Pd is used in an amount of about 2 g/L to about 4 g/L. In another embodiment, Pd is used in an amount of about 3 g/L. In another embodiment, Pd is used in an amount of about 1 g/L to about 5 g/L, and the amount of cerium oxide used in the PNA washcoat composition or layer is from about 100 g/L to about 350 g/L. In another embodiment, Pd is used in an amount of about 2 g/L to about 4 g/L, and the amount of cerium oxide used in the PNA washcoat composition or layer is from about 100 g/L to about 350 g/L. In another embodiment, Pd is used in an amount of about 3 g/L, and the amount of cerium oxide used in the PNA washcoat composition or layer is from about 150 g/L to about 300 g/L. In another embodiment, Pd is used in an amount of about 1 g/L to about 5 g/L, and the amount of cerium oxide used in the PNA washcoat composition or layer is from greater than or equal to about 150 g/L. In another embodiment, Pd is used in an amount of about 2 g/L to about 4 g/L, and the amount of cerium oxide used in the PNA washcoat composition or layer is from greater than or equal to about 150 g/L. In another embodiment, Pd is used in an amount of about 3 g/L, and the amount of cerium oxide used in the PNA washcoat composition or layer is from greater than or equal to about 150 g/L. The PNA washcoat composition or layer can include Pd in larger (cooler) engine systems (e.g., greater than 2.5 Liters).

In one embodiment, ruthenium is used in an amount of from about 0.01% to about 15% (by weight) of the amount of cerium oxide used in the PNA washcoat composition or layer. (As described above, in all embodiments, the cerium oxide can include zirconium oxide, lanthanum, lanthanum oxide yttrium oxide, or a combination thereof). In one embodiment, ruthenium is used in an amount of from about 0.5% to about 12% (by weight) of the amount of cerium oxide used in the PNA washcoat composition or layer. In one embodiment, ruthenium is used in an amount of from about 1% to about 10% (by weight) of the amount of cerium oxide used in the PNA washcoat composition or layer. In another embodiment, the amount of cerium oxide used in the PNA washcoat composition or layer is from about 50 g/L to about 400 g/L. In another embodiment, the amount of cerium oxide used in the PNA washcoat composition or layer is from about 100 g/L to about 350 g/L. In another embodiment, the amount of cerium oxide used in the PNA washcoat composition or layer is from about 150 g/L to about 300 g/L. In another embodiment, the amount of cerium oxide used in the PNA washcoat composition or layer is greater than or equal to about 150 g/L. In another embodiment, the amount of cerium oxide used in the PNA washcoat composition or layer is greater than or equal to about 300 g/L. In another embodiment, Ru is used in an amount of from about 3% to about 4.5% (by weight) of the amount of cerium oxide used in the PNA washcoat composition or layer, and the amount of cerium oxide used is from about 100 g/L to about 200 g/L. In another embodiment, Ru is used in an amount of from about 1% to about 2.5% (by weight) of the amount of cerium oxide used in the PNA washcoat composition or layer, and the amount of cerium oxide used is from about 250 g/L to about 350 g/L. In another embodiment, Ru is used in an amount of from about 1.67% to about 4% (by weight) of the amount of cerium oxide used in the PNA washcoat composition or layer, and the amount of cerium oxide used is greater than or equal to about 150 g/L. In another embodiment, Ru is used in an amount of from about 1.67% to about 4% (by weight) of the amount of cerium oxide used in the PNA washcoat composition or layer, and the amount of cerium oxide used is greater than or equal to about 300 g/L. In another embodiment, Ru is used in an amount of about 3.33% to about 4% (by weight) of the amount of cerium oxide used in the PNA washcoat composition or layer, and the amount of cerium oxide used is greater than or equal to about 150 g/L. In another embodiment, Ru is used in an amount of about 1.67% to about 2% (by weight) of the amount of cerium oxide used in the PNA washcoat composition or layer, and the amount of cerium oxide used is greater than or equal to about 300 g/L. In another embodiment, Ru is used in an amount of about 1 g/L to about 20 g/L. In another embodiment, Ru is used in an amount of about 3 g/L to about 15 g/L. In another embodiment, Ru is used in an amount of about 4 g/L to about 8 g/L. In another embodiment, Ru is used in an amount of about 5 g/L to about 6 g/L. In another embodiment, Ru is used in an amount of about 1 g/L to about 20 g/L, and the amount of cerium oxide used in the PNA washcoat composition or layer is from about 100 g/L to about 350 g/L. In another embodiment, Ru is used in an amount of about 3 g/L to about 15 g/L, and the amount of cerium oxide used in the PNA washcoat composition or layer is from about 100 g/L to about 350 g/L. In another embodiment, Ru is used in an amount of about 4 g/L to about 8 g/L, and the amount of cerium oxide used in the PNA washcoat composition or layer is from about 100 g/L to about 350 g/L. In another embodiment, Ru is used in an amount of about 5 g/L to about 6 g/L, and the amount of cerium oxide used in the PNA washcoat composition or layer is from about 150 g/L to about 350 g/L. In another embodiment, Ru is used in an amount of about 1 g/L to about 20 g/L, and the amount of cerium oxide used in the PNA washcoat composition or layer is from greater than or equal to about 150 g/L. In another embodiment, Ru is used in an amount of about 3 g/L to about 15 g/L, and the amount of cerium oxide used in the PNA washcoat composition or layer is from greater than or equal to about 150 g/L. In another embodiment, Ru is used in an amount of about 4 g/L to about 8 g/L, and the amount of cerium oxide used in the PNA washcoat composition or layer is from greater than or equal to about 150 g/L. In another embodiment, Ru is used in an amount of about 5 g/L to about 6 g/L, and the amount of cerium oxide used in the PNA washcoat composition or layer is from greater than or equal to about 150 g/L. In another embodiment, Ru is used in an amount of about 1 g/L to about 20 g/L, and the amount of cerium oxide used in the PNA washcoat composition or layer is from greater than or equal to about 300 g/L. In another embodiment, Ru is used in an amount of about 3 g/L to about 15 g/L, and the amount of cerium oxide used in the PNA washcoat composition or layer is from greater than or equal to about 300 g/L. In another embodiment, Ru is used in an amount of about 4 g/L to about 8 g/L, and the amount of cerium oxide used in the PNA washcoat composition or layer is from greater than or equal to about 300 g/L. In another embodiment, Ru is used in an amount of about 5 g/L to about 6 g/L, and the amount of cerium oxide used in the PNA washcoat composition or layer is from greater than or equal to about 300 g/L. The PNA washcoat composition or layer can include Ru in small (hotter) engine systems (e.g., less than 2 Liters).

In one embodiment, MgO is used in an amount of from about 1% to about 20% (by weight) of the amount of the cerium oxide used in the washcoat or layer. In one embodiment, MgO is used in an amount of from about 1% to about 15% (by weight) of the amount of the cerium oxide used in the washcoat or layer. In one embodiment, MgO is used in an amount of from about 1% to about 10% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, MgO is used in an amount of from about 2% to about 8% (by weight) of the amount of the cerium oxide used in the washcoat or layer, and the amount of cerium oxide used is from about 150 g/L to about 350 g/L. In another embodiment, MgO is used in an amount of from about 2% to about 4% (by weight) of the amount of the cerium oxide used in the washcoat or layer, and the amount of cerium oxide used is from about 250 g/L to about 350 g/L. In another embodiment, MgO is used in an amount of from about 6% to about 8% (by weight) of the amount of the cerium oxide used in the washcoat or layer, and the amount of cerium oxide used is from about 150 g/L to about 250 g/L. In another embodiment, MgO is used in an amount of about 3% (by weight) of the amount of the cerium oxide used in the washcoat or layer, and the amount of cerium oxide used is about 350 g/L. In another embodiment, MgO is used in an amount of about 7% (by weight) of the amount of the cerium oxide used in the washcoat or layer, and the amount of cerium oxide used is about 150 g/L. In another embodiment, MgO is used in an amount of about 10.5 g/L, and the amount of cerium oxide used in the washcoat or layer is from about 150 g/L to about 350 g/L.

In one embodiment, Mn₃O₄ is used in an amount of from about 1% to about 30% (by weight) of the amount of the cerium oxide used in the washcoat or layer. In one embodiment, Mn₃O₄ is used in an amount of from about 1% to about 25% (by weight) of the amount of the cerium oxide used in the washcoat or layer. In one embodiment, Mn₃O₄ is used in an amount of from about 1% to about 20% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, Mn₃O₄ is used in an amount of from about 5% to about 20% (by weight) of the amount of the cerium oxide used in the washcoat or layer, and the amount of cerium oxide used is from about 150 g/L to about 350 g/L. In another embodiment, Mn₃O₄ is used in an amount of from about 5% to about 10% (by weight) of the amount of the cerium oxide used in the washcoat or layer, and the amount of cerium oxide used is from about 250 g/L to about 350 g/L. In another embodiment, Mn₃O₄ is used in an amount of from about 15% to about 20% (by weight) of the amount of the cerium oxide used in the washcoat or layer, and the amount of cerium oxide used is from about 150 g/L to about 250 g/L. In another embodiment, Mn₃O₄ is used in an amount of about 8% (by weight) of the amount of the cerium oxide used in the washcoat or layer, and the amount of cerium oxide used is about 350 g/L. In another embodiment, Mn₃O₄ is used in an amount of about 18.67% (by weight) of the amount of the cerium oxide used in the washcoat or layer, and the amount of cerium oxide used is about 150 g/L. In another embodiment, Mn₃O₄ is used in an amount of about 28 g/L, and the amount of cerium oxide used in the washcoat or layer is from about 150 g/L to about 350 g/L.

In one embodiment, calcium oxide is used in an amount of from about 1% to about 20% (by weight) of the amount of the cerium oxide used in the washcoat or layer. In one embodiment, calcium oxide is used in an amount of from about 1% to about 15% (by weight) of the amount of the cerium oxide used in the washcoat or layer. In one embodiment, calcium oxide is used in an amount of from about 1% to about 10% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, calcium oxide is used in an amount of from about 2% to about 8% (by weight) of the amount of the cerium oxide used in the washcoat or layer, and the amount of cerium oxide used is from about 150 g/L to about 350 g/L. In another embodiment, calcium oxide is used in an amount of from about 2% to about 4% (by weight) of the amount of the cerium oxide used in the washcoat or layer, and the amount of cerium oxide used in the washcoat or layer is from about 250 g/L to about 350 g/L. In another embodiment, calcium oxide is used in an amount of from about 6% to about 8% (by weight) of the amount of the cerium oxide used in the washcoat or layer, and the amount of cerium oxide used is from about 150 g/L to about 250 g/L. In another embodiment, calcium oxide is used in an amount of about 3% (by weight) of the amount of the cerium oxide used in the washcoat or layer, and the amount of cerium oxide used is about 350 g/L. In another embodiment, calcium oxide is used in an amount of about 7% (by weight) of the amount of the cerium oxide used in the washcoat or layer, and the amount of cerium oxide used is about 150 g/L. In another embodiment, calcium oxide is used in an amount of about 10.5 g/L, and the amount of cerium oxide used in the washcoat or layer is from about 150 g/L to about 350 g/L.

In one embodiment, MgO is used in an amount of about 10.5 g/L, Mn₃O₄ is used in an amount of about 28 g/L, calcium oxide is used in an amount of about 10.5 g/L, and the amount of cerium oxide used in the washcoat or layer is from about 150 g/L to about 350 g/L.

In some embodiments, the PNA washcoat composition or layer-containing washcoat composition or PNA material does not comprise any platinum group metals. As discussed above, the six platinum group metals include ruthenium, rhodium, palladium, osmium, iridium, and platinum. (PGM is often referred to catalyst metals). In some embodiments, the PNA material-containing washcoat composition or PNA material is characterized by a substantial absence of any platinum group metals. In some embodiments, the PNA material-containing washcoat composition or PNA material layer is 100% free of any platinum group metals. In some embodiments, the PNA material containing washcoat composition or PNA material layer is approximately 100% free of any platinum group metals. In some embodiments, the PNA material-containing washcoat composition or PNA material layer does not comprise any catalytic particles. In some embodiments, the PNA material particle-containing washcoat composition or PNA material layer is characterized by a substantial absence of any catalytic particles. In some embodiments, the PNA material particle-containing washcoat composition or PNA material layer is 100% free of any catalytic particles. In some embodiments, the PNA material particle-containing washcoat composition or PNA material layer is approximately 100% free of any catalytic particles.

As discussed above, in other embodiments, the PNA material washcoat may contain PGM. In some embodiments, the PNA material is loaded with about 1 g/L to about 20 g/L of PGM. In another embodiment, the PNA material is loaded with about 1 g/L to about 15 g/L of PGM. In another embodiment, the PNA material is loaded with about 6.0 g/L and less of PGM. In another embodiment, the PNA material is loaded with about 5.0 g/L and less of PGM. In another embodiment, the PNA material is loaded with about 4.0 g/L and less of PGM. In another embodiment, the PNA material is loaded with about 3.0 g/L and less of PGM. In another embodiment, the PNA material is loaded with about 2 g/L to about 4 g/L Pd. In another embodiment, the PNA material is loaded with about 3 g/L Pd. In another embodiment, the PNA material is loaded with about 3 g/L to about 15 g/L Ru. In another embodiment, the PNA material is loaded with about 5 g/L to about 6 g/L Ru.

PGM can be added to the support particles using wet chemistry techniques described above. PGM can also be added to the support particles using incipient wetness techniques described above. PGM can be added to support particles using plasma based methods described above. In some embodiments, the PNA material washcoat includes support particles impregnated with alkali oxide or alkaline earth oxide particles and separate PGM particles, including, for example, NNm or NNiM particles. In some embodiments, the micro-sized particles of the PGM NNm and NNiM particles can be the micron-sized supports impregnated with alkali oxide or alkaline earth oxide particles. In some embodiments, the micro-sized particles of the PGM NNm can be impregnated with alkali oxide or alkaline earth oxide particles. In one embodiment, the NNm particles are nano-platinum group metals supported on nano-cerium oxide, wherein the nano-on-nano particles are supported on micron-sized cerium oxide. In another embodiment, the NNiM particles are nano-sized platinum group metals supported on nano-sized cerium oxide. In some embodiments, the platinum group metal is Pt, Pd, Ru, or a mixture thereof. In some embodiments, the alkali oxide or alkaline earth oxide particles and PGM are on the same support particle. In other embodiments, the alkali oxide or alkaline earth oxide particles and PGM are on different support particles. The support particles can also be aluminum oxide.

The composite nanoparticles for use as components of the PNA washcoat or layer can be produced by plasma-based methods as described above.

In some embodiments, the support particles may contain a mixture of 2:1 to 100:1 platinum to palladium. In some embodiments, the support particles may contain a mixture of 2:1 to 75:1 platinum to palladium. In some embodiments, the support particles may contain a mixture of 2:1 to 50:1 platinum to palladium. In some embodiments, the support particles may contain a mixture of 2:1 to 25:1 platinum to palladium. In some embodiments, the support particles may contain a mixture of 2:1 to 15:1 platinum to palladium. In some embodiments, the support particles may contain a mixture of 2:1 to 10:1 platinum to palladium. In some embodiments, the support particles may contain a mixture of 2:1 platinum to palladium, or approximately 2:1 platinum to palladium. In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

In some embodiments, the PNA material-containing washcoat composition or PNA material layer may include zeolites.

In some embodiments, the PNA material-containing washcoat composition is mixed with water and acid, such as acetic acid, prior to coating of a substrate with the PNA material-containing washcoat composition, thereby forming an aqueous mixture of the PNA material-containing washcoat composition, water, and acid. This aqueous mixture of the PNA material-containing washcoat composition, water, and acid may then be applied to the substrate (where the substrate may or may not already have other washcoat layers applied to it). In some embodiments, the pH of this aqueous mixture may be adjusted to a pH level of about 2 to about 7 prior to it being applied to the substrate. In some embodiments, the pH of this aqueous mixture may be adjusted to a pH level of about 4 prior to it being applied to the substrate.

The washcoat layers can include materials that are less active or inert to exhausts. Such materials can be incorporated as supports for the reactive catalysts or to provide surface area for the metals. In some embodiments, the catalyst-containing washcoat composition further includes “spacer” or “filler” particles, where the spacer particles may, for example, be ceramic, metal oxide, or metallic particles. In some embodiments, the spacer particles may be boehmite.

### PNA Material/Zeolite Washcoat Compositions and PNA/Zeolite Layers

The PNA material and zeolite particles can be applied to a substrate of a catalytic converter as part of the same washcoat. Both the PNA material and the zeolite particles can be used to trap hazardous gases during cold start of an internal combustion engine.

In some embodiments, the PNA material and the zeolite particles layer (P/Z layer) and washcoat compositions comprise, consist essentially of, or consist of PNA material, zeolite particles, boehmite particles, and metal-oxide particles. The metal-oxide particles are preferably porous. The metal-oxide particles may be aluminum-oxide particles (e.g., MI-386 from Grace Davison or the like) or cerium oxide particles. The aluminum-oxide particles may be porous. Different configurations of the weight concentrations of the PNA material, zeolite particles, boehmite particles, and metal-oxide particles may be employed. In the following descriptions, the percentages of the components of the washcoat compositions are provided in terms of the amount of solids present in the washcoat compositions, as the washcoat compositions can be provided in an aqueous suspension or, in some instances, as dry powder. The P/Z layer refers to the P/Z washcoat composition after it has been applied to the substrate, dried, and calcined.

In some embodiments, the PNA material and zeolite particles comprise at least 50%, comprise more than about 50%, or comprise about 50% to about 100% by weight of the combination of PNA material, zeolite particles, boehmite particles, and metal-oxide particles in the P/Z washcoat composition or P/Z 1 layer. In some embodiments, the PNA material and zeolite particles make up approximately 60% to approximately 80%, for example, approximately 65% to approximately 70% or approximately 70% to approximately 80%, by weight of the combination of PNA material, zeolite particles, boehmite particles, and metal-oxide particles in the P/Z-containing washcoat composition or P/Z layer.

In some embodiments, the boehmite particles make up approximately 1% to approximately 10% by weight of the combination of PNA material, zeolite particles, boehmite particles, and metal-oxide particles in the P/Z-containing washcoat composition or P/Z layer. In some embodiments, the boehmite particles make up approximately 2% to approximately 5% by weight of the combination of PNA material, zeolite particles, boehmite particles, and metal-oxide particles in the P/Z-containing washcoat composition or P/Z layer. In some embodiments, the boehmite particles make up approximately 3% by weight of the combination of PNA material, zeolite particles, boehmite particles, and metal-oxide particles in the P/Z-containing washcoat composition or P/Z layer.

In one embodiment, palladium is used in an amount of from about 0.01% to about 5% (by weight) of the amount of cerium oxide used in the PNA washcoat composition or layer. (As described above, in all embodiments, the cerium oxide can include zirconium oxide, lanthanum, lanthanum oxide yttrium oxide, or a combination thereof). In one embodiment, palladium is used in an amount of from about 0.5% to about 3% (by weight) of the amount of cerium oxide used in the PNA washcoat composition or layer. In one embodiment, palladium is used in an amount of from about 0.67% to about 2.67% (by weight) of the amount of cerium oxide used in the PNA washcoat composition or layer. In another embodiment, the amount of cerium oxide used in the PNA washcoat composition or layer is from about 50 g/L to about 400 g/L. In another embodiment, the amount of cerium oxide used in the PNA washcoat composition or layer is from about 100 g/L to about 350 g/L. In another embodiment, the amount of cerium oxide used in the PNA washcoat composition or layer is from about 150 g/L to about 300 g/L. In another embodiment, the amount of cerium oxide used in the PNA washcoat composition or layer is greater than or equal to about 150 g/L. In another embodiment, Pd is used in an amount of from about 1.5% to about 2.5% (by weight) of the amount of cerium oxide used in the PNA washcoat composition or layer, and the amount of cerium oxide used is from about 100 g/L to about 200 g/L. In another embodiment, Pd is used in an amount of from about 0.5% to about 1.5% (by weight) of the amount of cerium oxide used in the PNA washcoat composition or layer, and the amount of cerium oxide used is from about 250 g/L to about 350 g/L. In another embodiment, Pd is used in an amount of from about 1% to about 2% (by weight) of the amount of cerium oxide used in the PNA washcoat composition or layer, and the amount of cerium oxide used is greater than or equal to about 150 g/L. In another embodiment, Pd is used in an amount of about 2% (by weight) of the amount of cerium oxide used in the PNA washcoat composition or layer, and the amount of cerium oxide used is greater than or equal to about 150 g/L. In another embodiment, Pd is used in an amount of about 1% (by weight) of the amount of cerium oxide used in the PNA washcoat composition or layer, and the amount of cerium oxide used is greater than or equal to about 300 g/L. In another embodiment, Pd is used in an amount of about 1 g/L to about 5 g/L. In another embodiment, Pd is used in an amount of about 2 g/L to about 4 g/L. In another embodiment, Pd is used in an amount of about 3 g/L. In another embodiment, Pd is used in an amount of about 1 g/L to about 5 g/L, and the amount of cerium oxide used in the PNA washcoat composition or layer is from about 100 g/L to about 350 g/L. In another embodiment, Pd is used in an amount of about 2 g/L to about 4 g/L, and the amount of cerium oxide used in the PNA washcoat composition or layer is from about 100 g/L to about 350 g/L. In another embodiment, Pd is used in an amount of about 3 g/L, and the amount of cerium oxide used in the PNA washcoat composition or layer is from about 150 g/L to about 300 g/L. In another embodiment, Pd is used in an amount of about 1 g/L to about 5 g/L, and the amount of cerium oxide used in the PNA washcoat composition or layer is from greater than or equal to about 150 g/L. In another embodiment, Pd is used in an amount of about 2 g/L to about 4 g/L, and the amount of cerium oxide used in the PNA washcoat composition or layer is from greater than or equal to about 150 g/L. In another embodiment, Pd is used in an amount of about 3 g/L, and the amount of cerium oxide used in the PNA washcoat composition or layer is from greater than or equal to about 150 g/L. The PNA washcoat composition or layer can include Pd in larger (cooler) engine systems (e.g., greater than 2.5 Liters).

In one embodiment, ruthenium is used in an amount of from about 0.01% to about 15% (by weight) of the amount of cerium oxide used in the PNA washcoat composition or layer. (As described above, in all embodiments, the cerium oxide can include zirconium oxide, lanthanum, lanthanum oxide yttrium oxide, or a combination thereof). In one embodiment, ruthenium is used in an amount of from about 0.5% to about 12% (by weight) of the amount of cerium oxide used in the PNA washcoat composition or layer. In one embodiment, ruthenium is used in an amount of from about 1% to about 10% (by weight) of the amount of cerium oxide used in the PNA washcoat composition or layer. In another embodiment, the amount of cerium oxide used in the PNA washcoat composition or layer is from about 50 g/L to about 400 g/L. In another embodiment, the amount of cerium oxide used in the PNA washcoat composition or layer is from about 100 g/L to about 350 g/L. In another embodiment, the amount of cerium oxide used in the PNA washcoat composition or layer is from about 150 g/L to about 300 g/L. In another embodiment, the amount of cerium oxide used in the PNA washcoat composition or layer is greater than or equal to about 150 g/L. In another embodiment, the amount of cerium oxide used in the PNA washcoat composition or layer is greater than or equal to about 300 g/L. In another embodiment, Ru is used in an amount of from about 3% to about 4.5% (by weight) of the amount of cerium oxide used in the PNA washcoat composition or layer, and the amount of cerium oxide used is from about 100 g/L to about 200 g/L. In another embodiment, Ru is used in an amount of from about 1% to about 2.5% (by weight) of the amount of cerium oxide used in the PNA washcoat composition or layer, and the amount of cerium oxide used is from about 250 g/L to about 350 g/L. In another embodiment, Ru is used in an amount of from about 1.67% to about 4% (by weight) of the amount of cerium oxide used in the PNA washcoat composition or layer, and the amount of cerium oxide used is greater than or equal to about 150 g/L. In another embodiment, Ru is used in an amount of from about 1.67% to about 4% (by weight) of the amount of cerium oxide used in the PNA washcoat composition or layer, and the amount of cerium oxide used is greater than or equal to about 300 g/L. In another embodiment, Ru is used in an amount of about 3.33% to about 4% (by weight) of the amount of cerium oxide used in the PNA washcoat composition or layer, and the amount of cerium oxide used is greater than or equal to about 150 g/L. In another embodiment, Ru is used in an amount of about 1.67% to about 2% (by weight) of the amount of cerium oxide used in the PNA washcoat composition or layer, and the amount of cerium oxide used is greater than or equal to about 300 g/L. In another embodiment, Ru is used in an amount of about 1 g/L to about 20 g/L. In another embodiment, Ru is used in an amount of about 3 g/L to about 15 g/L. In another embodiment, Ru is used in an amount of about 4 g/L to about 8 g/L. In another embodiment, Ru is used in an amount of about 5 g/L to about 6 g/L. In another embodiment, Ru is used in an amount of about 1 g/L to about 20 g/L, and the amount of cerium oxide used in the PNA washcoat composition or layer is from about 100 g/L to about 350 g/L. In another embodiment, Ru is used in an amount of about 3 g/L to about 15 g/L, and the amount of cerium oxide used in the PNA washcoat composition or layer is from about 100 g/L to about 350 g/L. In another embodiment, Ru is used in an amount of about 4 g/L to about 8 g/L, and the amount of cerium oxide used in the PNA washcoat composition or layer is from about 100 g/L to about 350 g/L. In another embodiment, Ru is used in an amount of about 5 g/L to about 6 g/L, and the amount of cerium oxide used in the PNA washcoat composition or layer is from about 150 g/L to about 350 g/L. In another embodiment, Ru is used in an amount of about 1 g/L to about 20 g/L, and the amount of cerium oxide used in the PNA washcoat composition or layer is from greater than or equal to about 150 g/L. In another embodiment, Ru is used in an amount of about 3 g/L to about 15 g/L, and the amount of cerium oxide used in the PNA washcoat composition or layer is from greater than or equal to about 150 g/L. In another embodiment, Ru is used in an amount of about 4 g/L to about 8 g/L, and the amount of cerium oxide used in the PNA washcoat composition or layer is from greater than or equal to about 150 g/L. In another embodiment, Ru is used in an amount of about 5 g/L to about 6 g/L, and the amount of cerium oxide used in the PNA washcoat composition or layer is from greater than or equal to about 150 g/L. In another embodiment, Ru is used in an amount of about 1 g/L to about 20 g/L, and the amount of cerium oxide used in the PNA washcoat composition or layer is from greater than or equal to about 300 g/L. In another embodiment, Ru is used in an amount of about 3 g/L to about 15 g/L, and the amount of cerium oxide used in the PNA washcoat composition or layer is from greater than or equal to about 300 g/L. In another embodiment, Ru is used in an amount of about 4 g/L to about 8 g/L, and the amount of cerium oxide used in the PNA washcoat composition or layer is from greater than or equal to about 300 g/L. In another embodiment, Ru is used in an amount of about 5 g/L to about 6 g/L, and the amount of cerium oxide used in the PNA washcoat composition or layer is from greater than or equal to about 300 g/L. The PNA washcoat composition or layer can include Ru in small (hotter) engine systems (e.g., less than 2 Liters).

In one embodiment, MgO is used in an amount of from about 1% to about 20% (by weight) of the amount of the cerium oxide used in the washcoat or layer. In one embodiment, MgO is used in an amount of from about 1% to about 15% (by weight) of the amount of the cerium oxide used in the washcoat or layer. In one embodiment, MgO is used in an amount of from about 1% to about 10% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, MgO is used in an amount of from about 2% to about 8% (by weight) of the amount of the cerium oxide used in the washcoat or layer, and the amount of cerium oxide used is from about 150 g/L to about 350 g/L. In another embodiment, MgO is used in an amount of from about 2% to about 4% (by weight) of the amount of the cerium oxide used in the washcoat or layer, and the amount of cerium oxide used is from about 250 g/L to about 350 g/L. In another embodiment, MgO is used in an amount of from about 6% to about 8% (by weight) of the amount of the cerium oxide used in the washcoat or layer, and the amount of cerium oxide used is from about 150 g/L to about 250 g/L. In another embodiment, MgO is used in an amount of about 3% (by weight) of the amount of the cerium oxide used in the washcoat or layer, and the amount of cerium oxide used is about 350 g/L. In another embodiment, MgO is used in an amount of about 7% (by weight) of the amount of the cerium oxide used in the washcoat or layer, and the amount of cerium oxide used is about 150 g/L. In another embodiment, MgO is used in an amount of about 10.5 g/L, and the amount of cerium oxide used in the washcoat or layer is from about 150 g/L to about 350 g/L.

In one embodiment, Mn₃O₄ is used in an amount of from about 1% to about 30% (by weight) of the amount of the cerium oxide used in the washcoat or layer. In one embodiment, Mn₃O₄ is used in an amount of from about 1% to about 25% (by weight) of the amount of the cerium oxide used in the washcoat or layer. In one embodiment, Mn₃O₄ is used in an amount of from about 1% to about 20% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, Mn₃O₄ is used in an amount of from about 5% to about 20% (by weight) of the amount of the cerium oxide used in the washcoat or layer, and the amount of cerium oxide used is from about 150 g/L to about 350 g/L. In another embodiment, Mn₃O₄ is used in an amount of from about 5% to about 10% (by weight) of the amount of the cerium oxide used in the washcoat or layer, and the amount of cerium oxide used is from about 250 g/L to about 350 g/L. In another embodiment, Mn₃O₄ is used in an amount of from about 15% to about 20% (by weight) of the amount of the cerium oxide used in the washcoat or layer, and the amount of cerium oxide used is from about 150 g/L to about 250 g/L. In another embodiment, Mn₃O₄ is used in an amount of about 8% (by weight) of the amount of the cerium oxide used in the washcoat or layer, and the amount of cerium oxide used is about 350 g/L. In another embodiment, Mn₃O₄ is used in an amount of about 18.67% (by weight) of the amount of the cerium oxide used in the washcoat or layer, and the amount of cerium oxide used is about 150 g/L. In another embodiment, Mn₃O₄ is used in an amount of about 28 g/L, and the amount of cerium oxide used in the washcoat or layer is from about 150 g/L to about 350 g/L.

In one embodiment, calcium oxide is used in an amount of from about 1% to about 20% (by weight) of the amount of the cerium oxide used in the washcoat or layer. In one embodiment, calcium oxide is used in an amount of from about 1% to about 15% (by weight) of the amount of the cerium oxide used in the washcoat or layer. In one embodiment, calcium oxide is used in an amount of from about 1% to about 10% (by weight) of the amount of the cerium oxide used in the washcoat or layer. In another embodiment, the amount of cerium oxide used in the washcoat or layer is from about 50 g/L to about 450 g/L. In another embodiment, the amount of cerium oxide used in the washcoat or layer is from about 100 g/L to about 400 g/L. In another embodiment, the amount of cerium oxide used in the washcoat or layer is from about 150 g/L to about 350 g/L. In another embodiment, calcium oxide is used in an amount of from about 2% to about 8% (by weight) of the amount of the cerium oxide used in the washcoat or layer, and the amount of cerium oxide used is from about 150 g/L to about 350 g/L. In another embodiment, calcium oxide is used in an amount of from about 2% to about 4% (by weight) of the amount of the cerium oxide used in the washcoat or layer, and the amount of cerium oxide used in the washcoat or layer is from about 250 g/L to about 350 g/L. In another embodiment, calcium oxide is used in an amount of from about 6% to about 8% (by weight) of the amount of the cerium oxide used in the washcoat or layer, and the amount of cerium oxide used is from about 150 g/L to about 250 g/L. In another embodiment, calcium oxide is used in an amount of about 3% (by weight) of the amount of the cerium oxide used in the washcoat or layer, and the amount of cerium oxide used is about 350 g/L. In another embodiment, calcium oxide is used in an amount of about 7% (by weight) of the amount of the cerium oxide used in the washcoat or layer, and the amount of cerium oxide used is about 150 g/L. In another embodiment, calcium oxide is used in an amount of about 10.5 g/L, and the amount of cerium oxide used in the washcoat or layer is from about 150 g/L to about 350 g/L.

In one embodiment, MgO is used in an amount of about 10.5 g/L, Mn₃O₄ is used in an amount of about 28 g/L, calcium oxide is used in an amount of about 10.5 g/L, and the amount of cerium oxide used in the washcoat or layer is from about 150 g/L to about 350 g/L.

In some embodiments, the metal-oxide particles make up approximately 15% to approximately 38%, for example, approximately 15% to approximately 30%, approximately 17% to approximately 23% or approximately 17% to approximately 22%, by weight of the mixture of PNA material particles, zeolite particles, metal-oxide particles, and boehmite particles in the P/Z-containing washcoat composition or P/Z layer. In some embodiments, the metal-oxide particles make up approximately 15% to approximately 23% by weight of the mixture of PNA material, zeolite particles, metal-oxide particles, and boehmite particles in the P/Z-containing washcoat composition or P/Z layer. In some embodiments, the metal-oxide particles make up approximately 25% to approximately 35% by weight of the mixture of PNA material, zeolite particles, metal-oxide particles, and boehmite particles in the P/Z-containing washcoat composition or P/Z layer. In some embodiments, the P/Z containing washcoat composition or P/Z layer contains about 3% boehmite particles, about 67% PNA material and zeolite particles, and about 30% porous aluminum-oxide particles.

In some embodiments, the P/Z-containing washcoat composition or P/Z does not comprise any platinum group metals. As discussed above, the six platinum group metals include ruthenium, rhodium, palladium, osmium, iridium, and platinum. In some embodiments, the P/Z containing washcoat composition or P/Z is characterized by a substantial absence of any platinum group metals. In some embodiments, the P/Z-containing washcoat composition or P/Z layer is 100% free of any platinum group metals. In some embodiments, the P/Z containing washcoat composition or P/Z layer is approximately 100% free of any platinum group metals. In some embodiments, the P/Z-containing washcoat composition or P/Z layer does not comprise any catalytic particles. In some embodiments, the P/Z particle-containing washcoat composition or P/Z layer is characterized by a substantial absence of any catalytic particles. In some embodiments, the P/Z-containing washcoat composition or P P/Z layer is 100% free of any catalytic particles. In some embodiments, the P/Z containing washcoat composition or P/Z layer is approximately 100% free of any catalytic particles.

In other embodiments, the P/Z washcoat may comprise PGM. In some embodiments, the PNA material is loaded with about 1 g/L to about 20 g/L of PGM. In another embodiment, the PNA material is loaded with about 1 g/L to about 15 g/L of PGM. In another embodiment, the PNA material is loaded with about 6.0 g/L and less of PGM. In another embodiment, the PNA material is loaded with about 5.0 g/L and less of PGM. In another embodiment, the PNA material is loaded with about 4.0 g/L and less of PGM. In another embodiment, the PNA material is loaded with about 3.0 g/L and less of PGM. In another embodiment, the PNA material is loaded with about 2 g/L to about 4 g/L Pd. In another embodiment, the PNA material is loaded with about 3 g/L Pd. In another embodiment, the PNA material is loaded with about 3 g/L to about 15 g/L Ru. In another embodiment, the PNA material is loaded with about 5 g/L to about 6 g/L Ru.

PGM can be added to the support particles using wet chemistry techniques described above. PGM can also be added to the support particles using incipient wetness techniques described above. PGM can be added to support particles using plasma based methods described above. In some embodiments, the PNA material washcoat includes support particles impregnated with alkali oxide or alkaline earth oxide particles and separate PGM particles, including, for example, NNm or NNiM particles. In some embodiments, the micro-sized particles of the PGM NNm and NNiM particles can be the micron-sized supports impregnated with alkali oxide or alkaline earth oxide particles. In some embodiments, the micro-sized particles of the PGM NNm can be impregnated with alkali oxide or alkaline earth oxide particles. In one embodiment, the NNm particles are nano-platinum group metals supported on nano-cerium oxide, wherein the nano-on-nano particles are supported on micron-sized cerium oxide. In another embodiment, the NNiM particles are nano-sized platinum group metals supported on nano-sized cerium oxide. In some embodiments, the platinum group metal is Pt, Pd, Ru, or a mixture thereof. In some embodiments, the alkali oxide or alkaline earth oxide particles and PGM are on the same support particle. In other embodiments, the alkali oxide or alkaline earth oxide particles and PGM are on different support particles. The support particles can also be aluminum oxide.

The composite nanoparticles for use as components of the P/Z washcoat or layer can be produced by plasma-based methods as described above.

In some embodiments, the support particles may contain a mixture of 2:1 to 100:1 platinum to palladium. In some embodiments, the support particles may contain a mixture of 2:1 to 75:1 platinum to palladium. In some embodiments, the support particles may contain a mixture of 2:1 to 50:1 platinum to palladium. In some embodiments, the support particles may contain a mixture of 2:1 to 25:1 platinum to palladium. In some embodiments, the support particles may contain a mixture of 2:1 to 15:1 platinum to palladium. In some embodiments, the support particles may contain a mixture of 2:1 to 10:1 platinum to palladium. In some embodiments, the support particles may contain a mixture of 2:1 platinum to palladium, or approximately 2:1 platinum to palladium. In some embodiments, the support particles may contain a mixture of 2:1 to 20:1 platinum to palladium. In some embodiments, the support particles may contain a mixture of 5:1 to 15:1 platinum to palladium. In some embodiments, the support particles may contain a mixture of 8:1 to 12:1 platinum to palladium. In some embodiments, the support particles may contain a mixture of 10:1 platinum to palladium, or approximately 10:1 platinum to palladium. In some embodiments, the support particles may contain a mixture of 2:1 to 8:1 platinum to palladium. In some embodiments, the support particles may contain a mixture of 3:1 to 5:1 platinum to palladium. In some embodiments, the support particles may contain a mixture of 4:1 platinum to palladium, or approximately 4:1 platinum to palladium.

In some embodiments, the P/Z-containing washcoat composition or P/Z layer may include by weight about 2% to about 5% boehmite particles, about 60% to about 80% PNA material and zeolite particles, and the rest porous aluminum-oxide particles (i.e., about 15% to about 38%). In one embodiment, the P/Z containing washcoat composition or P/Z layer includes by weight about 2% to about 5% boehmite particles, about 75% to about 80% PNA material and zeolite particles, and the rest porous aluminum-oxide particles (i.e., about 15% to about 23%). In another embodiments, the P/Z containing washcoat composition or P/Z 1 layer includes by weight about 2% to about 5% boehmite particles, about 65% to about 70% PNA material and zeolite particles, and the rest porous aluminum-oxide particles (i.e., about 25% to about 33%). In some embodiment, the P/Z containing washcoat composition or P/Z layer contains about 3% boehmite particles, about 67% PNA material and zeolite particles, and about 30% porous aluminum-oxide particles. In some embodiments, the P/Z containing washcoat composition or P/Z layer does not contain any catalytic material. In some embodiments, the P/Z containing washcoat composition or P/Z layer does not contain any platinum group metals.

In some embodiments, the P/Z containing washcoat composition is mixed with water and acid, such as acetic acid, prior to coating of a substrate with the P/Z containing washcoat composition, thereby forming an aqueous mixture of the P/Z containing washcoat composition, water, and acid. This aqueous mixture of the P/Z containing washcoat composition, water, and acid may then be applied to the substrate (where the substrate may or may not already have other washcoat layers applied to it). In some embodiments, the pH of this aqueous mixture may be adjusted to a pH level of about 2 to about 7 prior to it being applied to the substrate. In some embodiments, the pH of this aqueous mixture may be adjusted to a pH level of about 4 prior to it being applied to the substrate.

The washcoat layers can include materials that are less active or inert to exhausts. Such materials can be incorporated as supports for the reactive catalysts or to provide surface area for the metals. In some embodiments, the catalyst-containing washcoat composition further includes “spacer” or “filler” particles, where the spacer particles may, for example, be ceramic, metal oxide, or metallic particles. In some embodiments, the spacer particles may be boehmite.

### PNA Material/Zeolite/Catalytically Active Washcoat Compositions and PNA/Zeolite/Catalyst Layers

The PNA material, zeolite particles, and catalytically active material can be applied to a substrate of a catalytic converter as part of the same washcoat, thereby eliminating the need for multiple washcoats. In other embodiments, the PNA material, zeolite particles, and catalytically active material can be applied to a substrate of a catalytic converter in multiple layered washcoats. In other embodiments, the PNA material, zeolite particles, and catalytically active material can be applied to a substrate of a catalytic converter in separate zones (different regions of the substrate), so that overlap between washcoat layers can be adjusted, minimized, or eliminated. Both the PNA material and the zeolite particles can be used to trap hazardous gases during cold start of an internal combustion engine and the catalytically active particles can oxidize the hazardous gases when they are released from the zeolites and PNA material.

In some embodiments, the PNA material and the zeolite particles layer (P/Z layer) and washcoat compositions comprise, consist essentially of, or consist of PNA material, zeolite particles, boehmite particles, metal-oxide particles, silica particles, alumina/sealant particles with or without BaO, and NNm particles. The compositions of the zeolite particles, PNA material, and catalytically active particles can be any of those described above.

### Some Example Washcoat Formulations

Several embodiments are described herein for illustrative purposes. The Catalytic Layer, Zeolite Layer, and PNA Layer can be applied in different zones of the substrate, in order to minimize or eliminate overlap between the layers. The Corner Fill Layer may also be applied to specific zones. However, the Corner Fill Layer is typically applied to the entire substrate prior to application of any other layers, whether the other layers are applied to the entire substrate or to specific zones of the substrate.

Table 3 lists exemplary embodiments of the washcoat formulations that can be applied to any zone of the substrate. Specifically, the composition of the various washcoat layers (Corner Fill Layer, Catalytic Layer (which comprises one or more plasma-generated catalyst components), and Zeolite Layer) are provided. Iron-exchanged zeolite is indicated as “Zeolite (Fe)”, while non-iron-exchanged zeolite is simply indicated as “Zeolite.” In addition, all of the washcoat configurations below and listed in Table 3 can contain a PNA layer or PNA material in the various washcoat formulations.

In some embodiments, the washcoat layers are formulated as follows: 1) the Corner Fill Layer is comprised of alumina, 2) the Catalytic Layer comprising one or more plasma-generated catalyst components is comprised of MI-386 support particles bearing composite catalytic nanoparticles, where the catalytic nanoparticles comprise a platinum/palladium alloy, and 3) the Zeolite Layer is comprised of zeolite particles. In other embodiments, the washcoat layers are formulated as follows: 1) the Corner Fill Layer is comprised of alumina, 2) the Catalytic Layer comprising one or more plasma-generated catalyst components is comprised of MI-386 support particles bearing composite catalytic nanoparticles, where the catalytic nanoparticles comprise a platinum/palladium alloy, and 3) the Zeolite Layer is comprised of iron-exchanged zeolite particles. In further embodiments, the washcoat layers are formulated as follows: 1) the Corner Fill Layer is comprised of alumina, 2) the Catalytic Layer comprising one or more plasma-generated catalyst components is comprised of MI-386 support particles bearing composite catalytic nanoparticles, where the catalytic nanoparticles comprise a platinum/palladium alloy, and 3) the Zeolite Layer is comprised of zeolite particles impregnated with palladium. In still further embodiments, the washcoat layers are formulated as follows: 1) the Corner Fill Layer is comprised of alumina, 2) the Catalytic Layer comprising one or more plasma-generated catalyst components is comprised of MI-386 support particles bearing composite catalytic nanoparticles, where the catalytic nanoparticles comprise a platinum/palladium alloy, and 3) the Zeolite Layer is comprised of iron-exchanged zeolite particles comprising palladium.

In some embodiments, the washcoat layers are formulated as follows: 1) the Corner Fill Layer is comprised of alumina, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles. In other embodiments, the washcoat layers are formulated as follows: 1) the Corner Fill Layer is comprised of alumina, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles. In further embodiments, the washcoat layers are formulated as follows: 1) the Corner Fill Layer is comprised of alumina, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles impregnated with palladium. In still other embodiments, the washcoat layers are formulated as follows: 1) the Corner Fill Layer is comprised of alumina, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles comprising palladium.

In some embodiments, the washcoat layers are formulated as follows: 1) the Corner Fill Layer is comprised of alumina, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles. In other embodiments, the washcoat layers are formulated as follows: 1) the Corner Fill Layer is comprised of alumina, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles. In further embodiments, the washcoat layers are formulated as follows: 1) the Corner Fill Layer is comprised of alumina, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles impregnated with palladium. In yet other embodiments, the washcoat layers are formulated as follows: 1) the Corner Fill Layer is comprised of alumina, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles comprising palladium.

In some embodiments, the washcoat layers are formulated as follows: 1) the Corner Fill Layer is comprised of zeolite particles impregnated with palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles. In other embodiments, the washcoat layers are formulated as follows: 1) the Corner Fill Layer is comprised of zeolite particles impregnated with palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles. In further embodiments, the washcoat layers are formulated as follows: 1) the Corner Fill Layer is comprised of zeolite particles impregnated with palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles impregnated with palladium. In still other embodiments, the washcoat layers are formulated as follows: 1) the Corner Fill Layer is comprised of zeolite particles impregnated with palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles comprising palladium.

In some embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles. In other embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles. In further embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles impregnated with palladium. In yet further embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles comprising palladium.

In some embodiments, the washcoat layers are formulated as follows: 1) the Corner Fill Layer is comprised of zeolite particles impregnated with palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles. In other embodiments, the washcoat layers are formulated as follows: 1) the Corner Fill Layer is comprised of zeolite particles impregnated with palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles. In further embodiments, the washcoat layers are formulated as follows: 1) the Corner Fill Layer is comprised of zeolite particles impregnated with palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles impregnated with palladium. In still further embodiments, the washcoat layers are formulated as follows: 1) the Corner Fill Layer is comprised of zeolite particles impregnated with palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles comprising palladium.

In some embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles. In other embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles. In further embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles impregnated with palladium. In still other embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles comprising palladium.

In some embodiments, the washcoat layers are formulated as follows: 1) the Corner Fill Layer is comprised of zeolite particles, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles. In other embodiments, the washcoat layers are formulated as follows: 1) the Corner Fill Layer is comprised of zeolite particles, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles. In further embodiments, the washcoat layers are formulated as follows: 1) the Corner Fill Layer is comprised of zeolite particles, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles impregnated with palladium. In yet other embodiments, the washcoat layers are formulated as follows: 1) the Corner Fill Layer is comprised of zeolite particles, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles comprising palladium.

In some embodiments, the washcoat layers are formulated as follows: 1) the Corner Fill Layer is comprised of iron-exchanged zeolite particles, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles. In other embodiments, the washcoat layers are formulated as follows: 1) the Corner Fill Layer is comprised of iron-exchanged zeolite particles, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles. In further embodiments, the washcoat layers are formulated as follows: 1) the Corner Fill Layer is comprised of iron-exchanged zeolite particles, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles impregnated with palladium. In yet other embodiments, the washcoat layers are formulated as follows: 1) the Corner Fill Layer is comprised of iron-exchanged zeolite particles, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles comprising palladium.

In some embodiments, the washcoat layers are formulated as follows: 1) the Corner Fill Layer is comprised of zeolite particles, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles. In other embodiments, the washcoat layers are formulated as follows: 1) the Corner Fill Layer is comprised of zeolite particles, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles. In further embodiments, the washcoat layers are formulated as follows: 1) the Corner Fill Layer is comprised of zeolite particles, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles impregnated with palladium. In still further embodiments, the washcoat layers are formulated as follows: 1) the Corner Fill Layer is comprised of zeolite particles, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles comprising palladium.

In some embodiments, the washcoat layers are formulated as follows: 1) the Corner Fill Layer is comprised of iron-exchanged zeolite particles, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles. In other embodiments, the washcoat layers are formulated as follows: 1) the Corner Fill Layer is comprised of iron-exchanged zeolite particles, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles. In further embodiments, the washcoat layers are formulated as follows: 1) the Corner Fill Layer is comprised of iron-exchanged zeolite particles, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles impregnated with palladium. In still further embodiments, the washcoat layers are formulated as follows: 1) the Corner Fill Layer is comprised of iron-exchanged zeolite particles, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles comprising palladium.

In some embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of MI-386 support particles bearing composite catalytic nanoparticles, where the catalytic nanoparticles comprise a platinum/palladium alloy, and 3) the Zeolite Layer is comprised of zeolite particles. In other embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of MI-386 support particles bearing composite catalytic nanoparticles, where the catalytic nanoparticles comprise a platinum/palladium alloy, and 3) the Zeolite Layer is comprised of iron-exchanged zeolite particles. In further embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of MI-386 support particles bearing composite catalytic nanoparticles, where the catalytic nanoparticles comprise a platinum/palladium alloy, and 3) the Zeolite Layer is comprised of zeolite particles impregnated with palladium. In other embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of MI-386 support particles bearing composite catalytic nanoparticles, where the catalytic nanoparticles comprise a platinum/palladium alloy, and 3) the Zeolite Layer is comprised of iron-exchanged zeolite particles comprising palladium.

In some embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles. In other embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles. In further embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles impregnated with palladium. In yet other embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles comprising palladium.

In some embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles. In other embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles. In some embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles impregnated with palladium. In some embodiments, the washcoat layers are formulated as follows: 1) the Corner Fill Layer is comprised of MI-386 support particles bearing composite catalytic nanoparticles, where the catalytic nanoparticles comprise a platinum/palladium alloy, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles comprising palladium.

In some embodiments, the washcoat layers are formulated as follows: 1) the Corner Fill Layer is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles. In other embodiments, the washcoat layers are formulated as follows: 1) the Corner Fill Layer is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles. In further embodiments, the washcoat layers are formulated as follows: 1) the Corner Fill Layer is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles impregnated with palladium. In still other embodiments, the washcoat layers are formulated as follows: 1) the Corner Fill Layer is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles comprising palladium.

In some embodiments, the washcoat layers are formulated as follows: 1) the Corner Fill Layer is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles. In other embodiments, the washcoat layers are formulated as follows: 1) the Corner Fill Layer is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles. In further embodiments, the washcoat layers are formulated as follows: 1) the Corner Fill Layer is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of zeolite particles impregnated with palladium. In yet further embodiments, the washcoat layers are formulated as follows: 1) the Corner Fill Layer is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, 2) the Catalytic Layer comprising one or more plasma-generated catalyst components is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, and 3) the Zeolite Layer is comprised of iron-exchanged zeolite particles comprising palladium.

In some embodiments, the washcoat layers are formulated as follows: 1) the Corner Fill Layer is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles. In other embodiments, the washcoat layers are formulated as follows: 1) the Corner Fill Layer is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles. In further embodiments, the washcoat layers are formulated as follows: 1) the Corner Fill Layer is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles impregnated with palladium. In yet other embodiments, the washcoat layers are formulated as follows: 1) the Corner Fill Layer is comprised of a population of micron-sized support particles bearing composite catalytic nanoparticles, where the population of particles is comprised of MI-386 support particles bearing composite catalytic nanoparticles comprising a platinum/palladium alloy, and MI-386 support particles bearing composite catalytic nanoparticles comprising palladium, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles comprising palladium.

In some embodiments, the washcoat layers are formulated as follows: 1) the Corner Fill Layer is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles. In other embodiments, the washcoat layers are formulated as follows: 1) the Corner Fill Layer is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles. In further embodiments, the washcoat layers are formulated as follows: 1) the Corner Fill Layer is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of zeolite particles impregnated with palladium. In some embodiments, the washcoat layers are formulated as follows: 1) the Corner Fill Layer is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, 2) the Catalytic Layer comprising one or more plasma-generated catalyst components is comprised of a population of micron-sized particles, where the population of particles is comprised of MI-386 support particles bearing composite catalytic nanoparticles, where the catalytic nanoparticles comprise a platinum/palladium alloy, and MI-386 particles impregnated with palladium by wet chemical methods, and 3) the Zeolite Layer is comprised of iron-exchanged zeolite particles comprising palladium.

In some embodiments, the washcoat layers are formulated as follows: 1) the Corner Fill Layer is comprised of alumina, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of zeolite particles. In other embodiments, the washcoat layers are formulated as follows: 1) the Corner Fill Layer is comprised of alumina, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of iron-exchanged zeolite particles.

In some embodiments, the washcoat layers are formulated as follows: 1) the Corner Fill Layer is comprised of zeolite particles impregnated with palladium, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of zeolite particles. In other embodiments, the washcoat layers are formulated as follows: 1) the Corner Fill Layer is comprised of zeolite particles impregnated with palladium, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of iron-exchanged zeolite particles. In further embodiments, the washcoat layers are formulated as follows: 1) the Corner Fill Layer is comprised of zeolite particles impregnated with palladium, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of zeolite particles impregnated with palladium. In still other embodiments, the washcoat layers are formulated as follows: 1) the Corner Fill Layer is comprised of zeolite particles impregnated with palladium, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of iron-exchanged zeolite particles comprising palladium.

In some embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of zeolite particles. In other embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of iron-exchanged zeolite particles. In further embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of zeolite particles impregnated with palladium. In yet further embodiments, the washcoat layers are formulated as follows: 1) the Corner Fill Layer is comprised of iron-exchanged zeolite particles comprising palladium, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of iron-exchanged zeolite particles comprising palladium.

In some embodiments, the washcoat layers are formulated as follows: 1) the Corner Fill Layer is comprised of zeolite particles, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of zeolite particles impregnated with palladium. In other embodiments, the washcoat layers are formulated as follows: 1) the Corner Fill Layer is comprised of zeolite particles, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of iron-exchanged zeolite particles comprising palladium.

In some embodiments, the washcoat layers are formulated as follows: 1) the Corner Fill Layer is comprised of iron-exchanged zeolite particles, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of zeolite particles impregnated with palladium. In other embodiments, the washcoat layers are formulated as follows: 1) the Corner Fill Layer is comprised of iron-exchanged zeolite particles, 2) the Catalytic Layer comprising one or more plasma-generated catalyst components is comprised of MI-386 support particles bearing composite catalytic nanoparticles, where the catalytic nanoparticles comprise platinum, and 3) the Zeolite Layer is comprised of iron-exchanged zeolite particles comprising palladium.

In some embodiments, the washcoat layers are formulated as follows: 1) the Corner Fill Layer is comprised of MI-386 support particles bearing composite catalytic nanoparticles, where the catalytic nanoparticles comprise platinum, 2) the Catalytic Layer comprising one or more plasma-generated catalyst components is comprised of a population of micron-sized support particles, where the population of particles is comprised of MI-386 support particles bearing composite catalytic nanoparticles comprising platinum, and MI-386 support particles bearing composite catalytic nanoparticles comprising palladium, and 3) the Zeolite Layer is comprised of zeolite particles. In other embodiments, the washcoat layers are formulated as follows: 1) the Corner Fill Layer is comprised of MI-386 support particles bearing composite catalytic nanoparticles, where the catalytic nanoparticles comprise platinum, 2) the Catalytic Layer comprising one or more plasma-generated catalyst components is comprised of a population of micron-sized support particles, where the population of particles is comprised of MI-386 support particles bearing composite catalytic nanoparticles comprising platinum, and MI-386 support particles bearing composite catalytic nanoparticles comprising palladium, and 3) the Zeolite Layer is comprised of iron-exchanged zeolite particles. In further embodiments, the washcoat layers are formulated as follows: 1) the Corner Fill Layer is comprised of MI-386 support particles bearing composite catalytic nanoparticles, where the catalytic nanoparticles comprise platinum, 2) the Catalytic Layer comprising one or more plasma-generated catalyst components is comprised of a population of micron-sized support particles, where the population of particles is comprised of MI-386 support particles bearing composite catalytic nanoparticles comprising platinum, and MI-386 support particles bearing composite catalytic nanoparticles comprising palladium, and 3) the Zeolite Layer is comprised of zeolite particles impregnated with palladium. In still further embodiments, the washcoat layers are formulated as follows: 1) the Corner Fill Layer is comprised of MI-386 support particles bearing composite catalytic nanoparticles, where the catalytic nanoparticles comprise platinum, 2) the Catalytic Layer comprising one or more plasma-generated catalyst components is comprised of a population of micron-sized support particles, where the population of particles is comprised of MI-386 support particles bearing composite catalytic nanoparticles comprising platinum, and MI-386 support particles bearing composite catalytic nanoparticles comprising palladium, and 3) the Zeolite Layer is comprised of iron-exchanged zeolite particles comprising palladium.

In some embodiments, the washcoat layers are formulated as follows: 1) the Corner Fill Layer is comprised of MI-386 support particles bearing composite catalytic nanoparticles, where the catalytic nanoparticles comprise platinum, 2) the Catalytic Layer comprising one or more plasma-generated catalyst components is comprised of a population of micron-sized support particles, where the population of particles is comprised of MI-386 support particles bearing composite catalytic nanoparticles comprising platinum, and MI-386 particles impregnated with palladium, and 3) the Zeolite Layer is comprised of zeolite particles. In other embodiments, the washcoat layers are formulated as follows: 1) the Corner Fill Layer is comprised of MI-386 support particles bearing composite catalytic nanoparticles, where the catalytic nanoparticles comprise platinum, 2) the Catalytic Layer comprising one or more plasma-generated catalyst components is comprised of a population of micron-sized support particles, where the population of particles is comprised of MI-386 support particles bearing composite catalytic nanoparticles comprising platinum, and MI-386 particles impregnated with palladium, and 3) the Zeolite Layer is comprised of iron-exchanged zeolite particles. In further embodiments, the washcoat layers are formulated as follows: 1) the Corner Fill Layer is comprised of MI-386 support particles bearing composite catalytic nanoparticles, where the catalytic nanoparticles comprise platinum, 2) the Catalytic Layer comprising one or more plasma-generated catalyst components is comprised of a population of micron-sized support particles, where the population of particles is comprised of MI-386 support particles bearing composite catalytic nanoparticles comprising platinum, and MI-386 particles impregnated with palladium, and 3) the Zeolite Layer is comprised of zeolite particles impregnated with palladium. In yet other embodiments, the washcoat layers are formulated as follows: 1) the Corner Fill Layer is comprised of MI-386 support particles bearing composite catalytic nanoparticles, where the catalytic nanoparticles comprise platinum, 2) the Catalytic Layer comprising one or more plasma-generated catalyst components is comprised of a population of micron-sized support particles, where the population of particles is comprised of MI-386 support particles bearing composite catalytic nanoparticles comprising platinum, and MI-386 particles impregnated with palladium, and 3) the Zeolite Layer is comprised of iron-exchanged zeolite particles comprising palladium.

In any of the foregoing embodiments of the washcoat layer formulations, the ratio of the total amount of platinum to palladium in the combined washcoat layers ranges from 8:1 to 1:1. In some embodiments, the ratio of the total amount of platinum/palladium in the combined washcoat layers is 4:1.

### Catalytic Converters and Methods of Producing Catalytic Converters

In some embodiments, the disclosure provides for catalytic converters, which can comprise any of the washcoat layers, washcoat zones, and washcoat configurations described herein. The catalytic converters are useful in a variety of applications, such as in diesel vehicles, including light-duty or heavy-duty diesel vehicles.

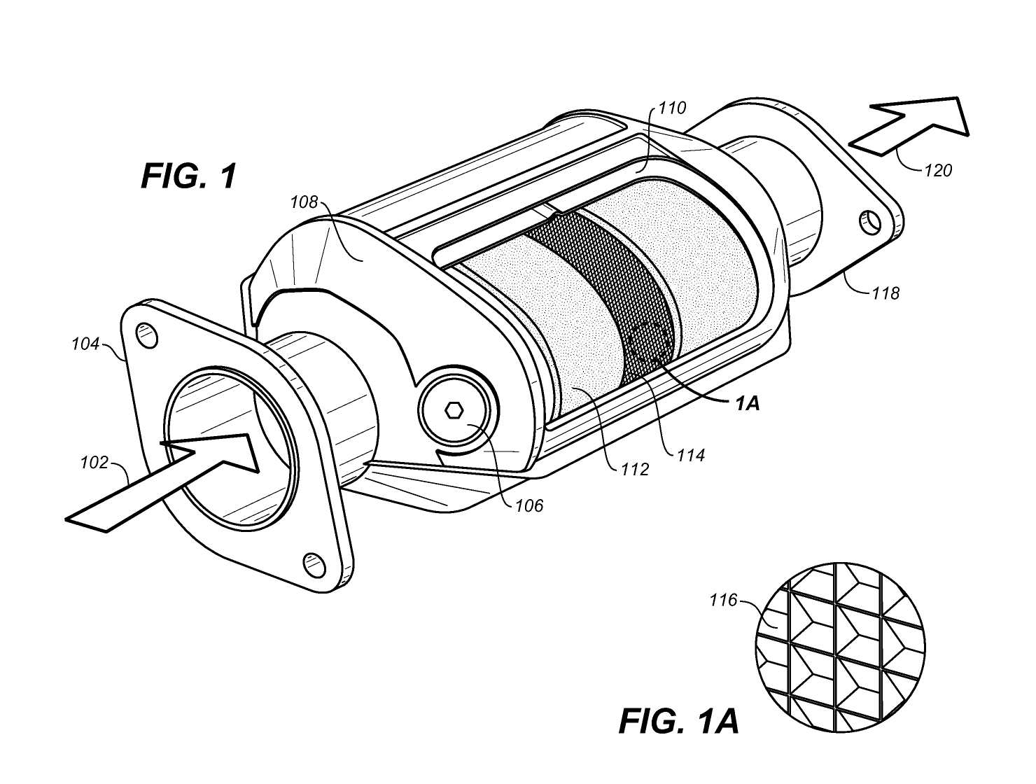

FIG. 1 illustrates a catalytic converter in accordance with some embodiments. Catalytically active material is included in a washcoat composition, which is coated onto a substrate to form a coated substrate. The substrate can be a zone coated substrate 114. The coated substrate 114 is enclosed within an insulating material 112, which in turn is enclosed within a metallic container 110 (of, for example, stainless steel). A heat shield 108 and a gas sensor (for example, an oxygen sensor) 106 are depicted. The catalytic converter may be affixed to the exhaust system of the vehicle through flanges 104 and 118. The exhaust gas, which includes the raw emissions of hydrocarbons, carbon monoxide, and nitrogen oxides, enters the catalytic converter at 102. As the raw emissions pass through the catalytic converter, they react with the catalytically active material on the coated substrate, resulting in tailpipe emissions of water, carbon dioxide, and nitrogen exiting at 120. FIG. 1A is a magnified view of a section of the coated substrate 114, which shows the honeycomb structure of the coated substrate. The coated substrates, which are discussed in further detail below, may be incorporated into a catalytic converter for use in a vehicle emissions control system.

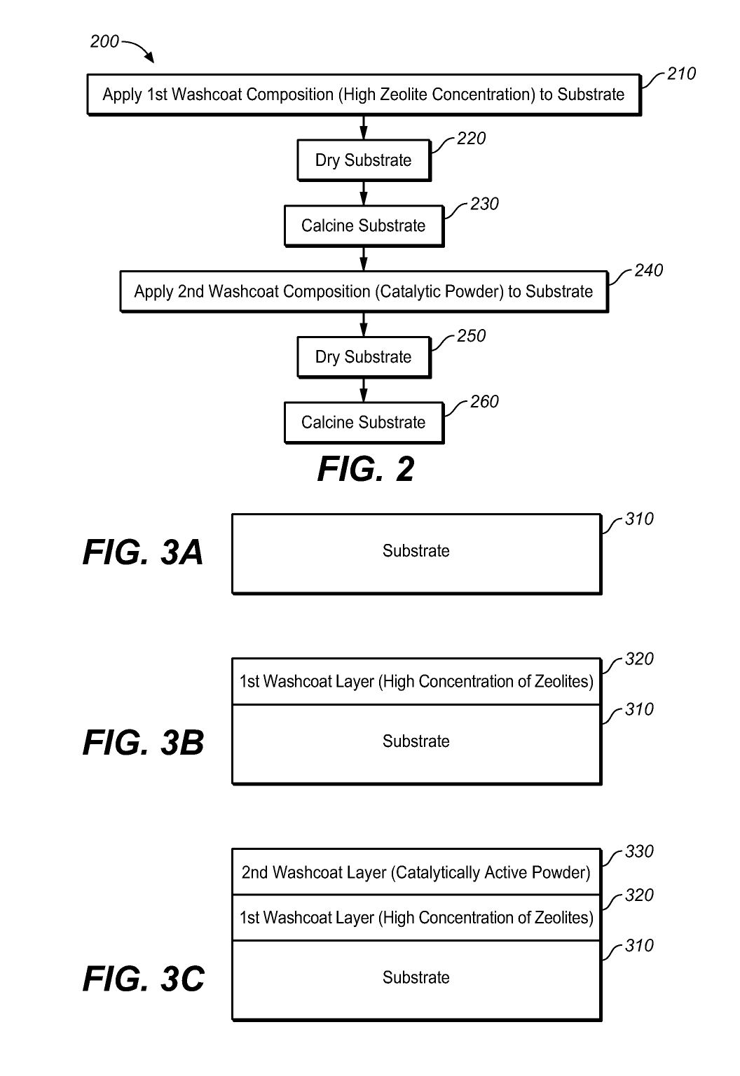

FIGS. 2-3, 5-8, 12-14, and 22 illustrate various methods of forming coated substrates for use in a catalytic converter. Any of the catalyst-containing washcoats, zeolite particle-containing washcoats, or PNA material washcoats disclosed herein can be used in these illustrative methods. Any of the corner-fill washcoats disclosed herein can be used in any of the illustrative methods where a corner-fill washcoat is used. In addition, layers or washcoats can be added to or removed from the substrates in any order.

FIG. 2 illustrates a method 200 of forming a coated substrate in accordance with some embodiments of the present disclosure. The method comprises coating a substrate with a zeolite particle-containing washcoat composition, wherein the zeolite particle-containing washcoat composition comprises zeolite particles in high concentration; and coating the resulting coated substrate with a catalyst-containing washcoat composition, wherein the catalyst washcoat composition can include one or more plasma-generated catalyst components to form the coated substrate, wherein the catalyst-containing washcoat composition comprises catalytic powder. Preferably, a drying process and a calcining process are performed between each coating step. This configuration is designated S-Z-C (substrate-zeolite layer-catalyst layer).

At step 210, a first washcoat composition, a zeolite particle-containing composition, is applied to a substrate in order to coat the substrate with a first washcoat layer. Preferably, the substrate comprises, consists essentially of, or consists of cordierite and comprises a honeycomb structure. However, it is contemplated that the substrate can be formed from other materials and in other configurations as well, as discussed herein.

At step 220, a first drying process is performed on the substrate. Examples of such drying processes include, but are not limited to, a hot-drying process, or a flash drying process.

At step 230, a first calcining process is performed on the substrate. It is contemplated that the length and temperature of the calcination process can vary depending on the characteristics of the components in a particular embodiment.

At step 240, a second washcoat composition, a catalyst-containing washcoat composition, comprising one or more plasma-generated catalyst components, is applied to the substrate in order to coat the first washcoat layer with a second washcoat layer.

At step 250, a second drying process is performed on the substrate. Examples of such drying processes include, but are not limited to, a hot-drying process, or a flash drying process.

At step 260, a second calcining process is performed on the substrate. It is contemplated that the length and temperature of the calcination process can vary depending on the characteristics of the components in a particular embodiment.

After the second calcining process, the coated substrate includes a first layer and a second layer on its surface. The first layer includes a high concentration of zeolites. The second layer, disposed over the first layer, includes catalytic material. This method illustrates the production of the Substrate-Zeolite Particles-Catalytic Powder configuration (S-Z-C) without additional washcoat layers; the method can be readily modified to apply additional washcoat layers as desired, before or after any step illustrated, such as an additional Catalytic layer (S-Z-C₁-C₂). Preferably, a drying process and a calcining process are performed between each coating step.

FIGS. 3A-C illustrate the production of a coated substrate at different stages of a washcoat coating method in accordance with some embodiments of the present disclosure.

FIG. 3A illustrates a substrate 310 prior to being coated with the first washcoat composition. Preferably, the substrate 310 comprises, consists essentially of, or consists of cordierite and comprises a honeycomb structure. However, it is contemplated that other configurations of the substrate 310 are also within the scope of the present disclosure. It should be noted that the depiction of substrate 310 in FIGS. 3A-C illustrates only a portion of the surface being coated, and thus the subsequent washcoat layers illustrated as being coated onto this portion of the substrate are shown as only coating the top surface of the portion of the substrate. In addition, other washcoat layers may be coated on other portions or zones of the substrate. If the depiction of the substrate 310 in FIGS. 3A-C had been meant to illustrate the entire substrate, the washcoat layers would be shown as coating the entire surface of the substrate, and not just the top surface, as is depicted in FIGS. 3A-C for the portion of the substrate shown.

FIG. 3B illustrates the substrate 310 after its surface has been coated with a zeolite particle-containing washcoat composition, as discussed in the process depicted in FIG. 2. The first washcoat composition including zeolite particles can be applied, dried, and calcined. A resulting first washcoat layer 320 is formed on the surface of the substrate 310. This first washcoat layer 320 includes a high concentration of zeolite particles.

FIG. 3C illustrates the substrate 310 after the first washcoat layer 320 has been coated with a second washcoat composition, as discussed in the process depicted in FIG. 2. The second washcoat composition containing catalytic powder as described above can be applied, dried, and calcined. As a result, a second washcoat layer 330 is formed over the first washcoat layer 320. This second washcoat layer 330 can include catalytically active powder comprising one or more plasma-generated catalyst components. This coated substrate is in the Substrate-Zeolite Particles-Catalytic Powder configuration (S-Z-C) without additional washcoat layers; additional washcoat layers can be included as desired, under, over, or between any layers illustrated.

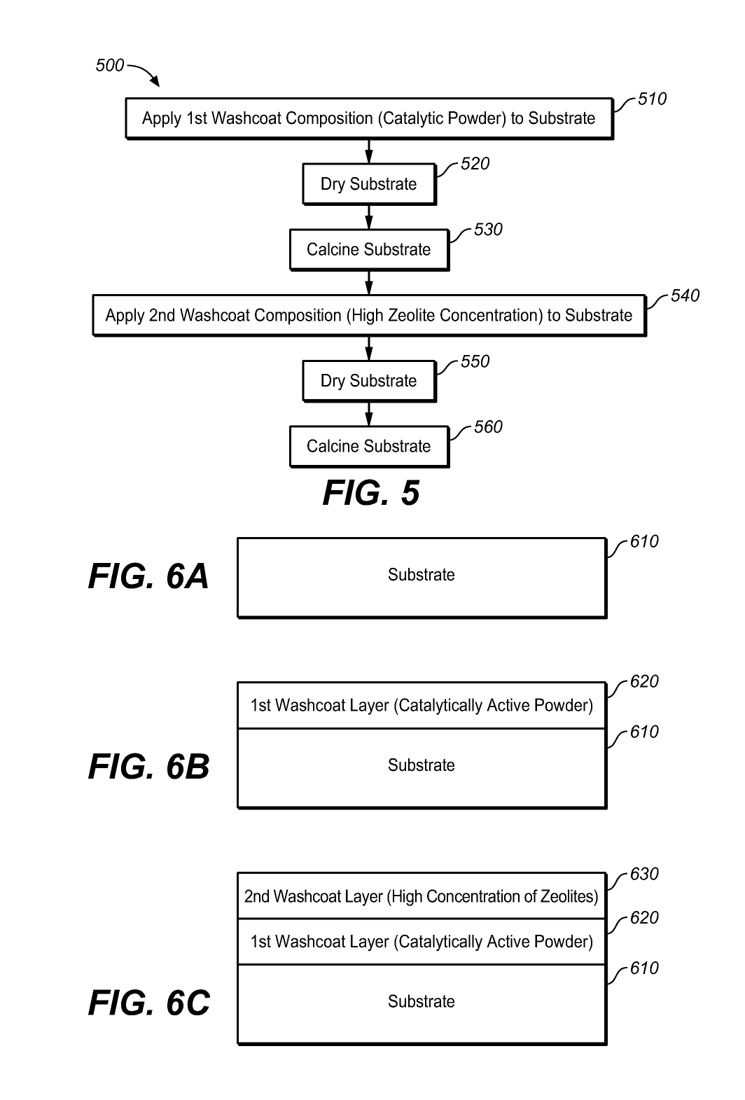

FIG. 5 illustrates a method 500 of forming a coated substrate in accordance with some embodiments. The method comprises: coating a substrate with a washcoat composition which comprises a composition comprising catalytic particles that can include one or more plasma-generated catalyst components to form a catalytic particle-coated substrate; and coating the resulting catalytic particle-coated substrate with yet another subsequent washcoat composition which comprises zeolite particles in high concentration (referred to as a zeolite particle-containing washcoat composition), to form the fully coated substrate, which is a catalytic particle-coated/zeolite particle-coated substrate. Preferably, a drying process and a calcining process are performed between each coating step. This configuration is designated S-C-Z (substrate-catalyst layer-zeolite layer).

At step 510, a first washcoat composition, a catalytic powder-containing composition, that can include one or more plasma-generated catalyst components, is applied to a substrate in order to coat the substrate with a first washcoat layer. Preferably, the substrate comprises, consists essentially of, or consists of cordierite and comprises a honeycomb structure. However, it is contemplated that the substrate can be formed from other materials and in other configurations as well, as discussed herein.

At step 520, a first drying process is performed on the substrate. Examples of such drying processes include, but are not limited to, a hot-drying process, or a flash drying process.

At step 530, a first calcining process is performed on the substrate. It is contemplated that the length and temperature of the calcination process can vary depending on the characteristics of the components in a particular embodiment.

At step 540, a second washcoat composition, a zeolite particle-containing washcoat composition, is applied to the substrate in order to coat the first washcoat layer with a second washcoat layer.

At step 550, a second drying process is performed on the substrate. Examples of such drying processes include, but are not limited to, a hot-drying process, or a flash drying process.

At step 560, a second calcining process is performed on the substrate. It is contemplated that the length and temperature of the calcination process can vary depending on the characteristics of the components in a particular embodiment.

After the second calcining process, the coated substrate comprises a first layer and a second layer on its surface. The first layer comprises catalytic material that can include one or more plasma-generated catalyst components. The second layer, disposed over the first layer, comprises a high concentration of zeolite. This method illustrates the production of the Substrate-Catalytic Powder-Zeolite Particles configuration (S-C-Z) without additional washcoat layers; the method can be readily modified to apply additional washcoat layers as desired, before or after any step illustrated.

FIGS. 6A-C illustrate the production of a coated substrate at different stages of a washcoat coating method in accordance with some embodiments.

FIG. 6A illustrates a substrate 610 prior to being coated with the first washcoat composition. Preferably, the substrate 610 comprises, consists essentially of, or consists of cordierite and comprises a honeycomb structure. However, it is contemplated that other configurations of the substrate 610 are also within the scope of the present disclosure. It should be noted that the depiction of substrate 610 in FIGS. 6A-C illustrates only a portion of the surface being coated, and thus the subsequent washcoat layers illustrated as being coated onto this portion of the substrate are shown as only coating the top surface of the portion of the substrate. In addition, other washcoat layers may be coated on other portions or zones of the substrate. If the depiction of the substrate 610 in FIGS. 6A-C had been meant to illustrate the entire substrate, the washcoat layers would be shown as coating the entire surface of the substrate, and not just the top surface, as is depicted in FIGS. 6A-C for the portion of the substrate shown.

FIG. 6B illustrates the substrate 610 after its surface has been coated with a catalyst-containing washcoat composition, as discussed in the process depicted in FIG. 5. The first washcoat composition that can contain catalytic powder comprising one or more plasma-generated catalyst components can be applied, dried, and calcined. A resulting first washcoat layer 620 is formed on the surface of the substrate 610. This first washcoat layer 620 comprises catalytic powder.

FIG. 6C illustrates the substrate 610 after the first washcoat layer 620 has been coated with a second washcoat composition, as discussed in the process depicted in FIG. 5. The second washcoat composition containing zeolite particles can be applied, dried, and calcined. As a result, a second washcoat layer 630 is formed over the first washcoat layer 620. This second washcoat layer 630 comprises zeolite particles, preferably in a high concentration. This coated substrate is in the Substrate-Catalytic Powder-Zeolite Particles configuration (S-C-Z) without additional washcoat layers; additional washcoat layers can be included as desired, under, over, or between any layers illustrated.

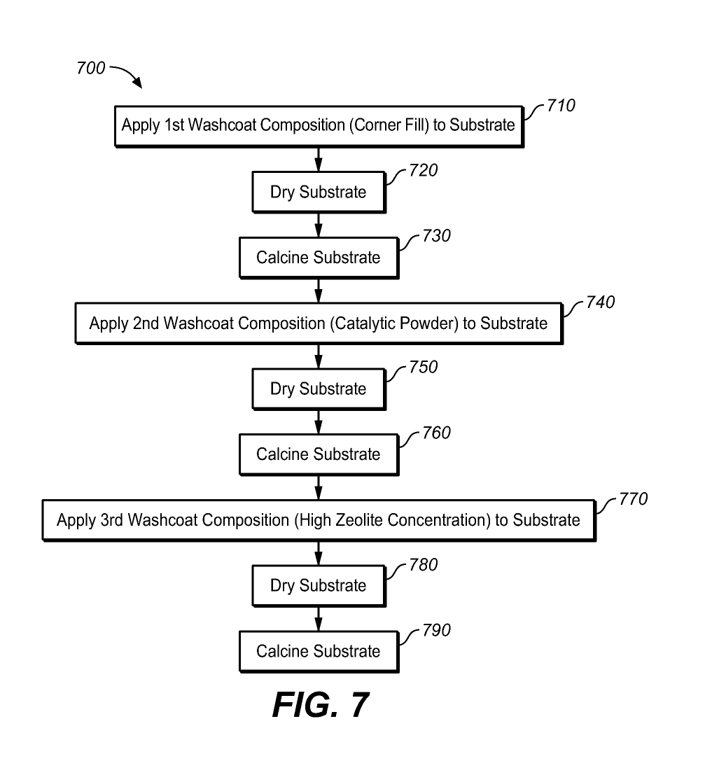

FIG. 7 illustrates a method 700 of forming a coated substrate in accordance with some embodiments. The method comprises coating a substrate with a washcoat composition which comprises a corner-fill washcoat composition comprising alumina; coating the resulting corner-fill-coated substrate with a subsequent washcoat composition, which comprises a composition comprising catalytic particles comprising one or more plasma-generated catalyst components (referred to as a catalyst-containing washcoat composition, a catalytically active powder-containing washcoat composition, or a catalyst powder-containing washcoat composition) to form a corner-fill-coated/catalyst particle-coated substrate; and coating the resulting corner-fill-coated/catalyst layer-coated substrate with yet another subsequent washcoat composition which comprises zeolite particles in high concentration (referred to as a zeolite particle-containing washcoat composition), to form the fully-coated substrate, which is a corner-fill-coated/catalyst particle-coated/zeolite particle-coated substrate. Preferably, a drying process and a calcining process are performed between each coating step. This configuration is designated S-F-C-Z (substrate-corner fill layer-catalyst layer-zeolite layer).

At step 710, a first washcoat composition, a corner-fill washcoat composition, is applied to a substrate in order to coat the substrate with a first washcoat layer. Preferably, the substrate comprises, consists essentially of, or consists of cordierite and comprises a honeycomb structure. However, it is contemplated that the substrate can be formed from other materials and in other configurations as well, as discussed herein.

At step 720, a first drying process is performed on the substrate. Examples of such drying processes include, but are not limited to, a hot-drying process, or a flash drying process.

At step 730, a first calcining process is performed on the substrate. It is contemplated that the length and temperature of the calcination process can vary depending on the characteristics of the components in a particular embodiment.

At step 740, a second washcoat composition, a catalyst-containing washcoat composition that can include one or more plasma-generated catalyst components, is applied to the substrate in order to coat the first washcoat layer with a second washcoat layer.

At step 750, a second drying process is performed on the substrate. Examples of such drying processes include, but are not limited to, a hot-drying process, or a flash drying process.

At step 760, a second calcining process is performed on the substrate. It is contemplated that the length and temperature of the calcination process can vary depending on the characteristics of the components in a particular embodiment.

At step 770, a third washcoat composition, a zeolite particle-containing washcoat composition, is applied to the substrate in order to coat the second washcoat layer with a third washcoat layer.

At step 780, a third drying process is performed on the substrate. Examples of such drying processes include, but are not limited to, a hot-drying process, or a flash drying process.

At step 790, a third calcining process is performed on the substrate. It is contemplated that the length and temperature of the calcination process can vary depending on the characteristics of the components in a particular embodiment.

After the third calcining process, the coated substrate comprises a first layer, a second layer, and a third layer on its surface. The first layer, disposed over the substrate, contains corner-fill material such as aluminum oxide. The second layer, disposed over the first layer, comprises catalytic material that can include one or more plasma-generated catalyst components. The third layer, disposed over the second layer, comprises a high concentration of zeolite. This method illustrates the production of the Substrate-Corner Fill-Catalytic Powder-Zeolite Particles configuration (S-F-C-Z) without additional washcoat layers; the method can be readily modified to apply additional washcoat layers as desired, before or after any step illustrated.

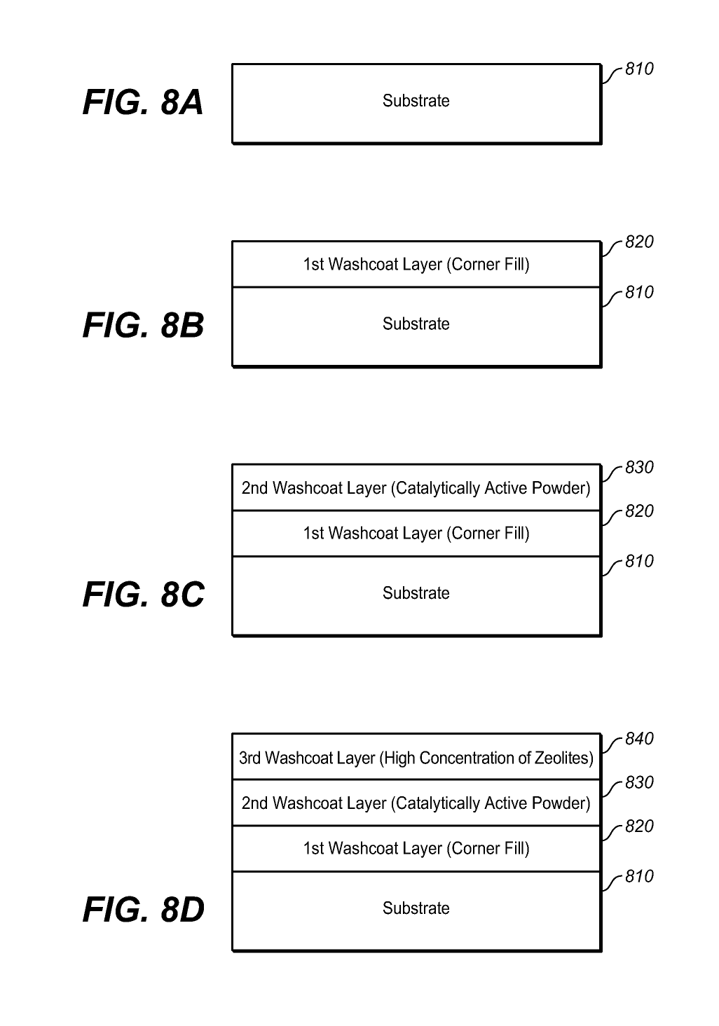

FIGS. 8A-D illustrate the production of a coated substrate at different stages of a washcoat coating method in accordance with some embodiments.

FIG. 8A illustrates a substrate 810 prior to being coated with the first washcoat composition. Preferably, the substrate 810 comprises, consists essentially of, or consists of cordierite and comprises a honeycomb structure. However, it is contemplated that other configurations of the substrate 810 may also be used. It should be noted that the depiction of substrate 810 in FIGS. 8A-D illustrates only a portion of the surface being coated, and thus the subsequent washcoat layers illustrated as being coated onto this portion of the substrate are shown as only coating the top surface of the portion of the substrate. In addition, other washcoat layers may be coated on other portions or zones of the substrate. If the depiction of the substrate 810 in FIGS. 8A-D had been meant to illustrate the entire substrate, the washcoat layers would be shown as coating the entire surface of the substrate, and not just the top surface, as is depicted in FIGS. 8A-D for the portion of the substrate shown.

FIG. 8B illustrates the substrate 810 after its surface has been coated with a corner-fill washcoat composition, as discussed in the process depicted in FIG. 7. The first washcoat composition containing corner fill material can be applied, dried, and calcined. A resulting first washcoat layer 820 is formed on the surface of the substrate 810. This first washcoat layer 820 comprises corner fill material, such as aluminum oxide.

FIG. 8C illustrates the substrate 810 after the first washcoat layer 820 has been coated with a second washcoat composition, as discussed in the process depicted in FIG. 7. The second washcoat composition containing catalytic powder that can include one or more plasma-generated catalyst components can be applied, dried, and calcined. As a result, a second washcoat layer 830 is formed over the first washcoat layer 820. This second washcoat layer 830 comprises catalytic powder comprising one or more plasma-generated catalyst components.

FIG. 8D illustrates the substrate 810 after the second washcoat layer 830 has been coated with a third washcoat composition, as discussed in the process depicted in FIG. 7. The third composition containing zeolite particles can be applied, dried, and calcined. As a result, a third washcoat layer 840 is formed over the second washcoat layer 830. This third washcoat layer 840 comprises zeolite particles, preferably in a high concentration. This coated substrate is in the Substrate-Corner Fill-Catalytic Powder-Zeolite Particles configuration (S-F-C-Z) without additional washcoat layers; additional washcoat layers can be included as desired, under, over, or between any layers illustrated.

FIG. 9 shows a single rectangular channel 900 in a coated substrate coated in the S-F-C-Z configuration, without additional washcoat layers. The wall 910 of the substrate channel has been coated with corner-fill washcoat layer 920, then catalyst-containing washcoat layer (comprising one or more plasma-generated catalyst components) 930, then zeolite particle-containing washcoat layer 940. Exhaust gases pass through the lumen 950 of the channel when the coated substrate is employed in a catalytic converter as part of an emissions control system.

While not illustrated, the disclosure also comprises a method of forming a coated substrate in accordance with the S-F-Z-C (substrate-corner fill layer-zeolite layer-catalyst layer) embodiment. The method comprises coating a substrate with a washcoat composition which comprises a corner-fill washcoat composition comprising alumina; coating the resulting corner-fill-coated substrate with a subsequent washcoat composition, which comprises a composition comprising zeolite particles (referred to as a zeolite particle-containing washcoat composition) to form a corner-fill-coated/zeolite particle-coated substrate; and coating the resulting corner-fill-coated/zeolite layer-coated substrate with yet another subsequent washcoat composition which comprises catalyst particles that can include one or more plasma-generated catalyst components (referred to as a catalyst-containing washcoat composition, a catalytically active powder-containing washcoat composition, or a catalyst powder-containing washcoat composition), to form the fully-coated substrate, which is a corner-fill-coated/zeolite particle-coated/catalyst particle-coated substrate. Preferably, a drying process and a calcining process are performed between each coating step. This configuration is designated S-F-Z-C (substrate-corner fill layer-zeolite layer-catalyst layer).

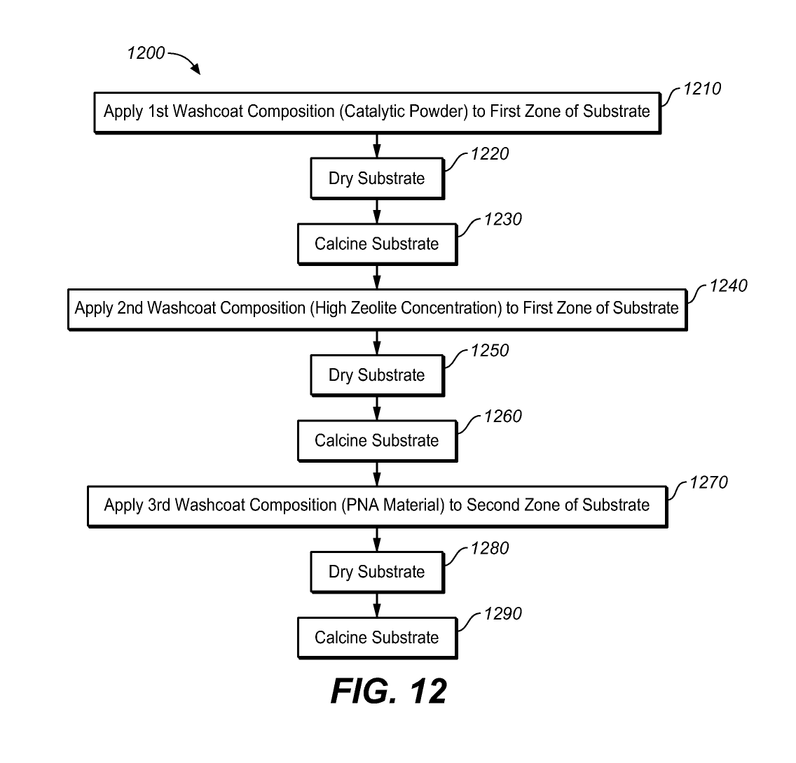

FIG. 12 illustrates a method 1200 of forming a zone coated substrate in accordance with some embodiments. The method comprises coating a first zone of a substrate with a washcoat composition which comprises a composition comprising catalytic particles, coating the resulting catalyst layer-coated first zone of the substrate with another subsequent washcoat composition which comprises zeolite particles in high concentration, to form a catalyst particle-coated/zeolite particle coated first zone of the substrate. The method further comprises coating a second zone of a substrate with a washcoat composition which comprises a composition comprising PNA material to form the zone-coated substrate comprising a catalyst particle-coated/zeolite particle-coated zone of the substrate and a PNA particle-coated zone of the substrate. Preferably, a drying process and a calcining process are performed between each coating step. This configuration is designated S-C-Z (substrate-catalyst layer-zeolite layer) on one zone of the substrate and S-P (substrate-PNA layer) on another zone of the substrate.

At step 1210, a first washcoat composition, a catalyst-containing washcoat composition that can include one or more plasma-generated catalyst components, is applied to a zone of the substrate in order to coat a first zone of the substrate. Preferably, the substrate comprises, consists essentially of, or consists of cordierite and comprises a honeycomb structure. However, it is contemplated that the substrate can be formed from other materials and in other configurations as well, as discussed herein.

At step 1220, a first drying process is performed on the substrate. Examples of such drying processes include, but are not limited to, a hot-drying process, or a flash drying process.

At step 1230, a first calcining process is performed on the substrate. It is contemplated that the length and temperature of the calcination process can vary depending on the characteristics of the components in a particular embodiment.

At step 1240, a second washcoat composition, a zeolite particle-containing washcoat composition, is applied to the first zone of the substrate in order to coat the first washcoat layer with a second washcoat layer

At step 1250, a second drying process is performed on the substrate. Examples of such drying processes include, but are not limited to, a hot-drying process, or a flash drying process.

At step 1260, a second calcining process is performed on the substrate. It is contemplated that the length and temperature of the calcination process can vary depending on the characteristics of the components in a particular embodiment.

At step 1270, a third washcoat composition, a PNA particle-containing washcoat composition, is applied to a second zone of the substrate in order to coat the second zone of the substrate.

At step 1280, a third drying process is performed on the substrate. Examples of such drying processes include, but are not limited to, a hot-drying process, or a flash drying process.

At step 1290, a third calcining process is performed on the substrate. It is contemplated that the length and temperature of the calcination process can vary depending on the characteristics of the components in a particular embodiment.

After the third calcining process, the coated substrate comprises a first layer and a second layer on a first zone of its surface and a third layer on a second zone of its surface. The first layer, disposed over the first zone of the substrate, comprises catalytic material. The second layer, disposed over the first layer, comprises a high concentration of zeolites. The third layer, disposed over the second zone of the substrate, comprises a PNA material. This method illustrates the production of the zone coated configuration (S-C-Z) and (S-P) on different zones of the substrate without additional washcoat layers; the method can be readily modified to apply additional washcoat layers to any zone of the substrate as desired, before or after any step illustrated. In addition, the substrate can contain more than two zones that may have zero or more washcoat layers. Furthermore, one zone of the substrate does not have to be completely coated before a second zone of the substrate receives its first washcoat layer. In addition, in some embodiments, the PNA washcoat composition can be applied to the second zone of the substrate before the catalytic layer or the zeolite layer is applied to the first zone of the substrate.

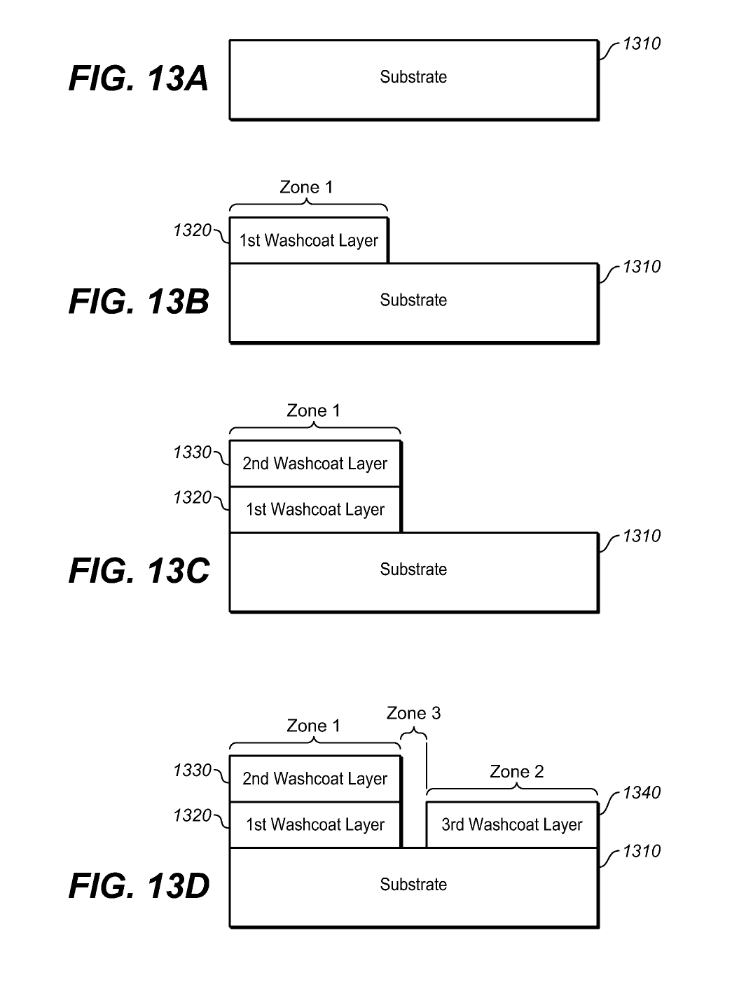

FIGS. 13A-D illustrate the production of a zone coated substrate at different stages of a washcoat coating method in accordance with some embodiments.

FIG. 13A illustrates a substrate 1310 prior to being coated with the first washcoat composition. Preferably, the substrate 1310 comprises, consists essentially of, or consists of cordierite and comprises a honeycomb structure. However, it is contemplated that other configurations of the substrate 1310 may also be used. It should be noted that the depiction of substrate 1310 in FIGS. 13A-D illustrates only a portion of the surface being coated, and thus the subsequent washcoat layers illustrated as being coated onto this portion of the substrate are shown as only coating the top surface of the portion of the substrate. If the depiction of the substrate 1310 in FIGS. 13A-D had been meant to illustrate the entire substrate, the washcoat layers would be shown as coating the entire surface of the substrate, and not just the top surface, as is depicted in FIGS. 13A-D for the portion of the substrate shown.

FIG. 13B illustrates the substrate 1310 after a Zone 1 of its surface has been coated with a first washcoat composition, as discussed in the process depicted in FIG. 12. The first washcoat composition containing catalytic powder can be applied, dried, and calcined. A resulting first washcoat layer 1320 is formed on Zone 1 of the surface of the substrate 1310. This first washcoat layer 1320 comprises catalytic powder.

FIG. 13C illustrates Zone 1 of the substrate 1310 after the first washcoat layer 1320 has been coated with a second washcoat composition, as discussed in the process depicted in FIG. 12. The second composition containing zeolite particles can be applied, dried, and calcined. As a result, a second washcoat layer 1330 is formed over the first washcoat layer 1320. This second washcoat layer 1330 comprises zeolite particles, preferably in a high concentration. This second washcoat layer can cover the entire first washcoat layer or only a portion of the first washcoat layer. In addition, part of this second washcoat layer may be formed over the substrate. As such, a portion of the second washcoat layer can be deposited directly on the substrate and another portion of the second washcoat layer can be deposited directly on the first washcoat layer so that a portion overlaps the first washcoat layer.

FIG. 13D illustrates the substrate 1310 after Zone 2 of the substrate has been coated with a third washcoat composition, as discussed in the process depicted in FIG. 12. The third composition containing PNA particles can be applied, dried, and calcined. As a result, a third washcoat layer 1340 is formed over Zone 2 of the substrate. This third washcoat layer 1340 comprises PNA material. A portion of the third washcoat layer can be deposited directly on the substrate and another portion of the third washcoat layer can be deposited directly on the first zone so that a portion overlaps the washcoat layers in Zone 1. This coated substrate is in the Substrate-Catalytic Powder-Zeolite Particles configuration (S-C-Z) in a first zone of the substrate and the Substrate-PNA Material configuration (S-P) in a second zone of the substrate without additional washcoat layers; the method can be readily modified to apply additional washcoat layers to any zone of the substrate as desired, before or after any step illustrated. In addition, the substrate can contain more than two zones that may have zero or more washcoat layers. For example, FIG. 13D includes a Zone 3 (or a gap as previously mentioned) on the substrate that does not have a washcoat layer. Furthermore, one zone of the substrate does not have to be completely coated before a second zone of the substrate receives its first washcoat layer.

While not illustrated, the disclosure also comprises a method of forming a zone coated substrate in accordance with any of the disclosed embodiments, such as (S-F-Z-C), (S-C) (S-C-Z-P), (S-Z-P), (S-P), etc., on any zone of the substrate in any combination. In addition, the Catalytic layer can include one or more catalytic layers such as a C₁-C₂ configuration.

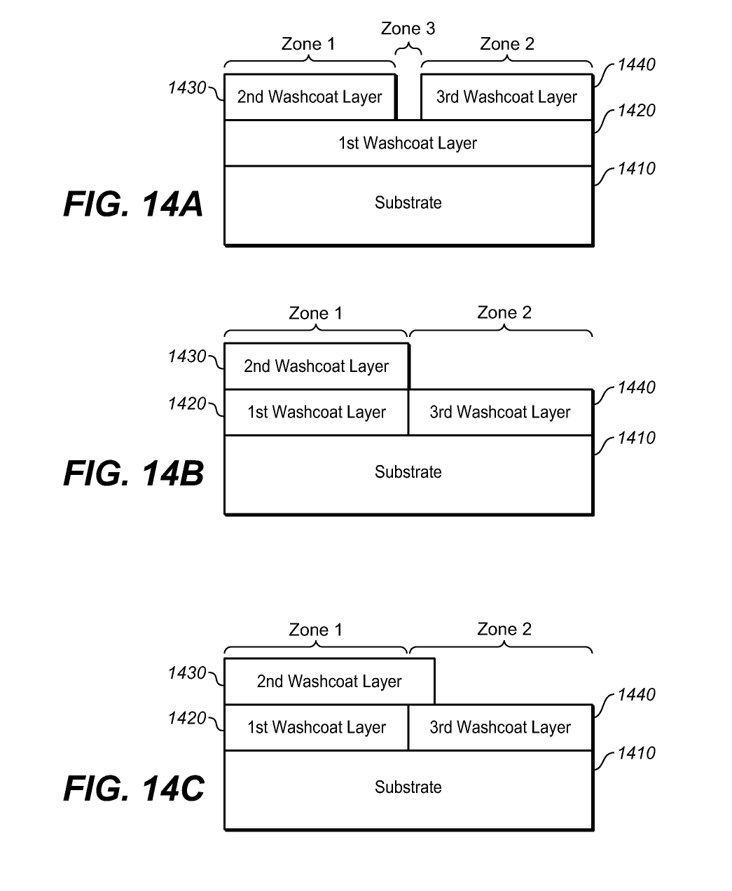

FIG. 14(A)-(C) shows additional embodiments of the zone coated substrate. FIG. 14A shows a zone coated substrate, wherein a first coated zone and a second coated zone of the substrate share a common 1^{st} washcoat layer 1420, for example a corner-fill layer. The zones can share other washcoat compositions besides the 1^{st} washcoat layer as well. FIG. 14B shows a zone coated substrate, wherein there is no uncoated zone between the first coated zone and the second coated zone of the substrate. FIG. 14C shows a zone coated substrate, wherein a 2^{nd} washcoat layer of the first coated zone of the substrate overlaps a portion of the second coated zone of the substrate. Any washcoat layer from any zone may overlap a portion of another coated zone. It should be noted that the washcoats are coated on the surface of the interior channels of the substrate; the highly schematic drawings of FIGS. 13-14 are simply meant to aid in conceptualizing the separation of the different washcoats in the different zones, and is not meant to be a detailed physical representation, nor are the dimensions drawn to scale (the same holds true for all other figures illustrating washcoats on a substrate).

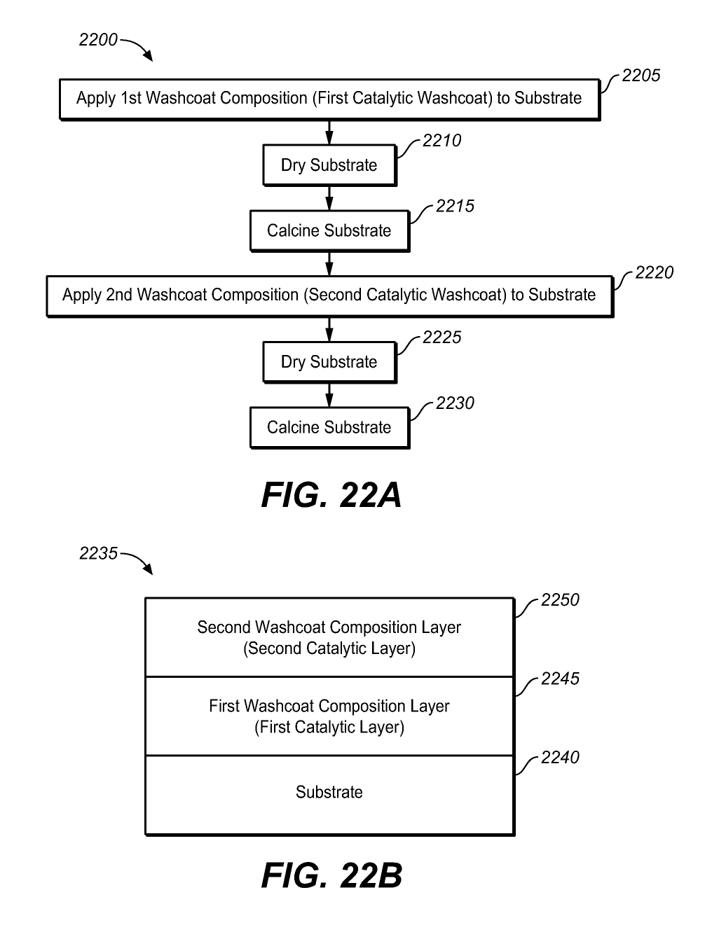

FIG. 22A illustrates one method of forming a coated substrate in accordance with some embodiments of the present disclosure. The method comprises coating a substrate with a first washcoat composition, such as a first catalytic washcoat composition, to form a first washcoat composition layer, such as a first catalytic layer, and coating the substrate with a second washcoat composition, such as a second catalytic washcoat composition, to form a second washcoat composition layer, such as a second catalytic layer. This configuration is designated S-C₁-C₂ (Substrate-First Catalytic Layer-Second Catalytic Layer). In some embodiments, the first catalytic washcoat composition and the second catalytic washcoat composition may be of the same composition. In other embodiments, the first catalytic washcoat composition and second catalytic washcoat composition may be of different compositions. The first catalytic washcoat composition and the second catalytic washcoat composition can be any catalytic washcoat composition disclosed in the application. In addition, there can be other washcoat compositions employed with the first catalytic washcoat and the second catalytic washcoat. For example, a corner-fill washcoat composition can be employed on the substrate first. In addition, there can be a zeolite washcoat and/or a PNA washcoat with the first and second catalytic washcoat compositions.

At step 2205, a first washcoat composition (a first catalytic washcoat composition) is applied to a substrate to form a first catalytic layer. Preferably, the substrate comprises, consists essentially of, or consists of cordierite and comprises a honeycomb structure. However, it is contemplated that the substrate can be formed from other materials and in other configurations as well, as discussed herein.

At step 2210, a first drying process is performed on the substrate. Examples of such drying processes include, but are not limited to, a hot-drying process, or a flash drying process.

At step 2215, a first calcining process is performed on the substrate. It is contemplated that the length and temperature of the calcination process can vary depending on the characteristics of the components in a particular embodiment.

At step 2220, a second washcoat composition (a second catalytic washcoat composition) is applied to the substrate in order to coat the first catalytic layer with a second layer.

At step 2225, a second drying process is performed on the substrate. Examples of such drying processes include, but are not limited to, a hot-drying process, or a flash drying process.

At step 2230, a second calcining process is performed on the substrate. It is contemplated that the length and temperature of the calcination process can vary depending on the characteristics of the components in a particular embodiment.

After the second calcining process, the coated substrate includes a first catalytic layer and a second catalytic layer on its surface. Both catalytic layers comprise catalytically active materials, but, in some embodiments, the composition of the catalytically active materials may differ between the first catalytic layer and the second catalytic layer. This method illustrates one method of producing the Substrate-First Catalytic Layer-Second Catalytic Layer (S-C₁-C₂) configuration without additional washcoat layers; the method can be readily modified to apply additional washcoat layers as desired, before or after any step illustrated. Preferably, a drying process and a calcining process are performed between each coating step.

FIG. 22B illustrates one embodiment of a substrate coated with a first catalytic layer and a second catalytic layer (S-C₁-C₂ configuration) 2235. In addition, other washcoat layers may be coated on other portions or zones of the substrate. Preferably, the substrate 2240 comprises, consists essentially of, or consists of cordierite and comprises a honeycomb structure. However, it is contemplated that the substrate can be formed from other materials and in other configurations as well, as discussed herein. The first catalytic layer 2245 coats the substrate 2240, and the second catalytic layer 450 coats the substrate 2240 external to the first catalytic layer 2245. In some embodiments, the first catalytic layer 2245 and the second catalytic layer 2250 may be of the same composition. In other embodiments, the first catalytic layer 2245 and second catalytic layer 2250 may be of different compositions. As previously stated, the first catalytic layer and the second catalytic layer can be any catalytic layer disclosed herein. In some embodiments, the first catalytic layer or the second catalytic layer may comprise an additional type of catalytically active material.

### Exhaust Systems, Vehicles, and Emissions Performance

It is understood that the coated substrates described herein, catalytic converters using the coated substrates described herein, and exhaust treatment systems using the coated substrates described herein, are particularly useful for light-duty diesel engines and heavy-duty diesel vehicles. Vehicles using the catalytic converters described herein may meet the Euro 5, Euro 6, U.S. EPA (as of year 2010), U.S. EPA Inherently Low Emissions Vehicle (ILEV), and/or U.S. EPA Ultra Low Emissions Vehicle (ULEV) standards for light-duty and heavy-duty diesel vehicles.

### Light-Duty Diesel

In some embodiments of the disclosure, a coated substrate as disclosed herein is housed within a catalytic converter in a position configured to receive exhaust gas from an internal combustion engine, such as in an exhaust system of an internal combustion engine. The catalytic converter can be used with the exhaust from a diesel engine, such as a light-duty diesel engine. The catalytic converter can be installed on a vehicle containing a diesel engine, such as a light-duty diesel engine.

The coated substrate is placed into a housing, such as that shown in FIG. 1, which can in turn be placed into an exhaust system (also referred to as an exhaust treatment system) of an internal combustion engine. The internal combustion engine can be a diesel engine, such as a light-duty diesel engine, such as the engine of a light-duty diesel vehicle. The exhaust system of the internal combustion engine receives exhaust gases from the engine, typically into an exhaust manifold, and delivers the exhaust gases to an exhaust treatment system. The catalytic converter forms part of the exhaust system and is often referred to as the diesel oxidation catalyst (DOC). The exhaust system can also include a diesel particulate filter (DPF) and/or a selective catalytic reduction unit (SCR unit) and/or a lean NOₓ trap (LNT); typical arrangements, in the sequence that exhaust gases are received from the engine, are DOC-DPF and DOC-DPF-SCR. The exhaust system can also include other components, such as oxygen sensors, HEGO (heated exhaust gas oxygen) sensors, UEGO (universal exhaust gas oxygen) sensors, sensors for other gases, and temperature sensors. The exhaust system can also include a controller such as an engine control unit (ECU), a microprocessor, or an engine management computer, which can adjust various parameters in the vehicle (fuel flow rate, fuel/air ratio, fuel injection, engine timing, valve timing, etc.) in order to optimize the components of the exhaust gases that reach the exhaust treatment system, so as to manage the emissions released into the environment.

“Treating” an exhaust gas, such as the exhaust gas from a diesel engine, such as a light-duty diesel engine, refers to having the exhaust gas proceed through an exhaust system (exhaust treatment system) prior to release into the environment. As noted above, typically the exhaust gas from the engine will flow through an exhaust system comprising a diesel oxidation catalyst and a diesel particulate filter, or an exhaust system comprising a diesel oxidation catalyst, a diesel particulate filter, and selective catalytic reduction unit (SCR), prior to release into the environment.

The United States Environmental Protection Agency defines a “light-duty diesel vehicle” (“LDDV”) as a diesel-powered motor vehicle, other than a diesel bus, that has a gross vehicle weight rating of 8,500 pounds or less and is designed primarily for transporting persons or property. In Europe, a “light-duty diesel engine” has been considered to be an engine used in a vehicle of 3.5 metric tons or less (7,716 pounds or less) (see European directives 1992/21 EC and 1995/48 EC). In some embodiments of the disclosure, a light-duty diesel vehicle is a diesel vehicle weighing about 8,500 pounds or less, or about 7,700 pounds or less, and a light-duty diesel engine is an engine used in a light-duty diesel vehicle.

When used in a catalytic converter, the coated substrates disclosed herein may provide a significant improvement over other catalytic converters. The zeolites in the coated substrate act as an intermediate storage device for the exhaust gases while the exhaust gas is still cold. The undesirable gases (including, but not limited to, hydrocarbons, carbon monoxide, and nitrogen oxides or NOₓ) adsorb to the zeolites during the cold start phase, while the catalyst is not yet active, and are released later when the catalyst reaches a temperature sufficient to effectively decompose the gases (that is, the light-off temperature).

In some embodiments, catalytic converters and exhaust treatment systems employing the coated substrates disclosed herein display emissions of 3400 mg/mile or less of CO emissions and 400 mg/mile or less of NOₓ emissions; 3400 mg/mile or less of CO emissions and 200 mg/mile or less of NOₓ emissions; or 1700 mg/mile or less of CO emissions and 200 mg/mile or less of NOₓ emissions. The disclosed coated substrates, used as catalytic converter substrates, can be used in an emission system to meet or exceed these standards. In some embodiments, the coated substrate is used in a catalytic converter (diesel oxidation catalyst) in the configuration DOC-DPF or DOC-DPF-SCR to meet or exceed these standards.

Emissions limits for Europe are summarized at the URL europa.eu/legislation_summaries/environment/air_pollution/128186_en.htm. The Euro 5 emissions standards, in force as of September 2009, specify a limit of 500 mg/km of CO emissions, 180 mg/km of NOₓ emissions, and 230 mg/km of HC (hydrocarbon)+NOₓ emissions. The Euro 6 emissions standards, scheduled for implementation as of September 2014, specify a limit of 500 mg/km of CO emissions, 80 mg/km of NOₓ emissions, and 170 mg/km of HC (hydrocarbon)+NOₓ emissions. The disclosed catalytic converter substrates can be used in an emission system to meet or exceed these standards. In some embodiments, the coated substrate is used in a catalytic converter (diesel oxidation catalyst) in the configuration DOC-DPF or DOC-DPF-SCR to meet or exceed these standards.

In some embodiments, a catalytic converter made with a coated substrate of the disclosure, loaded with 5.0 g/l of PGM or less, displays a carbon monoxide light-off temperature at least 5 degrees C. lower than a catalytic converter made using only wet chemistry methods and having the same or similar PGM loading. In some embodiments, a catalytic converter made with a coated substrate of the disclosure, loaded with 5.0 g/l of PGM or less, displays a carbon monoxide light-off temperature at least 10 degrees C. lower than a catalytic converter made using only wet chemistry methods and having the same or similar PGM loading. In some embodiments, a catalytic converter made with a coated substrate of the disclosure, loaded with 4.0 g/l of PGM or less, displays a carbon monoxide light-off temperature at least 5 degrees C. lower than a catalytic converter made using only wet chemistry methods and having the same or similar PGM loading. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within +/−3 degrees C. of the carbon monoxide light-off temperature of a catalytic converter made using only wet chemistry methods, while the catalytic converter made with a coated substrate employing 30% less catalyst than the catalytic converter made using only wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within +/−2 degrees C. of the carbon monoxide light-off temperature of a catalytic converter made using only wet chemistry methods, while the catalytic converter made with a coated substrate employing 30% less catalyst than the catalytic converter made using only wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within +/−4 degrees C. of the carbon monoxide light-off temperature of a catalytic converter made using only wet chemistry methods, while the catalytic converter made with a coated substrate employing 40% less catalyst than the catalytic converter made using only wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within +/−2 degrees C. of the carbon monoxide light-off temperature of a catalytic converter made using only wet chemistry methods, while the catalytic converter made with a coated substrate employing 40% less catalyst than the catalytic converter made using only wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within +/−5 degrees C. of the carbon monoxide light-off temperature of a catalytic converter made using only wet chemistry methods, while the catalytic converter made with a coated substrate of the present disclosure employing 50% less catalyst than the catalytic converter made using only wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure displays a carbon monoxide light-off temperature within +/−2 degrees C. of the carbon monoxide light-off temperature of a catalytic converter made using only wet chemistry methods, while the catalytic converter made with a coated substrate of the present disclosure employing 50% less catalyst than the catalytic converter made using only wet chemistry methods. In some embodiments, the catalytic converter made with a coated substrate of the present disclosure demonstrates this performance after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel engine or diesel vehicle, such as a light-duty diesel engine or light-duty diesel vehicle, complies with United States EPA emissions requirements, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which complies with the same standard. In some embodiments, the coated substrate is used in a catalytic converter (diesel oxidation catalyst) in the configuration DOC-DPF or DOC-DPF-SCR to meet or exceed these standards. The emissions requirements can be intermediate life requirements or full life requirements. The requirements can be TLEV requirements, LEV requirements, or ULEV requirements. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel engine or diesel vehicle, such as a light-duty diesel engine or light-duty diesel vehicle, complies with EPA TLEV/LEV intermediate life requirements. In some embodiments, a catalytic converter made with a coated substrate of the present disclosure employed on a diesel engine or diesel vehicle, such as a light-duty diesel engine or light-duty diesel vehicle, complies with EPA TLEV/LEV full life requirements. In some embodiments, a catalytic converter made with a coated substrate of the present disclosure employed on a diesel engine or diesel vehicle, such as a light-duty diesel engine or light-duty diesel vehicle, complies with EPA ULEV intermediate life requirements. In some embodiments, a catalytic converter made with a coated substrate of the present disclosure employed on a diesel engine or diesel vehicle, such as a light-duty diesel engine or light-duty diesel vehicle, complies with EPA ULEV full life requirements. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with a coated substrate of the present disclosure employed on a diesel engine or diesel vehicle, such as a light-duty diesel engine or light-duty diesel vehicle, complies with EPA TLEV/LEV intermediate life requirements, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which complies with that standard. In some embodiments, a catalytic converter made with a coated substrate of the present disclosure employed on a diesel engine or diesel vehicle, such as a light-duty diesel engine or light-duty diesel vehicle, complies with EPA TLEV/LEV full life requirements, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which complies with that standard. In some embodiments, a catalytic converter made with a coated substrate of the present disclosure employed on a diesel engine or diesel vehicle, such as a light-duty diesel engine or light-duty diesel vehicle, complies with EPA ULEV intermediate life requirements, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which complies with that standard. In some embodiments, a catalytic converter made with a coated substrate of the present disclosure employed on a diesel engine or diesel vehicle, such as a light-duty diesel engine or light-duty diesel vehicle, complies with EPA ULEV full life requirements, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which complies with that standard. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel engine or diesel vehicle, such as a light-duty diesel engine or light-duty diesel vehicle, complies with Euro 5 requirements. In some embodiments, a catalytic converter made with a coated substrate of the present disclosure employed on a diesel engine or diesel vehicle, such as a light-duty diesel engine or light-duty diesel vehicle, complies with Euro 6 requirements. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with a coated substrate of the present disclosure employed on a diesel engine or diesel vehicle, such as a light-duty diesel engine or light-duty diesel vehicle, complies with Euro 5 requirements, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which complies with Euro 5 requirements. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel engine or diesel vehicle, such as a light-duty diesel engine or light-duty diesel vehicle, complies with Euro 6 requirements, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which complies with Euro 6 requirements. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure employed on a diesel engine or diesel vehicle, such as a light-duty diesel engine or light-duty diesel vehicle, displays carbon monoxide emissions of 4200 mg/mile or less. In some embodiments, a catalytic converter made with a coated substrate of the present disclosure and employed on a diesel engine or diesel vehicle, such as a light-duty diesel engine or light-duty diesel vehicle, displays carbon monoxide emissions of 3400 mg/mile or less. In some embodiments, a catalytic converter made with a coated substrate of the present disclosure and employed on a diesel engine or diesel vehicle, such as a light-duty diesel engine or light-duty diesel vehicle, displays carbon monoxide emissions of 2100 mg/mile or less. In another embodiment, a catalytic converter made with a coated substrate of the present disclosure and employed on a diesel engine or diesel vehicle, such as a light-duty diesel engine or light-duty diesel vehicle, displays carbon monoxide emissions of 1700 mg/mile or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with a coated substrate of the present disclosure and employed on a diesel engine or diesel vehicle, such as a light-duty diesel engine or light-duty diesel vehicle, displays carbon monoxide emissions of 500 mg/km or less. In some embodiments, a catalytic converter made with a coated substrate of the present disclosure and employed on a diesel engine or diesel vehicle, such as a light-duty diesel engine or light-duty diesel vehicle, displays carbon monoxide emissions of 375 mg/km or less. In some embodiments, a catalytic converter made with a coated substrate of the present disclosure and employed on a diesel engine or diesel vehicle, such as a light-duty diesel engine or light-duty diesel vehicle, displays carbon monoxide emissions of 250 mg/km or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with a coated substrate of the present disclosure and employed on a diesel engine or diesel vehicle, such as a light-duty diesel engine or light-duty diesel vehicle, displays NOₓ emissions of 180 mg/km or less. In some embodiments, a catalytic converter made with a coated substrate of the present disclosure and employed on a diesel engine or diesel vehicle, such as a light-duty diesel engine or light-duty diesel vehicle, displays NOₓ emissions of 80 mg/km or less. In some embodiments, a catalytic converter made with a coated substrate of the present disclosure and employed on a diesel engine or diesel vehicle, such as a light-duty diesel engine or light-duty diesel vehicle, displays NOₓ emissions of 40 mg/km or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with a coated substrate of the present disclosure and employed on a diesel engine or diesel vehicle, such as a light-duty diesel engine or light-duty diesel vehicle, displays NOₓ plus HC emissions of 230 mg/km or less. In some embodiments, a catalytic converter made with a coated substrate of the present disclosure and employed on a diesel engine or diesel vehicle, such as a light-duty diesel engine or light-duty diesel vehicle, displays NOₓ plus HC emissions of 170 mg/km or less. In some embodiments, a catalytic converter made with a coated substrate of the present disclosure and employed on a diesel engine or diesel vehicle, such as a light-duty diesel engine or light-duty diesel vehicle, displays NOₓ plus HC emissions of 85 mg/km or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation.

In some embodiments, a catalytic converter made with a coated substrate of the present disclosure and employed on a diesel engine or diesel vehicle, such as a light-duty diesel engine or light-duty diesel vehicle, displays carbon monoxide emissions of 500 mg/km or less, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which displays the same or similar emissions. In some embodiments, a catalytic converter made with a coated substrate of the present disclosure and employed on a diesel engine or diesel vehicle, such as a light-duty diesel engine or light-duty diesel vehicle, displays carbon monoxide emissions of 375 mg/km or less, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which displays the same or similar emissions. In some embodiments, a catalytic converter made with a coated substrate of the present disclosure and employed on a diesel engine or diesel vehicle, such as a light-duty diesel engine or light-duty diesel vehicle, displays carbon monoxide emissions of 250 mg/km or less, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure and employed on a diesel engine or diesel vehicle, such as a light-duty diesel engine or light-duty diesel vehicle, displays NOₓ emissions of 180 mg/km or less, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which displays the same or similar emissions. In some embodiments, a catalytic converter made with a coated substrate of the present disclosure and employed on a diesel engine or diesel vehicle, such as a light-duty diesel engine or light-duty diesel vehicle, displays NOₓ emissions of 80 mg/km or less, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which displays the same or similar emissions. In some embodiments, a catalytic converter made with a coated substrate of the present disclosure and employed on a diesel engine or diesel vehicle, such as a light-duty diesel engine or light-duty diesel vehicle, displays NOₓ emissions of 40 mg/km or less, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, a catalytic converter made with a coated substrate of the present disclosure and employed on a diesel engine or diesel vehicle, such as a light-duty diesel engine or light-duty diesel vehicle, displays NOₓ plus HC emissions of 230 mg/km or less, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which displays the same or similar emissions. In some embodiments, a catalytic converter made with a coated substrate of the present disclosure and employed on a diesel engine or diesel vehicle, such as a light-duty diesel engine or light-duty diesel vehicle, displays NOₓ plus HC emissions of 170 mg/km or less, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which displays the same or similar emissions. In some embodiments, a catalytic converter made with a coated substrate of the present disclosure and employed on a diesel engine or diesel vehicle, such as a light-duty diesel engine or light-duty diesel vehicle, displays NOₓ plus HC emissions of 85 mg/km or less, while using at least about 30% less, up to about 30% less, at least about 40% less, up to about 40% less, at least about 50% less, or up to about 50% less, platinum group metal or platinum group metal loading, as compared to a catalytic converter made using only wet chemistry methods which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 125,000 km, about 125,000 miles, about 150,000 km, or about 150,000 miles of operation (for both the catalytic converter made with a coated substrate of the present disclosure and the comparative catalytic converter).

In some embodiments, for the above-described comparisons, the thrifting (reduction) of platinum group metal for the catalytic converters made with substrates of the present disclosure is compared with either 1) a commercially available catalytic converter, made using wet chemistry, for the application disclosed (e.g., for use on a diesel engine or vehicle, such as a light-duty diesel engine or light-duty diesel vehicle), or 2) a catalytic converter made using only wet chemistry, which uses the minimal amount of platinum group metal to achieve the performance standard indicated.

In some embodiments, for the above-described comparisons, both the coated substrate according to the present disclosure, and the catalyst used in the commercially available catalytic converter or the catalyst prepared using only wet chemistry methods, are aged (by the same amount) prior to testing. In some embodiments, both the coated substrate according to the present disclosure, and the catalyst substrate used in the commercially available catalytic converter or the catalyst substrate prepared using only wet chemistry methods, are aged to about (or up to about) 50,000 kilometers, about (or up to about) 50,000 miles, about (or up to about) 75,000 kilometers, about (or up to about) 75,000 miles, about (or up to about) 100,000 kilometers, about (or up to about) 100,000 miles, about (or up to about) 125,000 kilometers, about (or up to about) 125,000 miles, about (or up to about) 150,000 kilometers, or about (or up to about) 150,000 miles. In some embodiments, for the above-described comparisons, both the coated substrate according to the present disclosure, and the catalyst substrate used in the commercially available catalytic converter or the catalyst substrate prepared using only wet chemistry methods, are artificially aged (by the same amount) prior to testing. In some embodiments, they are artificially aged by heating to about 400° C., about 500° C., about 600° C., about 700° C., about 800° C., about 900° C., about 1000° C., about 1100° C., or about 1200° C. for about (or up to about) 4 hours, about (or up to about) 6 hours, about (or up to about) 8 hours, about (or up to about) 10 hours, about (or up to about) 12 hours, about (or up to about) 14 hours, about (or up to about) 16 hours, about (or up to about) 18 hours, about (or up to about) 20 hours, about (or up to about) 22 hours, or about (or up to about) 24 hours. In some embodiments, they are artificially aged by heating to about 800° C. for about 16 hours.

In some embodiments, for the above-described comparisons, the thrifting (reduction) of platinum group metal for the catalytic converters made with substrates of the present disclosure is compared with either 1) a commercially available catalytic converter, made using only wet chemistry, for the application disclosed (e.g., for use on a diesel engine or vehicle, such as a light-duty diesel engine or light-duty diesel vehicle), or 2) a catalytic converter made using only wet chemistry, which uses the minimal amount of platinum group metal to achieve the performance standard indicated, and after the coated substrate according to the present disclosure and the catalytic substrate used in the commercially available catalyst or catalyst made using only wet chemistry with the minimal amount of PGM to achieve the performance standard indicated are aged as described above.

In some embodiments, for the above-described catalytic converters employing the coated substrates of the present disclosure, for the exhaust treatment systems using catalytic converters employing the coated substrates of the present disclosure, and for vehicles employing these catalytic converters and exhaust treatment systems, the catalytic converter is employed as a diesel oxidation catalyst along with a diesel particulate filter, or the catalytic converter is employed as a diesel oxidation catalyst along with a diesel particulate filter and a selective catalytic reduction unit, to meet or exceed the standards for CO and/or NOₓ, and/or HC described above.

### Heavy-Duty Diesel

In some embodiments of the present disclosure, a coated substrate as disclosed herein is housed within a catalytic converter in a position configured to receive exhaust gas from an internal combustion engine, such as in an exhaust system of an internal combustion engine. The catalytic converter can be used with the exhaust from a diesel engine, such as a heavy-duty diesel engine. The catalytic converter can be installed on a vehicle containing a diesel engine, such as a heavy-duty diesel engine.

The coated substrate is placed into a housing, such as that shown in FIG. 1, which can in turn be placed into an exhaust system (also referred to as an exhaust treatment system) of an internal combustion engine. The internal combustion engine can be a diesel engine, such as a heavy-duty diesel engine, such as the engine of a heavy-duty diesel vehicle. The exhaust system of the internal combustion engine receives exhaust gases from the engine, typically into an exhaust manifold, and delivers the exhaust gases to an exhaust treatment system. The catalytic converter forms part of the exhaust system and is often referred to as the diesel oxidation catalyst (DOC). The exhaust system can also include a diesel particulate filter (DPF) and/or a selective catalytic reduction unit (SCR unit) and/or a lean NOₓ trap (LNT); typical arrangements, in the sequence that exhaust gases are received from the engine, are DOC-DPF and DOC-DPF-SCR. The exhaust system can also include other components, such as oxygen sensors, HEGO (heated exhaust gas oxygen) sensors, UEGO (universal exhaust gas oxygen) sensors, sensors for other gases, and temperature sensors. The exhaust system can also include a controller such as an engine control unit (ECU), a microprocessor, or an engine management computer, which can adjust various parameters in the vehicle (fuel flow rate, fuel/air ratio, fuel injection, engine timing, valve timing, etc.) in order to optimize the components of the exhaust gases that reach the exhaust treatment system, so as to manage the emissions released into the environment.

“Treating” an exhaust gas, such as the exhaust gas from a diesel engine, such as a heavy-duty diesel engine, refers to having the exhaust gas proceed through an exhaust system (exhaust treatment system) prior to release into the environment. As noted above, typically the exhaust gas from the engine will flow through an exhaust system comprising a diesel oxidation catalyst and a diesel particulate filter, or an exhaust system comprising a diesel oxidation catalyst, a diesel particulate filter, and selective catalytic reduction unit (SCR), prior to release into the environment.

Catalytic converters and exhaust systems described herein can be employed in heavy-duty diesel vehicles. The United States Environmental Protection Agency (“U.S. EPA”) defines a “heavy-duty vehicle” as those vehicles with a gross vehicle weight rating of more 8,500 pounds, except certain passenger vehicles weighing less than 10,000 pounds. The U.S. EPA further defines a “light heavy-duty diesel engine” as an engine used in a vehicle heavier than 8,500 pounds but lighter than 19,500 pounds, with the exception of certain passenger vehicles weighing less than 10,000 pounds. The U.S. EPA further defines a “medium heavy-duty diesel engine” as an engine used in a vehicle which is 19,500 pounds or heavier but 33,000 pounds or lighter. The U.S. EPA further defines a “heavy heavy-duty diesel engine” as an engine used in a vehicle more than 33,000 pounds. In California, “light heavy-duty diesel engines” are defined as engines used in a vehicle heavier than 14,000 pounds but lighter than 19,500 for those vehicles manufactured in the year 1995 or later. In Europe, a “heavy-duty diesel engine” has been considered to be an engine used in a vehicle of more than 3.5 metric tons (more than 7,716 pounds). In some embodiments of the present disclosure, a heavy-duty diesel vehicle is a diesel vehicle with a weight of more than about 7,700 pounds, or more than about 8,500 pounds, or more than about 10,000 pounds, or more than about 14,000 pounds, or more than about 19,500 pounds, or more than about 33,000 pounds, and a heavy-duty diesel engine is an engine used in a heavy-duty diesel vehicle.

When used in a catalytic converter, the coated substrates disclosed herein may provide a significant improvement over other catalytic converters used with heavy-duty vehicles. Different ratios of mixed platinum group metals can separately affect the catalytic efficiency of HC, CO, and NOₓ emissions. For example, in some embodiments, catalytically active materials with a mixture of platinum and palladium at a ratio of 20:1 Pt/Pd (weight/weight) are more efficient at catalyzing NOₓ emissions and less efficient at catalyzing HC emissions when compared to catalytically active materials with a mixture of platinum and palladium at a ratio of 5:1 Pt/Pd (weight/weight) for an equivalent amount of total PGM used. At the elevated average running temperatures of catalytic converters in heavy-duty vehicles, it is important to efficiently catalyze NOₓ emissions without losing efficient catalysis of HC and CO emissions. The catalyst combinations and washcoat architectures disclosed herein provide for both effective catalysis of NOₓ emissions and efficient catalysis of HC and CO emissions. The coated substrates disclosed herein are well-suited for use in combination with a downstream Selective Catalytic Reduction (SCR) unit. The SCR catalytic process reduces noxious nitrogen oxides (NOₓ) to harmless nitrogen gas (N₂). Optimum SCR performance occurs when the ratio of NO to NO₂ (that is, the ratio of nitric oxide to nitrogen dioxide) entering the unit is 1:1. By oxidizing some of the NO to NO₂ upstream of the SCR unit, the coated substrates disclosed herein adjust the ratio of NO:NO₂ closer to that optimum 1:1 ratio, and thus improve the overall performance of the emission control system in reducing emissions of nitrogen oxides.

The Euro 5 emissions standards for heavy-duty vehicle emissions, in force as of October 2008, specify a limit of 1500 mg/kWh of CO emissions, 460 mg/kWh of HC emissions, and 2000 mg/kWh of NOₓ emissions (Directive 2005/55/EC). The Euro 6 emissions standards for heavy-duty vehicle emissions, scheduled for implementation in December 2013, specify a limit of 1500 mg/kWh of CO emissions, 130 mg/kWh of HC emissions, and 400 mg/kWh of NOₓ emissions (Regulation 595/2009/EC). The disclosed catalytic converter substrates can be used in an emission system to meet or exceed these standards. In some embodiments, the coated substrate is used in a catalytic converter (diesel oxidation catalyst) in the configuration DOC-DPF or DOC-DPF-SCR to meet or exceed these standards.

The U.S. EPA emissions standards for “heavy-duty highway compression-ignition engines and urban buses” for those vehicle manufactured after 2010 are summarized at http://www.epa.gov/otaq/standards/heavy-duty/hdci-exhausthtm and specify a limit of 15.5 g/bhp-hr of CO emissions, 140 mg/bhp-hr of non-methane hydrocarbons (NMHC) emissions, and 200 mg/bhp-hr NOₓ emissions for the EPA Transient Test Procedure and the Supplemental Emission Test. The U.S. EPA emissions standards for “heavy-duty highway compression-ignition engines and urban buses” for those vehicle manufactured after 2010 have a limit of 15.5 g/bhp-hr of CO emissions, 210 mg/bhp-hr of non-methane hydrocarbons (NMHC) emissions, and 300 mg/bhp-hr NOx emissions for the Not to Exceed Test method.

The U.S. EPA emissions standards for “heavy-duty highway engine—clean fuel fleet exhaust emission standards” are summarized at http://www.epa.gov/otaq/standards/heavy-duty/hd-cff.htm and specify an additional limit of 14.4 g/bhp-hr of CO emissions for heavy-duty diesel engine Inherently Low Emissions Vehicles (“ILEVs”) and 7.2 g/bhp-hr of CO emissions for heavy-duty diesel engine Ultra Low Emissions Vehicles (“ULEVs”).

The U.S. EPA considers the “useful life” of an engine to be the earlier of 10 years or 110,000 miles for a light heavy-duty diesel engine, 185,000 miles for a medium heavy-duty diesel engine, and 435,000 miles (or 22,000 hours running time) for a heavy heavy-duty diesel engine manufactured after 2004.

In some embodiments, a catalytic converter made with a coated substrate of the present disclosure employed on a diesel engine or diesel vehicle, such as a heavy-duty diesel engine or heavy-duty diesel vehicle, complies with the Euro 5 requirements for CO, HC, and NOₓ emissions. In some embodiments a catalytic converter made with a coated substrate of the present disclosure employed on a diesel engine or diesel vehicle, such as a heavy-duty diesel engine or heavy-duty diesel vehicle, emits less than 1500 mg/kWh of CO emissions, less than 460 mg/kWh of HC emissions, and less than 2000 mg/kWh NOₓ emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation

In some embodiments, a catalytic converter made with a coated substrate of the present disclosure employed on a diesel engine or diesel vehicle, such as a heavy-duty diesel engine or heavy-duty diesel vehicle, complies with Euro 5 requirements, while using at least about 30% less, up to about 30% less, at least about 40% less, up to about 40% less, at least about 50% less, or up to about 50% less, platinum group metal or platinum group metal loading, as compared to a catalytic converter made using a single type of catalytically active material and complies with Euro 5 requirements. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure employed on a diesel engine or diesel vehicle, such as a heavy-duty diesel engine or heavy-duty diesel vehicle, complies with the Euro 6 requirements for CO, HC, and NOₓ emissions. In some embodiments a catalytic converter made with a coated substrate of the present disclosure employed on a diesel engine or diesel vehicle, such as a heavy-duty diesel engine or heavy-duty diesel vehicle, emits less than 1500 mg/kWh of CO emissions, less than 130 mg/kWh of HC emissions, and less than 400 mg/kWh NOₓ emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle, complies with Euro 6 requirements, while using at least about 30% less, up to about 30% less, at least about 40% less, up to about 40% less, at least about 50% less, or up to about 50% less, platinum group metal or platinum group metal loading, as compared to a catalytic converter made using a single type of catalytically active material and complies with Euro 6 requirements. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), complies with the U.S. EPA “heavy-duty highway compression-ignition engines and urban buses” emissions standards for CO, HC, and NOₓ emissions. In some embodiments a catalytic converter made with a coated substrate of the present disclosure employed on a diesel engine or diesel vehicle, such as a heavy-duty diesel engine or heavy-duty diesel vehicle, emits less than 15.5 g/bhp-hr of CO emissions, 140 mg/bhp-hr of non-methane hydrocarbons (NMHC) emissions, and 200 mg/bhp-hr of NOₓ emissions. In some embodiments, the emissions requirements are full “useful life” requirements. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), complies with U.S. EPA “heavy-duty highway compression-ignition engines and urban buses” emissions standards while using at least about 30% less, up to about 30% less, at least about 40% less, up to about 40% less, at least about 50% less, or up to about 50% less, platinum group metal or platinum group metal loading, as compared to a catalytic converter made using a single type of catalytically active material and complies with U.S. EPA “heavy-duty highway compression-ignition engines and urban buses” emissions standards. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), complies with the U.S. EPA “heavy-duty highway engine—clean fuel fleet exhaust emission standards” ILEV emissions standards for CO, HC, and NOₓ emissions. In some embodiments a catalytic converter made with a coated substrate of the present disclosure employed on a diesel engine or diesel vehicle, such as a heavy-duty diesel engine or heavy-duty diesel vehicle, emits less than 14.4 g/bhp-hr of CO emissions, 140 mg/bhp-hr of non-methane hydrocarbons (NMHC) emissions, and 200 mg/bhp-hr of NOₓ emissions. In some embodiments, the emissions requirements are full “useful life” requirements. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), complies with U.S. EPA “heavy-duty highway engine—clean fuel fleet exhaust emission standards” ILEV emissions standards while using at least about 30% less, up to about 30% less, at least about 40% less, up to about 40% less, at least about 50% less, or up to about 50% less, platinum group metal or platinum group metal loading, as compared to a catalytic converter made using a single type of catalytically active material and complies with U.S. EPA “heavy-duty highway compression-ignition engines and urban buses” emissions standards. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), complies with the U.S. EPA “heavy-duty highway engine—clean fuel fleet exhaust emission standards” ULEV emissions standards for CO, HC, and NOₓ emissions. In some embodiments a catalytic converter made with a coated substrate of the present disclosure employed on a diesel engine or diesel vehicle, such as a heavy-duty diesel engine or heavy-duty diesel vehicle, emits less than 7.2 g/bhp-hr of CO emissions, 140 mg/bhp-hr of non-methane hydrocarbons (NMHC) emissions, and 200 mg/bhp-hr of NOₓ emissions. In some embodiments, the emissions requirements are full “useful life” requirements. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), complies with U.S. EPA “heavy-duty highway engine—clean fuel fleet exhaust emission standards” ULEV emissions standards while using at least about 30% less, up to about 30% less, at least about 40% less, up to about 40% less, at least about 50% less, or up to about 50% less, platinum group metal or platinum group metal loading, as compared to a catalytic converter made using a single type of catalytically active material and complies with U.S. EPA “heavy-duty highway compression-ignition engines and urban buses” emissions standards. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the comparative catalytic converter).

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays NOₓ emissions of 4000 mg/bhp-hr or less, 2400 mg/bhp-hr or less, 1200 mg/bhp-hr or less, 400 mg/bhp-hr or less, 200 mg/bhp-hr or less, 150 mg/bhp-hr or less, or 100 mg/bhp-hr or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays NOₓ emissions of 4000 mg/kWh or less, 3000 mg/kWh or less, 2000 mg/kWh or less, 1000 mg/kWh or less, 400 mg/kWh or less, 300 mg/kWh or less, or 200 mg/kWh or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays carbon monoxide emissions of 46.5 g/bhp-hr or less, 31 g/bhp-hr or less, 15.5 g/bhp-hr or less, 14.4 g/bhp-hr or less, 7.2 g/bhp-hr or less, or 3.6 g/bhp-hr or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays carbon monoxide emissions of 4500 mg/kWh or less, 3000 mg/kWh or less, 1500 mg/kWh or less, 1200 mg/kWh or less, 800 mg/kWh or less, or 600 mg/kWh or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays carbon monoxide emissions of 46.5 g/bhp-hr (grams per brake horsepower-hour) or less, 31 g/bhp-hr or less, 15.5 g/bhp-hr or less, 14.4 g/bhp-hr or less, 7.2 g/bhp-hr or less, 3.6 g/bhp-hr or less, and NOₓ emissions of 4000 mg/bhp-hr or less, 2400 mg/bhp-hr or less, 1200 mg/bhp-hr, 400 mg/bhp-hr or less, 200 mg/bhp-hr or less, 150 mg/bhp-hr or less, or 100 mg/bhp-hr or less. In some embodiments, the catalytic converter made with a coated substrate of the present disclosure demonstrates any of the foregoing performance standards about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays carbon monoxide emissions of 4500 mg/kWh or less, 3000 mg/kWh or less, 1500 mg/kWh or less, 1200 mg/kWh or less, 800 mg/kWh or less, or 600 mg/kWh or less, and NOₓ emissions of 4000 mg/kWh or less, 3000 mg/kWh or less, 2000 mg/kWh or less, 1000 mg/kWh or less, 400 mg/kWh or less, 300 mg/kWh or less, or 200 mg/kWh or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays non-methane hydrocarbon (NMHC) emissions of 2400 mg/bhp-hr or less, 1200 mg/bhp-hr or less, 600 mg/bhp-hr or less, 300 mg/bhp-hr or less, 140 mg/bhp-hr or less, 100 mg/bhp-hr or less, or 60 mg/bhp-hr or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), such as a heavy-duty diesel engine or heavy-duty diesel vehicle, displays hydrocarbon (HC) emissions of 2000 mg/kWh or less, 1000 mg/kWh or less, 920 mg/kWh or less, 460 mg/kWh or less, 250 mg/kWh or less, 130 mg/kWh or less, or 60 mg/kWh or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays non-methane hydrocarbon (NMHC) emissions of 2400 mg/bhp-hr or less, 1200 mg/bhp-hr or less, 600 mg/bhp-hr or less, 300 mg/bhp-hr or less, 140 mg/bhp-hr or less, 100 mg/bhp-hr or less, or 60 mg/bhp-hr or less, and NOₓ emissions of 4000 mg/bhp-hr or less, 2400 mg/bhp-hr or less, 1200 mg/bhp-hr, 400 mg/bhp-hr or less, 200 mg/bhp-hr or less, 150 mg/bhp-hr or less, or 100 mg/bhp-hr or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays hydrocarbon (HC) emissions of 2000 mg/kWh or less, 1000 mg/kWh or less, 920 mg/kWh or less, 460 mg/kWh or less, 250 mg/kWh or less, 130 mg/kWh or less, or 60 mg/kWh or less, and NOₓ emissions of 4000 mg/kWh or less, 3000 mg/kWh or less, 2000 mg/kWh or less, 1000 mg/kWh or less, 400 mg/kWh or less, 300 mg/kWh or less, or 200 mg/kWh or less. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation.

In some embodiments, a catalytic converter made with a coated substrate of the present disclosure and employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays NOₓ emissions of 4000 mg/bhp-hr or less, 2400 mg/bhp-hr or less, 1200 mg/bhp-hr or less, 400 mg/bhp-hr or less, 200 mg/bhp-hr or less, 150 mg/bhp-hr or less, or 100 mg/bhp-hr or less, while using at least about 30% less, up to about 30% less, at least about 40% less, up to about 40% less, at least about 50% less, or up to about 50% less, platinum group metal or platinum group metal loading, as compared to a reference catalytic converter made using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure and employed on a diesel engine or diesel vehicle, such as a heavy-duty diesel engine or heavy-duty diesel vehicle, displays NOₓ emissions of 4000 mg/kWh or less, 3000 mg/kWh or less, 1500 mg/kWh or less, 1200 mg/kWh or less, 800 mg/kWh or less, or 600 mg/kWh or less, while using at least about 30% less, up to about 30% less, at least about 40% less, up to about 40% less, at least about 50% less, or up to about 50% less, platinum group metal or platinum group metal loading, as compared to a reference catalytic converter made using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure and employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays carbon monoxide emissions of 46.5 g/bhp-hr or less, 31 g/bhp-hr or less, 15.5 g/bhp-hr or less, 14.4 g/bhp-hr or less, 7.2 g/bhp-hr or less, or 3.6 g/bhp-hr or less, while using at least about 30% less, up to about 30% less, at least about 40% less, up to about 40% less, at least about 50% less, or up to about 50% less, platinum group metal or platinum group metal loading, as compared to a catalytic converter made with w using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure and employed on a diesel engine or diesel vehicle, such as a heavy-duty diesel engine or heavy-duty diesel vehicle, displays carbon monoxide emissions of 4500 mg/kWh or less, 3000 mg/kWh or less, 1500 mg/kWh or less, 1200 mg/kWh or less, 800 mg/kWh or less, or 600 mg/kWh or less, while using at least about 30% less, up to about 30% less, at least about 40% less, up to about 40% less, at least about 50% less, or up to about 50% less, platinum group metal or platinum group metal loading, as compared to a reference catalytic converter made using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure and employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays carbon monoxide emissions of 46.5 g/bhp-hr or less, 31 g/bhp-hr or less, 15.5 g/bhp-hr or less, 14.4 g/bhp-hr or less, 7.2 g/bhp-hr or less, or 3.6 g/bhp-hr or less, and NOₓ emissions of 4000 mg/bhp-hr or less, 2400 mg/bhp-hr or less, 1200 mg/bhp-hr, 400 mg/bhp-hr or less, 200 mg/bhp-hr or less, 150 mg/bhp-hr or less, or 100 mg/bhp-hr or less, while using at least about 30% less, up to about 30% less, at least about 40% less, up to about 40% less, at least about 50% less, or up to about 50% less, platinum group metal or platinum group metal loading, as compared to a catalytic converter made with w using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the comparative catalytic converter).

In some embodiments, a catalytic converter made with a coated substrate of the present disclosure and employed on a diesel engine or diesel vehicle, such as a heavy-duty diesel engine or heavy-duty diesel vehicle, displays carbon monoxide emissions of 4500 mg/kWh or less, 3000 mg/kWh or less, 1500 mg/kWh or less, 1200 mg/kWh or less, 800 mg/kWh or less, or 600 mg/kWh or less, and NOₓ emissions of 4000 mg/kWh or less, 3000 mg/kWh or less, 2000 mg/kWh or less, 1000 mg/kWh or less, 400 mg/kWh or less, 300 mg/kWh or less, or 200 mg/kWh or less, while using at least about 30% less, up to about 30% less, at least about 40% less, up to about 40% less, at least about 50% less, or up to about 50% less, platinum group metal or platinum group metal loading, as compared to a catalytic converter made using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation for both the catalytic converter made with a coated substrate of the present disclosure and the comparative catalytic converter).

In some embodiments, a catalytic converter made with a coated substrate of the present disclosure and employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays non-methane hydrocarbon (NMHC) emissions of 2400 mg/bhp-hr or less, 1200 mg/bhp-hr or less, 600 mg/bhp-hr or less, 300 mg/bhp-hr or less, 140 mg/bhp-hr or less, 100 mg/bhp-hr or less, or 60 mg/bhp-hr or less, while using at least about 30% less, up to about 30% less, at least about 40% less, up to about 40% less, at least about 50% less, or up to about 50% less, platinum group metal or platinum group metal loading, as compared to a reference catalytic converter made using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure and employed on a diesel engine or diesel vehicle, such as a heavy-duty diesel engine or heavy-duty diesel vehicle, displays hydrocarbon (HC) emissions of 2000 mg/kWh or less, 1000 mg/kWh or less, 920 mg/kWh or less, 460 mg/kWh or less, 250 mg/kWh or less, 130 mg/kWh or less, or 60 mg/kWh or less, while using at least about 30% less, up to about 30% less, at least about 40% less, up to about 40% less, at least about 50% less, or up to about 50% less, platinum group metal or platinum group metal loading, as compared to a reference catalytic converter made using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the comparative catalytic converter).

In some embodiments, a catalytic converter made with a coated substrate of the present disclosure and employed on a diesel engine or diesel vehicle, such as a heavy-duty diesel engine or heavy-duty diesel vehicle (for example, a light heavy-duty diesel engine or light heavy-duty diesel vehicle, or a medium heavy-duty diesel engine or medium heavy-duty diesel vehicle, or a heavy heavy-duty diesel engine or heavy heavy-duty diesel vehicle), displays non-methane hydrocarbon (NMHC) emissions of 2400 mg/bhp-hr or less, 1200 mg/bhp-hr or less, 600 mg/bhp-hr or less, 300 mg/bhp-hr or less, 140 mg/bhp-hr or less, 100 mg/bhp-hr or less, or 60 mg/bhp-hr or less, and NOₓ emissions of 4000 mg/bhp-hr or less, 2400 mg/bhp-hr or less, 1200 mg/bhp-hr, 400 mg/bhp-hr or less, 200 mg/bhp-hr or less, 150 mg/bhp-hr or less, or 100 mg/bhp-hr or less, while using at least about 30% less, up to about 30% less, at least about 40% less, up to about 40% less, at least about 50% less, or up to about 50% less, platinum group metal or platinum group metal loading, as compared to a reference catalytic converter made using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the reference catalytic converter).

In some embodiments, a catalytic converter made with a coated substrate of the present disclosure and employed on a diesel engine or diesel vehicle, such as a heavy-duty diesel engine or heavy-duty diesel vehicle, displays hydrocarbon (HC) emissions of 2000 mg/kWh or less, 1000 mg/kWh or less, 920 mg/kWh or less, 460 mg/kWh or less, 250 mg/kWh or less, 130 mg/kWh or less, or 60 mg/kWh or less, and NOₓ emissions of 4000 mg/kWh or less, 3000 mg/kWh or less, 2000 mg/kWh or less, 1000 mg/kWh or less, 400 mg/kWh or less, 300 mg/kWh or less, or 200 mg/kWh or less, while using at least about 30% less, up to about 30% less, at least about 40% less, up to about 40% less, at least about 50% less, or up to about 50% less, platinum group metal or platinum group metal loading, as compared to a catalytic converter made using a single type of catalytically active material which displays the same or similar emissions. In some embodiments, the coated substrate is used in a catalytic converter (diesel oxidation catalyst) in the configuration DOC-DPF or DOC-DPF-SCR to meet or exceed these standards. In some embodiments, the catalytic converter made with a coated substrate of the present disclosure demonstrates any of the foregoing performance standards after about 50,000 km, about 50,000 miles, about 75,000 km, about 75,000 miles, about 100,000 km, about 100,000 miles, about 110.00 km, about 110,000 miles, about 125,000 km, about 125,000 miles, about 150,000 km, about 150,000 miles, about 185,000 km, about 185,000 miles, about 200,000 km, about 200,000 miles, about 300,000 km, about 300,000 miles, about 400,000 km, about 400,000 miles, about 435,000 km, or about 435,000 miles of operation (for both the catalytic converter made with a coated substrate of the present disclosure and the comparative catalytic converter).

In some embodiments, for the above-described comparisons, the thrifting (reduction) of platinum group metal for the catalytic converters made with substrates of the present disclosure is compared with either 1) a commercially available catalytic converter, made using a single type of catalytically active material, for the application disclosed (e.g., for use on a diesel engine or vehicle, such as a heavy-duty diesel engine or heavy-duty diesel vehicle), or 2) a catalytic converter made using a single type of catalytically active material, which uses the minimal amount of platinum group metal to achieve the performance standard indicated.

In some embodiments, for the above-described comparisons, both the coated substrate according to the present disclosure, and the catalyst used in the commercially available catalytic converter or the catalyst prepared using a single type of catalytically active material, are aged (by the same amount) prior to testing. In some embodiments, both the coated substrate according to the present disclosure, and the catalyst substrate used in the commercially available catalytic converter or the catalyst substrate prepared using a single type of catalytically active material, are aged to about (or up to about) 50,000 km, about (or up to about) 50,000 miles, about (or up to about) 75,000 km, about (or up to about) 75,000 miles, about (or up to about) 100,000 km, about (or up to about) 100,000 miles, about (or up to about) 110.00 km, about (or up to about) 110,000 miles, about (or up to about) 125,000 km, about (or up to about) 125,000 miles, about (or up to about) 150,000 km, about (or up to about) 150,000 miles, about (or up to about) 185,000 km, about (or up to about) 185,000 miles, about (or up to about) 200,000 km, about (or up to about) 200,000 miles, about (or up to about) 300,000 km, about (or up to about) 300,000 miles, about (or up to about) 400,000 km, about (or up to about) 400,000 miles, about (or up to about) 435,000 km, or about (or up to about) 435,000 miles of operation. In some embodiments, for the above-described comparisons, both the coated substrate according to the present disclosure, and the catalyst substrate used in the commercially available catalytic converter or the catalyst substrate prepared using a single type of catalytically active material, are artificially aged (by the same amount) prior to testing. In some embodiments, they are artificially aged by heating to anywhere from about 200° C. to about 1200° C., for example about 400° C., about 500° C., about 600° C., about 700° C., about 800° C., about 900° C., about 1000° C., about 1100° C., or about 1200° C. for anywhere from about (or up to about) 1 hour to about (our up to about 1000 hours, for example about (or up to about) 4 hours, about (or up to about) 6 hours, about (or up to about) 8 hours, about (or up to about) 10 hours, about (or up to about) 12 hours, about (or up to about) 14 hours, about (or up to about) 16 hours, about (or up to about) 18 hours, about (or up to about) 20 hours, about (or up to about) 22 hours, about (or up to about) 24 hours, about (or up to about) 50 hours, (about or up to about) 100 hours, about (or up to about) 500 hours, or about (or up to about) 1000 hours. In some embodiments, they can be artificially aged under any atmosphere, for example 0% to 80% oxygen, 0-80% nitrogen, and 0-80% moisture content. In some embodiments, they are artificially aged by heating to about 700° C. for about 16 hours under an atmosphere comprising about 20% oxygen, 75% nitrogen, and about 5% moisture.

In some embodiments, for the above-described catalytic converters employing the coated substrates of the present disclosure, for the exhaust treatment systems using catalytic converters employing the coated substrates of the present disclosure, and for vehicles employing these catalytic converters and exhaust treatment systems, the catalytic converter is employed as a diesel oxidation catalyst along with a diesel particulate filter, or the catalytic converter is employed as a diesel oxidation catalyst along with a diesel particulate filter and a selective catalytic reduction unit, to meet or exceed the standards for CO and/or NOₓ, and/or HC described above.

### EXEMPLARY EMBODIMENTS

### Embodiment 1

A coated substrate comprising: a substrate comprising a first zone and a second zone; the first zone comprising a washcoat layer comprising zeolite particles, and a washcoat layer comprising catalytically active particles comprising composite nanoparticles on micron-sized carrier particles, wherein the composite nanoparticles comprise a support nanoparticle and a catalytic nanoparticle; and the second zone comprising a washcoat layer comprising a passive NOx adsorber (PNA) material.

### Embodiment 2

The coated substrate of embodiment 1, wherein the composite nanoparticles are plasma-created.

### Embodiment 3

The coated substrate of any of embodiments 1-2, wherein a portion of the first zone and the second zone overlap.

### Embodiment 4

The coated substrate of any of embodiments 1-3, wherein the washcoat layer comprising zeolite particles is formed on top of the washcoat layer comprising catalytically active particles.

### Embodiment 5

The coated substrate of any of embodiments 1-3, wherein the washcoat layer comprising catalytically active particles is formed on top of the washcoat layer comprising zeolite particles.

### Embodiment 6

The coated substrate of any of embodiments 1-5, wherein the catalytic nanoparticles comprise at least one platinum group metal.

### Embodiment 7

The coated substrate of any of embodiments 1-6, wherein the catalytic nano-particles comprise platinum and palladium.

### Embodiment 8

The coated substrate of embodiment 7, wherein the catalytic nano-particles comprise platinum and palladium in a weight ratio of 4:1 platinum:palladium.

### Embodiment 9

The coated substrate of any of embodiments 1-8, wherein the support nano-particles have an average diameter of 10 nm to 20 nm.

### Embodiment 10

The coated substrate of any of embodiments 1-9, wherein the catalytic nano-particles have an average diameter of between 1 nm and 5 nm.

### Embodiment 11

The coated substrate of any of embodiments 1-10, wherein the washcoat layer comprising zeolite particles comprises metal-oxide particles and boehmite particles.

### Embodiment 12

The coated substrate of embodiment 11, wherein the metal-oxide particles are aluminum-oxide particles.

### Embodiment 13

The coated substrate of any of embodiments 11-12, wherein the zeolite particles comprise 60% to 80% by weight of the mixture of zeolite particles, metal-oxide particles, and boehmite particles in the washcoat layer comprising zeolite particles.

### Embodiment 14

The coated substrate of any of embodiments 11-13, wherein the boehmite particles comprise 2% to 5% by weight of the mixture of zeolite particles, metal-oxide particles, and boehmite particles in the washcoat layer comprising zeolite particles.

### Embodiment 15

The coated substrate of any of embodiments 11-14, wherein the metal-oxide particles comprise 15% to 38% by weight of the mixture of zeolite particles, metal-oxide particles, and boehmite particles in the washcoat layer comprising zeolite particles.

### Embodiment 16

The coated substrate of any of embodiments 1-15, wherein the washcoat layer comprising zeolite particles does not include platinum group metals.

### Embodiment 17

The coated substrate of any of embodiments 1-16, wherein the zeolite particles in the washcoat layer comprising zeolite particles each have a diameter of 0.2 microns to 8 microns.

### Embodiment 18

The coated substrate of any of embodiments 1-17, wherein the washcoat layer comprising catalytically active particles further comprises boehmite particles and silica particles.

### Embodiment 19

The coated substrate of any of embodiments 1-18, wherein the washcoat layer comprising catalytically active particles is substantially free of zeolites.

### Embodiment 20

The coated substrate of any of embodiments 18-19, wherein the catalytically active particles comprise 35% to 95% by weight of the combination of the catalytically active particles, boehmite particles, and silica particles in the washcoat layer comprising catalytically active particles.

### Embodiment 21

The coated substrate of any of embodiments 18-20, wherein the silica particles are present in an amount up to 20% by weight of the combination of the catalytically active particles, boehmite particles, and silica particles in the washcoat layer comprising catalytically active particles.

### Embodiment 22

The coated substrate of any of embodiments 17-21, wherein the boehmite particles comprise 2% to 5% by weight of the combination of the catalytically active particles, the boehmite particles, and the silica particles in the washcoat layer comprising catalytically active particles.

### Embodiment 23

The coated substrate of any of embodiments 18-22, wherein the washcoat layer comprising catalytically active particles comprises 92% by weight of the catalytically active particles, 3% by weight of the boehmite particles, and 5% by weight of the silica particles.

### Embodiment 24

The coated substrate of any one of embodiments 1-23, wherein the PNA material comprises an alkali oxide or alkaline earth oxide on a plurality of micron-sized support particles.

### Embodiment 25

The coated substrate of embodiment 24, wherein the PNA material comprises a second alkali oxide or alkaline earth oxide on a second plurality of micron-sized support particles.

### Embodiment 26

The coated substrate of embodiment 25, wherein the PNA material comprises a third alkali oxide or alkaline earth oxide on a third plurality of micron-sized support particles.

### Embodiment 27

The coated substrate of any one of embodiments 24-26, wherein the first, second, and third alkali oxides or alkaline earth oxides are selected from the group consisting of manganese oxide, magnesium oxide, and calcium oxide.

### Embodiment 28

The coated substrate of any one of embodiments 1-27, wherein the PNA material comprises PGM.

### Embodiment 29

The coated substrate of embodiment 28, wherein PGM are on a fourth plurality of micron-sized support particles.

### Embodiment 30

The coated substrate of any one of embodiments 28-29, wherein PGM are on at least one of the first, second, or third pluralities of micron-sized support particles.

### Embodiment 31

The coated substrate of any one of embodiments 28-30, wherein the PGM comprises platinum, palladium, or a mixture thereof.

### Embodiment 32

The coated substrate of any one of embodiments 28-31, wherein the PGM on a plurality of micron-sized support particles comprises a NNm or NNiM particle.

### Embodiment 33

The coated substrate of any one of embodiments 24-32, wherein the alkali oxides or alkaline earth oxides are nano-sized.

### Embodiment 34

The coated substrate of any one of embodiments 24-33, wherein the pluralities of support particles comprise ceria.

### Embodiment 35

The coated substrate of embodiment 34, wherein the PNA material comprises about 150 g/L to about 350 g/L ceria.

### Embodiment 36

The coated substrate of any one of embodiments 1-35, wherein the PNA material stores NOₓ emissions from ambient temperature to about 100° C.

### Embodiment 37

The coated substrate of any one of embodiments 1-36, wherein the PNA material stores NOₓ emissions from ambient temperature to about 150° C.

### Embodiment 38

The coated substrate of any one of embodiments 1-37, wherein the PNA material stores NOₓ emissions from ambient temperature to about 200° C.

### Embodiment 39

The coated substrate of any one of embodiments 1-38, wherein the washcoat layer comprising the PNA material further comprises boehmite particles.

### Embodiment 40

The coated substrate of embodiment 39, wherein the PNA material comprises 95% to 98% by weight of the mixture of PNA material and boehmite particles in the washcoat layer comprising PNA material.

### Embodiment 41

The coated substrate of any one of embodiments 39-40, wherein the boehmite particles comprise 2% to 5% by weight of the mixture of PNA material and boehmite particles in the washcoat layer comprising PNA material.

### Embodiment 42

The coated substrate of any one of embodiments 1-41, wherein the substrate comprises cordierite.

### Embodiment 43

The coated substrate of any one of embodiments 1-42, wherein the substrate comprises a honeycomb structure.

### Embodiment 44

The coated substrate of any one of embodiments 1-43, wherein the washcoat layer comprising zeolite particles has a thickness of 25 g/l to 90 g/l.

### Embodiment 45

The coated substrate of any one of embodiments 1-44, wherein the washcoat layer comprising catalytically active particles has a thickness of 50 g/l to 250 g/l.

### Embodiment 46

The coated substrate of any one of embodiments 1-45, further comprising a corner-fill layer deposited directly on the substrate.

### Embodiment 47

The coated substrate of any one of embodiments 1-46, wherein the coated substrate has a platinum group metal loading of 4 g/l or less and a light-off temperature for carbon monoxide at least 5° C. lower than the light-off temperature of a substrate with the same platinum group metal loading deposited by solely wet-chemistry methods.

### Embodiment 48

The coated substrate of any one of embodiments 1-47, wherein the coated substrate has a platinum group metal loading of about 3.0 g/l to about 4.0 g/l.

### Embodiment 49

The coated substrate of any one of embodiments 1-48, said coated substrate having a platinum group metal loading of about 3.0 g/l to about 5.5 g/l, wherein after 125,000 miles of operation in a vehicular catalytic converter, the coated substrate has a light-off temperature for carbon monoxide at least 5° C. lower than a coated substrate prepared by depositing platinum group metals solely by wet chemical methods having the same platinum group metal loading after 125,000 miles of operation in a vehicular catalytic converter.

### Embodiment 50

The coated substrate of any one of embodiments 1-49, said coated substrate having a platinum group metal loading of about 3.0 g/l to about 5.5 g/l, wherein after aging for 16 hours at 800° C., the coated substrate has a light-off temperature for carbon monoxide at least 5° C. lower than a coated substrate prepared by depositing platinum group metals solely by wet chemical methods having the same platinum group metal loading after aging for 16 hours at 800° C.

### Embodiment 51

A catalytic converter comprising a coated substrate according to any of embodiments 1-50.

### Embodiment 52

An exhaust treatment system comprising a conduit for exhaust gas and a catalytic converter according to embodiment 51.

### Embodiment 53

A diesel vehicle comprising a catalytic converter according to embodiment 51.

### Embodiment 54

The diesel vehicle of embodiment 53, wherein said diesel vehicle is a light-duty diesel vehicle.

### Embodiment 55

A method of treating an exhaust gas, comprising contacting the coated substrate of any of Embodiments 1-50 with the exhaust gas.

### Embodiment 56

The method of embodiment 55, wherein the exhaust gas contacts the first zone of the substrate before contacting the second zone of the substrate.

### Embodiment 57

A method of treating an exhaust gas, comprising contacting the coated substrate of any of Embodiments 1-50 with the exhaust gas, wherein the substrate is housed within a catalytic converter configured to receive the exhaust gas.

### Embodiment 58

The method of embodiment 57, wherein the exhaust gas contacts the first zone of the substrate before contacting the second zone of the substrate.

### Embodiment 59

A method of forming a coated substrate comprising: coating a first zone of a substrate with a washcoat composition comprising zeolite particles; coating the first zone of the substrate with a washcoat composition comprising catalytically active particles comprising composite nanoparticles on micron-sized carrier particles, wherein the composite nanoparticles comprise a support nanoparticle and a catalytic nanoparticle; coating a second zone of the substrate with a washcoat composition comprising a PNA material.

### Embodiment 60

The method of embodiment 59, wherein the composite nanoparticles are plasma-created.

### Embodiment 61

The method of any of embodiments 59-60, wherein a portion of the first zone and the second zone overlap.

### Embodiment 62

The method of any of embodiments 57-61, wherein coating the first zone of the substrate with the washcoat composition comprising zeolite particles is performed before coating the first zone of the substrate with the washcoat composition comprising catalytically active particles.

### Embodiment 63

The method of any of embodiments 57-61, wherein coating the first zone of the substrate with the washcoat composition comprising catalytically active particles is performed before coating the first zone of the substrate with the washcoat composition comprising zeolite particles.

### Embodiment 64

The method of any of embodiments 59-63, wherein the catalytic nanoparticles comprise at least one platinum group metal.

### Embodiment 65

The method of any of embodiments 59-64, wherein the catalytic nano-particles comprise platinum and palladium.

### Embodiment 66

The method of embodiment 65, wherein the catalytic nano-particles comprise platinum and palladium in a weight ratio of 4:1 platinum:palladium.

### Embodiment 67

The method of any of embodiments 59-66, wherein the support nano-particles have an average diameter of 10 nm to 20 nm.

### Embodiment 68

The method of any of embodiments 59-67, wherein the catalytic nano-particles have an average diameter of between 1 nm and 5 nm.

### Embodiment 69

The method of any of embodiments 59-68, wherein the washcoat layer comprising zeolite particles comprises metal-oxide particles and boehmite particles.

### Embodiment 70

The method of embodiment 69, wherein the metal-oxide particles are aluminum-oxide particles.

### Embodiment 71

The method of any of embodiments 69-70, wherein the zeolite particles comprise 60% to 80% by weight of the mixture of zeolite particles, metal-oxide particles, and boehmite particles in the washcoat layer comprising zeolite particles.

### Embodiment 72

The method of any of embodiments 69-71, wherein the boehmite particles comprise 2% to 5% by weight of the mixture of zeolite particles, metal-oxide particles, and boehmite particles in the washcoat layer comprising zeolite particles.

### Embodiment 73

The method of any of embodiments 69-72, wherein the metal-oxide particles comprise 15% to 38% by weight of the mixture of zeolite particles, metal-oxide particles, and boehmite particles in the washcoat layer comprising zeolite particles.

### Embodiment 74

The method of any of embodiments 69-73, wherein the washcoat layer comprising zeolite particles does not include platinum group metals.

### Embodiment 75

The method of any of embodiments 59-74, wherein the zeolite particles in the washcoat layer comprising zeolite particles each have a diameter of 0.2 microns to 8 microns.

### Embodiment 76

The method of any of embodiments 59-75, wherein the washcoat layer comprising catalytically active particles further comprises boehmite particles and silica particles.

### Embodiment 77

The method of any of embodiments 59-76, wherein the washcoat layer comprising catalytically active particles is substantially free of zeolites.

### Embodiment 78

The method of any of embodiments 76-77, wherein the catalytically active particles comprise 35% to 95% by weight of the combination of the catalytically active particles, boehmite particles, and silica particles in the washcoat layer comprising catalytically active particles.

### Embodiment 79

The method of any of embodiments 76-78, wherein the silica particles are present in an amount up to 20% by weight of the combination of the catalytically active particles, boehmite particles, and silica particles in the washcoat layer comprising catalytically active particles.

### Embodiment 80

The method of any of embodiments 76-79, wherein the boehmite particles comprise 2% to 5% by weight of the combination of the catalytically active particles, the boehmite particles, and the silica particles in the washcoat layer comprising catalytically active particles.

### Embodiment 81

The method of any of embodiments 76-80, wherein the washcoat layer comprising catalytically active particles comprises 92% by weight of the catalytically active particles, 3% by weight of the boehmite particles, and 5% by weight of the silica particles.

### Embodiment 82

The method of any one of embodiments 59-81, wherein the PNA material comprises an alkali oxide or alkaline earth oxide on a plurality of micron-sized support particles.

### Embodiment 83

The method of embodiment 82, wherein the PNA material comprises a second alkali oxide or alkaline earth oxide on a second plurality of micron-sized support particles.

### Embodiment 84

The method of embodiment 83, wherein the PNA material comprises a third alkali oxide or alkaline earth oxide on a third plurality of micron-sized support particles.

### Embodiment 85

The method of any one of embodiments 82-84, wherein the first, second, and third alkali oxides or alkaline earth oxides are selected from the group consisting of manganese oxide, magnesium oxide, and calcium oxide.

### Embodiment 86

The method of any one of embodiments 59-85, wherein the PNA material comprises PGM.

### Embodiment 87

The method of embodiment 86, wherein PGM are on a fourth plurality of micron-sized support particles.

### Embodiment 88

The method of any one of embodiments 86-87, wherein PGM are on at least one of the first, second, or third pluralities of micron-sized support particles.

### Embodiment 89

The method of any one of embodiments 86-88, wherein the PGM comprises platinum, palladium, or a mixture thereof.

### Embodiment 90

The method of any one of embodiments 86-89, wherein the PGM on a plurality of micron-sized support particles comprises a NNm or NNiM particle.

### Embodiment 91

The method of any one of embodiments 82-90, wherein the alkali oxides or alkaline earth oxides are nano-sized.

### Embodiment 92

The method of any one of embodiments 82-91, wherein the pluralities of support particles comprise ceria.

### Embodiment 93

The method of embodiment 92, wherein the PNA material comprises about 150 g/L to about 350 g/L ceria.

### Embodiment 94

The method of any one of embodiments 59-93, wherein the PNA material stores NOₓ emissions from ambient temperature to about 100° C.

### Embodiment 95

The method of any one of embodiments 59-94, wherein the PNA material stores NOₓ emissions from ambient temperature to about 150° C.

### Embodiment 96

The method of any one of embodiments 59-95, wherein the PNA material stores NOₓ emissions from ambient temperature to about 200° C.

### Embodiment 97

The method of any one of embodiments 59-96, wherein the washcoat layer comprising the PNA material further comprises boehmite particles.

### Embodiment 98

The method of embodiment 97, wherein the PNA material comprises 95% to 98% by weight of the mixture of PNA material and boehmite particles in the washcoat layer comprising PNA material.

### Embodiment 99

The method of any one of embodiments 97-98, wherein the boehmite particles comprise 2% to 5% by weight of the mixture of PNA material and boehmite particles in the washcoat layer comprising PNA material.

### Embodiment 100

The method of any one of embodiments 59-99, wherein the substrate comprises cordierite.

### Embodiment 101

The method of any one of embodiments 59-100, wherein the substrate comprises a honeycomb structure.

### Embodiment 102

The method of any one of embodiments 59-101, wherein the washcoat layer comprising zeolite particles has a thickness of 25 g/l to 90 g/l.

### Embodiment 103

The method of any one of embodiments 59-102, wherein the washcoat layer comprising catalytically active particles has a thickness of 50 g/l to 250 g/l.

### Embodiment 104

The method of any one of embodiments 59-103, further comprising coating the substrate with a corner-fill washcoat composition prior to coating the substrate with the other washcoat compositions.

### Embodiment 105

The method of any one of embodiments 59-104, wherein the coated substrate has a platinum group metal loading of 4 g/l or less and a light-off temperature for carbon monoxide at least 5° C. lower than the light-off temperature of a substrate with the same platinum group metal loading deposited by solely wet-chemistry methods.

### Embodiment 106

The method of any one of embodiments 59-105, wherein the coated substrate has a platinum group metal loading of about 3.0 g/l to about 4.0 g/l.

### Embodiment 107

The method of any one of embodiments 59-106, said coated substrate having a platinum group metal loading of about 3.0 g/l to about 5.5 g/l, wherein after 125,000 miles of operation in a vehicular catalytic converter, the coated substrate has a light-off temperature for carbon monoxide at least 5° C. lower than a coated substrate prepared by depositing platinum group metals solely by wet chemical methods having the same platinum group metal loading after 125,000 miles of operation in a vehicular catalytic converter.

### Embodiment 108

The method of any one of embodiments 59-107, said coated substrate having a platinum group metal loading of about 3.0 g/l to about 5.5 g/l, wherein after aging for 16 hours at 800° C., the coated substrate has a light-off temperature for carbon monoxide at least 5° C. lower than a coated substrate prepared by depositing platinum group metals solely by wet chemical methods having the same platinum group metal loading after aging for 16 hours at 800° C.

### Embodiment 109

A catalytic converter comprising a coated substrate according to any one of embodiments 59-108.

### Embodiment 110

An exhaust treatment system comprising a conduit for exhaust gas and a catalytic converter according to embodiment 109.

### Embodiment 111

A vehicle comprising a catalytic converter according to embodiment 109.

### Embodiment 112

A diesel vehicle comprising a catalytic converter according to embodiment 109.

### Embodiment 113

The diesel vehicle of embodiment 112, wherein the diesel vehicle is a light-duty diesel vehicle.

### Embodiment 114

A vehicle comprising a catalytic converter comprising a coated substrate comprising: a substrate comprising a first zone and a second zone; the first zone comprising a washcoat layer comprising zeolite particles, and a washcoat layer comprising catalytically active particles comprising composite nanoparticles on micron-sized carrier particles, wherein the composite nanoparticles comprise a support nanoparticle and a catalytic nanoparticle; and the second zone comprising a washcoat layer comprising a PNA material.

### Embodiment 115

The vehicle of embodiment 114, wherein the composite nanoparticles are plasma-created.

### Embodiment 116

The vehicle of any of embodiments 114-115, wherein a portion of the first zone and the second zone overlap.

### Embodiment 117

The vehicle of any of embodiments 114-116, wherein the washcoat layer comprising zeolite particles is formed on top of the washcoat layer comprising catalytically active particles.

### Embodiment 118

The vehicle of any of embodiments 114-116, wherein the washcoat layer comprising catalytically active particles is formed on top of the washcoat layer comprising zeolite particles.

### Embodiment 119

The vehicle of any of embodiments 114-118, wherein the catalytic nanoparticles comprise at least one platinum group metal.

### Embodiment 120

The vehicle of any of embodiments 114-119, wherein the catalytic nano-particles comprise platinum and palladium.

### Embodiment 121

The vehicle of embodiment 120, wherein the catalytic nano-particles comprise platinum and palladium in a weight ratio of 4:1 platinum:palladium.

### Embodiment 122

The vehicle of any of embodiments 120-121, wherein the support nano-particles have an average diameter of 10 nm to 20 nm.

### Embodiment 123

The vehicle of any of embodiments 120-122, wherein the catalytic nano-particles have an average diameter of between 1 nm and 5 nm.

### Embodiment 124

The vehicle of any of embodiments 120-123, wherein the washcoat layer comprising zeolite particles comprises metal-oxide particles and boehmite particles.

### Embodiment 125

The vehicle of embodiment 124, wherein the metal-oxide particles are aluminum-oxide particles.

### Embodiment 126

The vehicle of any of embodiments 124-125, wherein the zeolite particles comprise 60% to 80% by weight of the mixture of zeolite particles, metal-oxide particles, and boehmite particles in the washcoat layer comprising zeolite particles.

### Embodiment 127

The vehicle of any of embodiments 124-126, wherein the boehmite particles comprise 2% to 5% by weight of the mixture of zeolite particles, metal-oxide particles, and boehmite particles in the washcoat layer comprising zeolite particles.

### Embodiment 128

The vehicle of any of embodiments 124-127, wherein the metal-oxide particles comprise 15% to 38% by weight of the mixture of zeolite particles, metal-oxide particles, and boehmite particles in the washcoat layer comprising zeolite particles.

### Embodiment 129

The vehicle of any of embodiments 114-128, wherein the washcoat layer comprising zeolite particles does not include platinum group metals.

### Embodiment 130

The vehicle of any of embodiments 114-129, wherein the zeolite particles in the washcoat layer comprising zeolite particles each have a diameter of 0.2 microns to 8 microns.

### Embodiment 131

The vehicle of any of embodiments 114-130, wherein the washcoat layer comprising catalytically active particles further comprises boehmite particles and silica particles.

### Embodiment 132

The vehicle of any of embodiments 114-131, wherein the washcoat layer comprising catalytically active particles is substantially free of zeolites.

### Embodiment 133

The vehicle of any of embodiments 131-132, wherein the catalytically active particles comprise 35% to 95% by weight of the combination of the catalytically active particles, boehmite particles, and silica particles in the washcoat layer comprising catalytically active particles.

### Embodiment 134

The vehicle of any of embodiments 131-133, wherein the silica particles are present in an amount up to 20% by weight of the combination of the catalytically active particles, boehmite particles, and silica particles in the washcoat layer comprising catalytically active particles.

### Embodiment 135

The vehicle of any of embodiments 131-134, wherein the boehmite particles comprise 2% to 5% by weight of the combination of the catalytically active particles, the boehmite particles, and the silica particles in the washcoat layer comprising catalytically active particles.

### Embodiment 136

The vehicle of any of embodiments 131-135, wherein the washcoat layer comprising catalytically active particles comprises 92% by weight of the catalytically active particles, 3% by weight of the boehmite particles, and 5% by weight of the silica particles.

### Embodiment 137

The vehicle of any one of embodiments 114-136, wherein the PNA material comprises an alkali oxide or alkaline earth oxide on a plurality of micron-sized support particles.

### Embodiment 138

The vehicle of embodiment 137, wherein the PNA material comprises a second alkali oxide or alkaline earth oxide on a second plurality of micron-sized support particles.

### Embodiment 139

The vehicle of embodiment 138, wherein the PNA material comprises a third alkali oxide or alkaline earth oxide on a third plurality of micron-sized support particles.

### Embodiment 140

The vehicle of any one of embodiments 137-139, wherein the first, second, and third alkali oxides or alkaline earth oxides are selected from the group consisting of manganese oxide, magnesium oxide, and calcium oxide.

### Embodiment 141

The vehicle of any one of embodiments 114-140, wherein the PNA material comprises PGM.

### Embodiment 142

The vehicle of embodiment 141, wherein PGM are on a fourth plurality of micron-sized support particles.

### Embodiment 143

The vehicle of any one of embodiments 141-142, wherein PGM are on at least one of the first, second, or third pluralities of micron-sized support particles.

### Embodiment 144

The vehicle of any one of embodiments 141-143, wherein the PGM comprises platinum, palladium, or a mixture thereof.

### Embodiment 145

The vehicle of any one of embodiments 141-144, wherein the PGM on a plurality of micron-sized support particles comprises a NNm or NNiM particle.

### Embodiment 146

The vehicle of any one of embodiments 137-145, wherein the alkali oxides or alkaline earth oxides are nano-sized.

### Embodiment 147

The vehicle of any one of embodiments 137-146, wherein the pluralities of support particles comprise ceria.

### Embodiment 148

The vehicle of embodiment 147, wherein the PNA material comprises about 150 g/L to about 350 g/L ceria.

### Embodiment 149

The vehicle of any one of embodiments 114-148, wherein the PNA material stores NOₓ emissions from ambient temperature to about 100° C.

### Embodiment 150

The vehicle of any one of embodiments 114-149, wherein the PNA material stores NOₓ emissions from ambient temperature to about 150° C.

### Embodiment 151

The vehicle of any one of embodiments 114-150, wherein the PNA material stores NOₓ emissions from ambient temperature to about 200° C.

### Embodiment 152

The vehicle of any one of embodiments 114-151, wherein the washcoat layer comprising the PNA material further comprises boehmite particles.

### Embodiment 153

The vehicle of embodiment 152, wherein the PNA material comprises 95% to 98% by weight of the mixture of PNA material and boehmite particles in the washcoat layer comprising PNA material.

### Embodiment 154

The vehicle of any one of embodiments 152-153, wherein the boehmite particles comprise 2% to 5% by weight of the mixture of PNA material and boehmite particles in the washcoat layer comprising PNA material.

### Embodiment 155

The vehicle of any one of embodiments 114-154, wherein the substrate comprises cordierite.

### Embodiment 156

The vehicle of any one of embodiments 114-155, wherein the substrate comprises a honeycomb structure.

### Embodiment 157

The vehicle of any one of embodiments 114-156, wherein the washcoat layer comprising zeolite particles has a thickness of 25 g/l to 90 g/l.

### Embodiment 158

The vehicle of any one of embodiments 114-157, wherein the washcoat layer comprising catalytically active particles has a thickness of 50 g/l to 250 g/l.

### Embodiment 159

The vehicle of any one of embodiments 114-158, further comprising a corner-fill layer deposited directly on the substrate.

### Embodiment 160

The vehicle of any one of embodiments 114-159, wherein the coated substrate has a platinum group metal loading of 4 g/l or less and a light-off temperature for carbon monoxide at least 5° C. lower than the light-off temperature of a substrate with the same platinum group metal loading deposited by solely wet-chemistry methods.

### Embodiment 161

The vehicle of any one of embodiments 114-160, wherein the coated substrate has a platinum group metal loading of about 3.0 g/l to about 4.0 g/l.

### Embodiment 162

The vehicle of any one of embodiments 114-161, said coated substrate having a platinum group metal loading of about 3.0 g/l to about 5.5 g/l, wherein after 125,000 miles of operation in a vehicular catalytic converter, the coated substrate has a light-off temperature for carbon monoxide at least 5° C. lower than a coated substrate prepared by depositing platinum group metals solely by wet chemical methods having the same platinum group metal loading after 125,000 miles of operation in a vehicular catalytic converter.

### Embodiment 163

The vehicle of any one of embodiments 114-162, said coated substrate having a platinum group metal loading of about 3.0 g/l to about 5.5 g/l, wherein after aging for 16 hours at 800° C., the coated substrate has a light-off temperature for carbon monoxide at least 5° C. lower than a coated substrate prepared by depositing platinum group metals solely by wet chemical methods having the same platinum group metal loading after aging for 16 hours at 800° C.

### Embodiment 164

The vehicle of any one of embodiments 114-163, wherein the vehicle is a diesel vehicle.

### Embodiment 165

The vehicle of embodiment 164, wherein the vehicle is a light duty diesel vehicle.

### Embodiment 166

The vehicle of any one of embodiments 114-165, wherein the vehicle complies with European emission standard Euro 5 or Euro 6.

### Embodiment 167

The vehicle of any one of embodiments 114-166, further comprising an SCR unit.

### Embodiment 168

A catalytic converter comprising a coated substrate comprising: a substrate comprising a first zone and a second zone; the first zone comprising a washcoat layer comprising zeolite particles, and a washcoat layer comprising catalytically active particles comprising composite nanoparticles on micron-sized carrier particles, wherein the composite nanoparticles comprise a support nanoparticle and a catalytic nanoparticle; and the second zone comprising a washcoat layer comprising a PNA material.

### Embodiment 169

The catalytic converter of embodiment 168, wherein the composite nanoparticles are plasma-created.

### Embodiment 170

The catalytic converter of any of embodiments 168-169, wherein a portion of the first zone and the second zone overlap.

### Embodiment 171

The catalytic converter of any of embodiments 168-170, wherein the washcoat layer comprising zeolite particles is formed on top of the washcoat layer comprising catalytically active particles.

### Embodiment 172

The catalytic converter of any of embodiments 168-170, wherein the washcoat layer comprising catalytically active particles is formed on top of the washcoat layer comprising zeolite particles.

### Embodiment 173

The catalytic converter of any of embodiments 168-172, wherein the catalytic nanoparticles comprise at least one platinum group metal.

### Embodiment 174

The catalytic converter of any of embodiments 168-173, wherein the catalytic nano-particles comprise platinum and palladium.

### Embodiment 175

The catalytic converter of embodiment 174, wherein the catalytic nano-particles comprise platinum and palladium in a weight ratio of 4:1 platinum:palladium.

### Embodiment 176

The catalytic converter of any of embodiments 168-175, wherein the support nano-particles have an average diameter of 10 nm to 20 nm.

### Embodiment 177

The catalytic converter of any of embodiments 168-176, wherein the catalytic nano-particles have an average diameter of between 1 nm and 5 nm.

### Embodiment 178

The catalytic converter of any of embodiments 168-177, wherein the washcoat layer comprising zeolite particles comprises metal-oxide particles and boehmite particles.

### Embodiment 179

The catalytic converter of embodiment 178, wherein the metal-oxide particles are aluminum-oxide particles.

### Embodiment 180

The catalytic converter of any of embodiments 178-179, wherein the zeolite particles comprise 60% to 80% by weight of the mixture of zeolite particles, metal-oxide particles, and boehmite particles in the washcoat layer comprising zeolite particles.

### Embodiment 181

The catalytic converter of any of embodiments 178-180, wherein the boehmite particles comprise 2% to 5% by weight of the mixture of zeolite particles, metal-oxide particles, and boehmite particles in the washcoat layer comprising zeolite particles.

### Embodiment 182

The catalytic converter of any of embodiments 178-181, wherein the metal-oxide particles comprise 15% to 38% by weight of the mixture of zeolite particles, metal-oxide particles, and boehmite particles in the washcoat layer comprising zeolite particles.

### Embodiment 183

The catalytic converter of any of embodiments 168-182, wherein the washcoat layer comprising zeolite particles does not include platinum group metals.

### Embodiment 184

The catalytic converter of any of embodiments 168-183, wherein the zeolite particles in the washcoat layer comprising zeolite particles each have a diameter of 0.2 microns to 8 microns.

### Embodiment 185

The catalytic converter of any of embodiments 168-184, wherein the washcoat layer comprising catalytically active particles further comprises boehmite particles and silica particles.

### Embodiment 186

The catalytic converter of any of embodiments 168-185, wherein the washcoat layer comprising catalytically active particles is substantially free of zeolites.

### Embodiment 187

The catalytic converter of any of embodiments 185-186, wherein the catalytically active particles comprise 35% to 95% by weight of the combination of the catalytically active particles, boehmite particles, and silica particles in the washcoat layer comprising catalytically active particles.

### Embodiment 188

The catalytic converter of any of embodiments 185-187, wherein the silica particles are present in an amount up to 20% by weight of the combination of the catalytically active particles, boehmite particles, and silica particles in the washcoat layer comprising catalytically active particles.

### Embodiment 189

The catalytic converter of any of embodiments 185-188, wherein the boehmite particles comprise 2% to 5% by weight of the combination of the catalytically active particles, the boehmite particles, and the silica particles in the washcoat layer comprising catalytically active particles.

### Embodiment 190

The catalytic converter of any of embodiments 185-189, wherein the washcoat layer comprising catalytically active particles comprises 92% by weight of the catalytically active particles, 3% by weight of the boehmite particles, and 5% by weight of the silica particles.

### Embodiment 191

The catalytic converter of any one of embodiments 168-190, wherein the PNA material comprises an alkali oxide or alkaline earth oxide on a plurality of micron-sized support particles.

### Embodiment 192

The catalytic converter of embodiment 191, wherein the PNA material comprises a second alkali oxide or alkaline earth oxide on a second plurality of micron-sized support particles.

### Embodiment 193

The catalytic converter of embodiment 192, wherein the PNA material comprises a third alkali oxide or alkaline earth oxide on a third plurality of micron-sized support particles.

### Embodiment 194

The catalytic converter of any one of embodiments 191-193, wherein the first, second, and third alkali oxides or alkaline earth oxides are selected from the group consisting of manganese oxide, magnesium oxide, and calcium oxide.

### Embodiment 195

The catalytic converter of any one of embodiments 168-194, wherein the PNA material comprises PGM.

### Embodiment 196

The catalytic converter of embodiment 195, wherein PGM are on a fourth plurality of micron-sized support particles.

### Embodiment 197

The catalytic converter of any one of embodiments 195-196, wherein PGM are on at least one of the first, second, or third pluralities of micron-sized support particles.

### Embodiment 198

The catalytic converter of any one of embodiments 195-197, wherein the PGM comprises platinum, palladium, or a mixture thereof.

### Embodiment 199

The catalytic converter of any one of embodiments 195-198, wherein the PGM on a plurality of micron-sized support particles comprises a NNm or NNiM particle.

### Embodiment 200

The catalytic converter of any one of embodiments 191-199, wherein the alkali oxides or alkaline earth oxides are nano-sized.

### Embodiment 201

The catalytic converter of any one of embodiments 191-200, wherein the pluralities of support particles comprise ceria.

### Embodiment 202

The catalytic converter of embodiment 201, wherein the PNA material comprises about 150 g/L to about 350 g/L ceria.

### Embodiment 203

The catalytic converter of any one of embodiments 168-202, wherein the PNA material stores NOₓ emissions from ambient temperature to about 100° C.

### Embodiment 204

The catalytic converter of any one of embodiments 168-203, wherein the PNA material stores NOₓ emissions from ambient temperature to about 150° C.

### Embodiment 205

The catalytic converter of any one of embodiments 168-204, wherein the PNA material stores NOₓ emissions from ambient temperature to about 200° C.

### Embodiment 206

The catalytic converter of any one of embodiments 168-205, wherein the washcoat layer comprising the PNA material further comprises boehmite particles.

### Embodiment 207

The catalytic converter of embodiment 206, wherein the PNA material comprises 95% to 98% by weight of the mixture of PNA material and boehmite particles in the washcoat layer comprising PNA material.

### Embodiment 208

The catalytic converter of any one of embodiments 206-207, wherein the boehmite particles comprise 2% to 5% by weight of the mixture of PNA material and boehmite particles in the washcoat layer comprising PNA material.

### Embodiment 209

The catalytic converter of any one of embodiments 168-208, wherein the substrate comprises cordierite.

### Embodiment 210

The catalytic converter of any one of embodiments 168-209, wherein the substrate comprises a honeycomb structure.

### Embodiment 211

The catalytic converter of any one of embodiments 168-210, wherein the washcoat layer comprising zeolite particles has a thickness of 25 g/l to 90 g/l.

### Embodiment 212

The catalytic converter of any one of embodiments 168-211, wherein the washcoat layer comprising catalytically active particles has a thickness of 50 g/l to 250 g/l.

### Embodiment 213

The catalytic converter of any one of embodiments 168-212, further comprising a corner-fill layer deposited directly on the substrate.

### Embodiment 214

The catalytic converter of any one of embodiments 168-213, wherein the coated substrate has a platinum group metal loading of 4 g/l or less and a light-off temperature for carbon monoxide at least 5° C. lower than the light-off temperature of a substrate with the same platinum group metal loading deposited by solely wet-chemistry methods.

### Embodiment 215

The catalytic converter of any one of embodiments 168-214, wherein the coated substrate has a platinum group metal loading of about 3.0 g/l to about 4.0 g/l.

### Embodiment 216

The catalytic converter of any one of embodiments 168-215, said coated substrate having a platinum group metal loading of about 3.0 g/l to about 5.5 g/l, wherein after 125,000 miles of operation in a vehicular catalytic converter, the coated substrate has a light-off temperature for carbon monoxide at least 5° C. lower than a coated substrate prepared by depositing platinum group metals solely by wet chemical methods having the same platinum group metal loading after 125,000 miles of operation in a vehicular catalytic converter.

### Embodiment 217

The catalytic converter of any one of embodiments 168-216, said coated substrate having a platinum group metal loading of about 3.0 g/l to about 5.5 g/l, wherein after aging for 16 hours at 800° C., the coated substrate has a light-off temperature for carbon monoxide at least 5° C. lower than a coated substrate prepared by depositing platinum group metals solely by wet chemical methods having the same platinum group metal loading after aging for 16 hours at 800° C.

### Embodiment 218

An exhaust treatment system comprising a conduit for exhaust gas and a catalytic converter comprising a coated substrate comprising: a substrate comprising a first zone and a second zone; the first zone comprising a washcoat layer comprising zeolite particles, and a washcoat layer comprising catalytically active particles comprising composite nanoparticles on micron-sized carrier particles, wherein the composite nanoparticles comprise a support nanoparticle and a catalytic nanoparticle; and the second zone comprising a washcoat layer comprising a PNA material.

### Embodiment 219

The exhaust treatment system of embodiment 218, wherein the composite nanoparticles are plasma-created.

### Embodiment 220

The exhaust treatment system of any of embodiments 218-219, wherein a portion of the first zone and the second zone overlap.

### Embodiment 221

The exhaust treatment system of any of embodiments 218-220, wherein the washcoat layer comprising zeolite particles is formed on top of the washcoat layer comprising catalytically active particles.

### Embodiment 222

The exhaust treatment system of any of embodiments 218-220, wherein the washcoat layer comprising catalytically active particles is formed on top of the washcoat layer comprising zeolite particles.

### Embodiment 223

The exhaust treatment system of any of embodiments 218-222, wherein the catalytic nanoparticles comprise at least one platinum group metal.

### Embodiment 224

The exhaust treatment system of any of embodiments 218-223, wherein the catalytic nano-particles comprise platinum and palladium.

### Embodiment 225

The exhaust treatment system of embodiment 224, wherein the catalytic nano-particles comprise platinum and palladium in a weight ratio of 4:1 platinum:palladium.

### Embodiment 226

The exhaust treatment system of any of embodiments 218-225, wherein the support nano-particles have an average diameter of 10 nm to 20 nm.

### Embodiment 227

The exhaust treatment system of any of embodiments 218-226, wherein the catalytic nano-particles have an average diameter of between 1 nm and 5 nm.

### Embodiment 228

The exhaust treatment system of any of embodiments 218-227, wherein the washcoat layer comprising zeolite particles comprises metal-oxide particles and boehmite particles.

### Embodiment 229

The exhaust treatment system of embodiment 228, wherein the metal-oxide particles are aluminum-oxide particles.

### Embodiment 230

The exhaust treatment system of any of embodiments 228-229, wherein the zeolite particles comprise 60% to 80% by weight of the mixture of zeolite particles, metal-oxide particles, and boehmite particles in the washcoat layer comprising zeolite particles.

### Embodiment 231

The exhaust treatment system of any of embodiments 228-230, wherein the boehmite particles comprise 2% to 5% by weight of the mixture of zeolite particles, metal-oxide particles, and boehmite particles in the washcoat layer comprising zeolite particles.

### Embodiment 232

The exhaust treatment system of any of embodiments 218-231, wherein the metal-oxide particles comprise 15% to 38% by weight of the mixture of zeolite particles, metal-oxide particles, and boehmite particles in the washcoat layer comprising zeolite particles.

### Embodiment 233

The exhaust treatment system of any of embodiments 218-232, wherein the washcoat layer comprising zeolite particles does not include platinum group metals.

### Embodiment 234

The exhaust treatment system of any of embodiments 218-233, wherein the zeolite particles in the washcoat layer comprising zeolite particles each have a diameter of 0.2 microns to 8 microns.

### Embodiment 235

The exhaust treatment system of any of embodiments 218-234, wherein the washcoat layer comprising catalytically active particles further comprises boehmite particles and silica particles.

### Embodiment 236

The exhaust treatment system of any of embodiments 218-235, wherein the washcoat layer comprising catalytically active particles is substantially free of zeolites.

### Embodiment 237

The exhaust treatment system of any of embodiments 235-236, wherein the catalytically active particles comprise 35% to 95% by weight of the combination of the catalytically active particles, boehmite particles, and silica particles in the washcoat layer comprising catalytically active particles.

### Embodiment 238

The exhaust treatment system of any of embodiments 235-237, wherein the silica particles are present in an amount up to 20% by weight of the combination of the catalytically active particles, boehmite particles, and silica particles in the washcoat layer comprising catalytically active particles.

### Embodiment 239

The exhaust treatment system of any of embodiments 235-238, wherein the boehmite particles comprise 2% to 5% by weight of the combination of the catalytically active particles, the boehmite particles, and the silica particles in the washcoat layer comprising catalytically active particles.

### Embodiment 240

The exhaust treatment system of any of embodiments 235-239, wherein the washcoat layer comprising catalytically active particles comprises 92% by weight of the catalytically active particles, 3% by weight of the boehmite particles, and 5% by weight of the silica particles.

### Embodiment 241

The exhaust treatment system of any one of embodiments 218-240, wherein the PNA material comprises an alkali oxide or alkaline earth oxide on a plurality of micron-sized support particles.

### Embodiment 242

The exhaust treatment system of embodiment 241, wherein the PNA material comprises a second alkali oxide or alkaline earth oxide on a second plurality of micron-sized support particles.

### Embodiment 243

The exhaust treatment system of embodiment 242, wherein the PNA material comprises a third alkali oxide or alkaline earth oxide on a third plurality of micron-sized support particles.

### Embodiment 244

The exhaust treatment system of any one of embodiments 241-243, wherein the first, second, and third alkali oxides or alkaline earth oxides are selected from the group consisting of manganese oxide, magnesium oxide, and calcium oxide.

### Embodiment 245

The exhaust treatment system of any one of embodiments 218-244, wherein the PNA material comprises PGM.

### Embodiment 246

The exhaust treatment system of embodiment 245, wherein PGM are on a fourth plurality of micron-sized support particles.

### Embodiment 247

The exhaust treatment system of any one of embodiments 245-246, wherein PGM are on at least one of the first, second, or third pluralities of micron-sized support particles.

### Embodiment 248

The exhaust treatment system of any one of embodiments 245-247, wherein the PGM comprises platinum, palladium, or a mixture thereof.

### Embodiment 249

The exhaust treatment system of any one of embodiments 245-248, wherein the PGM on a plurality of micron-sized support particles comprises a NNm or NNiM particle.

### Embodiment 250

The exhaust treatment system of any one of embodiments 241-249, wherein the alkali oxides or alkaline earth oxides are nano-sized.

### Embodiment 251

The exhaust treatment system of any one of embodiments 241-250, wherein the pluralities of support particles comprise ceria.

### Embodiment 252

The exhaust treatment system of embodiment 251, wherein the PNA material comprises about 150 g/L to about 350 g/L ceria.

### Embodiment 253

The exhaust treatment system of any one of embodiments 218-252, wherein the PNA material stores NOₓ emissions from ambient temperature to about 100° C.

### Embodiment 254

The exhaust treatment system of any one of embodiments 218-253, wherein the PNA material stores NOₓ emissions from ambient temperature to about 150° C.

### Embodiment 255

The exhaust treatment system of any one of embodiments 218-254, wherein the PNA material stores NOₓ emissions from ambient temperature to about 200° C.

### Embodiment 256

The exhaust treatment system of any one of embodiments 218-255, wherein the washcoat layer comprising the PNA material further comprises boehmite particles.

### Embodiment 257

The exhaust treatment system of embodiment 256, wherein the PNA material comprises 95% to 98% by weight of the mixture of PNA material and boehmite particles in the washcoat layer comprising PNA material.

### Embodiment 258

The exhaust treatment system of any one of embodiments 256-257, wherein the boehmite particles comprise 2% to 5% by weight of the mixture of PNA material and boehmite particles in the washcoat layer comprising PNA material.

### Embodiment 259

The exhaust treatment system of any one of embodiments 218-258, wherein the substrate comprises cordierite.

### Embodiment 260

The exhaust treatment system of any one of embodiments 218-259, wherein the substrate comprises a honeycomb structure.

### Embodiment 261

The exhaust treatment system of any one of embodiments 218-260, wherein the washcoat layer comprising zeolite particles has a thickness of 25 g/l to 90 g/l.

### Embodiment 262

The exhaust treatment system of any one of embodiments 218-261, wherein the washcoat layer comprising catalytically active particles has a thickness of 50 g/l to 250 g/l.

### Embodiment 263

The exhaust treatment system of any one of embodiments 218-262, further comprising a corner-fill layer deposited directly on the substrate.

### Embodiment 264

The exhaust treatment system of any one of embodiments 218-263, wherein the coated substrate has a platinum group metal loading of 4 g/l or less and a light-off temperature for carbon monoxide at least 5° C. lower than the light-off temperature of a substrate with the same platinum group metal loading deposited by solely wet-chemistry methods.

### Embodiment 265

The exhaust treatment system of any one of embodiments 218-264, wherein the coated substrate has a platinum group metal loading of about 3.0 g/l to about 4.0 g/l.

### Embodiment 266

The exhaust treatment system of any one of embodiments 218-265, said coated substrate having a platinum group metal loading of about 3.0 g/l to about 5.5 g/l, wherein after 125,000 miles of operation in a vehicular catalytic converter, the coated substrate has a light-off temperature for carbon monoxide at least 5° C. lower than a coated substrate prepared by depositing platinum group metals solely by wet chemical methods having the same platinum group metal loading after 125,000 miles of operation in a vehicular catalytic converter.

### Embodiment 267

The exhaust treatment system of any one of embodiments 218-266, said coated substrate having a platinum group metal loading of about 3.0 g/l to about 5.5 g/l, wherein after aging for 16 hours at 800° C., the coated substrate has a light-off temperature for carbon monoxide at least 5° C. lower than a coated substrate prepared by depositing platinum group metals solely by wet chemical methods having the same platinum group metal loading after aging for 16 hours at 800° C.

### Embodiment 268

The exhaust treatment system of any one of embodiments 218-267, further comprising an SCR unit.

### Embodiment 269

The coated substrate of embodiment 1, the method of embodiment 59, the vehicle of embodiment 114, the catalytic converter of embodiment 168, or the exhaust treatment system of embodiment 218, wherein the micron-sized carrier particles further comprise one or more platinum group metals deposited by a wet chemistry method or methods.

### Embodiment 270

A coated substrate comprising: a substrate comprising a first zone and a second zone; the first zone comprising a Passive NOx Adsorber (PNA) layer comprising nano-sized platinum group metal (PGM) on a plurality of support particles comprising cerium oxide; and the second zone comprising a first catalytic layer comprising a first composite nanoparticle, wherein the first composite nanoparticle comprises a first catalytic nanoparticle on a first support nanoparticle.

### Embodiment 271

The coated substrate of embodiment 270, wherein the first composite nanoparticle is plasma created.

### Embodiment 272

The coated substrate of embodiment 270, further comprising a third zone between the first zone and the second zone.

### Embodiment 273

The coated substrate of any of embodiments 270-272, wherein the first composite nanoparticle is bonded to a micron-sized carrier particle to form a first NNm particle.

### Embodiment 274

The coated substrate of any of embodiments 270-272, wherein the first composite nanoparticle is embedded within carrier particles to form a first NNiM particle.

### Embodiment 275

The coated substrate of any of embodiments 270-274, wherein the second zone further comprises a second catalytic layer comprising a second composite nanoparticle, wherein the second composite nanoparticle comprises a second catalytic nanoparticle on a second support nanoparticle.

### Embodiment 276

The coated substrate of embodiment 275, wherein the second catalytic layer is formed on top of the first catalytic layer.

### Embodiment 277

The coated substrate of any of embodiments 270-276, wherein the first, second, or first and second catalytic nanoparticles comprise at least one platinum group metal.

### Embodiment 278

The coated substrate of any of embodiments 270-277, wherein the first, second, or first and second catalytic nanoparticles comprise platinum and palladium.

### Embodiment 279

The coated substrate of embodiment 278, wherein the first, second, or first and second catalytic nanoparticles comprise platinum and palladium in a weight ratio of 2:1 to 10:1 platinum:palladium.

### Embodiment 280

The coated substrate of any of embodiments 270-279, wherein the first, second, or first and second support nanoparticles have an average diameter of 5 nm to 20 nm.

### Embodiment 281

The coated substrate of any of embodiments 270-280, wherein the first, second, or first and second catalytic nanoparticles have an average diameter of between 1 nm and 5 nm.

### Embodiment 282

The coated substrate of any of embodiments 270-281, wherein the second zone further comprises a zeolite layer comprising zeolite particles.

### Embodiment 283

The coated substrate of embodiment 282, wherein the zeolite layer does not include platinum group metals.

### Embodiment 284

The coated substrate of any of embodiments 282-283, wherein the zeolite layer is formed on top of the first catalytic layer.

### Embodiment 285

The coated substrate of any of embodiments 282-283, wherein the first catalytic layer is formed on top of the zeolite layer.

### Embodiment 286

The coated substrate of embodiment 285, wherein the second catalytic layer is formed on top of the first catalytic layer.

### Embodiment 287

The coated substrate of embodiment 286, wherein the first catalytic layer comprises platinum and palladium in a weight ratio of 2:1 to 4:1 platinum:palladium.

### Embodiment 288

The coated substrate of embodiment 287, wherein the second catalytic layer comprises platinum and palladium in a weight ratio of 10:1 platinum:palladium.

### Embodiment 289

The coated substrate of any of embodiments 270-288, wherein the first, second, or first and second catalytic layer is substantially free of zeolites.

### Embodiment 290

The coated substrate of any of embodiments 270-289, wherein the PNA layer stores NOₓ gas up to at least a first temperature and releases the stored NOₓ gas at or above the first temperature.

### Embodiment 291

The coated substrate of embodiment 290, wherein the first temperature is 150° C.

### Embodiment 292

The coated substrate of any one of embodiments 270-291, wherein the plurality of support particles are micron-sized.

### Embodiment 293

The coated substrate of any one of embodiments 270-292, wherein the plurality of support particles are nano-sized.

### Embodiment 294

The coated substrate of any one of embodiments 270-293, wherein the plurality of support particles further comprise zirconium oxide, lanthanum oxide, yttrium oxide, or a combination thereof.

### Embodiment 295

The coated substrate of embodiment 294, wherein the plurality of support particles comprise HSA5.

### Embodiment 296

The coated substrate of any of embodiments 270-295, wherein the nano-sized PGM on the plurality of support particles is produced by wet chemistry techniques followed by calcination.

### Embodiment 297

The coated substrate of any of embodiments 270-296, wherein the nano-sized PGM on the plurality of support particles is produced by incipient wetness followed by calcination.

### Embodiment 298

The coated substrate of any of embodiments 270-291 and 293-297, wherein the nano-sized PGM on the plurality of support particles comprise PNA composite nanoparticles, wherein the PNA composite nanoparticles comprise a PGM nanoparticle on a third support particle comprising cerium oxide.

### Embodiment 299

The coated substrate of embodiment 298, wherein the PNA composite nanoparticles are bonded to micron-sized carrier particles to form second NNm particles.

### Embodiment 300

The coated substrate of embodiment 298, wherein the PNA composite nanoparticles are embedded within carrier particles to form second NNiM particles.

### Embodiment 301

The coated substrate of any one of embodiments 299-300, wherein the carrier particles comprise cerium oxide, zirconium oxide, lanthanum oxide, yttrium oxide, or a combination thereof.

### Embodiment 302

The coated substrate of embodiment 301, wherein the carrier particle comprises 86 wt % cerium oxide, 10 wt % zirconium oxide, and 4 wt % lanthanum oxide.

### Embodiment 303

The coated substrate of any one of embodiments 270-302, wherein the PNA composite nanoparticles are plasma created.

### Embodiment 304

The coated substrate of any one of embodiments 270-303, wherein the PGM comprises palladium.

### Embodiment 305

The coated substrate of embodiment 304, wherein the PNA layer comprises about 2 g/L to about 4 g/L palladium.

### Embodiment 306

The coated substrate of embodiment 305, wherein the PNA layer comprises about 3 g/L palladium.

### Embodiment 307

The coated substrate of any one of embodiments 304-306, wherein the coated substrate is used in a greater than or equal to 2.5 L engine system.

### Embodiment 308

The coated substrate of any one of embodiments 270-303, wherein the PGM comprises ruthenium.

### Embodiment 309

The coated substrate of embodiment 308, wherein the PNA layer comprises about 3 g/L to about 15 g/L ruthenium.

### Embodiment 310

The coated substrate of embodiment 309, wherein the PNA layer comprises about 5 g/L to about 6 g/L ruthenium.

### Embodiment 311

The coated substrate of any one of embodiments 308-310, wherein the first temperature is 300° C.

### Embodiment 312

The coated substrate of any one of embodiments 308-311, wherein the coated substrate is used in a less than or equal to 2.5 L engine system.

### Embodiment 313

The coated substrate of any one of embodiments 270-312, wherein the PNA layer comprises greater than or equal to about 150 g/L of the plurality of support particles.

### Embodiment 314

The coated substrate of any one of embodiments 270-313, wherein the PNA layer comprises greater than or equal to about 300 g/L of the plurality of support particles.

### Embodiment 315

The coated substrate of any one of embodiments 270-314, wherein the PNA layer further comprises boehmite particles.

### Embodiment 316

The coated substrate of embodiment 315, wherein the nano-sized PGM on the plurality of support particles comprises 95% to 98% by weight of the mixture of the nano-sized PGM on the plurality of support particles and boehmite particles in the PNA layer.

### Embodiment 317

The coated substrate of any one of embodiments 315-316, wherein the boehmite particles comprise 2% to 5% by weight of the mixture of the nano-sized PGM on the plurality of support particles and boehmite particles in the PNA layer.

### Embodiment 318

The coated substrate of any one of embodiments 270-317, wherein the substrate comprises cordierite.

### Embodiment 319

The coated substrate of any one of embodiments 270-318, wherein the substrate comprises a honeycomb structure.

### Embodiment 320

The coated substrate of any one of embodiments 270-319, further comprising a corner-fill layer deposited directly on the substrate.

### Embodiment 321

The coated substrate of embodiment 320, wherein the corner-fill layer is deposited directly on the second zone of the substrate.

### Embodiment 322

The coated substrate of embodiment 321, wherein the corner-fill layer is deposited directly on the first and second zone of the substrate.

### Embodiment 323

A catalytic converter comprising a coated substrate according to any of embodiments 270-322.

### Embodiment 324

An exhaust treatment system comprising a conduit for exhaust gas and a catalytic converter according to embodiment 323.

### Embodiment 325

A vehicle comprising a catalytic converter according to embodiment 323.

### Embodiment 326

The vehicle of embodiment 325, wherein the vehicle complies with the European emission standard Euro 5.

### Embodiment 327

The vehicle of embodiment 325, wherein the vehicle complies with the European emission standard Euro 6.

### Embodiment 328

The vehicle of embodiment 325, wherein said vehicle is a diesel vehicle.

### Embodiment 329

The vehicle of embodiment 326, wherein the diesel vehicle is a light-duty diesel vehicle or a heavy-duty diesel vehicle.

### Embodiment 330

A method of treating an exhaust gas, comprising contacting the coated substrate of any of embodiments 270-322 with the exhaust gas.

### Embodiment 331

The method of embodiment 330, wherein the exhaust gas contacts the first zone of the substrate before contacting the second zone of the substrate.

### Embodiment 332

A method of treating an exhaust gas, comprising contacting the coated substrate of any of embodiments 270-322 with the exhaust gas, wherein the substrate is housed within a catalytic converter configured to receive the exhaust gas.

### Embodiment 333

The method of embodiment 333, wherein the exhaust gas contacts the first zone of the substrate before contacting the second zone of the substrate.

### Embodiment 334

A method of forming a coated substrate comprising: coating a first zone of a substrate with a Passive NOx Adsorber (PNA) washcoat composition comprising nano-sized platinum group metal (PGM) on a plurality of support particles comprising cerium oxide; and coating a second zone of the substrate with a first catalytic washcoat composition comprising a first composite nanoparticle, wherein the first composite nanoparticle comprises a first catalytic nanoparticle on a first support nanoparticle.

### Embodiment 335

The method of embodiment 334, wherein there is a third zone between the first zone and the second zone.

### Embodiment 336

The method of embodiment 334, wherein the second zone is coated prior to coating the first zone.

### Embodiment 337

The method of any of embodiments 334-336, wherein the first composite nanoparticle is bonded to a micron-sized carrier particle to form a first NNm particle.

### Embodiment 338

The method of any of embodiments 334-336, wherein the first composite nanoparticle is embedded within carrier particles to form a first NNiM particles.

### Embodiment 339

The method of any of embodiments 334-336, further comprising coating the second zone with a second catalytic washcoat composition comprising a second composite nanoparticle, wherein the second composite nanoparticle comprises a second catalytic nanoparticle on a second support nanoparticle.

### Embodiment 340

The method of embodiment 339, wherein coating the second zone of the substrate with the first catalytic washcoat composition is performed before coating the second zone of the substrate with the second catalytic washcoat composition.

### Embodiment 341

The method of any of embodiments 334-340, wherein the first, second, or first and second catalytic nanoparticles comprise at least one platinum group metal.

### Embodiment 342

The method of any of embodiments 334-341, wherein the first, second, or first and second catalytic nanoparticles comprise platinum and palladium.

### Embodiment 343

The method of embodiment 342, wherein the first, second, or first and second catalytic nanoparticles comprise platinum and palladium in a weight ratio of 2:1 to 10:1 platinum:palladium.

### Embodiment 344

The method of any of embodiments 334-343, wherein the first, second, or first and second support nanoparticles have an average diameter of 5 nm to 20 nm.

### Embodiment 345

The method of any of embodiments 334-344, wherein the first, second, or first and second catalytic nanoparticles have an average diameter of between 1 nm and 5 nm.

### Embodiment 346

The method of any of embodiments 334-345, further comprising coating the second zone of the substrate with a zeolite washcoat composition comprising zeolite particles.

### Embodiment 347

The method of embodiment 346, wherein the zeolite washcoat composition does not include platinum group metals.

### Embodiment 348

The method of any of embodiments 346-347, wherein coating the second zone of the substrate with the first catalytic washcoat composition is performed before coating the second zone of the substrate with the zeolite washcoat composition.

### Embodiment 349

The method of any of embodiments 346-347, wherein coating the second zone of the substrate with the zeolite washcoat composition is performed before coating the second zone of the substrate with the first catalytic washcoat composition.

### Embodiment 350

The method of embodiment 349, wherein coating the second zone of the substrate with the first catalytic washcoat composition is performed before coating the second zone of the substrate with the second catalytic washcoat composition.

### Embodiment 351

The method of embodiment 350, wherein the first catalytic washcoat composition comprises platinum and palladium in a weight ratio of 2:1 to 4:1 platinum:palladium.

### Embodiment 352

The method of embodiment 351, wherein the second catalytic washcoat composition comprises platinum and palladium in a weight ratio of 10:1 platinum:palladium.

### Embodiment 353

The method of any of embodiments 334-352, wherein the first, second, or first and second catalytic washcoat compositions are substantially free of zeolites.

### Embodiment 354

The method of any of embodiments 334-353, wherein the PNA washcoat composition stores NOₓ gas up to at least a first temperature and releases the stored NOₓ gas at or above the first temperature.

### Embodiment 355

The method of embodiment 354, wherein the first temperature is 150° C.

### Embodiment 356

The method of any one of embodiments 334-355, wherein the plurality of support particles are micron-sized.

### Embodiment 357

The method of any one of embodiments 334-356, wherein the plurality of support particles are nano-sized.

### Embodiment 358

The method of any one of embodiments 334-357, wherein the plurality of support particles further comprise zirconium oxide, lanthanum oxide, yttrium oxide, or a combination thereof.

### Embodiment 359

The method of embodiment 358, wherein the plurality of support particles comprise HSA5.

### Embodiment 360

The method of any of embodiments 334-359, wherein the nano-sized PGM on the plurality of support particles is produced by wet chemistry techniques followed by calcination.

### Embodiment 361

The method of any of embodiments 334-360, wherein the nano-sized PGM on the plurality of support particles is produced by incipient wetness followed by calcination.

### Embodiment 362

The method of any of embodiments 334-355 and 357-361, wherein the nano-sized PGM on the plurality of support particles comprise PNA composite nanoparticles, wherein the PNA composite nanoparticles comprise a PGM nanoparticle on a third support nanoparticle comprising cerium oxide.

### Embodiment 363

The method of embodiment 362, wherein the PNA composite nanoparticles are bonded to micron-sized carrier particles to form second NNm particles.

### Embodiment 364

The method of embodiment 362, wherein the PNA composite nano-particles are embedded within carrier particles to form second NNiM particles.

### Embodiment 365

The method of any one of embodiments 363-364, wherein the carrier particles comprise cerium oxide, zirconium oxide, lanthanum oxide, yttrium oxide, or a combination thereof.

### Embodiment 366

The method of embodiment 365, wherein the carrier particle comprises 86 wt % cerium oxide, 10 wt % zirconium oxide, and 4 wt % lanthanum oxide.

### Embodiment 367

The method of any one of embodiments 334-366, wherein the first, second, and PNA composite nanoparticles are plasma created.

### Embodiment 368

The method of any one of embodiments 334-367, wherein the PGM comprises palladium.

### Embodiment 369

The method of embodiment 368, wherein the PNA washcoat composition comprises about 2 g/L to about 4 g/L palladium.

### Embodiment 370

The method of embodiment 369, wherein the PNA washcoat composition comprises about 3 g/L palladium.

### Embodiment 371

The method of any one of embodiments 368-370, wherein the coated substrate is used in a greater than or equal to 2.5 L engine system.

### Embodiment 372

The method of any one of embodiments 334-367, wherein the PGM comprises ruthenium.

### Embodiment 373

The method of embodiment 372, wherein the PNA washcoat composition comprises about 3 g/L to about 15 g/L ruthenium.

### Embodiment 374

The method of embodiment 373, wherein the PNA washcoat composition comprises about 5 g/L to about 6 g/L ruthenium.

### Embodiment 375

The method of any one of embodiments 372-374, wherein the first temperature is 300° C.

### Embodiment 376

The method of any one of embodiments 372-375, wherein the coated substrate is used in a less than or equal to 2.5 L engine system.

### Embodiment 377

The method of any one of embodiments 334-376, wherein the PNA washcoat composition comprises greater than or equal to about 150 g/L of the plurality of support particles.

### Embodiment 378

The method of any one of embodiments 334-377, wherein the PNA washcoat composition comprises greater than or equal to about 300 g/L of the plurality of support particles.

### Embodiment 379

The method of any one of embodiments 334-378, wherein the PNA washcoat composition further comprises boehmite particles.

### Embodiment 380

The method of embodiment 379, wherein the nano-sized PGM on the plurality of support particles comprises 95% to 98% by weight of the mixture of the nano-sized PGM on the plurality of support particles and boehmite particles in the PNA washcoat composition.

### Embodiment 381

The method of any one of embodiments 379-380, wherein the boehmite particles comprise 2% to 5% by weight of the mixture of the nano-sized PGM on the plurality of support particles and boehmite particles in the PNA washcoat composition.

### Embodiment 382

The method of any one of embodiments 334-381, wherein the substrate comprises cordierite.

### Embodiment 383

The method of any one of embodiments 334-382, wherein the substrate comprises a honeycomb structure.

### Embodiment 384

The method of any one of embodiments 334-383, further comprising coating the substrate with a corner-fill washcoat composition.

### Embodiment 385

The method of embodiment 384, wherein the corner-fill washcoat composition is deposited directly on the second zone of the substrate.

### Embodiment 386

The method of embodiment 385, wherein the corner-fill washcoat composition is deposited directly on the first and second zone of the substrate.

### Embodiment 387

A catalytic converter comprising a coated substrate according to any of embodiments 334-386.

### Embodiment 388

An exhaust treatment system comprising a conduit for exhaust gas and a catalytic converter according to embodiment 387.

### Embodiment 389

A vehicle comprising a catalytic converter according to embodiment 387.

### Embodiment 390

The vehicle of embodiment 389, wherein the vehicle complies with the European emission standard Euro 5.

### Embodiment 391

The vehicle of embodiment 389, wherein the vehicle complies with the European emission standard Euro 6.

### Embodiment 392

The vehicle of embodiment 389, wherein said vehicle is a diesel vehicle.

### Embodiment 393

The vehicle of embodiment 392, wherein the diesel vehicle is a light-duty diesel vehicle or a heavy-duty diesel vehicle.

### Embodiment 394

A method of treating an exhaust gas, comprising contacting the coated substrate of any of Embodiments 334-386 with the exhaust gas.

### Embodiment 395

The method of embodiment 394, wherein the exhaust gas contacts the first zone of the substrate before contacting the second zone of the substrate.

### Embodiment 396

A method of treating an exhaust gas, comprising contacting the coated substrate of any of Embodiments 334-386 with the exhaust gas, wherein the substrate is housed within a catalytic converter configured to receive the exhaust gas.

### Embodiment 397

The method of embodiment 396, wherein the exhaust gas contacts the first zone of the substrate before contacting the second zone of the substrate.

### Embodiment 398

A method of treating an exhaust gas, comprising: contacting a coated substrate with an exhaust gas comprising NOₓ emissions, wherein the coated substrate comprises: a substrate comprising a first zone and a second zone; the first zone comprising a Passive NOx Adsorber (PNA) layer comprising nano-sized platinum group metal (PGM) on a plurality of support particles comprising cerium oxide; and the second zone comprising a first catalytic layer comprising a first composite nanoparticle, wherein the first composite nanoparticle comprises a first catalytic nanoparticle on a first support nanoparticle.

### Embodiment 399

The method of embodiment 398, wherein the first composite nanoparticle is plasma created.

### Embodiment 400

The method of embodiment 398, wherein the substrate further comprises a third zone between the first zone and the second zone.

### Embodiment 401

The method of any of embodiments 398-400, wherein the first composite nanoparticle is bonded to a micron-sized carrier particle to form a first NNm particle.

### Embodiment 402

The method of any of embodiments 398-400, wherein the first composite nanoparticle is embedded within carrier particles to form a first NNiM particle.

### Embodiment 403

The method of any of embodiments 398-402, wherein the second zone further comprises a second catalytic layer comprising a second composite nanoparticle, wherein the second composite nanoparticle comprises a second catalytic nanoparticle on a second support nanoparticle.

### Embodiment 404

The method of embodiment 403, wherein the second catalytic layer is formed on top of the first catalytic layer.

### Embodiment 405

The method of any of embodiments 398-404, wherein the first, second, or first and second catalytic nanoparticles comprise at least one platinum group metal.

### Embodiment 406

The method of any of embodiments 398-405, wherein the first, second, or first and second catalytic nanoparticles comprise platinum and palladium.

### Embodiment 407

The method of embodiment 406, wherein the first, second, or first and second catalytic nanoparticles comprise platinum and palladium in a weight ratio of 2:1 to 10:1 platinum:palladium.

### Embodiment 408

The method of any of embodiments 398-407, wherein the first, second, or first and second support nanoparticles have an average diameter of 5 nm to 20 nm.

### Embodiment 409

The method of any of embodiments 398-408, wherein the first, second, or first and second catalytic nanoparticles have an average diameter of between 1 nm and 5 nm.

### Embodiment 410

The method of any of embodiments 398-409, wherein the second zone further comprises a zeolite layer comprising zeolite particles.

### Embodiment 411

The method of embodiment 410, wherein the zeolite layer does not include platinum group metals.

### Embodiment 412

The method of any of embodiments 410-411, wherein the zeolite layer is formed on top of the first catalytic layer.

### Embodiment 413

The method of any of embodiments 410-411, wherein the first catalytic layer is formed on top of the zeolite layer.

### Embodiment 414

The method of embodiment 413, wherein the second catalytic layer is formed on top of the first catalytic layer.

### Embodiment 415

The method of embodiment 414, wherein the first catalytic layer comprises platinum and palladium in a weight ratio of 2:1 to 4:1 platinum:palladium.

### Embodiment 416

The method of embodiment 415, wherein the second catalytic layer comprises platinum and palladium in a weight ratio of 10:1 platinum:palladium.

### Embodiment 417

The method of any of embodiments 398-416, wherein the first, second, or first and second catalytic layer is substantially free of zeolites.

### Embodiment 418

The method of any of embodiments 398-417, wherein the PNA layer stores NOₓ emissions up to at least a first temperature and releases the stored NOₓ emissions at or above the first temperature.

### Embodiment 419

The method of embodiment 418, wherein the first temperature is 150° C.

### Embodiment 420

The method of any one of embodiments 398-419, wherein the plurality of support particles are micron-sized.

### Embodiment 421

The method of any one of embodiments 398-420, wherein the plurality of support particles are nano-sized.

### Embodiment 422

The method of any one of embodiments 398-421, wherein the plurality of support particles further comprise zirconium oxide, lanthanum oxide, yttrium oxide, or a combination thereof.

### Embodiment 423

The method of embodiment 422, wherein the plurality of support particles comprise HSA5.

### Embodiment 424

The method of any of embodiments 398-423, wherein the nano-sized PGM on the plurality of support particles is produced by wet chemistry techniques followed by calcination.

### Embodiment 425

The method of any of embodiments 398-424, wherein the nano-sized PGM on the plurality of support particles is produced by incipient wetness followed by calcination.

### Embodiment 426

The method of any of embodiments 398-419 and 421-425, wherein the nano-sized PGM on the plurality of support particles comprise PNA composite nanoparticles, wherein the PNA composite nanoparticles comprise a PGM nanoparticle on a third support nanoparticle comprising cerium oxide.

### Embodiment 427

The method of embodiment 426, wherein the PNA composite nanoparticles are bonded to micron-sized carrier particles to form second NNm particles.

### Embodiment 428

The method of embodiment 426, wherein the PNA composite nanoparticles are embedded within carrier particles to form second NNiM particles.

### Embodiment 429

The method of any one of embodiments 427-428, wherein the carrier particles comprise cerium oxide, zirconium oxide, lanthanum oxide, yttrium oxide, or a combination thereof.

### Embodiment 430

The method of embodiment 429, wherein the carrier particle comprises 86 wt % cerium oxide, 10 wt % zirconium oxide, and 4 wt % lanthanum oxide.

### Embodiment 431

The method of any one of embodiments 398-430, wherein the PNA composite nanoparticles are plasma created.

### Embodiment 432

The method of any one of embodiments 398-430, wherein the PGM comprises palladium.

### Embodiment 433

The method of embodiment 432, wherein the PNA layer comprises about 2 g/L to about 4 g/L palladium.

### Embodiment 434

The method of embodiment 433, wherein the PNA layer comprises about 3 g/L palladium.

### Embodiment 435

The method of any one of embodiments 432-434, wherein the coated substrate is used in a greater than or equal to 2.5 L engine system.

### Embodiment 436

The method of any one of embodiments 398-430, wherein the PGM comprises ruthenium.

### Embodiment 437

The method of embodiment 436, wherein the PNA layer comprises about 3 g/L to about 15 g/L ruthenium.

### Embodiment 438

The method of embodiment 437, wherein the PNA layer comprises about 5 g/L to about 6 g/L ruthenium.

### Embodiment 439

The method of any one of embodiments 436-438, wherein the first temperature is 300° C.

### Embodiment 440

The method of any one of embodiments 436-439, wherein the coated substrate is used in a less than or equal to 2.5 L engine system.

### Embodiment 441

The method of any one of embodiments 398-440, wherein the PNA layer comprises greater than or equal to about 150 g/L of the plurality of support particles.

### Embodiment 442

The method of any one of embodiments 398-441, wherein the PNA layer comprises greater than or equal to about 300 g/L of the plurality of support particles.

### Embodiment 443

The method of any one of embodiments 398-442, wherein the PNA layer further comprises boehmite particles.

### Embodiment 444

The method of embodiment 443, wherein the nano-sized PGM on the plurality of support particles comprises 95% to 98% by weight of the mixture of the nano-sized PGM on the plurality of support particles and boehmite particles in the PNA layer.

### Embodiment 445

The method of any one of embodiments 443-444, wherein the boehmite particles comprise 2% to 5% by weight of the mixture of the nano-sized PGM on the plurality of support particles and boehmite particles in the PNA layer.

### Embodiment 446

The method of any one of embodiments 398-445, wherein the substrate comprises cordierite.

### Embodiment 447

The method of any one of embodiments 398-446, wherein the substrate comprises a honeycomb structure.

### Embodiment 448

The method of any one of embodiments 398-447, further comprising a corner-fill layer deposited directly on the substrate.

### Embodiment 449

The method of embodiment 448, wherein the corner-fill layer is deposited directly on the second zone of the substrate.

### Embodiment 450

The method of embodiment 449, wherein the corner-fill layer is deposited directly on the first and second zone of the substrate.

### Embodiment 451

The method of any one of embodiments 398-449, wherein the exhaust gas contacts the first zone of the substrate before contacting the second zone of the substrate.

### Embodiment 452

A catalytic converter comprising: a coated substrate comprising: a substrate comprising a first zone and a second zone; the first zone comprising a Passive NOx Adsorber (PNA) layer comprising nano-sized platinum group metal (PGM) on a plurality of support particles comprising cerium oxide; and the second zone comprising a first catalytic layer comprising a first composite nanoparticle, wherein the first composite nanoparticle comprises a first catalytic nanoparticle on a first support nanoparticle.

### Embodiment 453

The catalytic converter of embodiment 452, further comprising a third zone between the first zone and the second zone.

### Embodiment 454

The catalytic converter of embodiment 452, wherein the first composite nanoparticle is plasma created.

### Embodiment 455

The catalytic converter of any of embodiments 452-454, wherein the first composite nanoparticle is bonded to a micron-sized carrier particle to form a first NNm particle.

### Embodiment 456

The catalytic converter of any of embodiments 452-454, wherein the first composite nanoparticle is embedded within carrier particles to form a first NNiM particle.

### Embodiment 457

The catalytic converter of any of embodiments 452-456, wherein the second zone further comprises a second catalytic layer comprising a second composite nanoparticle, wherein the second composite nanoparticle comprises a second catalytic nanoparticle on a second support nanoparticle.

### Embodiment 458

The catalytic converter of embodiment 457, wherein the second catalytic layer is formed on top of the first catalytic layer.

### Embodiment 459

The catalytic converter of any of embodiments 452-458, wherein the first, second, or first and second catalytic nanoparticles comprise at least one platinum group metal.

### Embodiment 460

The catalytic converter of any of embodiments 452-459, wherein the first, second, or first and second catalytic nanoparticles comprise platinum and palladium.

### Embodiment 461

The catalytic converter of embodiment 460, wherein the first, second, or first and second catalytic nano-particles comprise platinum and palladium in a weight ratio of 2:1 to 10:1 platinum:palladium.

### Embodiment 462

The catalytic converter of any of embodiments 452-461, wherein the first, second, or first and second support nanoparticles have an average diameter of 5 nm to 20 nm.

### Embodiment 463

The catalytic converter of any of embodiments 452-462, wherein the first, second, or first and second catalytic nanoparticles have an average diameter of between 1 nm and 5 nm.

### Embodiment 464

The catalytic converter of any of embodiments 452-463, wherein the second zone further comprises a zeolite layer comprising zeolite particles.

### Embodiment 465

The catalytic converter of embodiment 464, wherein the zeolite layer does not include platinum group metals.

### Embodiment 466

The catalytic converter of any of embodiments 464-465, wherein the zeolite layer is formed on top of the first catalytic layer.

### Embodiment 467

The catalytic converter of any of embodiments 464-465 wherein the first catalytic layer is formed on top of the zeolite layer.

### Embodiment 468

The catalytic converter of embodiment 467, wherein the second catalytic layer is formed on top of the first catalytic layer.

### Embodiment 469

The catalytic converter of embodiment 468, wherein the first catalytic layer comprises platinum and palladium in a weight ratio of 2:1 to 4:1 platinum:palladium.

### Embodiment 470

The catalytic converter of embodiment 469, wherein the second catalytic layer comprises platinum and palladium in a weight ratio of 10:1 platinum:palladium.

### Embodiment 471

The catalytic converter of any of embodiments 452-470, wherein the first, second, or first and second catalytic layer is substantially free of zeolites.

### Embodiment 472

The catalytic converter of any of embodiments 452-471, wherein the PNA layer stores NOₓ gas up to at least a first temperature and releases the stored NOₓ gas at or above the first temperature.

### Embodiment 473

The catalytic converter of embodiment 472, wherein the first temperature is 150° C.

### Embodiment 474

The catalytic converter of any one of embodiments 452-473, wherein the plurality of support particles are micron-sized.

### Embodiment 475

The catalytic converter of any one of embodiments 452-474, wherein the plurality of support particles are nano-sized.

### Embodiment 476

The catalytic converter of any one of embodiments 452-475, wherein the plurality of support particles further comprise zirconium oxide, lanthanum oxide, yttrium oxide, or a combination thereof.

### Embodiment 477

The catalytic converter of embodiment 476, wherein the plurality of support particles comprise HSA5.

### Embodiment 478

The catalytic converter of any of embodiments 452-477, wherein the nano-sized PGM on the plurality of support particles is produced by wet chemistry techniques followed by calcination.

### Embodiment 479

The catalytic converter of any of embodiments 452-478, wherein the nano-sized PGM on the plurality of support particles is produced by incipient wetness followed by calcination.

### Embodiment 480

The catalytic converter of any of embodiments 452-473 and 475-479, wherein the nano-sized PGM on the plurality of support particles comprise PNA composite nano-particles, wherein the PNA composite nanoparticles comprise a PGM nanoparticle on a third support nanoparticle comprising cerium oxide.

### Embodiment 481

The catalytic converter of embodiment 480, wherein the PNA composite nanoparticles are bonded to micron-sized carrier particles to form second NNm particles.

### Embodiment 482

The catalytic converter of embodiment 480, wherein the PNA composite nanoparticles are embedded within carrier particles to form second NNiM particles.

### Embodiment 483

The catalytic converter of any one of embodiments 481-482, wherein the carrier particles comprise cerium oxide, zirconium oxide, lanthanum oxide, yttrium oxide, or a combination thereof.

### Embodiment 484

The catalytic converter of embodiment 483, wherein the carrier particle comprises 86 wt % cerium oxide, 10 wt % zirconium oxide, and 4 wt % lanthanum oxide.

### Embodiment 485

The catalytic converter of any one of embodiments 452-484, wherein the PNA composite nanoparticles are plasma created.

### Embodiment 486

The catalytic converter of any one of embodiments 452-485, wherein the PGM comprises palladium.

### Embodiment 487

The catalytic converter of embodiment 486, wherein the PNA layer comprises about 2 g/L to about 4 g/L palladium.

### Embodiment 488

The catalytic converter of embodiment 487, wherein the PNA layer comprises about 3 g/L palladium.

### Embodiment 489

The catalytic converter of any one of embodiments 486-488, wherein the catalytic converter is used in a greater than or equal to 2.5 L engine system.

### Embodiment 490

The catalytic converter of any one of embodiments 452-485, wherein the PGM comprises ruthenium.

### Embodiment 491

The catalytic converter of embodiment 490, wherein the PNA layer comprises about 3 g/L to about 15 g/L ruthenium.

### Embodiment 492

The catalytic converter of embodiment 491, wherein the PNA layer comprises about 5 g/L to about 6 g/L ruthenium.

### Embodiment 493

The catalytic converter of any one of embodiments 490-492, wherein the first temperature is 300° C.

### Embodiment 494

The catalytic converter of any one of embodiments 490-493, wherein the catalytic converter is used in a less than or equal to 2.5 L engine system.

### Embodiment 495

The catalytic converter of any one of embodiments 452-494, wherein the PNA layer comprises greater than or equal to about 150 g/L of the plurality of support particles.

### Embodiment 496

The catalytic converter of any one of embodiments 452-495, wherein the PNA layer comprises greater than or equal to about 300 g/L of the plurality of support particles.

### Embodiment 497

The catalytic converter of any one of embodiments 452-496, wherein the PNA layer further comprises boehmite particles.

### Embodiment 498

The catalytic converter of embodiment 497, wherein the nano-sized PGM on the plurality of support particles comprises 95% to 98% by weight of the mixture of the nano-sized PGM on the plurality of support particles and boehmite particles in the PNA layer.

### Embodiment 499

The catalytic converter of any one of embodiments 497-498, wherein the boehmite particles comprise 2% to 5% by weight of the mixture of the nano-sized PGM on the plurality of support particles and boehmite particles in the PNA layer.

### Embodiment 500

The catalytic converter of any one of embodiments 452-499, wherein the substrate comprises cordierite.

### Embodiment 501

The catalytic converter of any one of embodiments 452-500, wherein the substrate comprises a honeycomb structure.

### Embodiment 502

The catalytic converter of any one of embodiments 452-501, further comprising a corner-fill layer deposited directly on the substrate.

### Embodiment 503

A vehicle comprising a catalytic converter comprising a coated substrate comprising: a substrate comprising a first zone and a second zone; the first zone comprising a Passive NOx Adsorber (PNA) layer comprising nano-sized platinum group metal (PGM) on a plurality of support particles comprising cerium oxide; and the second zone comprising a first catalytic layer comprising a first composite nanoparticle, wherein the first composite nanoparticle comprises a first catalytic nanoparticle on a first support nanoparticle.

### Embodiment 504

The coated substrate of embodiment 503, further comprising a third zone between the first zone and the second zone.

### Embodiment 505

The vehicle of embodiment 503, wherein the first composite nanoparticle is plasma created.

### Embodiment 506

The vehicle of any of embodiments 503-505, wherein the first composite nanoparticle is bonded to a micron-sized carrier particle to form a first NNm particle.

### Embodiment 507

The vehicle of any of embodiments 503-505, wherein the first composite nanoparticle is embedded within carrier particles to form a first NNiM particle.

### Embodiment 508

The vehicle of any of embodiments 503-507, wherein the second zone further comprises a second catalytic layer comprising a second composite nanoparticle, wherein the second composite nanoparticle comprises a second catalytic nanoparticle on a second support nanoparticle.

### Embodiment 509

The vehicle of embodiment 508, wherein the second catalytic layer is formed on top of the first catalytic layer.

### Embodiment 510

The vehicle of any of embodiments 503-509, wherein the first, second, or first and second catalytic nanoparticles comprise at least one platinum group metal.

### Embodiment 511

The vehicle of any of embodiments 503-510, wherein the first, second, or first and second catalytic nanoparticles comprise platinum and palladium.

### Embodiment 512

The vehicle of embodiment 511, wherein the first, second, or first and second catalytic nanoparticles comprise platinum and palladium in a weight ratio of 2:1 to 10:1 platinum:palladium.

### Embodiment 513

The vehicle of any of embodiments 503-512, wherein the first, second, or first and second support nanoparticles have an average diameter of 5 nm to 20 nm.

### Embodiment 514

The vehicle of any of embodiments 503-513, wherein the first, second, or first and second catalytic nanoparticles have an average diameter of between 1 nm and 5 nm.

### Embodiment 515

The vehicle of any of embodiments 503-514, wherein the second zone further comprises a zeolite layer comprising zeolite particles.

### Embodiment 516

The vehicle of embodiment 515, wherein the zeolite layer does not include platinum group metals.

### Embodiment 517

The vehicle of any of embodiments 515-516, wherein the zeolite layer is formed on top of the first catalytic layer.

### Embodiment 518

The vehicle of any of embodiments 515-516, wherein the first catalytic layer is formed on top of the zeolite layer.

### Embodiment 519

The vehicle of embodiment 518, wherein the second catalytic layer is formed on top of the first catalytic layer.

### Embodiment 520

The vehicle of embodiment 519, wherein the first catalytic layer comprises platinum and palladium in a weight ratio of 2:1 to 4:1 platinum:palladium.

### Embodiment 521

The vehicle of embodiment 520, wherein the second catalytic layer comprises platinum and palladium in a weight ratio of 10:1 platinum:palladium.

### Embodiment 522

The vehicle of any of embodiments 503-521, wherein the first, second, or first and second catalytic layer is substantially free of zeolites.

### Embodiment 523

The vehicle of any of embodiments 503-522, wherein the PNA layer stores NOₓ exhaust gas from an engine of the vehicle up to at least a first temperature and releases the stored NOₓ exhaust gas at or above the first temperature.

### Embodiment 524

The vehicle of embodiment 523, wherein the first temperature is 150° C.

### Embodiment 525

The vehicle of any one of embodiments 503-524, wherein the plurality of support particles are micron-sized.

### Embodiment 526

The vehicle of any one of embodiments 503-525, wherein the plurality of support particles are nano-sized.

### Embodiment 527

The vehicle of any one of embodiments 503-526, wherein the plurality of support particles further comprise zirconium oxide, lanthanum oxide, yttrium oxide, or a combination thereof.

### Embodiment 528

The vehicle of embodiment 527, wherein the plurality of support particles comprise HSA5.

### Embodiment 529

The vehicle of any of embodiments 503-528, wherein the nano-sized PGM on the plurality of support particles is produced by wet chemistry techniques followed by calcination.

### Embodiment 530

The vehicle of any of embodiments 503-529, wherein the nano-sized PGM on the plurality of support particles is produced by incipient wetness followed by calcination.

### Embodiment 531

The vehicle of any of embodiments 503-524 and 526-530, wherein the nano-sized PGM on the plurality of support particles comprise PNA composite nanoparticles, wherein the PNA composite nanoparticles comprise a PGM nanoparticle on a third support nanoparticle comprising cerium oxide.

### Embodiment 532

The vehicle of embodiment 531, wherein the PNA composite nanoparticles are bonded to micron-sized carrier particles to form second NNm particles.

### Embodiment 533

The vehicle of embodiment 531, wherein the PNA composite nano-particles are embedded within carrier particles to form second NNiM particles.

### Embodiment 534

The vehicle of any one of embodiments 532-533, wherein the carrier particles comprise cerium oxide, zirconium oxide, lanthanum oxide, yttrium oxide, or a combination thereof.

### Embodiment 535

The vehicle of embodiment 534, wherein the carrier particle comprises 86 wt % cerium oxide, 10 wt % zirconium oxide, and 4 wt % lanthanum oxide.

### Embodiment 536

The vehicle of any one of embodiments 503-535, wherein the PNA composite nanoparticles are plasma created.

### Embodiment 537

The vehicle of any one of embodiments 503-536, wherein the PGM comprises palladium.

### Embodiment 538

The vehicle of embodiment 537, wherein the PNA layer comprises about 2 g/L to about 4 g/L palladium.

### Embodiment 539

The vehicle of embodiment 538, wherein the PNA layer comprises about 3 g/L palladium.

### Embodiment 540

The vehicle of any one of embodiments 537-539, wherein the vehicle has a greater than or equal to 2.5 L engine.

### Embodiment 541

The vehicle of any one of embodiments 503-536, wherein the PGM comprises ruthenium.

### Embodiment 542

The vehicle of embodiment 541, wherein the PNA layer comprises about 3 g/L to about 15 g/L ruthenium.

### Embodiment 543

The vehicle of embodiment 542, wherein the PNA layer comprises about 5 g/L to about 6 g/L ruthenium.

### Embodiment 544

The vehicle of any one of embodiments 541-543, wherein the first temperature is 300° C.

### Embodiment 545

The vehicle of any one of embodiments 541-544, wherein the vehicle has a less than or equal to 2.5 L engine.

### Embodiment 546

The vehicle of any one of embodiments 503-545, wherein the PNA layer comprises greater than or equal to about 150 g/L of the plurality of support particles.

### Embodiment 547

The vehicle of any one of embodiments 503-546, wherein the PNA layer comprises greater than or equal to about 300 g/L of the plurality of support particles.

### Embodiment 548

The vehicle of any one of embodiments 503-547, wherein the PNA layer further comprises boehmite particles.

### Embodiment 549

The vehicle of embodiment 548, wherein the nano-sized PGM on the plurality of support particles comprises 95% to 98% by weight of the mixture of the nano-sized PGM on the plurality of support particles and boehmite particles in the PNA layer.

### Embodiment 550

The vehicle of any one of embodiments 548-549, wherein the boehmite particles comprise 2% to 5% by weight of the mixture of the nano-sized PGM on the plurality of support particles and boehmite particles in the PNA layer.

### Embodiment 551

The vehicle of any one of embodiments 503-550, wherein the substrate comprises cordierite.

### Embodiment 552

The vehicle of any one of embodiments 503-551, wherein the substrate comprises a honeycomb structure.

### Embodiment 553

The vehicle of any one of embodiments 503-550, further comprising a corner-fill layer deposited directly on the substrate.

### Embodiment 554

The vehicle of embodiment 553, wherein the corner-fill layer is deposited directly on the second zone of the substrate.

### Embodiment 555

The vehicle of embodiment 554, wherein the corner-fill layer is deposited directly on the first and second zone of the substrate.

### Embodiment 556

The vehicle of any one of embodiments 503-555, wherein the vehicle is a diesel vehicle.

### Embodiment 557

The vehicle of embodiment 556, wherein the vehicle is a light-duty or heavy-duty diesel vehicle.

### Embodiment 558

The vehicle of any one of embodiments 503-557, wherein the vehicle complies with European emission standard Euro 5 or Euro 6.

### Embodiment 559

The vehicle of any one of embodiments 503-558, further comprising an SCR unit downstream the catalytic converter.

### Embodiment 560

The vehicle of any one of embodiments 503-559, further comprising an LNT.

### Embodiment 561

An exhaust treatment system comprising a conduit for exhaust gas comprising NOₓ emissions and a catalytic converter comprising a coated substrate comprising: a substrate comprising a first zone and a second zone; the first zone comprising a Passive NOx Adsorber (PNA) layer comprising nano-sized platinum group metal (PGM) on a plurality of support particles comprising cerium oxide; and the second zone comprising a first catalytic layer comprising a first composite nanoparticle, wherein the first composite nanoparticle comprises a first catalytic nanoparticle on a first support nanoparticle.

### Embodiment 562

The exhaust treatment system of embodiment 561, further comprising a third zone between the first zone and the second zone.

### Embodiment 563

The exhaust treatment system of embodiment 561, wherein the first composite nanoparticle is plasma created.

### Embodiment 564

The exhaust treatment system of any of embodiments 561-563, wherein the first composite nanoparticle is bonded to a micron-sized carrier particle to form a first NNm particle.

### Embodiment 565

The exhaust treatment system of any of embodiments 561-563, wherein the first composite nanoparticle is embedded within carrier particles to form a first NNiM particles.

### Embodiment 566

The exhaust treatment system of any of embodiments 561-565, wherein the second zone further comprises a second catalytic layer comprising a second composite nanoparticle, wherein the second composite nanoparticle comprises second catalytic nanoparticle on a second support nanoparticle.

### Embodiment 567

The exhaust treatment system of embodiment 566, wherein the second catalytic layer is formed on top of the first catalytic layer.

### Embodiment 568

The exhaust treatment system of any of embodiments 561-567, wherein the first, second, or first and second catalytic nanoparticles comprise at least one platinum group metal.

### Embodiment 569

The exhaust treatment system of any of embodiments 561-568, wherein the first, second, or first and second catalytic nanoparticles comprise platinum and palladium.

### Embodiment 570

The exhaust treatment system of embodiment 569, wherein the first, second, or first and second catalytic nanoparticles comprise platinum and palladium in a weight ratio of 2:1 to 10:1 platinum:palladium.

### Embodiment 571

The exhaust treatment system of any of embodiments 561-570, wherein the first, second, or first and second support nanoparticles have an average diameter of 5 nm to 20 nm.

### Embodiment 572

The exhaust treatment system of any of embodiments 561-571, wherein the first, second, or first and second catalytic nanoparticles have an average diameter of between 1 nm and 5 nm.

### Embodiment 573

The exhaust treatment system of any of embodiments 561-572, wherein the second zone further comprises a zeolite layer comprising zeolite particles.

### Embodiment 574

The exhaust treatment system of embodiment 573, wherein the zeolite layer does not include platinum group metals.

### Embodiment 575

The exhaust treatment system of any of embodiments 573-574, wherein the zeolite layer is formed on top of the first catalytic layer.

### Embodiment 576

The exhaust treatment system of any of embodiments 573-574, wherein the first catalytic layer is formed on top of the zeolite layer.

### Embodiment 577

The exhaust treatment system of embodiment 576, wherein the second catalytic layer is formed on top of the first catalytic layer.

### Embodiment 578

The exhaust treatment system of embodiment 577, wherein the first catalytic layer comprises platinum and palladium in a weight ratio of 2:1 to 4:1 platinum:palladium.

### Embodiment 579

The exhaust treatment system of embodiment 578, wherein the second catalytic layer comprises platinum and palladium in a weight ratio of 10:1 platinum:palladium.

### Embodiment 580

The exhaust treatment system of any of embodiments 561-579, wherein the first, second, or first and second catalytic layer is substantially free of zeolites.

### Embodiment 581

The exhaust treatment system of any of embodiments 561-580, wherein the PNA layer stores NOₓ emissions up to at least a first temperature and releases the stored NOₓ emissions at or above the first temperature.

### Embodiment 582

The exhaust treatment system of embodiment 581, wherein the first temperature is 150° C.

### Embodiment 583

The exhaust treatment system of any one of embodiments 561-582, wherein the plurality of support particles are micron-sized.

### Embodiment 584

The exhaust treatment system of any one of embodiments 561-583, wherein the plurality of support particles are nano-sized.

### Embodiment 585

The exhaust treatment system of any one of embodiments 561-584, wherein the plurality of support particles further comprise zirconium oxide, lanthanum oxide, yttrium oxide, or a combination thereof.

### Embodiment 586

The exhaust treatment system of embodiment 585, wherein the plurality of support particles comprise HSA5.

### Embodiment 587

The exhaust treatment system of any of embodiments 561-586, wherein the nano-sized PGM on the plurality of support particles is produced by wet chemistry techniques followed by calcination.

### Embodiment 588

The exhaust treatment system of any of embodiments 561-587, wherein the nano-sized PGM on the plurality of support particles is produced by incipient wetness followed by calcination.

### Embodiment 589

The exhaust treatment system of any of embodiments 561-582 and 584-588, wherein the nano-sized PGM on the plurality of support particles comprise PNA composite nanoparticles, wherein the PNA composite nanoparticles comprise a PGM nanoparticle on a third support nanoparticle comprising cerium oxide.

### Embodiment 590

The exhaust treatment system of embodiment 589, wherein the PNA composite nanoparticles are bonded to micron-sized carrier particles to form second NNm particles.

### Embodiment 591

The exhaust treatment system of embodiment 589, wherein the PNA composite nanoparticles are embedded within carrier particles to form second NNiM particles.

### Embodiment 592

The exhaust treatment system of any one of embodiments 590-591, wherein the carrier particles comprise cerium oxide, zirconium oxide, lanthanum oxide, yttrium oxide, or a combination thereof.

### Embodiment 593

The exhaust treatment system of embodiment 592, wherein the carrier particle comprises 86 wt % cerium oxide, 10 wt % zirconium oxide, and 4 wt % lanthanum oxide.

### Embodiment 594

The exhaust treatment system of any one of embodiments 561-593, wherein the PNA composite nanoparticles are plasma created.

### Embodiment 595

The exhaust treatment system of any one of embodiments 561-594, wherein the PGM comprises palladium.

### Embodiment 596

The exhaust treatment system of embodiment 595, wherein the PNA layer comprises about 2 g/L to about 4 g/L palladium.

### Embodiment 597

The exhaust treatment system of embodiment 596, wherein the PNA layer comprises about 3 g/L palladium.

### Embodiment 598

The exhaust treatment system of any one of embodiments 595-597, wherein The exhaust treatment system is used in a greater than or equal to 2.5 L engine system.

### Embodiment 599

The exhaust treatment system of any one of embodiments 561-594, wherein the PGM comprises ruthenium.

### Embodiment 600

The exhaust treatment system of embodiment 599, wherein the PNA layer comprises about 3 g/L to about 15 g/L ruthenium.

### Embodiment 601

The exhaust treatment system of embodiment 600, wherein the PNA layer comprises about 5 g/L to about 6 g/L ruthenium.

### Embodiment 602

The exhaust treatment system of any one of embodiments 599-601, wherein the first temperature is 300° C.

### Embodiment 603

The exhaust treatment system of any one of embodiments 599-602, wherein the exhaust treatment system is used in a less than or equal to 2.5 L engine system.

### Embodiment 604

The exhaust treatment system of any one of embodiments 561-603, wherein the PNA layer comprises greater than or equal to about 150 g/L of the plurality of support particles.

### Embodiment 605

The exhaust treatment system of any one of embodiments 561-604, wherein the PNA layer comprises greater than or equal to about 300 g/L of the plurality of support particles.

### Embodiment 606

The exhaust treatment system of any one of embodiments 561-605, wherein the PNA layer further comprises boehmite particles.

### Embodiment 607

The exhaust treatment system of embodiment 606, wherein the nano-sized PGM on the plurality of support particles comprises 95% to 98% by weight of the mixture of the nano-sized PGM on the plurality of support particles and boehmite particles in the PNA layer.

### Embodiment 608

The exhaust treatment system of any one of embodiments 606-607, wherein the boehmite particles comprise 2% to 5% by weight of the mixture of the nano-sized PGM on the plurality of support particles and boehmite particles in the PNA layer.

### Embodiment 609

The exhaust treatment system of any one of embodiments 561-608, wherein the substrate comprises cordierite.

### Embodiment 610

The exhaust treatment system of any one of embodiments 561-609, wherein the substrate comprises a honeycomb structure.

### Embodiment 611

The exhaust treatment system of any one of embodiments 561-610, further comprising a corner-fill layer deposited directly on the substrate.

### Embodiment 612

The exhaust treatment system of embodiment 611, wherein the corner-fill layer is deposited directly on the second zone of the substrate.

### Embodiment 613

The exhaust treatment system of embodiment 612, wherein the corner-fill layer is deposited directly on the first and second zone of the substrate.

### Embodiment 614

The exhaust treatment system of any one of embodiments 561-613, further comprising an SCR unit downstream the catalytic converter.

### Embodiment 615

The exhaust treatment system of any one of embodiments 561-614, further comprising an LNT.

### Embodiment 616

The exhaust treatment system of any one of embodiments 561-615, wherein the exhaust treatment system complies with European emission standard Euro 5.

### Embodiment 617

The exhaust treatment system of any one of embodiments 561-616, wherein the exhaust treatment system complies with European emission standard Euro 6.

### EXAMPLES

As discussed above, the washcoat compositions can be configured and applied in a variety of different ways. The configurations provide examples of preparing substrates coated with the washcoats.

### General Procedure for Preparation of Washcoats

The washcoats are made by mixing the solid ingredients (about 30% by weight) with water (about 70% by weight). Acetic acid is added to adjust the pH to about 4. The washcoat slurry is then milled to arrive at an average particle size of about 4 μm to about 6 μm. The viscosity of the washcoat is adjusted by mixing with a cellulose solution or with corn starch to the desired viscosity, typically between about 300 cP to about 1200 cP. The washcoat is aged for about 24 hours to about 48 hours after cellulose or corn starch addition. The washcoat is coated onto the substrate by either dip-coating or vacuum coating. The part(s) to be coated can be optionally pre-wetted prior to coating. The washcoat amount coated onto the substrate can range from about 50 g/l to about 250 g/l. Excess washcoat is blown off and recycled. The washcoat-coated substrate is then dried at about 25° C. to about 95° C. by flowing air over the coated part, until the weight levels off. The washcoat-coated substrate is then calcined at about 450° C. to about 650° C. for about 1 hour to about 2 hours.

In one of these configurations, a first washcoat composition applied to a substrate comprises 3% (or approximately 3%) boehmite, 80% (or approximately 80%) zeolites, and 17% (or approximately 17%) porous alumina (e.g., MI-386 or the like), while a second washcoat composition comprises 3% (or approximately 3%) boehmite, 5% (or approximately 5%) silica (or, in another embodiment, instead of silica, 5% zeolites or approximately 5% zeolites), and 92% (or approximately 92%) catalytic powder (i.e., the powder containing the catalytic material), wherein the catalytic powder is NNm Powder (catalytic nanoparticle on support nanoparticle on support micro-particle).

The ingredients discussed above for the first washcoat composition are mixed with water and acid, such as acetic acid, and the pH is adjusted to about 4. After adjusting the viscosity to the proper levels, this first washcoat is coated onto the substrate with an approximate layer thickness of 70 g/l.

This first washcoat layer is then dried and calcined. Following this first washcoating step, a second washcoating step is applied, where the ingredients discussed above for the second washcoat composition are mixed with water and acid, such as acetic acid, and the pH is adjusted to about 4. After adjusting the viscosity to the proper levels, this second washcoat is coated onto the substrate with an approximate layer thickness of 120 g/l. This second washcoat layer is then dried and calcined.

### Example 1

### Substrate-Zeolite Particles-Catalytic Powder Configuration, or S-Z-C, Configuration: No Zeolites in Catalyst-Containing Washcoat

(a) First Washcoat Composition: Approx. 70 g/l as follows:
3% Boehmite
80% Zeolites
17% Porous alumina (MI-386 or the like)
   (b) Second Washcoat Composition: Approx. 120 g/l as follows:
3% Boehmite;
5% Silica;
92% NNm Powder (nanoparticle on nanoparticle on micro-particle), the powder that contains the PGM, i.e. the platinum group metals or precious metals.

Mix the washcoat ingredients from (a) with water and acetic acid and to adjust the pH to about 4. After adjusting the viscosity to the proper levels, the washcoat is coated onto the substrate with an approximate layer thickness of 70 g/l. Excess washcoat is blown off and recycled. This first washcoat layer is then dried and calcined. Following this first washcoating step, a second washcoating step is performed: the ingredients from (b) are mixed with water and acetic acid and the pH adjusted to about 4. After adjusting the viscosity to the proper levels the washcoat is coated onto the substrate with an approximate layer thickness of 120 g/l. Again, excess washcoat is blown off and recycled. This second washcoat layer is then dried and calcined.

### Example 2

### Substrate-Zeolite Particles-Catalytic Powder Configuration, or S-Z-C, Configuration: Zeolites Present in Catalyst-Containing Washcoat

(a) First Washcoat Composition: Approx. 70 g/l as follows:
3% Boehmite
80% Zeolites
17% Porous alumina (MI-386 or the like)
   (b) Second Washcoat Composition: Approx. 120 g/l as follows:
3% Boehmite;
5% Zeolites;
92% NNm Powder (catalytic nanoparticle on support nanoparticle on support micro-particle), the powder that contains the PGM, i.e. the platinum group metals or precious metals.

The same procedure described in Example 1 is used to coat the substrate in this example.

### Example 3

### Additional Example of Substrate-Zeolite Particles-Catalytic Powder, or S-Z-C, Configuration

(a) First Washcoat Composition: 25 g/l to 90 g/l (approximately. 60 g/l or approximately 70 g/l preferred) as follows:
   2-5% Boehmite (about 3% preferred);
   60-80% Zeolites, such as 75-80% Zeolites (about 80% preferred);
   15-38% Porous alumina (MI-386 or the like), such as 15-22% Porous alumina (about 17% to about 22% preferred).
(b) Second Washcoat Composition: 50 g/l to 250 g/l (approximately 120 g/l preferred) as follows:
   2-5% Boehmite (about 3% preferred);
   0-20% Silica (about 5% preferred);
   40-92% catalytically active powder (about 92% preferred); and
   0-52% porous alumina (about 0% preferred).

The same procedure described in Example 1 is used to coat the substrate in this example. In another embodiment, 0-20% Zeolites are used instead of the 0-20% Silica (with about 5% being the preferred amount of Zeolite used).

### Example 4

### Substrate-Corner Fill-Catalytic Particle-Zeolite, or S-F-C-Z, Configuration

In another advantageous configuration, a first washcoat composition applied to the substrate is a corner-fill washcoat applied to the substrate. The solids content of the corner-fill washcoat comprises about 97% by weight porous alumina (MI-386) and about 3% by weight boehmite. Water and acetic acid are added to the corner fill washcoat, the pH is adjusted to about 4, and viscosity is adjusted. The corner-fill washcoat composition is applied to the substrate, excess washcoat is blown off and recycled, and the washcoat is dried and calcined. The zeolite-containing washcoat composition and the catalyst-containing washcoat composition illustrated in the foregoing examples can also be used in this example. Thus, a second washcoat composition is applied over the corner-fill washcoat layer, which comprises 3% (or approximately 3%) boehmite, 5% (or approximately 5%) silica, and 92% (or approximately 92%) catalytic powder (i.e., the powder containing the catalytic material). Excess catalyst-containing washcoat is blown off and recycled. After application, the catalyst-containing washcoat composition is dried and calcined. A third washcoat composition, applied over the catalyst-containing washcoat layer, comprises 3% (or approximately 3%) boehmite, 67% (or approximately 67%) zeolites, and 30% (or approximately 30%) porous alumina (e.g., MI-386 or the like). After application, excess zeolite particle-containing washcoat is blown off and recycled, and the zeolite particle-containing washcoat composition is dried and calcined.

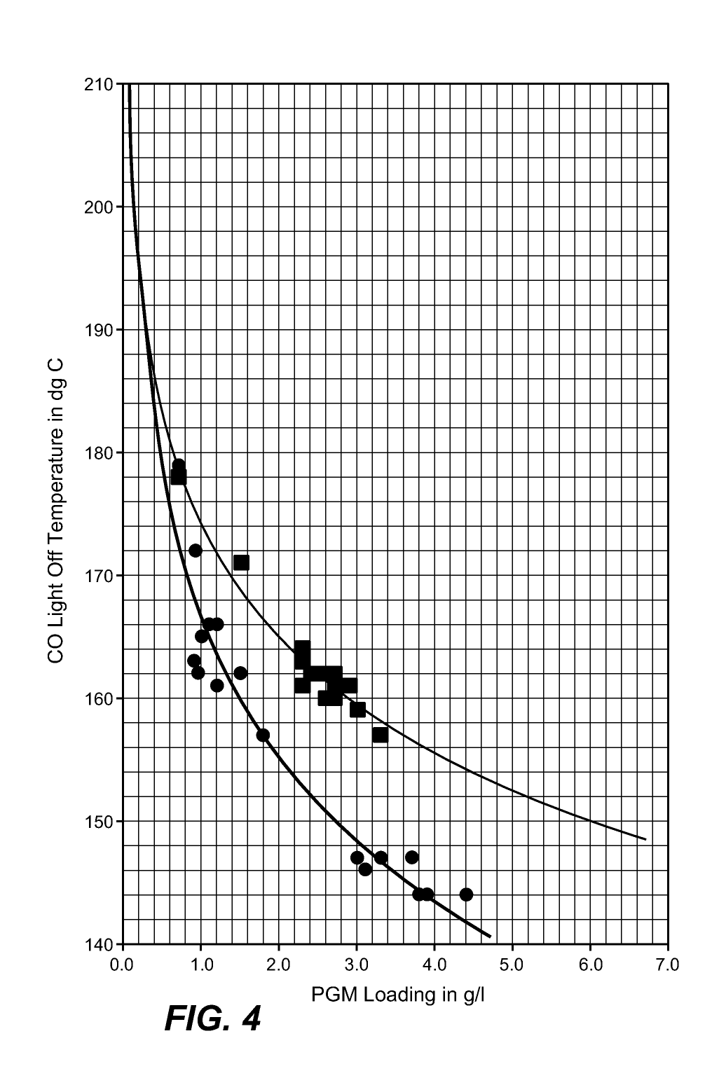

FIG. 4 illustrates the performance of a coated substrate prepared according to one embodiment, compared to the configuration used in nanoparticulate coated substrates prepared with a washcoat where the zeolites are not separated from the catalytic particles. All test results described below utilize catalysts which were artificially aged at 800° C. for 16 hours to simulate operation after 125,000 miles in a car.

The filled circles and the curve fit to those data points represent the following coating scheme:

a) A first layer which is a corner fill washcoat, followed by

b) A second layer which is a PGM washcoat using nano-on-nano-on-micron catalyst, containing 5% zeolites (that is, very low zeolite concentration). The PGM is 2:1 Pt/Pd.

For the simulation, this second layer may or may not be followed by a zeolite particle-containing washcoat layer. In actual practice, a zeolite particle-containing washcoat composition will be applied either under the PGM layer (that is, applied, dried, and calcined to the substrate prior to applying the PGM washcoat) or above the PGM layer (that is, applied, dried, and calcined to the substrate after applying the PGM washcoat).

The filled squares ▪ and the line fit to those data points represent the following coating scheme:

a) A first layer which is a corner fill washcoat, followed by

b) A second layer which is a PGM washcoat, containing the entire zeolite amount (that is, all of the zeolites of the zeolite-containing washcoat layer are combined with the nano-on-nano-on-micron catalytic powder-containing layer). The PGM is 2:1 Pt/Pd.

The simulation is performed under steady-state conditions for experimental purposes (in actual operation, cold-start conditions are not steady-state). A carrier gas containing carbon monoxide, NOₓ, and hydrocarbons is passed over the coated substrates, in order to simulate diesel exhaust. The temperature of the substrate is gradually raised until the light-off temperature is achieved (that is, when the coated substrate reaches a temperature sufficient to convert CO into CO₂).

As is evident from the graph, when compared to the coated substrate prepared with a combined washcoat of zeolite and PGM, the coated substrate prepared according to the present disclosure demonstrated either a lower light-off temperature for carbon monoxide at the same loading of platinum group metal (i.e., the coated substrate as described herein demonstrates better performance as compared to the coated substrate with a combined zeolite-PGM washcoat, while using the same amount of PGM), or required a lower loading of platinum group metal at the same light-off temperature (i.e., to obtain the same performance with the coated substrate described herein as compared to the coated substrate with a combined zeolite-PGM washcoat, less of the expensive PGM was required for the coated substrates described herein).

Specifically, the lowest light-off temperature attained with the combined zeolite-PGM washcoat was 157° C. at 3.3 g/l platinum group metal loading, while a coated substrate prepared according as described herein (using a catalytic layer with a low zeolite content) and with the same 3.3 g/l PGM loading had a light-off temperature of 147° C., a reduction in light-off temperature of 10° C. Thus, the low zeolite-containing washcoated substrate demonstrated superior performance at the same PGM loading.

The lowest light-off temperature of 157° C. was attained with the coated substrate having a combined zeolite-PGM washcoat at 3.3 g/l platinum group metal loading. A light-off temperature of 157° C. was attained with the coated substrate having the low zeolite-containing washcoat at a platinum group metal loading of 1.8 g/l, a reduction in platinum group metal loading of 1.5 g/l or 45%. Thus, the coated substrate with the low zeolite-containing washcoat demonstrated identical performance, at a significantly reduced PGM loading, to the coated substrate with the combined zeolite-PGM washcoat.

### Comparison of Catalytic Converter Performance Described Herein to Commercially Available Catalytic Converters

A. Improvement in Light-Off Temperatures

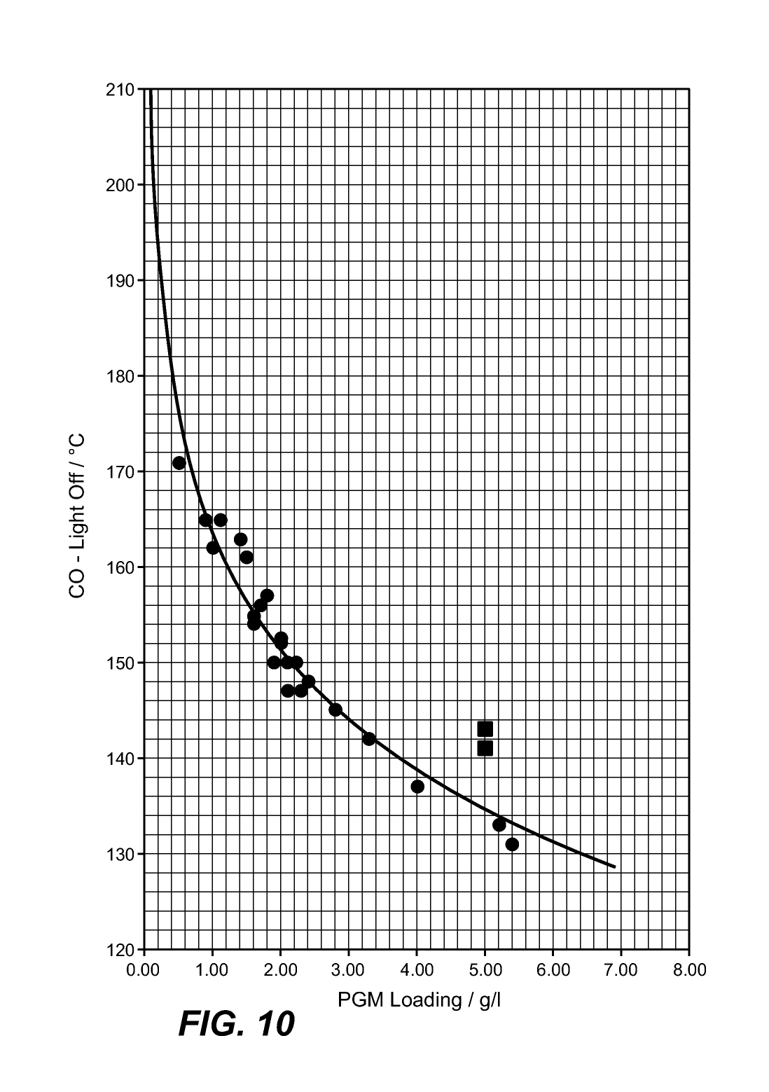

FIG. 10 illustrates the performance of a coated substrate in a catalytic converter, where the coated substrate is prepared according to one embodiment of the present disclosure, compared to a commercially available catalytic converter having a substrate prepared using only wet-chemistry methods for the deposition of platinum group metal. The coated substrates are artificially aged and tested in a similar fashion as that indicated in the section above in the description of FIG. 4 results.

The filled circles represent data points for the carbon monoxide light-off temperatures for the coated substrate prepared with a washcoat having nano-on-nano-on-micron (NNm) catalyst (where the PGM is 2:1 Pt:Pd). The filled squares indicate the CO light-off temperatures for a commercially available coated substrate prepared using only wet-chemistry methods for the deposition of platinum group metal (also with a 2:1 Pt:Pd ratio).

The commercially available coated substrate displays CO light-off temperatures of 141° C. and 143° C. at a PGM loading of 5.00 g/l (for an average of 142° C.). The coated substrate with the NNm washcoat displays CO light-off temperatures of 133° C. at 5.1 g/l PGM loading and 131° C. at 5.2 g/l PGM loading, or about 8 to about 10 degrees C. lower than the commercially available coated substrate at similar PGM loading. The coated substrate with the NNm washcoat displays a CO light-off temperature of 142° C. at a PGM loading of 3.3 g/l, for similar light-off performance to the commercially available coated substrate, but at a thrifting (reduction) of PGM loading of 34%.

B. Improvement in Emissions Profile in Vehicle

FIG. 11 illustrates the performance of a coated substrate prepared according to some embodiments of the present disclosure installed in a catalytic converter and used as a diesel oxidation catalyst, compared to a commercially available catalytic converter prepared using only wet-chemistry methods for the deposition of platinum group metal. These measurements were made on an actual diesel engine vehicle, mounted on rollers and driven robotically for testing. The exhaust from the engine passes through the diesel oxidation catalyst (DOC), and sensors measure the emissions profile after the exhaust passes through the DOC. (The emissions then pass through a diesel particulate filter (DPF) prior to release into the environment.) The DOCs tested were artificially aged at 800° C. for 16 hours to simulate operation after 125,000 miles in a car.

The midbed emissions profile of the exhaust, after passing through the DOC and before entering the DPF, are shown in FIG. 11. Midbed emissions of carbon monoxide are shown in the left group of bars, while midbed emissions of hydrocarbons and nitrogen oxides are shown in the right group of bars. The emissions profile after passing through a commercially available diesel oxidation catalyst (DOC) is shown in the left bar of each group, and are normalized to 1.0. The emissions profile of a DOC using a catalytic converter prepared according to the methods described herein are illustrated by the center and right bars of each group. The center bars of each group are for a catalytic converter prepared according to the present disclosure which are 40% thrifted (that is, containing 40% less PGM than the commercially available catalytic converter), while the right bars of each group are for a catalytic converter prepared according to the present disclosure which are 50% thrifted (that is, containing 50% less PGM than the commercially available catalytic converter). The 40% thrifted converters of the present disclosure showed 85.3% of the CO emissions and 89.5% of the HC/NOx emissions as the commercially available catalyst. The 50% thrifted converters of the present disclosure showed 89.3% of the CO emissions and 94.7% of the HC/NOx emissions as the commercially available catalyst. Thus, catalytic converters prepared with coated substrates according to the present disclosure demonstrated superior emissions performance over commercially available catalysts prepared using only wet-chemistry for the deposition of platinum group metal, while using significantly less PGM.

### Example 5

### Fe-Exchanged Zeolites Used in a Substrate-Corner Fill-Catalytic Particle-Zeolite, or S-F-C-Z, Configuration

A first washcoat composition comprising aluminum oxide particles was applied to a substrate as a corner-fill washcoat, and dried and calcined, in a similar manner to that described in Example 4. A second washcoat composition was applied over the corner-fill washcoat layer, comprising about 2% boehmite and about 98% nano-on-nano-on-micro (NNm) catalytic powder. The ratio of platinum to palladium in the catalytic powder was 4:1 Pt:Pd. (The loading of the precious metals was 1.8%; at 150 g/L of NNm powder and 3 g/L boehmite, approximately 2.7 g of precious metal is used per liter.) After application, the catalyst-containing washcoat composition is dried and calcined. A third washcoat composition was applied over the catalyst-containing washcoat layer, comprising about 3% boehmite, about 47% porous alumina impregnated with palladium via wet chemistry methods for the deposition of platinum group metal (at a weight percent of approximately 1%, hence 0.5 g/L of Pd in a 50 g/L suspension of Pd-impregnated Al2O3), and about 50% iron-exchanged zeolites (3% iron-exchanged zeolites). The ratio of the total amount of the platinum to the total amount of palladium on the substrate in the combined washcoat layers is 2:1 Pt:Pd (four parts Pt in the NNm catalytic particle layer, one part Pd in the NNm catalytic particle layer, and one part Pd in the zeolite layer). The third washcoat layer was dried and calcined.

When hydrocarbon emissions for catalysts prepared using non-iron-exchanged zeolites and having no palladium in the zeolite layer are normalized to 100, the hydrocarbon emissions for the Fe-exchanged zeolite configuration are about 75, that is, reduced by about 25%. Similarly, when carbon monoxide emissions for catalysts prepared using non-iron-exchanged zeolites and having no palladium in the zeolite layer are normalized to 100, the CO emissions for the Fe-exchanged zeolite configuration are about 75, that is, also reduced by about 25%. This is a significant advance over previous configurations.

### Example 6

### Substrate-Catalytic Layer (S-C) Configuration with Two Types of Catalytically Active Material in Catalytic Layer

In one example configuration, a catalytic washcoat composition applied to a substrate comprises a substrate and a catalytic washcoat layer. The catalytic washcoat layer may comprise about 3 wt % boehmite, about 40 wt % NNm particles with a platinum:palladium weight ratio of 20:1, about 40 wt % NNm particles with platinum:palladium weight ratio of 5:1, and about 17 wt % porous alumina (such as MI-386).

The ingredients discussed above for the catalytic washcoat composition are mixed with water and acid, such as acetic acid, and the pH is adjusted to about 4. After adjusting the viscosity to the proper levels, this first washcoat is coated onto the substrate. Excess washcoat is blown off and recycled. The coated substrate is then dried and calcined.

### Example 7

### Substrate-First Catalytic Layer-Second Catalytic Layer (S-C₁-C₂) Configuration with Two Catalytic Layers, Each Comprising a Different Type of Catalytically Active Material

In one example configuration, a catalytic washcoat composition applied to a substrate comprises a substrate, a first catalytic washcoat layer, and a second catalytic washcoat layer. The first catalytic washcoat layer may comprise about 3 wt % boehmite, about 80 wt % NNm particles with a platinum:palladium weight ratio of 20:1, and about 17 wt % porous alumina (such as MI-386). The second catalytic washcoat layer may comprise about 3 wt % boehmite, about 80 wt % NNm particles with a platinum:palladium weight ratio of 5:1, and about 17 wt % porous alumina (such as MI-386).

The ingredients discussed above for the first catalytic washcoat composition are mixed with water and acid, such as acetic acid, and the pH is adjusted to about 4. After adjusting the viscosity to the proper levels, this first washcoat is coated onto the substrate. Excess washcoat is blown off and recycled. This first catalytic washcoat layer is then dried and calcined.

Following this first coating step, a second coating step is applied, where the ingredients discussed above for the second washcoat composition are mixed with water and acid, such as acetic acid, and the pH is adjusted to about 4. After adjusting the viscosity to the proper levels, this second washcoat is coated onto the substrate. Again, excess washcoat is blown off and recycled. This second washcoat layer is then dried and calcined.

### Example 8

### Substrate-First Catalytic Layer-Second Catalytic Layer (S-C1-C2) Additional Configuration with Two Catalytic Layers

In another example configuration, a catalytic washcoat composition applied to a substrate comprises a substrate, an optional corner fill layer, a first catalytic washcoat layer, and a second catalytic washcoat layer. The substrate contains about 0.8 g/L total platinum group metal loading.

The optional corner fill layer can be comprised of porous alumina (such as MI-386 particles) and about 3% boehmite, and may optionally also include zeolites. The zeolites can be included in an amount of between 20% and 90% by weight of the solids content of the corner fill layer washcoat, such as about 50%. The optional corner fill layer, when used, is applied in an amount of about 50 g/L to 60 g/L to the substrate.

The first catalytic washcoat layer may comprise boehmite (about 3 wt %), NNm particles (nano-platinum:palladium alloy on nano-alumina on micro-alumina) with a platinum:palladium weight ratio of 20:1 in an amount of about 25 g/L (corresponding to about 0.33 g/L of Pt:Pd); alumina particles impregnated with palladium via wet chemistry in an amount of about 18 g/L (corresponding to about 0.07 g/L of Pd); and about 10-15 g/L of porous alumina (such as MI-386). The total platinum group metal loading in the first catalytic washcoat layer is about 0.4 g/L, with a ratio of [20:1 Pt:Pd alloy] to [Pd] of about 5 to 1. This first catalytic washcoat layer is applied to the substrate in an amount of about 50 g/L to 60 g/L.

The second catalytic washcoat layer may comprise about 3 wt % boehmite, about 48.5 wt % NNm particles with a platinum:palladium weight ratio of 20:1, and about 48.5 wt % porous alumina (such as MI-386). The amount of NNm particles with a platinum:palladium weight ratio of 20:1 is about 25-30 g/L, corresponding to about 1.2% to 1.5% of platinum group metal in the washcoat. The amount of alumina is about 25-30 g/L. The total platinum group metal loading in the second catalytic washcoat layer is about 0.4 g/L, comprised of 20:1 Pt:Pd. This second catalytic washcoat layer is applied to the substrate in an amount of about 50 g/L to 60 g/L.

When the optional corner fill layer is used, the ingredients discussed above for the corner fill layer washcoat composition are mixed with water and acid, such as acetic acid, and the pH is adjusted to about 4. After adjusting the viscosity to the proper levels, the corner fill layer washcoat is coated onto the substrate. Excess washcoat is blown off and can be recycled. This corner fill washcoat layer is then dried and calcined.

The ingredients discussed above for the first catalytic washcoat composition are mixed with water and acid, such as acetic acid, and the pH is adjusted to about 4. After adjusting the viscosity to the proper levels, this first catalytic washcoat is coated onto the substrate. Excess catalytic washcoat is blown off and recycled. This first catalytic washcoat layer is then dried and calcined.

Following this first coating step, a second coating step is applied, where the ingredients discussed above for the second catalytic washcoat composition are mixed with water and acid, such as acetic acid, and the pH is adjusted to about 4. After adjusting the viscosity to the proper levels, this second catalytic washcoat is coated onto the substrate. Again, excess catalytic washcoat is blown off and recycled. This second catalytic washcoat layer is then dried and calcined.

### Example 9

### Substrate-Corner Fill Layer-First Catalytic Layer-Second Catalytic Layer (S-F-C₁-C₂)

In another exemplary configuration, a catalytic washcoat composition applied to a substrate comprises a substrate, a corner fill layer, a first catalytic washcoat layer, and a second catalytic washcoat layer. The catalyst was prepared as in Example 8, with the following washcoats.

### Corner Fill Layer:

Composed of 50 g/L Al2O3 (MI-386) plus˜5% boehmite.

### 1^{st} Catalytic Layer:

21 g/l of NNm, nano-20:1 Pt:Pd/nano-Al2O3/micro-Al2O3 (approx. 0.33 g/L of 20:1 Pt:Pd) and 8 g/l of wet-chem Pd impregnated into micro-Al2O3 (MI-386) (approx. 0.07 g/L Pd), which together provide a 3-to-1 ratio of Pt:Pd (total 0.4 g/L PGM);
30 g/l of Al2O3 (MI-386 filler); and
5% boehmite.

### 2^{nd} Catalytic Layer:

27 g/l 20:1 of NNm, nano-20:1 Pt:Pd/nano-Al2O3/micro-Al2O3 (approx. 0.4 g/L of 20:1 Pt:Pd) and 28 g/l of Al2O3 (MI-386 filler); and
5% boehmite.

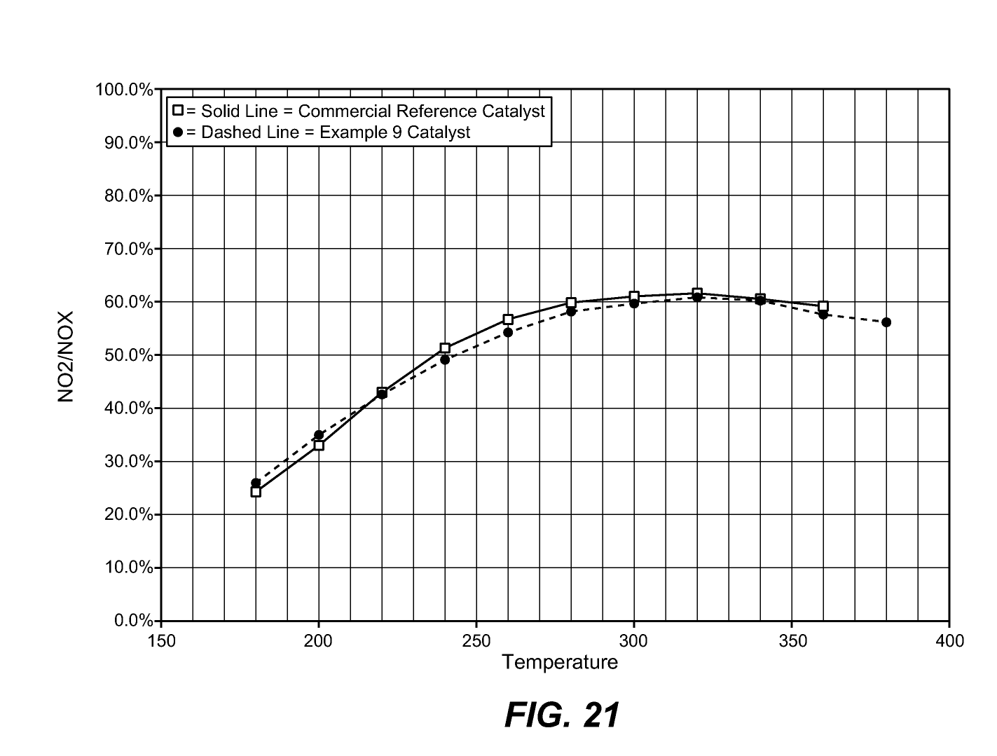

Performance data for this catalyst for oxidation of NOₓ to NO₂ at various temperatures (° C.) is shown in FIG. 21 and Table 4 (plotted as a dotted line, with circles at the data points; column marked EX. 9 CAT. in Table 4), and matches the performance of a commercially available catalyst which meets EPA specifications (plotted as a solid line, with squares at the data points; column marked COMM. CAT. in Table 1). The percentages given represent the percentage of NO₂ relative to total NOₓ present.

TABLE 4

| TEMPERATURE | COMM. CAT. | EX. 4 CAT. |
|---|---|---|
| 180 | 24.3% | 25.8% |
| 200 | 32.8% | 34.8% |
| 220 | 43.0% | 42.8% |
| 240 | 51.3% | 49.2% |
| 260 | 56.8% | 54.4% |
| 280 | 60.0% | 58.0% |
| 300 | 61.1% | 59.9% |
| 320 | 61.6% | 61.0% |
| 340 | 60.5% | 60.1% |
| 360 | 59.3% | 57.7% |
| 380 | | 56.2% |

### Testing the PNA Material for NOₓ Storage and Release

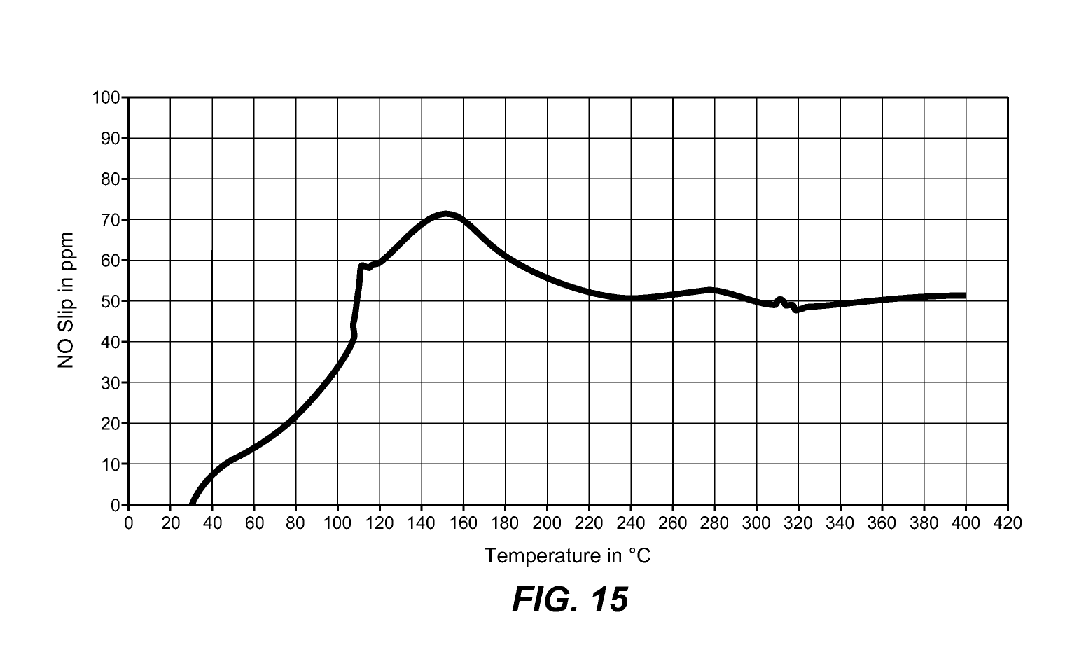

The performance of various PNA materials were tested for NOₓ storage and release temperatures. In order to test the performance of the various PNA materials, the following process was adhered to: (1) build the actual PNA samples; (2) age the samples hydrothermally; (3) test the samples for NOₓ emission storage and release using a synthetic gas mixture that mimics the exhaust of a light duty diesel vehicle. The results shown in FIGS. 15-17 are “second runs” (i.e., the PNA samples were run back to back to see whether there was any residual storage effects). Based on the results shown in FIGS. 15-17, there were none and the PNA materials release 100% of the stored NOₓ emissions.

The following Tables 1 and 2 list the Aging Conditions and Testing Protocol used to test the PNA samples.

TABLE 1
Aging Conditions

| | |
|---|---|
| Heating Rate | 2 hrs (=6.7° C./min) |
| Temperature | 750° C. |
| Holding Period | 20 hrs |
| Cool Down Rate | <3° C./min |
| Atmosphere | H₂O (~5%), O₂ (20%), N₂ |
| | (rest) |
| Volumetric Flow | N/A |

TABLE 2

| Testing Protocol | |
|---|---|
| Sample Size | 1″ × 1″core |
| GHSV | 60,000 h⁻¹ |
| Gas Mixture | Propene = 400 ppm |
| | CO = 1,200 ppm |
| | NO = 50 ppm |
| | O₂ = 12.5% |
| | CO₂ = 6% |
| | H₂O = 6.5% |
| | N₂ = Rest |
| Heating Rate | 5° C./min (100° C.-350° C.) |

FIG. 15 is a graph showing the NOₓ emission adsorption and release for manganese based PNA material across an operating temperature spectrum. As shown in FIG. 15, manganese based PNA material stores NOₓ emissions efficiently up to about 110° C. At that point, the PNA material stops adsorbing NOₓ emissions and starts releasing the adsorbed NOₓ. At about 220° C., all the stored NOₓ emissions are released. Thus, manganese based oxides are good NOₓ emission adsorbers from ambient temperature to about 100° C. In addition, the manganese based oxides exhibited a “sharp” release temperature. The slight drop in NO slippage at 110° C. is due to water being turned on.

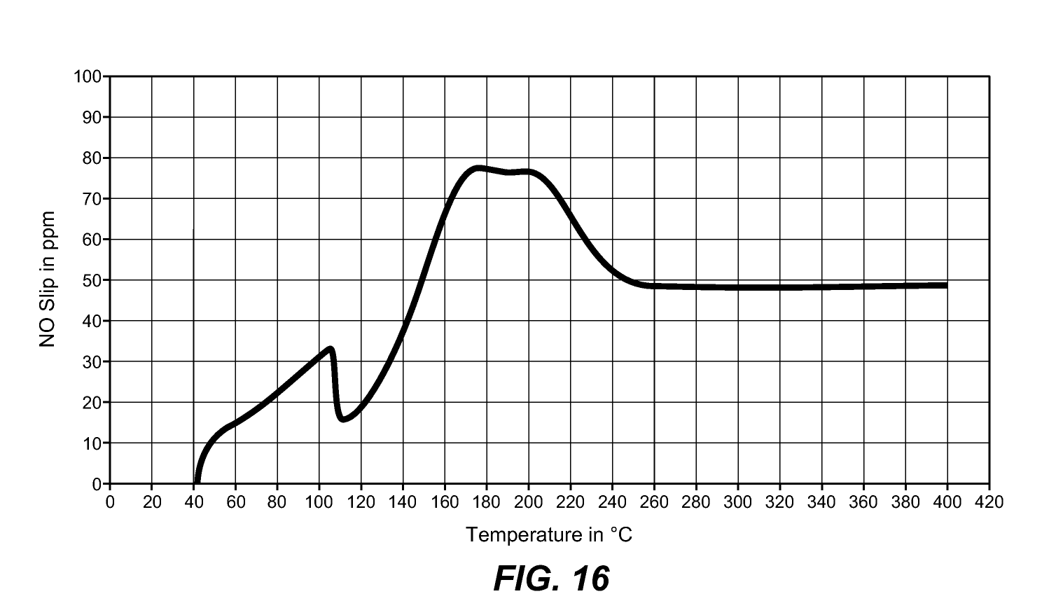

FIG. 16 is a graph showing the NOₓ emission adsorption and release for magnesium based PNA material across an operating temperature spectrum. As shown in FIG. 16, magnesium based PNA material stores NOₓ emissions efficiently up to about 150° C. At that point, the PNA material stops adsorbing NOₓ emissions and starts releasing the adsorbed NOₓ. At about 240° C., all the stored NOₓ emissions are released. Thus, magnesium based oxides are good NOₓ emission adsorbers from ambient temperature to about 150° C. In addition, the magnesium based oxides exhibited a “sharp” release temperature. The sharp drop in NO slippage at 110° C. is due to water being turned on.

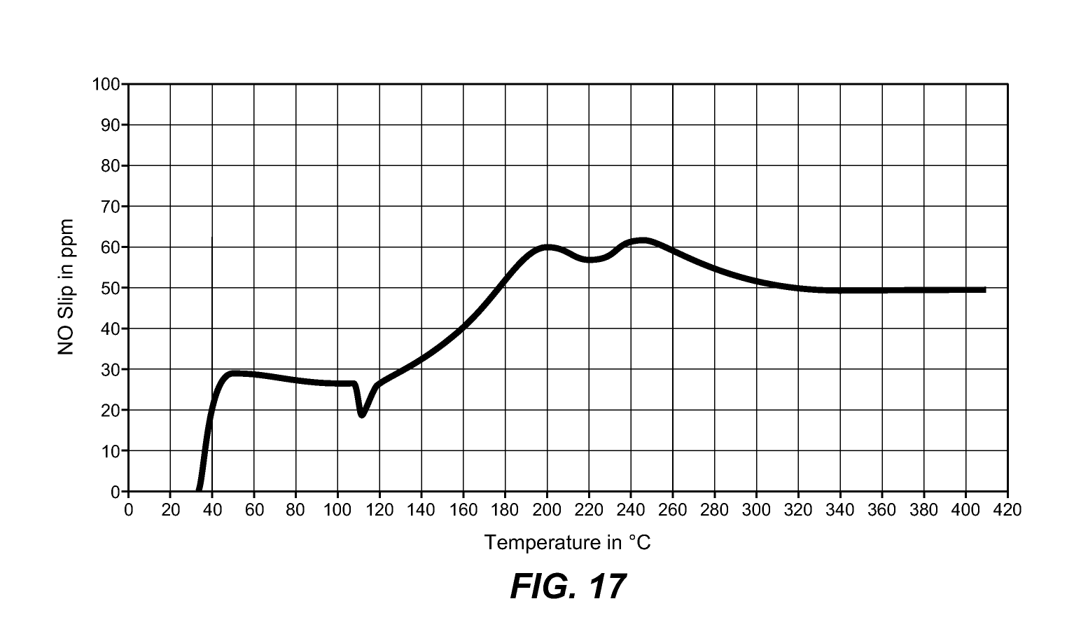

FIG. 17 is a graph showing the NOₓ emission adsorption and release for calcium based PNA material across an operating temperature spectrum. As shown in FIG. 17, calcium based PNA material stores NOₓ emissions efficiently up to about 180° C. At that point, the PNA material stops adsorbing NOₓ emissions and starts releasing the adsorbed NOₓ. At about 310° C., all the stored NOₓ emissions are released. Thus, calcium based oxides are good NOₓ emission adsorbers from ambient temperature to about 150° C. In addition, the calcium based oxides exhibited a “sharp” release temperature. The sharp drop in NO slippage at 110° C. is due to water being turned on.

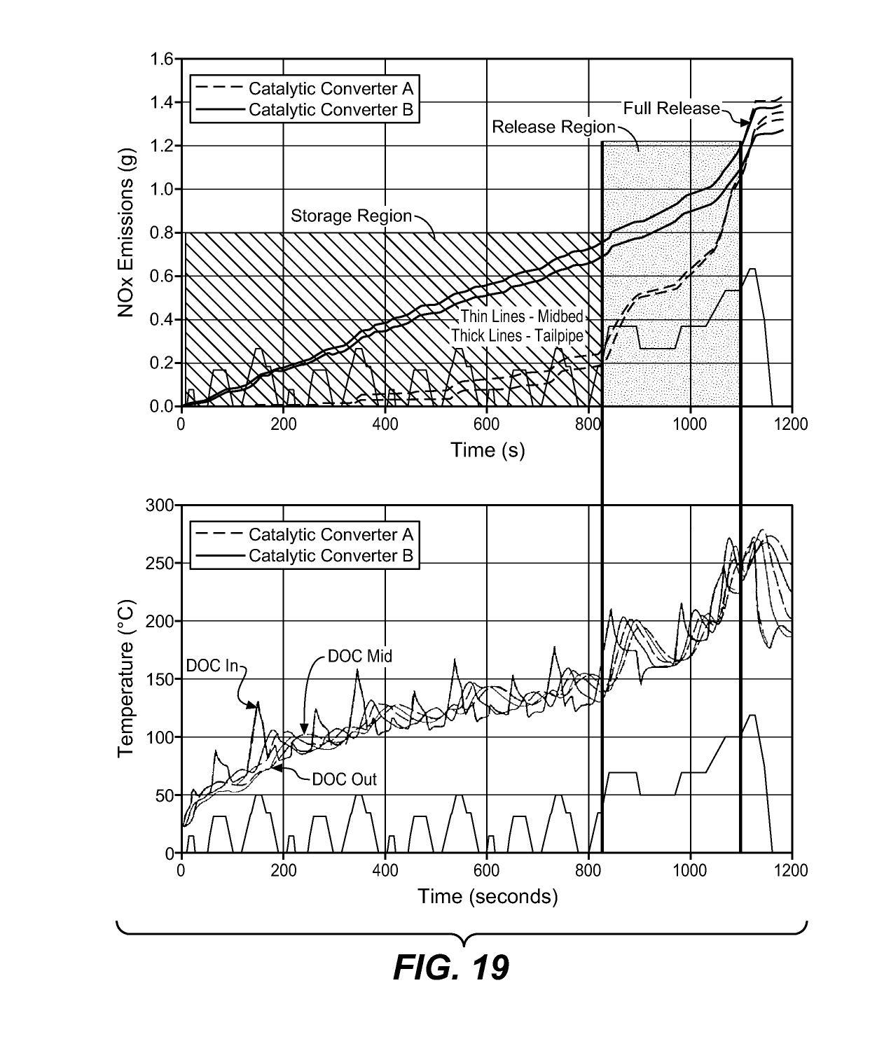

FIG. 19 illustrates NOₓ emission storage comparison performance of one embodiment of a catalytic converter employing a substrate coated with palladium based PNA material and a platinum group metal loading of the entire catalytic converter of about 2.5 g/l (catalytic converter A, dashed line) to the performance of a commercially available catalytic converter (catalytic converter B, solid line) with a platinum group metal loading of the entire catalytic converter of about 6.4 g/l.

Catalytic converter A (employing PNA material as described herein) was formed by generating a PNA washcoat including palladium on cerium oxide produced by wet chemistry methods and boehmite. The PNA washcoat was coated onto a first zone of the substrate and the substrate was dried and calcined. On a second zone of the substrate downstream the PNA zone, the substrate had a corner fill layer, a catalytic layer (on top of the corner fill layer) including NNm particles and a Pt:Pd weight ratio of 2:1, and a zeolite layer (on top of the catalytic layer), all of which as described herein. Catalytic converter B is a commercially available catalytic converter formed by wet chemistry methods. Both catalytic converters were tested under the same conditions.

As shown in FIG. 19, as the temperature of the catalytic converter B increased, the NOₓ emissions increased linearly. In contrast, as the temperature of the catalytic converter A increased, the NOₓ emissions only slightly increased until after a designated time and temperature, wherein the NOₓ emissions were sharply released. Accordingly, catalytic converter A was able to store NOₓ emissions from ambient up to about 150° C.

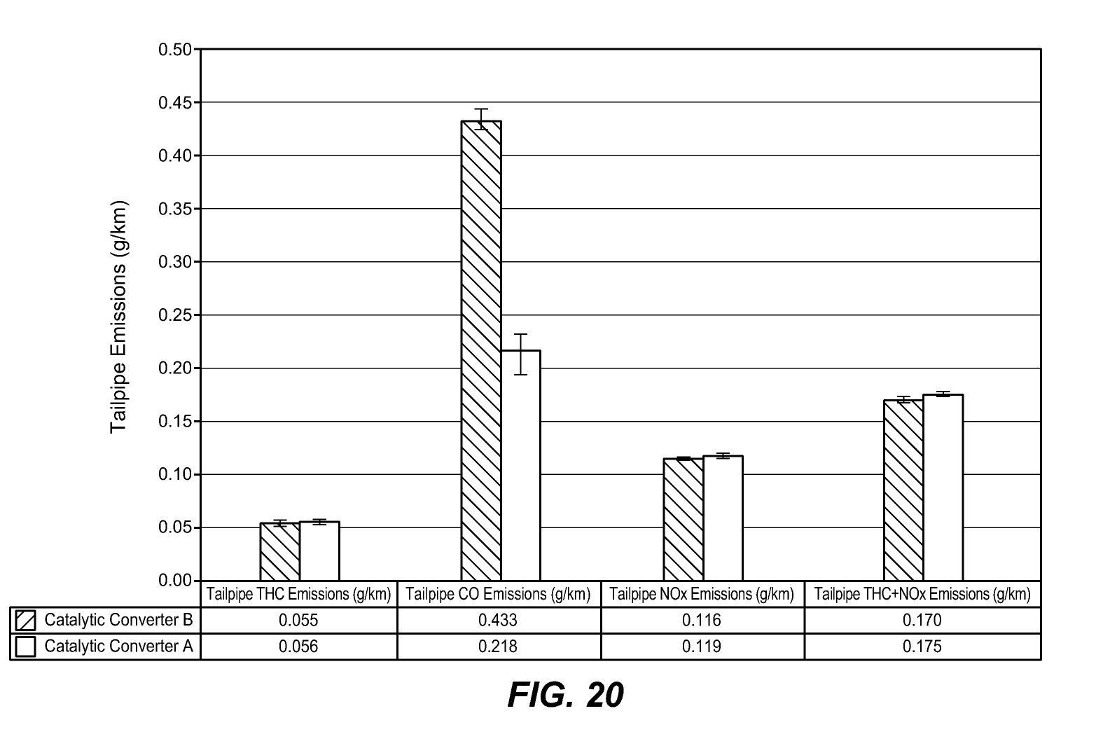

FIG. 20 illustrates a comparison of the tailpipe emissions of the catalytic converter A and the catalytic converter B. As shown in FIG. 20, catalytic converter A can have about 50% less CO emissions than catalytic converter B and use significantly less PGM thereby reducing cost.

The disclosures of all publications, patents, patent applications and published patent applications referred to herein by an identifying citation are hereby incorporated herein by reference in their entirety.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications can be made in the embodiments chosen for illustration without departing from the spirit and scope of the invention. Therefore, the description and examples should not be construed as limiting the scope of the invention.

TABLE 31
Exemplary Embodiments of Washcoat Formulations

| Corner | Alumina | | | | Alumina | | | | Alumina | | | |
|---|---|---|---|---|---|---|---|---|---|---|---|---|
| Fill | | | | | | | | | | | | |
| Layer | | | | | | | | | | | | |
| Catalytic | Pt/Pd on MI-386 (NNm) | | | | Pt/Pd on MI-386 (NNm) and | | | | Pt/Pd on MI-386 (NNm) and | | | |
| Layer | | | | | Pd on MI-386 (NNm) | | | | Pd on MI-386 (wet chem. method) | | | |
| Zeolite | Plain | Zeolite | Zeolite + | Zeolite | Plain | Zeolite | Zeolite + | Zeolite | Plain | Zeolite | Zeolite + | Zeolite |
| Layer | zeolite | (Fe) | Pd | (Fe) + | zeolite | (Fe) | Pd | (Fe) + | zeolite | (Fe) | Pd | (Fe) + |
| | | | | Pd | | | | Pd | | | | Pd |
| Corner | Zeolite + | | Zeolite | | Zeolite + | | Zeolite | | | | | |
| Fill | Pd | | (Fe) + | | Pd | | (Fe) + | | | | | |
| Layer | | | Pd | | | | Pd | | | | | |
| Catalytic | Pt/Pd on MI-386 (NNm) and | | | | Pt/Pd on MI-386 (NNm) and | | | | | | | |
| Layer | Pd on MI-386 (NNm) | | | | Pd on MI-386 (wet chem. method) | | | | | | | |
| Zeolite | Plain | Zeolite | Zeolite + | Zeolite | Plain | Zeolite | Zeolite + | Zeolite | | | | |
| Layer | zeolite | (Fe) | Pd | (Fe) + | zeolite | (Fe) | Pd | (Fe) + | | | | |
| | | | | Pd | | | | Pd | | | | |
| Corner | Plain | | Zeolite | | Plain | | Zeolite | | | | | |
| Fill | zeolite | | (Fe) | | zeolite | | (Fe) | | | | | |
| Layer | | | | | | | | | | | | |
| Catalytic | Pt/Pd on MI-386 (NNm) and | | | | Pt/Pd on MI-386 (NNm) and | | | | | | | |
| Layer | Pd on MI-386 (NNm) | | | | Pd on MI-386 (wet chem. method) | | | | | | | |
| Zeolite | Plain | Zeolite | Zeolite + | Zeolite | Plain | Zeolite | Zeolite + | Zeolite | | | | |
| Layer | zeolite | (Fe) | Pd | (Fe) + | zeolite | (Fe) | Pd | (Fe) + | | | | |
| | | | | Pd | | | | Pd | | | | |
| Corner | Pt/Pd on MI-386 (NNm) | | | | Pt/Pd on MI-386 (NNm) | | | | Pt/Pd on MI-386 (NNm) | | | |
| Fill | | | | | | | | | | | | |
| Layer | | | | | | | | | | | | |
| Catalytic | Pt/Pd on MI-386 (NNm) | | | | Pt/Pd on MI-386 (NNm) and | | | | Pt/Pd on MI-386 (NNm) and | | | |
| Layer | | | | | Pd on MI-386 (NNm) | | | | Pd on MI-386 (wet chem. method) | | | |
| Zeolite | Plain | Zeolite | Zeolite + | Zeolite | Plain | Zeolite | Zeolite + | Zeolite | Plain | Zeolite | Zeolite + | Zeolite |
| Layer | zeolite | (Fe) | Pd | (Fe) + | zeolite | (Fe) | Pd | (Fe) + | zeolite | (Fe) | Pd | (Fe) + |
| | | | | Pd | | | | Pd | | | | Pd |

| Corner | Pt/Pd on MI-386 (NNm) and | | | | Pt/Pd on MI-386 (NNm) and | | | | | |
|---|---|---|---|---|---|---|---|---|---|---|
| Fill | Pd on MI-386 (NNm) | | | | Pd on MI-386 (NNm) | | | | | |
| Layer | | | | | | | | | | |
| Catalytic | Pt/Pd on MI-386 (NNm) and | | | | Pt/Pd on MI-386 (NNm) and | | | | | |
| Layer | Pd on MI-386 (NNm) | | | | Pd on MI-386 (wet chem. method) | | | | | |
| Zeolite | Plain | Zeolite | Zeolite + | Zeolite | Plain | Zeolite | Zeolite + | Zeolite | | |
| Layer | zeolite | (Fe) | Pd | (Fe) + | zeolite | (Fe) | Pd | (Fe) + | | |
| | | | | Pd | | | | Pd | | |
| Corner | Pt/Pd on MI-386 (NNm) and | | | | Pt/Pd on MI-386 (NNm) and | | | | | |
| Fill | Pd on MI-386 (wet chem. method) | | | | Pd on MI-386 (wet chem. method) | | | | | |
| Layer | | | | | | | | | | |
| Catalytic | Pt/Pd on MI-386 (NNm) and | | | | Pt/Pd on MI-386 (NNm) and | | | | | |
| Layer | Pd on MI-386 (NNm) | | | | Pd on MI-386 (wet chem. method) | | | | | |
| Zeolite | Plain | Zeolite | Zeolite + | Zeolite | Plain | Zeolite | Zeolite + | Zeolite | | |
| Layer | zeolite | (Fe) | Pd | (Fe) + | zeolite | (Fe) | Pd | (Fe) + | | |
| | | | | Pd | | | | Pd | | |
| Corner | Alumina | | | | Zeolite + | | Zeolite | | Plain | Zeolite |
| Fill | | | | | Pd | | (Fe) + | | zeolite | (Fe) |
| Layer | | | | | | | Pd | | | |
| Catalytic | Pt on MI-386 (NNm) | | | | Pt on MI-386 (NNm) | | | | Pt on MI-386 (NNm) | |
| Layer | | | | | | | | | | |
| Zeolite | Zeolite + | | Zeolite | | Plain | Zeolite | Zeolite + | Zeolite | Zeolite + | Zeolite |
| Layer | Pd | | (Fe) + | | zeolite | (Fe) | Pd | (Fe) + | Pd | (Fe) + |
| | | | Pd | | | | | Pd | | Pd |
| Corner | Pt on MI-386 (NNm) | | | | Pt on MI-386 (NNm) | | | | | |
| Fill | | | | | | | | | | |
| Layer | | | | | | | | | | |
| Catalytic | Pt on MI-386 (NNm) and | | | | Pt on MI-386 (NNm) and | | | | | |
| Layer | Pd on MI-386 (NNm) | | | | Pd on MI-386 (wet chem. method) | | | | | |
| Zeolite | Plain | Zeolite | Zeolite + | Zeolite | Plain | Zeolite | Zeolite + | Zeolite | | |
| Layer | zeolite | (Fe) | Pd | (Fe) + | zeolite | (Fe) | Pd | (Fe) + | | |
| | | | | Pd | | | | Pd | | |

1. A coated substrate comprising:
a substrate comprising a first zone and a second zone;
the first zone comprising a Passive NOx Adsorber (PNA) layer comprising nano-sized platinum group metal (PGM) on a plurality of support particles comprising cerium oxide; and
the second zone comprising a first catalytic layer comprising a first composite nanoparticle, wherein the first composite nanoparticle comprises a first catalytic nanoparticle on a first support nanoparticle.

2. The coated substrate of claim 1, wherein the first composite nanoparticle is plasma created.

3. (canceled)

4. The coated substrate of claim 1, wherein the first composite nanoparticle is bonded to a micron-sized carrier particle to form a first NNm particle.

5. The coated substrate of claim 1, wherein the first composite nanoparticle is embedded within carrier particles to form a first NNiM particle.

6. The coated substrate of claim 1, wherein the second zone further comprises a second catalytic layer comprising a second composite nanoparticle, wherein the second composite nanoparticle comprises a second catalytic nanoparticle on a second support nanoparticle.

7-8. (canceled)

9. The coated substrate of claim 1, wherein the first, second, or first and second catalytic nanoparticles comprise platinum and palladium.

10-12. (canceled)

13. The coated substrate of claim 1, wherein the second zone further comprises a zeolite layer comprising zeolite particles.

14. The coated substrate of claim 13, wherein the zeolite layer does not include platinum group metals.

15-20. (canceled)

21. The coated substrate of claim 1, wherein the PNA layer stores NOₓ gas up to at least a first temperature and releases the stored NOₓ gas at or above the first temperature.

22. The coated substrate of claim 21, wherein the first temperature is 150° C.

23-24. (canceled)

25. The coated substrate of claim 1, wherein the plurality of support particles further comprise zirconium oxide, lanthanum oxide, yttrium oxide, or a combination thereof.

26. The coated substrate of claim 25, wherein the plurality of support particles comprise HSA5, HSA20, or a mixture thereof.

27-28. (canceled)

29. The coated substrate of claim 1, wherein the nano-sized PGM on the plurality of support particles comprise PNA composite nanoparticles, wherein the PNA composite nanoparticles comprise a PGM nanoparticle on a third support particle comprising cerium oxide.

30-53. (canceled)

54. A catalytic converter comprising a coated substrate according to claim 1.

55. An exhaust treatment system comprising a conduit for exhaust gas and a catalytic converter according to claim 54.

56. A vehicle comprising a catalytic converter according to claim 54.

57-60. (canceled)

61. A method of treating an exhaust gas, comprising contacting the coated substrate of claim 1 with the exhaust gas.

62. The method of claim 61, wherein the exhaust gas contacts the first zone of the substrate before contacting the second zone of the substrate.

63-64. (canceled)

65. A method of forming a coated substrate comprising:
coating a first zone of a substrate with a Passive NOx Adsorber (PNA) washcoat composition comprising nano-sized platinum group metal (PGM) on a plurality of support particles comprising cerium oxide; and
coating a second zone of the substrate with a first catalytic washcoat composition comprising a first composite nanoparticle, wherein the first composite nanoparticle comprises a first catalytic nanoparticle on a first support nanoparticle.

66-128. (canceled)

129. A method of treating an exhaust gas, comprising:
contacting a coated substrate with an exhaust gas comprising NOₓ emissions, wherein the coated substrate comprises:
a substrate comprising a first zone and a second zone;
the first zone comprising a Passive NOx Adsorber (PNA) layer comprising nano-sized platinum group metal (PGM) on a plurality of support particles comprising cerium oxide; and
the second zone comprising a first catalytic layer comprising a first composite nanoparticle, wherein the first composite nanoparticle comprises a first catalytic nanoparticle on a first support nanoparticle.

130-182. (canceled)

183. A catalytic converter comprising:
a coated substrate comprising:
a substrate comprising a first zone and a second zone;
the first zone comprising a Passive NOx Adsorber (PNA) layer comprising nano-sized platinum group metal (PGM) on a plurality of support particles comprising cerium oxide; and
the second zone comprising a first catalytic layer comprising a first composite nanoparticle, wherein the first composite nanoparticle comprises a first catalytic nanoparticle on a first support nanoparticle.

184-233. (canceled)

234. A vehicle comprising a catalytic converter comprising a coated substrate comprising:
a substrate comprising a first zone and a second zone;
the first zone comprising a Passive NOx Adsorber (PNA) layer comprising nano-sized platinum group metal (PGM) on a plurality of support particles comprising cerium oxide; and
the second zone comprising a first catalytic layer comprising a first composite nanoparticle, wherein the first composite nanoparticle comprises a first catalytic nanoparticle on a first support nanoparticle.

235-291. (canceled)

292. An exhaust treatment system comprising a conduit for exhaust gas comprising NOₓ emissions and a catalytic converter comprising a coated substrate comprising:
a substrate comprising a first zone and a second zone;
the first zone comprising a Passive NOx Adsorber (PNA) layer comprising nano-sized platinum group metal (PGM) on a plurality of support particles comprising cerium oxide; and
the second zone comprising a first catalytic layer comprising a first composite nanoparticle, wherein the first composite nanoparticle comprises a first catalytic nanoparticle on a first support nanoparticle.

293-348. (canceled)
